(19) United States
(12) Patent Application Publication
(10) Pub. No.: US 2026/0126221 A1
(43) Pub. Date: May 7, 2026

(54) COMPOSITIONS COMPRISING FLUOROOLEFINS AND NATURAL REFRIGERANTS AND USES THEREOF

(71) Applicant: THE CHEMOURS COMPANY FC, LLC, WILMINGTON, DE (US)

(72) Inventors: JOSHUA HUGHES, WILMINGTON, DE (US); SHENG PENG, HOCKESSIN, DE (US); LUKE DAVID SIMONI, WILMINGTON, DE (US)

(73) Assignee: THE CHEMOURS COMPANY FC, LLC, WILMINGTON, DE (US)

(21) Appl. No.: 19/424,427

(22) Filed: Dec. 18, 2025

Related U.S. Application Data
(63) Continuation-in-part of application No. PCT/US2025/034101, filed on Jun. 18, 2025.
(60) Provisional application No. 63/662,898, filed on Jun. 21, 2024.
(60) Provisional application No. 63/676,102, filed on Jul. 26, 2024.

(51) Int. Cl. F25B 30/02; C09K 5/04

(52) U.S. Cl. CPC F25B 30/02; C09K 5/045; C09K 2205/126; F25B 2400/121

(57) ABSTRACT

Refrigerant blends of HFOs and HCs, having HFOs as the main component, provide better cooling capacity than incumbent HFOs and maintain low flammability. Refrigerant blends of HFOs and HCs, having HCs as the main component, allow for larger HC charge at reduced flammability. Such compositions include (i) at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, (ii) at least one other compound selected from HC-290, HC-1270, R-600, R-600a, R-601, R-601a, R-744, R-717, and combinations thereof, and optionally (iii) at least one other compound selected from HFC-134, HFC-134a, HFC-125, HFC-32, HFC-152a, and combinations thereof. These compositions are useful as refrigerants in air conditioning, heat pumps, refrigeration, and/or chillers.

### CROSS-REFERENCE TO RELATED APPLICATIONS

This application is a Continuation-in-Part of International PCT Application No. PCT/US2025/034101 filed Jun. 18, 2025, which claims the benefit of U.S. Patent Application No. 63/662,898, filed Jun. 21, 2024, and U.S. Patent Application No. 63/676,102, filed Jul. 26, 2024, the disclosures of which are all incorporated herein by reference in their entireties.

### FIELD

The present invention is directed to fluoroolefin refrigerant compositions, methods and systems using the same, and systems containing the E-HFO-1234ze refrigerant compositions.

### BACKGROUND

The fluorocarbon industry has been working for the past few decades to find replacement refrigerants for ozone depleting chlorofluorocarbons (CFCs), such as CFC-11 and CFC-12, and hydrochlorofluorocarbons (HCFCs) being phased out as a result of the Montreal Protocol. The solution for many applications has been the commercialization of hydrofluorocarbon (HFC) compounds for use as refrigerants, solvents, fire extinguishing agents, foam blowing agents and propellants. These new compounds, such as HFC-refrigerants, HFC-134a and HFC-125 being the most widely used at this time, have zero ozone depletion potential (ODP) and thus are not affected by the current regulatory phase-out as a result of the Montreal Protocol. In addition to ozone depleting concerns, global warming is another environmental concern in many applications. HFC refrigerants such as HFC-134a and HFC-125 respectively have global warming potentials (GWP) of 1,430 and 3,500 according to the UN's IPCC Fourth Assessment Report (AR4).

This regulatory landscape is continuously evolving, taking into consideration properties beyond just ODP and GWP. More particularly, there is a need for refrigerants composition that not only meet low ODP standards and have lower (<500 GWP or <300 GWP) or low (<150 GWP) global warming potentials, but that also exhibit low or no flammability, provide superior performance in a variety of applications and which meet the standards of evolving regulations.

There is a need in this art for new refrigerant compositions that meet evolving regulations as well as provide heat transfer and refrigerant characteristics that meet or exceed the effectiveness of conventional refrigerant and refrigerant blends.

Fluoroolefins, and more particularly hydrofluoroolefins (HFOs), have been replacing saturated CFCs, HCFCs, and HFCs in a variety of applications for several years. HFOs have low ODP and low GWP as compared to ozone depleting CFCs (e.g., trichlorofluoromethane (CFC-11) and CFC-12 (dichlorodifluoromethane)) and high GWP HFCs (e.g., pentafluoroethane (HFC-125) and 1,1,1,2-tetrafluoroethane (HFC-134a), while maintaining their nonflammable or mildly flammable properties. For example, E-1,3,3,3-tetrafluoropropene (E-HFO-1234ze), like 2,3,3,3-tetrafluoropropene (HFO-1234yf), has zero ozone depletion and very low global warming potential, and has thus been identified as a potential useful refrigerant. For example, U.S. Pat. No. 7,862,742 discloses compositions comprising E-HFC-1234ze and HFO-1234yf. U.S. Pat. No. 9,302,962 discloses methods for making E-HFO-1234ze. The disclosures of U.S. Pat. Nos. 7,862,742 and 9,302,962 are hereby incorporated by reference in their entireties. E-HFO-1234ze, which, in addition to zero ozone depletion and very low global warming potential, has a boiling point of −19.0° C. and possesses physical properties that make it an attractive option for refrigeration, air conditioning, and heat pump applications.

However, HFOs often bear higher costs than CFCs and HFCs, due to more complex manufacturing processes. So-called natural thermal management fluids, also typically referred to as A3 refrigerants, such as HC-290 (propane), HC-1270 (propylene), R-600 (butane), R-600a (isobutane), exhibit acceptable performance and are cost effective. However, the high flammability of A3 refrigerants limits their charge size. In 2019, the International Electrotechnical Commission (IEC) 60336-2-89 standard was updated to increase the charge limit for A3 refrigerants, including HC-290 and R-600a, to 500 grams, at the international level.

The present invention provides refrigerant compositions that have HFO and HC blends with HFOs as the main component, at reduced costs relative to HFO blends, while have better cooling capacity and maintaining low flammability, while also meeting the evolving regulatory landscape. The present invention also provides compositions having HC and HFO blends having HCs as the main component, which allow for large HC charge at reduced flammability, while also meeting the evolving regulatory landscape.

### SUMMARY

The present disclosure relates to compositions comprising at least one compound selected from (i) trans-1,3,3,3-tetrafluoropropene (E-HFO-1234ze or HFO-1234ze(E)), cis-1,3,3,3-tetrafluoropropene (Z-HFO-1234ze or HFO-1234ze(Z)), trans-1,1,1,4,4,4-hexafluoro-2-butene (E-HFO-1336mzz or HFO-1336mzz(E)), cis-1,1,1,4,4,4-hexafluoro-2-butene (Z-HFO-1336mzz or HFO-1336mzz(Z)), trans-1-chloro-3,3,3-trifluoropropene (E-HCFO-1233zd or HCFO-1233zd(E)), cis-1-chloro-3,3,3-trifluoropropene (Z-HCFO-1233zd or HCFO-1233zd(Z)), 1,2-dichloro-1,2-difluoroethylene (CFO-1112), and combinations thereof; and (ii) at least one other compound selected from HC-290 (propane), HC-1270 (propylene), R-600 (butane), R-600a (isobutane), isobutene, R-601 (pentane), R-601a (isopentane), R-744 (carbon dioxide), R-717 (ammonia), and combinations thereof.

In some embodiments, present invention relates to compositions comprising at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof; (ii) at least one other compound selected from HC-290, HC-1270, R-600, R-600a, isobutene, R-601, R-601a, R-744, R-717, and combinations thereof; and optionally (iii) at least one other compound selected from 1,1,2,2-tetrafluoroethane (HFC-134), 1,1,1,2-tetrafluoroethane (HFC-134a), pentafluoroethane (HFC-125), difluoromethane (HFC-32), 1,1-difluoroethane (HFC-152a), and combinations thereof.

In one aspect of the invention the compositions include refrigerant blends containing one of:
a. HFO-1234ze(E) and HC-290;
b. HFO-1234ze(E) and HC-1270;
c. HFO-1234ze(E) and R-600;
d. HFO-1234ze(E) and R-600a; and
e. HFO-1234ze(E) and R-717.

In one aspect of the invention the compositions include refrigerant blends containing one of:
a. HFO-1234ze(Z) and R-600;
b. HFO-1234ze(Z) and R-600a;
c. HFO-1234ze(Z) and R-601; and
d. HFO-1234ze(Z) and isobutene.

According to any of the foregoing embodiments, also disclosed herein are compositions comprising from about 2 to about 98 weight percent HFO-1234ze(E), from about 2 to about 98 weight percent HC-290.

According to any of the foregoing embodiments, also disclosed herein are compositions comprising from about 2 to about 98 weight percent HFO-1234ze(E), from about 2 to about 98 weight percent HC-1270.

According to any of the foregoing embodiments, also disclosed herein are compositions comprising from about 2 to about 98 weight percent HFO-1234ze(E), from about 2 to about 98 weight percent R-600.

According to any of the foregoing embodiments, also disclosed herein are compositions comprising from about 2 to about 98 weight percent HFO-1234ze(E), from about 2 to about 98 weight percent R-600a.

According to any of the foregoing embodiments, also disclosed herein are compositions comprising from about 2 to about 98 weight percent HFO-1234ze(E), from about 2 to about 98 weight percent R-717.

According to any of the foregoing embodiments, also disclosed herein are compositions comprising from about 2 to about 98 weight percent HFO-1234ze(Z), from about 2 to about 98 weight percent R-600.

According to any of the foregoing embodiments, also disclosed herein are compositions comprising from about 2 to about 98 weight percent HFO-1234ze(Z), from about 2 to about 98 weight percent R-600a.

According to any of the foregoing embodiments, also disclosed herein are compositions comprising from about 2 to about 98 weight percent HFO-1234ze(Z), from about 2 to about 98 weight percent R-601.

According to any of the foregoing embodiments, also disclosed herein are compositions comprising from about 2 to about 98 weight percent HFO-1234ze(E), from about 2 to about 98 weight percent HFC-134, and from about 2 to about 98 weight percent R-600.

According to any of the foregoing embodiments, also disclosed herein are compositions comprising from about 2 to about 98 weight percent HFO-1234ze(E), from about 2 to about 98 weight percent HFC-134, and from about 2 to about 98 weight percent R-600a.

According to any of the foregoing embodiments, also disclosed herein are compositions comprising from about 2 to about 98 weight percent HFO-1234ze(E), from about 2 to about 98 weight percent HFC-134, and from about 2 to about 98 weight percent HC-290.

According to any of the foregoing embodiments, also disclosed herein are compositions comprising from about 2 to about 98 weight percent HCFO-1233zd(E), from about 2 to about 98 weight percent HFC-134, and from about 2 to about 98 weight percent R-600.

According to any of the foregoing embodiments, also disclosed herein are compositions comprising from about 2 to about 98 weight percent HFO-1234ze(Z), from about 2 to about 98 weight percent and trans-1,2-dichloroethylene (t-DCE), and from about 2 to about 98 weight percent R-601.

According to any of the foregoing embodiments, also disclosed herein are compositions comprising from about 2 to about 98 weight percent HFO-1234ze(Z), from about 2 to about 98 weight percent HFO-1336mzz(E), and from about 2 to about 98 weight percent R-601.

According to any of the foregoing embodiments, also disclosed herein are compositions comprising from about 2 to about 98 weight percent HFO-1234ze(Z), from about 2 to about 98 weight percent HFO-1336mzz(Z), and from about 2 to about 98 weight percent R-601.

According to any of the foregoing embodiments, also disclosed herein are compositions comprising from about 2 to about 98 weight percent HFO-1336mzz(E), from about 2 to about 98 weight percent HFC-134, and from about 2 to about 98 weight percent R-600.

According to any of the foregoing embodiments, also disclosed herein are compositions comprising from about 2 to about 98 weight percent HFO-1234ze(Z) and from about 2 to about 98 weight percent isobutene.

According to any of the foregoing embodiments, also disclosed herein are compositions further comprising less than 100 ppm (weight) water, or less than 20 ppm (weight) water, or less than 10 ppm (weight) water.

According to any of the foregoing embodiments, also disclosed herein are compositions further comprising less than 5 volume percent non-adsorbable gases (NAG) or less than 3 volume percent NAG, or less than 1.5 volume percent NAG.

According to any of the foregoing embodiments, also disclosed herein are compositions further comprising a stabilizer.

According to any of the foregoing embodiments, also disclosed herein are compositions further comprising a lubricant selected from polyol ester, polyvinyl ether, and polyalkylene glycol.

According to any of the foregoing embodiments, also disclosed herein are compositions wherein said composition has global warming potential per IPCC AR4 less than 750, or less than 300, or less than 150.

According to any of the foregoing embodiments, also disclosed herein are compositions wherein said composition is characterized as flammability class 1 (non-flammable), flammability class 2L (mildly flammable), or flammability class 2.

According to any of the foregoing embodiments, also disclosed herein are compositions wherein the composition is free of or substantially free of Group A Fluorinated Substances, as defined herein.

According to any of the foregoing embodiments, also disclosed herein are compositions wherein degradation products of the composition are free of or substantially free of Group A Fluorinated Substances.

According to any of the foregoing embodiments, also disclosed herein is a process for producing cooling comprising condensing any of the foregoing compositions and thereafter evaporating said composition in the vicinity of a body to be cooled.

According to any of the foregoing embodiments, also disclosed herein is a process for producing heating comprising evaporating any of the foregoing compositions and thereafter condensing said composition in the vicinity of a body to be heated.

According to any of the foregoing embodiments, also disclosed herein is a refrigeration, air conditioning, heat pump, or chiller apparatus containing any of the foregoing compositions. The apparatus comprises an evaporator, a compressor, a condenser, and an expansion device. In one embodiment, the apparatus is a chiller. I another embodiment the apparatus is a heat pump. In another embodiment, the heat pump is a high temperature heat pump system. In another embodiment, the apparatus is an air conditioner or air conditioning system. In another embodiment, the apparatus is a medium temperature refrigeration system or a low temperature refrigeration system. In another embodiment, the apparatus is a stand-alone refrigeration system, such as a beverage cooler, vending machine or ice machine.

According to any of the foregoing embodiments, also disclosed herein are methods of replacing a first refrigerant in a heat transfer system comprising providing any of the foregoing compositions to said heat transfer system, wherein the first refrigerant is selected from HCFC-22, HFC-134a, HFO-1234yf, HFO-1234ze(E), R-407C, R-404A, R-410A, R-444A, R-454A, R-454B, R-454C, R-448A, R-449A, R-449B, R-449C, R-456A, R-471A, R-476A, R-482A, R-452A, R-452C, R-513A, R-515B, or propane.

### BRIEF DESCRIPTION OF THE SEVERAL VIEWS OF THE DRAWINGS

The following detailed description of preferred embodiments of the present invention will be better understood when read in conjunction with the appended drawing. For the purposes of illustrating the invention, there is shown in the drawing an embodiment which is presently preferred. It is understood, however, that the invention is not limited to the precise arrangements and instrumentalities shown. In the drawings:

FIGS. 1A, 1B and 1C provide graphical representations of the average glide, the CAP relative to the incumbent fluid, and the COP relative to the incumbent fluid, respectively, for a composition according to Example 1;

FIGS. 2A, 2B and 2C provide graphical representations of the average glide, the CAP relative to the incumbent fluid, and the COP relative to the incumbent fluid, respectively, for a composition according to Example 2;

FIGS. 3A, 3B and 3C provide graphical representations of the average glide, the CAP relative to the incumbent fluid, and the COP relative to the incumbent fluid, respectively, for a composition according to Example 3;

FIGS. 4A, 4B and 4C provide graphical representations of the average glide, the CAP relative to the incumbent fluid, and the COP relative to the incumbent fluid, respectively, for a composition according to Example 4;

FIGS. 5A, 5B and 5C provide graphical representations of the average glide, the CAP relative to the incumbent fluid, and the COP relative to the incumbent fluid, respectively, for a composition according to Example 5;

FIGS. 6A, 6B and 6C provide graphical representations of the average glide, the CAP relative to the incumbent fluid, and the COP relative to the incumbent fluid, respectively, for a composition according to Example 6;

FIGS. 7A, 7B and 7C provide graphical representations of the average glide, the CAP for cooling relative to the incumbent fluid, and the COP relative to the incumbent fluid, respectively, for a composition according to Example 8;

FIGS. 7D, 7E and 7F provide graphical representations of the average glide, the CAP for heating relative to the incumbent fluid, and the COP relative to the incumbent fluid, respectively, for a composition according to Example 8;

FIGS. 8A, 8B and 8C provide graphical representations of the average glide, the CAP for cooling relative to the incumbent fluid, and the COP relative to the incumbent fluid, respectively, for a composition according to Example 9;

FIGS. 8D, 8E and 8F provide graphical representations of the average glide, the CAP for heating relative to the incumbent fluid, and the COP relative to the incumbent fluid, respectively, for a composition according to Example 9;

FIGS. 9A, 9B and 9C provide graphical representations of the average glide, the CAP for cooling relative to the incumbent fluid, and the COP relative to the incumbent fluid, respectively, for a composition according to Example 10;

FIGS. 9D, 9E and 9F provide graphical representations of the average glide, the CAP for heating relative to the incumbent fluid, and the COP relative to the incumbent fluid, respectively, for a composition according to Example 10;

FIGS. 10A, 10B and 10C provide graphical representations of the average glide, the CAP relative to the incumbent fluid, and the COP relative to the incumbent fluid, respectively, for a composition according to Example 11;

FIGS. 11A, 11B and 11C provide graphical representations of the average glide, the CAP relative to the incumbent fluid, and the COP relative to the incumbent fluid, respectively, for a composition according to Example 12;

FIGS. 12A, 12B and 12C provide graphical representations of the average glide, the CAP relative to the incumbent fluid, and the COP relative to the incumbent fluid, respectively, for a composition according to Example 13;

FIGS. 13A, 13B and 13C provide graphical representations of the average glide, the CAP relative to the incumbent fluid, and the COP relative to the incumbent fluid, respectively, for a composition according to Example 14;

FIGS. 14A, 14B and 14C provide graphical representations of the average glide, the CAP relative to the incumbent fluid, and the COP relative to the incumbent fluid, respectively, for a composition according to Example 15;

FIGS. 15A, 15B and 15C provide graphical representations of the average glide, the CAP relative to the incumbent fluid, and the COP relative to the incumbent fluid, respectively, for a composition according to Example 16;

FIGS. 16A, 16B and 16C provide graphical representations of the average glide, the CAP relative to the incumbent fluid, and the COP relative to the incumbent fluid, respectively, for a composition according to Example 17;

FIGS. 17A, 17B and 17C provide graphical representations of the average glide, the CAP relative to the incumbent fluid, and the COP relative to the incumbent fluid, respectively, for a composition according to Example 18;

FIGS. 18A, 18B and 18C provide graphical representations of the average glide, the CAP relative to the incumbent fluid, and the COP relative to the incumbent fluid, respectively, for a composition according to Example 19;

FIGS. 19A, 19B and 19C provide graphical representations of the average glide, the CAP relative to the incumbent fluid, and the COP relative to the incumbent fluid, respectively, for a composition according to Example 20;

FIGS. 20A, 20B and 20C provide graphical representations of the average glide, the CAP relative to the incumbent fluid, and the COP relative to the incumbent fluid, respectively, for a composition according to Example 21;

FIGS. 21A, 21B and 21C provide graphical representations of the average glide, the CAP relative to the incumbent fluid, and the COP relative to the incumbent fluid, respectively, for a composition according to Example 22;

FIGS. 22A, 22B and 22C provide graphical representations of the average glide, the CAP relative to the incumbent fluid, and the COP relative to the incumbent fluid, respectively, for a composition according to Example 23;

FIGS. 23A, 23B and 23C provide graphical representations of the average glide, the CAP relative to the incumbent fluid, and the COP relative to the incumbent fluid, respectively, for a composition according to Example 24;

FIGS. 24A, 24B and 24C provide graphical representations of the average glide, the CAP relative to the incumbent fluid, and the COP relative to the incumbent fluid, respectively, for a composition according to Example 25;

FIGS. 25A, 25B and 25C provide graphical representations of the average glide, the CAP relative to the incumbent fluid, and the COP relative to the incumbent fluid, respectively, for a composition according to Example 26;

FIGS. 26A, 26B and 26C provide graphical representations of the average glide, the CAP relative to the incumbent fluid, and the COP relative to the incumbent fluid, respectively, for a composition according to Example 27;

FIGS. 27A, 27B and 27C provide graphical representations of the average glide, the CAP relative to the incumbent fluid, and the COP relative to the incumbent fluid, respectively, for a composition according to Example 28;

FIGS. 28A, 28B and 28C provide graphical representations of the average glide, the CAP relative to the incumbent fluid, and the COP relative to the incumbent fluid, respectively, for a composition according to Example 29;

FIGS. 29A, 29B and 29C provide graphical representations of the average glide, the CAP for cooling relative to the incumbent fluid, and the COP relative to the incumbent fluid, respectively, for a composition according to Example 31;

FIGS. 29D, 29E and 29F provide graphical representations of the average glide, the CAP for heating relative to the incumbent fluid, and the COP relative to the incumbent fluid, respectively, for a composition according to Example 31;

FIGS. 30A, 30B and 30C provide graphical representations of the average glide, the CAP for cooling relative to the incumbent fluid, and the COP relative to the incumbent fluid, respectively, for a composition according to Example 32;

FIGS. 30D, 30E and 30F provide graphical representations of the average glide, the CAP for heating relative to the incumbent fluid, and the COP relative to the incumbent fluid, respectively, for a composition according to Example 32;

FIGS. 31A, 31B and 31C provide graphical representations of the average glide, the CAP relative to the incumbent fluid, and the COP relative to the incumbent fluid, respectively, for a composition according to Example 35;

FIGS. 32A, 32B and 32C provide graphical representations of the average glide, the CAP relative to the incumbent fluid, and the COP relative to the incumbent fluid, respectively, for a composition according to Example 36;

FIGS. 33A, 33B and 33C provide graphical representations of the average glide, the CAP relative to the incumbent fluid, and the COP relative to the incumbent fluid, respectively, for a composition according to Example 37;

FIGS. 34A, 34B and 34C provide graphical representations of the average glide, the CAP relative to the incumbent fluid, and the COP relative to the incumbent fluid, respectively, for a composition according to Example 38;

FIGS. 35A, 35B and 35C provide graphical representations of the average glide, the CAP relative to the incumbent fluid, and the COP relative to the incumbent fluid, respectively, for a composition according to Example 39;

FIGS. 36A, 36B and 36C provide graphical representations of the average glide, the CAP relative to the incumbent fluid, and the COP relative to the incumbent fluid, respectively, for a composition according to Example 40;

FIGS. 37A, 37B and 37C provide graphical representations of the average glide, the CAP relative to the incumbent fluid, and the COP relative to the incumbent fluid, respectively, for a composition according to Example 41;

FIG. 38 is a T-x (temperature-mass %) phase diagram of a binary composition of HFO-1234ze(E) and isobutane;

FIG. 39 is a T-x (temperature-mass %) phase diagram of a binary composition of HFO-1234ze(E) and butane;

FIG. 40 is a T-x (temperature-mass %) phase diagram of a binary composition of HFO-1234ze(E) and propylene;

FIG. 41 is a T-x (temperature-mass %) phase diagram of a binary composition of HFO-1234ze(E) and propane;

FIG. 42 is a T-x (temperature-mass %) phase diagram of a binary composition of HFO-1234ze(E) and ammonia;

FIG. 43 is a T-x (temperature-mass %) phase diagram of a binary composition of HFO-1234ze(Z) and isobutane;

FIG. 44 is a T-x (temperature-mass %) phase diagram of a binary composition of HFO-1234ze(Z) and butane;

FIG. 45 is a T-x (temperature-mass %) phase diagram of a binary composition of HFO-1234ze(Z) and pentane;

FIGS. 46A and 46B are graphical representations of compositions according to Example 31 in terms of the bubble point pressure (BP) and dew point pressure (DP);

FIGS. 47A and 47B are graphical representations of compositions according to Example 32 in terms of the bubble point pressure (BP) and dew point pressure (DP);

FIG. 48 is a graphical representation of compositions according to Example 35 in terms of the bubble point pressure (BP) and dew point pressure (DP);

FIGS. 49A and 49B are graphical representations of compositions according to Example 36 in terms of the bubble point pressure (BP) and dew point pressure (DP);

FIG. 50 is a graphical representation of compositions according to Example 37 in terms of the bubble point pressure (BP) and dew point pressure (DP);

FIG. 51 is a graphical representation of compositions according to Example 38 in terms of the bubble point pressure (BP) and dew point pressure (DP);

FIG. 52 is a graphical representation of compositions according to Example 39 in terms of the bubble point pressure (BP) and dew point pressure (DP);

FIG. 53 is a graphical representation of compositions according to Example 41 in terms of the bubble point pressure (BP) and dew point pressure (DP);

FIGS. 54A, 54B and 54C provide graphical representations of the average glide, the CAP for cooling relative to the incumbent fluid, and the COP relative to the incumbent fluid, respectively, for a composition according to Example 7;

FIGS. 54D, 54E and 54F provide graphical representations of the average glide, the CAP for heating relative to the incumbent fluid, and the COP relative to the incumbent fluid, respectively, for a composition according to Example 7;

FIGS. 55A, 55B and 55C provide graphical representations of the average glide, the CAP for cooling relative to the incumbent fluid, and the COP relative to the incumbent fluid, respectively, for a composition according to Example 42;

FIGS. 55D, 55E and 55F provide graphical representations of the average glide, the CAP for heating relative to the incumbent fluid, and the COP relative to the incumbent fluid, respectively, for a composition according to Example 42; and

FIGS. 56A, 56B and 56C provide graphical representations of the average glide, the CAP for cooling relative to the incumbent fluid, and the COP relative to the incumbent fluid, respectively, for a composition according to Example 43.

### DETAILED DESCRIPTION

A refrigerant is defined as a heat transfer fluid that undergoes a phase change from liquid to gas and back again during a cycle used to transfer of heat.

A heat transfer system is the system (or apparatus) used to produce a heating or cooling effect in a particular space. A heat transfer system may be a mobile system or a stationary system.

Examples of heat transfer systems are any type of refrigeration systems and air conditioning systems including, but are not limited to, stationary heat transfer systems, air conditioners, freezers, refrigerators, heat pumps, flooded evaporator heat pumps, direct expansion chillers heat pumps, chillers, flooded evaporator chillers, direct expansion chillers, walk-in coolers, mobile refrigerators, mobile heat transfer systems, mobile heat pumps, mobile air conditioning units, dehumidifiers, and combinations thereof.

Volumetric capacity is the amount of heat absorbed or rejected divided by the theoretical compressor displacement. Heat removed or absorbed is the enthalpy difference across a heat exchanger multiplied by the refrigerant mass flowrate. Theoretical compressor displacement is the refrigerant mass flowrate divided by the density of the gas entering the compressor (i.e., compressor suction density). More simply, volumetric capacity is the suction density multiplied by the heat exchanger enthalpy difference. Higher volumetric capacity allows the use of a smaller compressor for the same heat load. Herein, cooling capacity refers to the volumetric capacity in cooling mode and heating capacity refers to the volumetric capacity in heating mode.

Coefficient of performance (COP) is the amount of heat absorbed or rejected divided by the required energy input to operate the cycle (approximated by the compressor power). COP is specific to the mode of operation of a heat pump, thus COP for heating or COP for cooling. COP is directly related to the energy efficiency ratio (EER).

Subcooling refers to the reduction of the temperature of a liquid below that liquid's saturation point for a given pressure. The liquid saturation point is the temperature at which the vapor is completely condensed to a liquid. By cooling a liquid below the saturation temperature (or bubble point temperature), the net refrigeration effect can be increased. Subcooling thereby improves refrigeration capacity and energy efficiency of a system. The subcooling amount is the amount of cooling below the saturation temperature (in degrees).

Superheating refers to the increase of the temperature of a vapor above that vapor's saturation point for a given pressure. The vapor saturation point is the temperature at which the liquid is completely evaporated to a vapor. Superheating continues to heat the vapor to a higher temperature vapor at the given pressure. By heating the vapor above the saturation temperature (or dew point temperature), the net refrigeration effect can be increased. Superheating thereby improves refrigeration capacity and energy efficiency of a system when it occurs in the evaporator. Suction line superheat does not add to the net refrigeration effect and can reduce efficiency and capacity. The superheat amount is the amount of heating above the saturation temperature (in degrees).

Temperature glide (sometimes referred to simply as “glide”) is the absolute value of the difference between the starting and ending temperatures of a phase-change process by a refrigerant within a condenser of a refrigerant system, exclusive of any subcooling or superheating. For an evaporator, the glide is the difference in temperature between the dew point and the evaporator inlet. Glide may be used to describe condensation or evaporation of a near azeotrope or non-azeotropic composition. When referring to the temperature glide of an air conditioning or heat pump system, it is common to provide the average temperature glide being the average of the temperature glide in the evaporator and the temperature glide in the condenser. Glide is applicable to blend refrigerants, i.e. refrigerants that are composed of at least 2 components.

The net refrigeration effect is the quantity of heat that each kilogram of refrigerant absorbs in the evaporator to produce useful cooling.

The mass flow rate is the quantity of refrigerant in kilograms circulating through the refrigeration, heat pump or air conditioning system over a given period of time.

As used herein, the term “lubricant” means any material added to a composition or a compressor (and in contact with any heat transfer composition in use within any heat transfer system) that provides hydrodynamic lubrication to the compressor to aid in preventing parts from seizing.

Flammability is a term used to mean the ability of a composition to ignite and/or propagate a flame. For refrigerants and other heat transfer compositions, the lower flammability limit (“LFL”) is the minimum concentration of the heat transfer composition in air that is capable of propagating a flame through a homogeneous mixture of the composition and air under test conditions specified in ASTM (American Society of Testing and Materials) E681. The upper flammability limit (“UFL”) is the maximum concentration of the heat transfer composition in air that is capable of propagating a flame through a homogeneous mixture of the composition and air under the same test conditions. Determination of whether a refrigerant compound or mixture able to propagate a flame or not is also done by testing under the conditions of ASTM E-681.

During a refrigerant leak, the more volatile components of a mixture may leak preferentially. Thus, the composition in the system as well as the vapor leaking can vary over the time period of the leak. Thus, a non-flammable mixture may become able to propagate a flame under leakage scenarios.

In order to be classified by ANSI/ASHRAE (American Society of Heating, Refrigerating and Air-Conditioning Engineers) standard 34 as (class 1, no flame propagation) (i.e., non-flammable), a refrigerant or heat transfer composition must be non-flammable as formulated, but also under specified leakage conditions. More specifically, a refrigerant must meet the conditions of ASTM E681 as formulated in both the liquid and vapor phase as well as non-flammable in both the liquid and vapor phases that result during leakage scenarios.

In order for a refrigerant to be classified by ANSI/ASHRAE standard 34 as low flammability (class 2L), it must: 1) exhibit flame propagation when tested at 140° F. (60° C.) and 14.7 psia (101.3 kPa); 2) have an LFL>0.0062 lb/ft³ (0.10 kg/m³); 3) have a heat of combustion <8169 Btu/lb (19,000 kJ/kg); and 4) have a maximum burning velocity of ≤3.9 in./s (10 cm/s) when tested at 73.4° F. (23.0° C.) and 14.7 psia (101.3 kPa) in dry air.

In order for a refrigerant to be classified by ANSI/ASHRAE standard 34 as flammable (class 2), it must: 1) exhibit flame propagation when tested at 140° F. (60° C.) and 14.7 psia (101.3 kPa); 2) have an LFL>0.0062 lb/ft³ (0.10 kg/m³); and 3) have a heat of combustion <8169 Btu/lb (19,000 kJ/kg).

In order for a refrigerant to be classified by ANSI/ASHRAE standard 34 class 3, the refrigerant 1) exhibits flame propagation when tested at 140° F. (60° C.) and 14.7 psia (101.3 kPa), 2) has an LFL<0.0062 lb/ft³ (0.10 kg/m³) or 3) has a heat of combustion >8169 Btu/lb (19,000 kJ/kg).

ASHRAE Standard 34 provides a methodology to calculate the heat of combustion for refrigerant blends using a balanced stoichiometric equation based on the complete combustion of one mole of refrigerant with enough oxygen for a stoichiometric reaction.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100-year time horizon is commonly the value referenced. For mixtures, a weighted average can be calculated based on the individual GWPs for each component. Herein, the GWP values are those reported in the International Panel on Climate Change (IPCC) Fourth Assessment Report (AR4) as those are the currently used values for several regulatory bodies

Ozone depletion potential (ODP) is a number that refers to the amount of ozone depletion caused by a substance. The ODP is the ratio of the impact on ozone of a chemical compared to the impact of a similar mass of CFC-11 (fluorotrichloromethane). Thus, the ODP of CFC-11 is defined to be 1.0. Other CFCs and HCFCs have ODPs that range from 0.01 to 1.0. HFCs and HFOs have zero ODP because they do not contain chlorine, bromine or other ozone depleting halogens.

An azeotropic composition may refer to a constant-boiling mixture of two or more substances that behave as a single substance. One way to characterize an azeotropic composition is that the vapor produced by partial evaporation or distillation of the liquid has the same composition as the liquid from which it is evaporated or distilled. For example, the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within a refrigeration or air conditioning system during operation. Additionally, an azeotropic composition will not fractionate upon leakage from a refrigeration or air conditioning system.

As used herein, “near-azeotrope” or “azeotrope-like” refers to a composition of two or more refrigerant compounds that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. In contrast, the vapor and liquid compositions of non-near-azeotrope compositions change to a substantial degree during boiling or evaporation. As used herein, “near-azeotrope” refers to a composition exhibiting near-azeotropic behavior.

As used herein, “near-azeotropic behavior” refers to a behavior exhibiting dew point pressure and bubble point pressure with virtually no pressure differential. In some embodiments, the difference in the dew point pressure and bubble point pressure at a given temperature is 10% or less, alternatively 9% or less, alternatively 8% or less, alternatively 7% or less, alternatively 6% or less, alternatively 5% or less, alternatively 4% or less, alternatively 3% or less, alternatively 2% or less, alternatively 1% or less, or any value, range, or sub-range therebetween. In some instances, certain of the Examples identify azeotropes or near azeotropes based on a difference between the dew point pressure and bubble point pressure at a given temperature is 5% or less. However, it will be understood by those skilled in the art that this difference may be higher, e.g., 10% or less, for characterization of a near azeotropic composition.

Another manner to characterize a near-azeotropic composition is that the bubble point vapor pressure and the dew point pressure of the composition at a particular temperature are substantially the same. Herein, a composition of the invention is near-azeotropic if, after 50 weight percent (50 wt. %) of the composition is removed, such as by evaporation or boiling off, the difference in vapor pressure, between the original composition and the composition remaining after 50 weight percent of the original composition has been removed, is less than about 10 percent (10%).

A near-azeotropic composition can also be characterized by the area that is adjacent to the maximum or minimum bubble-point pressure in a plot of composition vapor pressure at a given temperature as a function of mole fraction of components in the composition.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus.

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed provided that these additional included materials, steps, features, components, or elements do not materially affect the basic and novel characteristic(s) of the claimed invention. The term ‘consisting essentially of’ occupies a middle ground between “comprising” and ‘consisting of’. Typically, components of the refrigerant mixtures and the refrigerant mixtures themselves can contain minor amounts (e.g., less than about 0.5 weight percent total) of impurities and/or byproducts (e.g., from the manufacture of the refrigerant components or reclamation of the refrigerant components from other systems) which do not materially affect the novel and basic characteristics of the refrigerant mixture.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value, preferably as within 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

The present invention relates to compositions comprising at least one fluoroolefin and at least one other compound such as a natural refrigerant. Some of compounds contained in compositions of the present inventive compositions are listed in Table 1.

TABLE 1

| Compound | Chemical name | Chemical formula |
|---|---|---|
| E-HFO-1234ze | E-1,3,3,3-tetrafluoropropene | CF₃CH═CHF |
| Z-HFO-1234ze | Z-1,3,3,3-tetrafluoropropene | CF₃CH═CHF |
| E-HFO- | E-1,1,1,4,4,4-hexafluoro-2- | CF₃CH═CHCF₃ |
| 1336mzz | butene | |
| Z-HFO- | Z-1,1,1,4,4,4-hexafluoro-2- | CF₃CH═CHCF₃ |
| 1336mzz | butene | |
| E-HCFO- | E-1-chloro-3,3,3- | CF₃CH═CHCl |
| 1233zd | trifluoropropene | |
| Z-HCFO- | Z-1-chloro-3,3,3- | CF₃CH═CHCl |
| 1233zd | trifluoropropene | |
| CFO-1112 | 1,2-dichloro-1,2- | CFCl═CFCl |
| | difluoroethylene | |
| HFC-32 | Difluoromethane | CH₂F₂ |
| HFC-125 | Pentafluoroethane | CF₃CHF₂ |
| HFC-134 | 1,1,2,2-tetrafluoroethane | CHF₂CHF₂ |
| HFC-134a | 1,1,1,2-tetrafluoroethane | CH₂FCF₃ |
| HFC-152a | 1,1-difluoroethane | CHF₂CH₃ |
| HC-290 | propane | CH₃CH₂CH₃ |
| HC-1270 | propylene | CH₃CH═CH₂ |
| R-600 | butane | CH₃CH₂CH₂CH₃ |
| R-600a | isobutane | CH₃CH(CH₃)CH₃ |
| | isobutene | (CH₃)₂C═CH₂ |
| R-601 | pentane | CH₃CH₂CH₂CH₂CH₃ |
| R-601a | isopentane | CH₃CH(CH₃)CH₂CH₃ |
| R-744 | carbon dioxide | CO₂ |
| R-717 | Ammonia | NH₃ |

The individual components listed in Table 1 may be prepared by methods known in the art.

The fluoroolefin compounds used in the compositions of the present invention, such as HFO-1234ze, may exist as different configurational isomers or stereoisomers. Unless specified otherwise, the present invention is intended to include all single configurational isomers, single stereoisomers or any combination or mixture thereof. For instance, HFO-1234ze is meant to represent the cis-isomer, trans-isomer, or any combination or mixture of both isomers in any ratio, unless explicitly specified otherwise.

In one embodiment the present disclosure provides compositions comprising In some embodiments, present invention relates to compositions comprising at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof; and (ii) at least one other compound selected from HC-290, HC-1270, R-600, R-600a, isobutene, R-601, R-601a, R-744, R-717, and combinations thereof.

In some embodiments, present invention relates to compositions comprising at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof; (ii) at least one other compound selected from HC-290, HC-1270, R-600, R-600a, isobutene, R-601, R-601a, R-744, R-717, and combinations thereof; and optionally (iii) at least one other compound selected from HFC-134, HFC-134a, HFC-125, HFC-32, HFC-152a, and combinations thereof.

The compositions of the present invention are based on the unexpected finding of synergy by coupling these two classes of thermal management fluids, namely hydrofluoroolefins and natural refrigerants. The compositions of the present invention provide refrigerant performance that is improved over existing HFC refrigerants and blends and even improved over existing HFO refrigerants and blend, at lower costs with an increase in the natural thermal management fluids charging size, while maintaining a reduced flammability classification at 1, 2L, or 2. [014]HFO-1234ze(E) is available commercially from Honeywell (Charlotte, North Carolina, USA). HFC-152a, HFO-1336mzzE, HFC-134 and HFC-134a are available commercially from Chemours™ (Wilmington, DE, USA). HFC-32 and HFC-125 are available commercially from various sources worldwide.

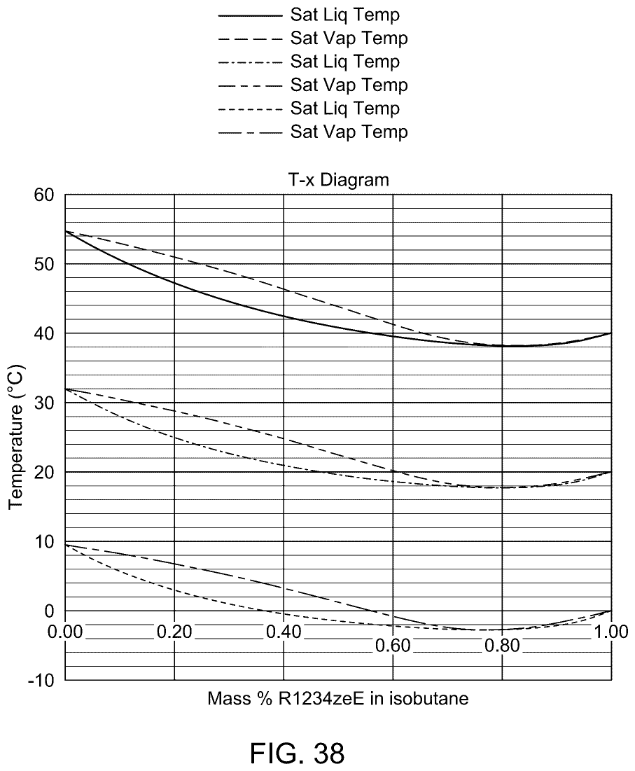

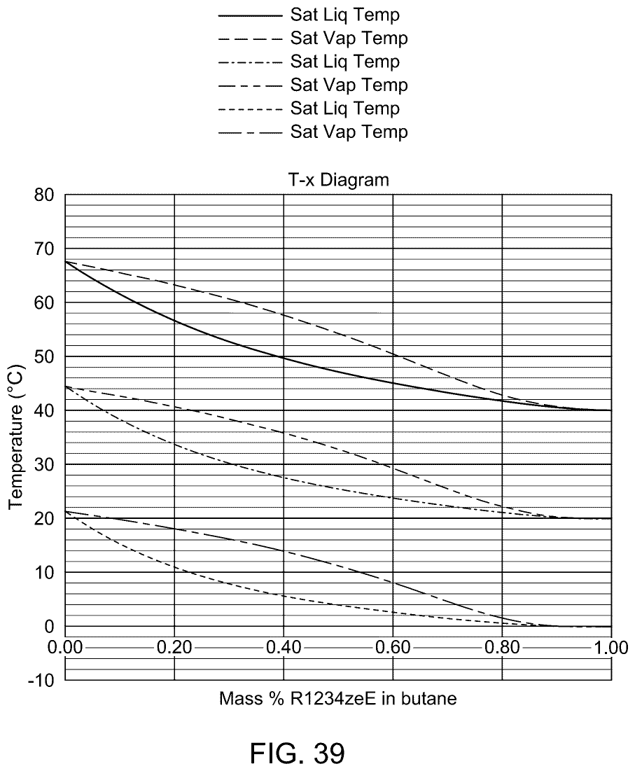

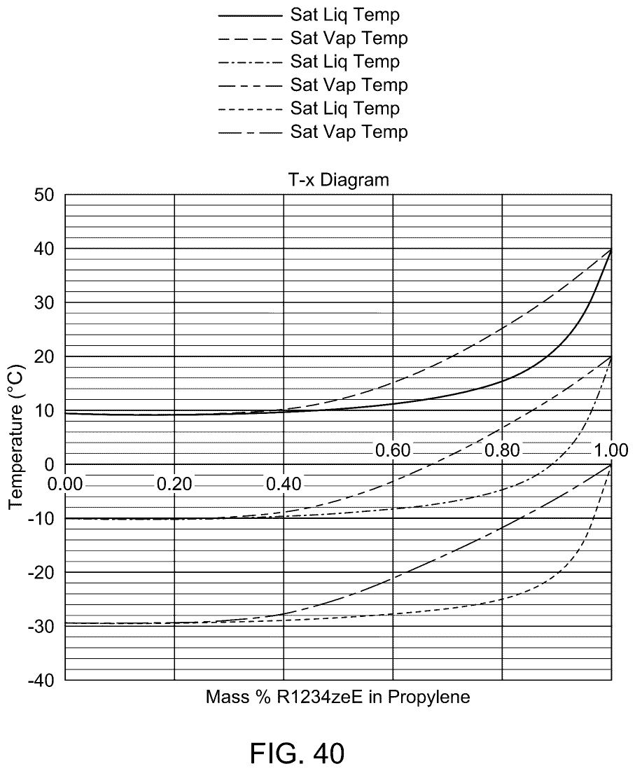

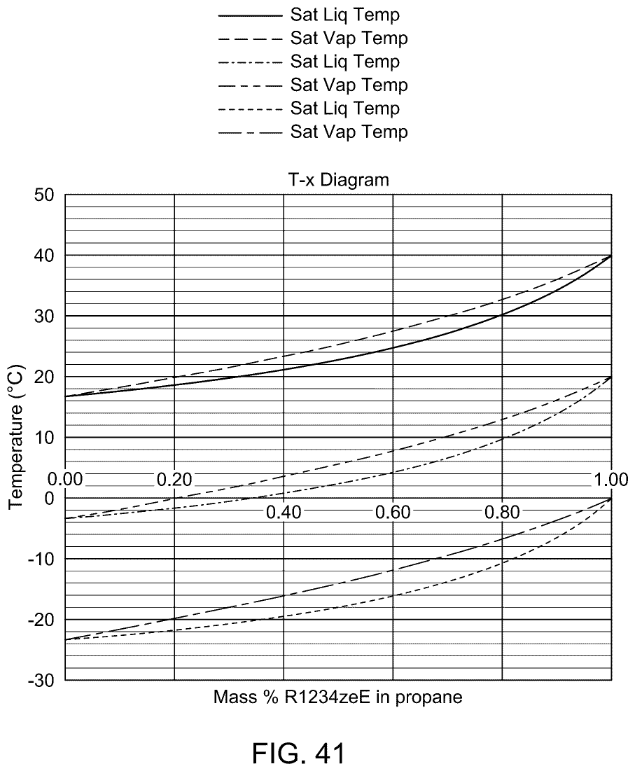

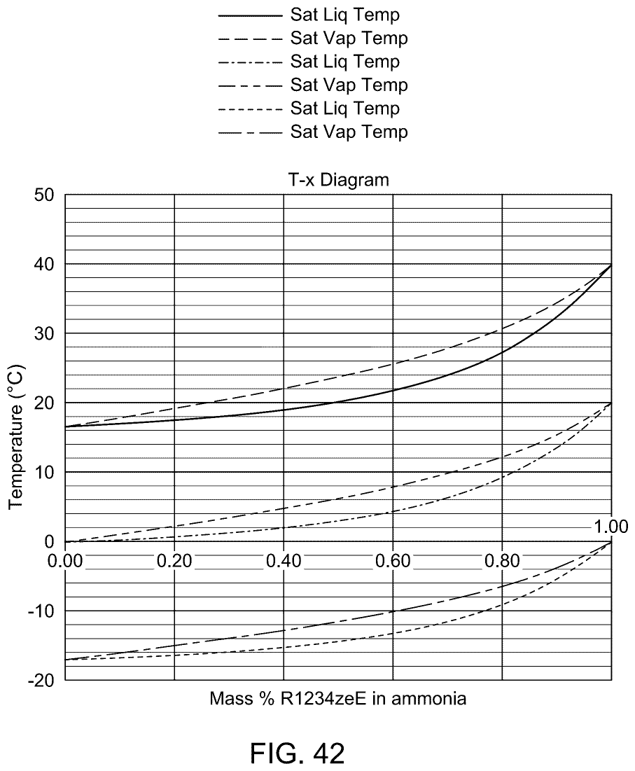

In another embodiment, the compositions comprise one of:
a. HFO-1234ze(E) and HC-290 (see FIG. 41);
b. HFO-1234ze(E) and HC-1270 (see FIG. 40);
c. HFO-1234ze(E) and R-600 (see FIG. 39);
d. HFO-1234ze(E) and R-600a (see FIG. 38); and
e. HFO-1234ze(E) and R-717 (see FIG. 42).

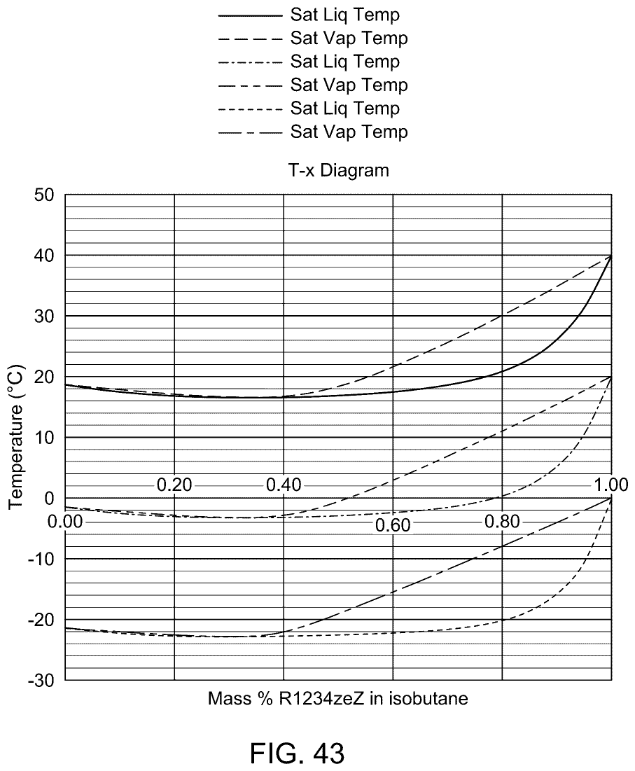

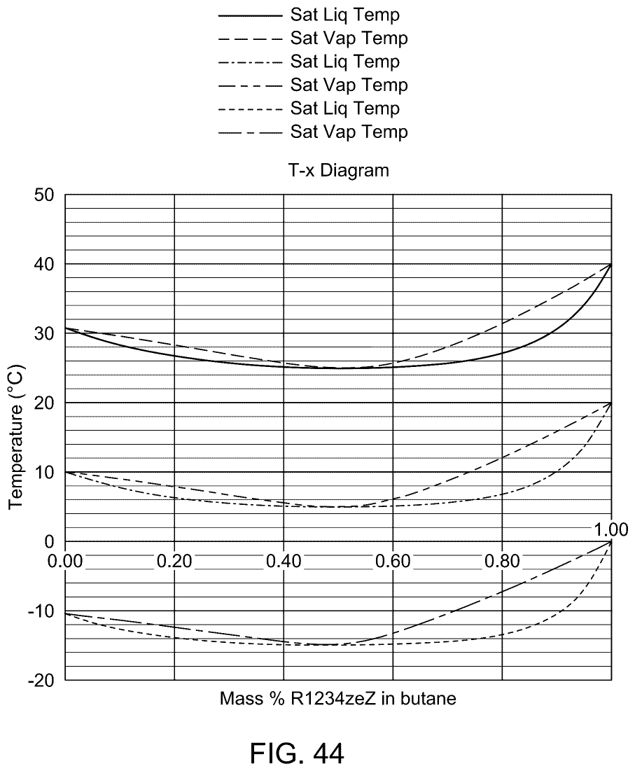

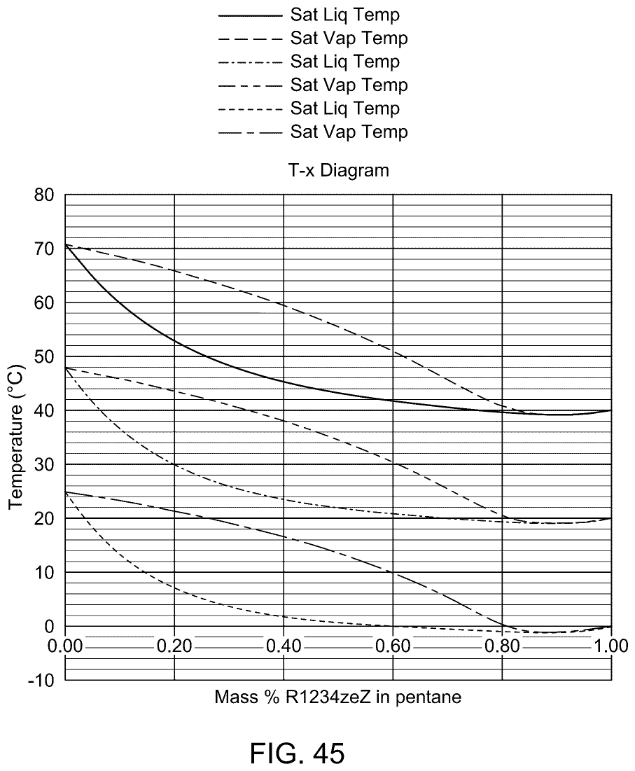

In another embodiment, the compositions comprise one of:
a. HFO-1234ze(Z) and R-600 (see FIG. 44);
b. HFO-1234ze(Z) and R-600a (see FIG. 43);
c. HFO-1234ze(Z) and R-601 (see FIG. 45); and
d. HFO-1234ze(Z) and isobutene.

According to some embodiments, also disclosed herein are compositions comprising from about 2 to about 98 weight percent HFO-1234ze(E), from about 2 to about 98 weight percent HC-290.

According to some embodiments, also disclosed herein are compositions comprising (i) HFO-1234ze(E); (ii) HC-290; (iii) one or more additional compounds selected from Group I; and (iv) one or more additional compounds selected from butane, isobutane, propylene, pentane and isopentane, or one or more additional compounds selected from methane, ethane, butadiene, allene, butane, cyclobutane, acetylene, propyne and propylene. In some embodiments, the composition comprises about 2 to about 98 weight percent HFO-1234ze(E), about 2 to about 98 weight percent HC-290, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(E), from about 2 to about 98 weight percent HC-1270.

According to some embodiments, also disclosed herein are compositions comprising HFO-1234ze(E); HC-1270; one or more additional compounds selected from Group I; and one or more additional compounds selected from propane, butane, isobutane, butylene, isobutene, ethylene, ethane and methane. In some embodiments, the composition comprises about 2 to about 98 weight percent HFO-1234ze(E), about 2 to about 98 weight percent HC-1270, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(E), from about 2 to about 98 weight percent R-600.

According to some embodiments, also disclosed herein are compositions comprising HFO-1234ze(E); R-600; one or more additional compounds selected from Group I; and one or more additional compounds selected from propane, propylene, isobutane, butylene, isobutene, pentane and isopentane. In some embodiments, the composition comprises about 2 to about 98 weight percent HFO-1234ze(E), about 2 to about 98 weight percent R-600, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(E), from about 2 to about 98 weight percent R-600a.

According to some embodiments, also disclosed herein are compositions comprising (i) HFO-1234ze(E); (ii) R-600a; (iii) one or more additional compounds selected from Group I; and (iv) one or more additional compounds selected from butane, propane, propylene, pentane and isopentane, or one or more additional compounds selected from methane, ethane, butadiene, allene, methyl cyclopropane, 2-methylpropene, propane, propyne and propylene. In some embodiments, the composition comprises about 2 to about 98 weight percent HFO-1234ze(E), about 2 to about 98 weight percent R-600a, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(E), from about 2 to about 98 weight percent R-717.

According to some embodiments, also disclosed herein are compositions comprising HFO-1234ze(E); R-717; one or more additional compounds selected from Group I; and one or more additional compounds selected from N₂ and H₂O. In some embodiments, the composition comprises about 2 to about 98 weight percent HFO-1234ze(E), about 2 to about 98 weight percent R-717, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(Z), from about 2 to about 98 weight percent R-600.

According to some embodiments, also disclosed herein are compositions comprising HFO-1234ze(Z); R-600; one or more additional compounds selected from Group II; and one or more additional compounds selected from propane, propylene, isobutane, butylene, isobutene, pentane and isopentane. In some embodiments, the composition comprises about 2 to about 98 weight percent HFO-1234ze(Z), about 2 to about 98 weight percent R-600, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(Z), from about 2 to about 98 weight percent R-600a.

According to some embodiments, also disclosed herein are compositions comprising (i) HFO-1234ze(Z); (ii) R-600a; (iii) one or more additional compounds selected from Group II; and (iv) one or more additional compounds selected from butane, propane, propylene, pentane and isopentane, or one or more additional compounds selected from methane, ethane, butadiene, allene, methyl cyclopropane, 2-methylpropene, propane, propyne and propylene. In some embodiments, the composition comprises about 2 to about 98 weight percent HFO-1234ze(Z), about 2 to about 98 weight percent R-600a, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(Z), from about 2 to about 98 weight percent R-601.

According to some embodiments, also disclosed herein are compositions comprising HFO-1234ze(Z); R-601; one or more additional compounds selected from Group II; and one or more additional compounds selected from propane, propylene, butane, isobutane, butylene, isobutene and isopentane. In some embodiments, the composition comprises about 2 to about 98 weight percent HFO-1234ze(Z), about 2 to about 98 weight percent R-601, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(E), from about 2 to about 98 weight percent HFC-134, and from about 2 to about 98 weight percent R-600.

According to some embodiments, also disclosed herein are compositions comprising HFO-1234ze(E); R-600; HFC-134; one or more additional compounds selected from Group I; one or more additional compounds selected from HFC-134a, HCFC-124, HCFC-124a, HCFO-1122, HFC-143a, HCFC-31, HFC-32, HFC-125, CFC-114, CFC-114a, FCO-1114, HFC-152a, FCO-1318my, HFC-245cb, FC-C318, and HC-161; and one or more additional compounds selected from propane, propylene, isobutane, butylene, isobutene, pentane and isopentane. In some embodiments, the composition comprises about 2 to about 98 weight percent HFO-1234ze(E), about 2 to about 98 weight percent HFC-134, about 2 to about 98 weight percent R-600, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(E), from about 2 to about 98 weight percent HFC-134, and from about 2 to about 98 weight percent R-600a.

According to some embodiments, also disclosed herein are compositions comprising (i) HFO-1234ze(E); (ii) R-600a; (iii) HFC-134; (iv) one or more additional compounds selected from Group I; (v) one or more additional compounds selected from HFC-134a, HCFC-124, HCFC-124a, HCFO-1122, HFC-143a, HCFC-31, HFC-32, HFC-125, CFC-114, CFC-114a, FCO-1114, HFC-152a, FCO-1318my, HFC-245cb, FC-C318, and HC-161; and (vi) one or more additional compounds selected from butane, propane, propylene, pentane and isopentane, or one or more additional compounds selected from methane, ethane, butadiene, allene, methyl cyclopropane, 2-methylpropene, propane, propyne and propylene. In some embodiments, the composition comprises about 2 to about 98 weight percent HFO-1234ze(E), about 2 to about 98 weight percent HFC-134, about 2 to about 98 weight percent R-600a, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(E), from about 2 to about 98 weight percent HFC-134, and from about 2 to about 98 weight percent HC-290.

According to some embodiments, also disclosed herein are compositions comprising (i) HFO-1234ze(E); (ii) HC-290; (iii) HFC-134; (iv) one or more additional compounds selected from Group I; (v) one or more additional compounds selected from HFC-134a, HCFC-124, HCFC-124a, HCFO-1122, HFC-143a, HCFC-31, HFC-32, HFC-125, CFC-114, CFC-114a, FCO-1114, HFC-152a, FCO-1318my, HFC-245cb, FC-C318, and HC-161; and (vi) one or more additional compounds selected from methane, ethane, butadiene, allene, butane, cyclobutane, acetylene, propyne and propylene. In some embodiments, the composition comprises about 2 to about 98 weight percent HFO-1234ze(E), about 2 to about 98 weight percent HFC-134, about 2 to about 98 weight percent HC-290, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HCFO-1233zd(E), from about 2 to about 98 weight percent HFC-134, and from about 2 to about 98 weight percent R-600.

According to some embodiments, also disclosed herein are compositions comprising HCFO-1233zd(E); R-600; HFC-134; one or more additional compounds selected from HFO-1234ze(Z), HCFO-1233zd(Z) and HFC-245fa; one or more additional compounds selected from HFC-134a, HCFC-124, HCFC-124a, HCFO-1122, HFC-143a, HCFC-31, HFC-32, HFC-125, CFC-114, CFC-114a, FCO-1114, HFC-152a, FCO-1318my, HFC-245cb, FC-C318, and HC-161; and one or more additional compounds selected from propane, propylene, isobutane, butylene, isobutene, pentane and isopentane. In some embodiments, the composition comprises about 2 to about 98 weight percent HCFO-1233zd(E), about 2 to about 98 weight percent HFC-134, about 2 to about 98 weight percent R-600, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(Z), from about 2 to about 98 weight percent and trans-1,2-dichloroethylene (t-DCE), and from about 2 to about 98 weight percent R-601.

According to some embodiments, also disclosed herein are compositions comprising HFO-1234ze(Z); R-601; t-DCE; one or more additional compounds selected from Group II; one or more additional compounds selected from chloroethyne (HCC-2120), vinyl chloride (HCC-1140), 1,1-dichloroethene (HCO-1130a), methylene chloride (HCC-30), 1,1-dichloroethane (HCC-150a), cis 1,2-DCE, chloroform (HCC-20), 1,1,1-trichloroethane (HCC-140a), and trichloroethylene (HCO-1120); and one or more additional compounds selected from propane, propylene, butane, isobutane, butylene, isobutene and isopentane. In some embodiments, the composition comprises about 2 to about 98 weight percent HFO-1234ze(Z), about 2 to about 98 weight percent t-DCE, about 2 to about 98 weight percent R-601, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(Z), from about 2 to about 98 weight percent HFO-1336mzz(E), and from about 2 to about 98 weight percent R-601.

According to some embodiments, also disclosed herein are compositions comprising HFO-1234ze(Z); R-601; HFO-1336mzz(E); one or more additional compounds selected from Group II; one or more additional compounds selected from C-30, HCFC-114, HCFC-114a, HCFC-133, HCFC-133a, HFC-245fa, HFC-338mee, HFC-338mf, HFC-347mef, HCO-1140, HCFO-1224 isomers, HCFO-1224yd, HCFO-1224yb, HCFO-1233xf, HCFO-1233zd, HFO-1243zf, HFO-1327mz, HFO-1336 ft and HCFO-1326mxz; and one or more additional compounds selected from propane, propylene, butane, isobutane, butylene, isobutene and isopentane. In some embodiments, the composition comprises about 2 to about 98 weight percent HFO-1234ze(Z), about 2 to about 98 weight percent HFO-1336mzz(E), about 2 to about 98 weight percent R-601, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(Z), from about 2 to about 98 weight percent HFO-1336mzz(Z), and from about 2 to about 98 weight percent R-601.

According to some embodiments, also disclosed herein are compositions comprising HFO-1234ze(Z); R-601; HFO-1336mzz(Z); one or more additional compounds selected from Group II; one or more additional compounds selected from HFO-1326mxzE, HFO-1326nxzZ, HFC-346mdf, HFC-356mff and HFO-1336mzz(E); and one or more additional compounds selected from propane, propylene, butane, isobutane, butylene, isobutene and isopentane. In some embodiments, the composition comprises about 2 to about 98 weight percent HFO-1234ze(Z), about 2 to about 98 weight percent HFO-1336mzz(Z), about 2 to about 98 weight percent R-601, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1336mzz(E), from about 2 to about 98 weight percent HFC-134, and from about 2 to about 98 weight percent R-600.

According to some embodiments, also disclosed herein are compositions comprising HFO-1336mzz(E); R-600; HFC-134; one or more additional compounds selected from C-30, HCFC-114, HCFC-114a, HCFC-133, HCFC-133a, HFC-245fa, HFC-338mee, HFC-338mf, HFC-347mef, HCO-1140, HCFO-1224 isomers, HCFO-1224yd, HCFO-1224yb, HCFO-1233xf, HCFO-1233zd, HFO-1243zf, HFO-1327mz, HFO-1336 ft and HCFO-1326mxz; one or more additional compounds selected from HFC-134a, HCFC-124, HCFC-124a, HCFO-1122, HFC-143a, HCFC-31, HFC-32, HFC-125, CFC-114, CFC-114a, FCO-1114, HFC-152a, FCO-1318my, HFC-245cb, FC-C318, and HC-161; and one or more additional compounds selected from propane, propylene, isobutane, butylene, isobutene, pentane and isopentane. In some embodiments, the composition comprises about 2 to about 98 weight percent HFO-1336mzz(E), about 2 to about 98 weight percent HFC-134, about 2 to about 98 weight percent R-600, with the remainder being the additional compounds preferably in an amount of 1 wt % or less or more preferably 0.5 wt. % or less, based on a total weight of the composition.

According to any of the foregoing embodiments, also disclosed herein are compositions comprising from about 2 to about 98 weight percent HFO-1234ze(Z) and from about 2 to about 98 weight percent isobutene.

According to some embodiments, also disclosed herein are compositions comprising HFO-1234ze(Z); isobutene; one or more additional compounds selected from Group II; and one or more additional compounds selected from propane, propylene, isobutane, butylene, butane, pentane and isopentane. In some embodiments, the composition comprises about 2 to about 98 weight percent HFO-1234ze(Z), about 2 to about 98 weight percent R-600, with the remainder being the additional compounds preferably in an amount of 1 wt % or less or more preferably 0.5 wt. % or less, based on a total weight of the composition.

In some embodiments, the amount of additional compounds present in any of the refrigerant compositions disclosed herein can be greater than 0 ppm and less than 5,000 ppm and, in particular, can range from about 5 to about 1,000 ppm, about 5 to about 500 ppm and about 1 to about 100 ppm.

The total amount of additional compounds in any of the blend compositions disclosed herein ranges from greater than 0 wt. % to less than or equal to about 2 wt. %, about 1 wt. %, about 0.9 wt. %, about 0.8 wt. %, about 0.7 wt. %, about 0.6 wt. %, about 0.5 wt. %, about 0.4 wt. %, about 0.3 wt. %, about 0.2 wt. %, about 0.1 wt. %, based on the total weight of the composition. In another embodiment, the total amount of additional compound(s) ranges from 0.01 ppm (weight) to about 1 wt. %, and all values therebetween up to 1 wt. %. In another embodiment, the total amount of additional compound(s) ranges from 0.1 ppm (weight) to about 1 wt. %. In another embodiment, the total amount of additional compound(s) ranges from 0.001 wt. % to about 1 wt. %. In another embodiment, the total amount of additional compound(s) ranges from 0.001 wt. % to about 0.5 wt. %. In another embodiment, the total amount of additional compound(s) ranges from 0.001 wt. % to 0.4 wt. % or less, based on the total weight of the composition. In another embodiment, the total amount of additional compound(s) ranges from 0.001 wt. % to 0.1 wt. % or less, based on the total weight of the composition. In one embodiment, the total amount of additional compound(s) is about 0.1 wt. % based on the total weight of the composition.

For any of the compositions or blend compositions disclosed herein, particularly the compositions/blend compositions comprising HFO-1234ze(E) as a component thereof, the Group I additional compounds comprise:
i) one or more, two or more, three or more or four or more additional compounds selected from HFC-134a, HFC-134, HFO-1225zc, HFO-1234yf, HFC-245cb, HFC-236fa, HFO-1234zc, HFC-245fa, HCFC-124, CFC-114, trifluoropropyne, HFC-152a, HFO-1225ye(Z), HFO-1225ye(E), HCFO-1233xf, HFC-263fb, HFO-1243zf, HCFO-1233zd(E), HFO-1234ze(Z) and combinations thereof; or
ii) one or more, two or more, three or more of four or more additional compounds selected from HFO-1234yf, HFC-143a, HFC-152a, HFO-1243zf, HCFO-1233xf, HCFO-1233zd(E), HCFO-1233zd(Z), HCFO-1224yd, HCFO-1224zc, HCFO-1326mxz, CFC-113, HFC-32, HFC-23, trifluoropropyne and combinations thereof; or
iii) one or more, two or more, three or more or four or more additional compounds selected from HFO-1234yf, HFC-143a, HFC-152a, HFO-1243zf, HCFO-1233xf, HCFO-1233zd(E), HCFO-1233zd(Z), HCFO-1224yd, HCFO-1224zc, HCFO-1326mxz, CFC-113, HFC-32, HFC-23, trifluoropropyne, HFC-125, HFC-143, HFC-134, HFC-263fb, CFC-114, CFC-114a, HCC-40, HCO-1140, HCFO-1113, CFC-13, CFC-12, HFC-227ca, HCFO-1131(E), HCFC-124, HCFC-124a, HFC-134a, HFC-227ea, CFC-217ca, CFC-217ba and combinations thereof.

In some embodiments, for any of the compositions or blend compositions disclosed herein, particularly the compositions/blend compositions comprising HFO-1234ze(E) as a component thereof, the Group I additional compounds comprise at least three additional compounds selected from:
a) HFO-1225zc, HFO-1243zf and HCFC-124;
b) HFO-1234yf, HFO-1225zc and HFC-245cb;
c) HFO-1234yf, HFC-245cb and HFC-134;
d) HFO-1234yf, HFC-245cb and HFC-134a;
e) HFO-1234yf, HFO-1243zf and HFC-134;
f) HFO-1234yf, HFO-1243zf and HFC-134a;
g) HFC-125, HFC-134a and HFC-134;
h) HFO-1225zc, HFO-1243zf and HFC-134a;
i) HFO-1225zc, HFO-1243zf and CFC-114;
j) HFO-1225zc, HFO-1225ye(Z) and HCFC-124;
k) HFO-1225zc, HFC-245cb and CFC-114;
l) HFO-1225zc, HFC-236fa and HFC-134a;
m) HFC-236fa, HFC-263fb and HFC-134;
n) HFC-134a, HFC-134 and HFO-1234yf;
o) HFO-1234ze(Z), HFC-134 and HFC-134a;
p) HFO-1234ze(Z), HFO-1225zc and HFC-134;
q) HFO-1234ze(Z), HFO-1225zc and CFC-114;
r) HFO-1234ze(Z), HFO-1234zc and HFO-1243zf;
s) HFO-1234ze(Z), HCFC-124 and CFC-114;
t) HFO-1234ze(Z), HFC-227ea and HFC-227ca; and
u) HFO-1243zf, HFC-134 and HFC-236fa.

In some embodiments, for any of the compositions or blend compositions disclosed herein, particularly the compositions/blend compositions comprising HFO-1234ze(E) as a component thereof, the Group I additional compounds comprise at least four additional compounds selected from:
a) HFO-1234yf, HFC-245cb, HFO-1225zc and HFO-1243zf;
b) HFO-1234yf, HFC-245cb, HFC-134a and HFC-134;
c) HFO-1234yf, HFC-245cb, HFO-1225zc and HFO-1243zf;
d) HCFC-124, CFC-114, HFC-134a and HFC-134a;
e) HFO-1234yf, HFC-263fb, HFO-1243zf and HFO-1225zc;
f) HFC-125, HFO-1234yf, HFC-245cb and HFO-1243zf;
g) HFC-125, HFC-134, HFC-134a and HFO-1234yf;
h) HFO-1234yf, HFO-1225zc, HFC-134 and HFC-134a;
i) HFO-1234yf, HFO-1243zf, HFO-1225zc and HFC-134;
j) HFO-1234yf, HFO-1243zf, HFO-1225zc and HFC-134a;
k) HFO-1234yf, HCFO-1233zd(E), HCFC-124 and HFO-1243zf;
l) HFO-1234yf, HCFO-1233zd(E), HFC-236fa and HCFC-124;
m) HFO-1234yf, HCFO-1233zd(E), CFC-114 and HFC-263fb;
n) HCFO-1233zd(E), CFC-114, HCFC-124 and HFC-263fb;
o) HFO-1234ze(Z), HFC-134, HFC-134a and HFC-245fa;
p) HFO-1234ze(Z), HFO-1225zc, HFC-134 and HCFC-124;
q) HFO-1234ze(Z), HFO-1225zc, HFC-134 and CFC-114;
r) HFO-1234ze(Z), HFO-1234zc, HFO-1243zf and HFC-245cb;
s) HFO-1234yf, HFC-134, HCFC-124 and CFC-114.

For any of the compositions or blend compositions disclosed herein, particularly the compositions/blend compositions comprising HFO-1234ze(Z) as a component thereof, the Group II additional compounds comprise:
i) one or more, two or more, or three or more additional compounds selected from HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFC-1131(E), CFC-114a, HCFC-124a, HFC-227ca, HFO-1234yf, HFC-152a, HFO-1234zf, HFC-134, HFC-245cb and combinations thereof; or
ii) one or more, two or more, or three or more additional compounds selected from HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131(E), CFC-114a, HCFC-124a, HFC-227ca, HFO-1234yf, HFC-152a, HFO-1243zf, HCC-30, HFC-134a, HFC-236fa, HFO-1327 isomer, HFO-1336mzz(E), CFO-1112a, HFC-227ea, HFC-245cb and combinations thereof; or
iii) one or more, two or more, or three or more additional compounds selected from HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131(E), CFC-114a, HCFC-124a, HFC-227ca, HFO-1234yf, HFC-152a, HFO-1243zf, HCC-30, HFC-134a, HFC-236fa, HFO-1327me, HFO-1336mzz(E), CFO-1112a, HFC-227ea, HFC-245cb, CFO-1112 and combinations thereof; or
iv) one or more, two or more, or three or more additional compounds selected from HFO-1234ze(E), HFC-236fa, HFC-227ea, HFC-245fa, HFO-1234zc, CFC-114, HCFO-1233xf, HCFO-1233zd(E), HCFO-1233zd(Z), HFO-1327me, HFO-1336mzz(E), CFO-1112 and combinations thereof.

In some embodiments, for any of the compositions or blend compositions disclosed herein, particularly the compositions/blend compositions comprising HFO-1234ze(Z) as a component thereof, the Group II additional compounds comprise at least two additional compounds selected from:
a) HFC-245fa and HCFO-1233ze(E);
b) HFO-1234zc and HFC-245fa;
c) HCFO-1233xf and HCFO-1233zd(E);
d) CFC-114 and HFC-245fa;
e) HFC-236fa and HFC-227ea;
f) HFC-236fa and HFC-245fa;
e) HFO-1234ze(E) and HFC-236fa;
f) HFO-1234ze(E) and HFC-245fa;
g) HFO-1234ze(E) and HFO-1234zc;
h) HFO-1234ze(E) and CFC-114; and
i) HFO-1234ze(E) and HCFO-1233zd(E).

In some embodiments, for any of the compositions or blend compositions disclosed herein, particularly the compositions/blend compositions comprising HFO-1234ze(Z) as a component thereof, the Group II additional compounds comprise at least three additional compounds selected from:
a) HFC-236fa, HFC-227ea, HFC-245fa;
b) HFO-1234zc, HFC-245fa and HCFO-1233xf;
c) HCFO-1233xf, HCFO-1233zd(E) and HCFO-1233zd(Z);
d) HFO-1234ze(E), CFC-114 and HFC-245fa;
e) HFO-1234ze(E), HFO-1234zc and HCFO-1233xf;
f) HFO-1234ze(E), HCFO-1233xf and HCFO-1233zd(E);
g) HFO-1234ze(E), CFC-114 and HFC-236fa;
h) HFC-245fa, HFC-236fa and CFC-114;
i) HFC-245fa, HCFO-1233xf and CFC-114; and
j) HFC-245fa, HCFO-1233zd(E) and CFC-114.

In some embodiments, for any of the compositions or blend compositions disclosed herein which comprise HFO-1234ze(E) and HFO-1234ze(Z) as components thereof, the composition/blend comprises at least one Group I additional compound and at least one Group II additional compound, or at least two Group I additional compounds and at least two Group II additional compounds.

In some embodiments, for any of the compositions or blend compositions disclosed herein which comprise HFO-1234ze(E) and HFO-1234ze(Z) as components thereof, the Group I and Group II additional compounds comprise at least two additional compounds selected from:
a) HCFC-124 and CFC-114;
b) HCFO-1233xf and HCFO-1233zd(E);
c) HFC-245fa, HCFO-1233zd(E);
d) HFC-236fa and HFC-134;
e) HFC-227ea and HFC-134;
f) HFC-227ca and HFC-134;
g) HFO-1225zc and HFC-134;
h) HFO-1225ye(Z) and HFC-134; and
i) HFO-1243zf and HFC-134.

In some embodiments, for any of the compositions or blend compositions disclosed herein which comprise HFO-1234ze(E) and HFO-1234ze(Z) as components thereof, the Group I and Group II additional compounds comprise at least two additional compounds selected from:
a) HFO-1225zc, HFO-1243zf and HCFC-124;
b) HFO-1225zc, HFO-1243zf and HFC-134;
c) HFO-1225zc, HFC-134a and HFC-134;
d) HFO-1243zf, HFC-134 and HFC-134a;
e) HCFC-124, CFC-114 and HFO-1234zc;
f) HFC-236fa, HCFC-124 and CFC-114;
g) HFC-236fa, HFC-227ea and HFC-245fa;
h) HFO-1234zc, HFC-245fa and HCFO-1233xf;
i) HCFO-1233xf, HCFO-1233zd(E) and HCFO-1233zd(Z);
j) HFC-245fa, HFC-236fa and CFC-114;
k) HFC-245fa, HCFO-1233xf and CFC-114;
l) HFC-245fa, HCFO-1233zd(E) and CFC-114; and
m) HCFO-1233xf, HFO-1243zf and CFC-114.

In some embodiments, for any of the compositions or blend compositions disclosed herein which comprise isobutane (R-600a) as a component thereof, the isobutane component of the composition comprises 99.9 wt. % isobutane and 0.1 wt. % one or more additional compounds selected from butane, 2-methylpropene, methyl cyclopropane, methane, ethane and combinations thereof. In some embodiments, the amount of butane in the composition is less than 100 ppm, preferably less than 50 ppm, based on the total weight of the isobutane component. In some embodiments, the amount of 2-methylpropene in the composition is less than 100 ppm, preferably less than 50 ppm, based on the total weight of the isobutane component. In some embodiments, the amount of methane in the composition is less than 100 ppm, preferably less than 50 ppm, based on the total weight of the isobutane component. In some embodiments, the amount of ethane in the composition is less than 100 ppm, preferably less than 50 ppm, based on the total weight of the isobutane component. In some embodiments, the amount of methyl cyclopropane in the composition is less than 100 ppm, preferably less than 50 ppm, based on the total weight of the isobutane component. In some embodiments, the total amount of methane and ethane in the composition is less than 100 ppm, preferably less than 50 ppm, based on the total weight of the isobutane component. In some embodiments, the total amount of butane, 2-methylpropene, methyl cyclopropane, methane and ethane in the composition is less than 100 ppm, preferably less than 50 ppm, based on the total weight of the isobutane component.

In some embodiments, the isobutane component of the composition comprises 99.9 wt. % isobutane and 0.1 wt. % one or more additional compounds selected from propane, butane, butadiene, propyne, allene, propylene, methane, ethane and combinations thereof. In some embodiments, the amount of propylene in the composition is less than 100 ppm, preferably less than 50 ppm, based on the total weight of the isobutane component. In some embodiments, the amount of propane in the composition is less than 100 ppm, preferably less than 50 ppm, based on the total weight of the isobutane component. In some embodiments, the amount of butane in the composition is less than 100 ppm, preferably less than 50 ppm, based on the total weight of the isobutane component. In some embodiments, the amount of butadiene in the composition is less than 100 ppm, preferably less than 50 ppm, based on the total weight of the isobutane component. In some embodiments, the amount of propyne in the composition is less than 100 ppm, preferably less than 50 ppm, based on the total weight of the isobutane component. In some embodiments, the amount of allene in the composition is less than 100 ppm, preferably less than 50 ppm, based on the total weight of the isobutane component. In some embodiments, the amount of methane in the composition is less than 100 ppm, preferably less than 50 ppm, based on the total weight of the isobutane component. In some embodiments, the amount of ethane in the composition is less than 100 ppm, preferably less than 50 ppm, based on the total weight of the isobutane component. In some embodiments, the total amount of methane and ethane in the composition is less than 100 ppm, preferably less than 50 ppm, based on the total weight of the isobutane component. In some embodiments, the total amount of butadiene, allene and propyne in the composition is less than 100 ppm, preferably less than 50 ppm, based on the total weight of the isobutane component. In some embodiments, the total amount of propane, butane, butadiene, propyne, allene, propylene, methane and ethane in the composition is less than 100 ppm, preferably less than 50 ppm, based on the total weight of the isobutane component.

In some embodiments, for any of the compositions or blend compositions disclosed herein which comprise propane (R-290) as a component thereof, the propane component of the composition comprises 99.9 wt. % propane and 0.1 wt. % one or more additional compounds selected from isobutane, butane, methane, ethane and combinations thereof. In some embodiments, the amount of methane is less than 100 ppm, preferably less than 50 ppm, based on the total weight of the propane component. In some embodiments, the amount of ethane in the composition is less than 100 ppm, preferably less than 50 ppm, based on the total weight of the propane component. In some embodiments, the total amount of methane and ethane in the composition is less than 100 ppm, preferably less than 50 ppm, based on the total weight of the propane component.

In some embodiments, the propane component of the composition comprises 99.9 wt. % propane and 0.1 wt. % one or more additional compounds selected from isobutane, butane, propylene, methane, ethane and combinations thereof. In some embodiments, the amount of propylene in the composition is less than 100 ppm, preferably less than 50 ppm, based on the total weight of the propane component. In some embodiments, the amount of methane in the composition is less than 100 ppm, preferably less than 50 ppm, based on the total weight of the propane component. In some embodiments, the amount of ethane in the composition is less than 100 ppm, preferably less than 50 ppm, based on the total weight of the propane component. In some embodiments, the total amount of methane and ethane in the composition is less than 100 ppm, preferably less than 50 ppm, based on the total weight of the propane component. In some embodiments, the total amount of propylene, methane and ethane in the composition is less than 100 ppm, preferably less than 50 ppm, based on the total weight of the propane component.

In some embodiments, the propane component of the composition comprises 99.9 wt. % propane and 0.1 wt. % impurities selected from isobutane, butane, propylene, butadiene, allene, propyne, methane, ethane and combinations thereof. In some embodiments, the amount of propylene in the composition is less than 100 ppm, preferably less than 50 ppm, based on the total weight of the propane component. In some embodiments, the amount of methane in the composition is less than 100 ppm, preferably less than 50 ppm, based on the total weight of the propane component. In some embodiments, the amount of ethane in the composition is less than 100 ppm, preferably less than 50 ppm, based on the total weight of the propane component. In some embodiments, the amount of butadiene in the composition is less than 100 ppm, preferably less than 50 ppm, based on the total weight of the propane component. In some embodiments, the amount of allene in the composition is less than 100 ppm, preferably less than 50 ppm, based on the total weight of the propane component. In some embodiments, the amount of propyne in the composition is less than 100 ppm, preferably less than 50 ppm, based on the total weight of the propane component. In some embodiments, the total amount of methane and ethane in the composition is less than 100 ppm, preferably less than 50 ppm, based on the total weight of the propane component. In some embodiments, the total amount of propylene, methane and ethane in the composition is less than 100 ppm, preferably less than 50 ppm, based on the total weight of the propane component. In some embodiments, the total amount of butadiene, allene and propyne in the composition is less than 100 ppm, preferably less than 50 ppm, based on the total weight of the propane component.

The presently disclosed compositions will perform more consistently and be more stable with only minor amounts of water present. Thus, the presently claimed compositions may further comprise less than 100 ppm (by weight) water, preferably less than 20 ppm (by weight) water, and even more preferably less than 10 ppm (by weight) water.

Additionally, the presently disclosed compositions will perform more consistently and be more stable with only minor amounts of oxygen or air present. Therefore, the presently claimed compositions may further comprise less than about 5 volume percent non-adsorbable gases (NAG), preferably less than 3 volume percent NAG, and more preferably less than 1.5 volume percent NAG. Further, the presently claimed compositions, due to the presence of air or NAG, will contain less than 1 volume percent oxygen, preferably less than 0.5 volume percent oxygen, and more preferably less than 0.3 volume percent oxygen.

In another embodiment, the presently disclosed compositions may contain a stabilizer. Such stabilizer compounds are intended to be present in a small amount and prevent decomposition due to the presence of water, air, NAG, or oxygen in a system while in use or while the composition is stored. HFO type refrigerants, due to the presence of a double bond, may be subject to thermal instability and decompose under extreme use, handling or storage situations also. Therefore, there may be advantages to adding stabilizers to HFO type refrigerants. Stabilizers may notably include nitromethane, ascorbic acid, terephthalic acid, azoles such as tolutriazole or benzotriazole, phenolic compounds such as tocopherol, hydroquinone, t-butyl hydroquinone, 2,6-di-tertbutyl-4-methylphenol, epoxides (possibly fluorinated or perfluorinated alkyl epoxides or alkenyl or aromatic epoxides) such as n-butyl glycidyl ether, hexanediol diglycidyl ether, allyl glycidyl ether, butylphenylglycidyl ether, cyclic monoterpenes, terpenes, such as d-limonene, a-terpinene, b-terpinene, g-terpinene, a-pinene, or b-pinene, phosphites, phosphates, phosphonates, thiols and lactones. Examples of suitable stabilizers are disclosed in WO2019213004, WO2020222864, and WO2020222865; the disclosures of which are hereby incorporated by reference.

Blends may or may not include stabilizers depending on the requirements of the system being used. If the refrigerant blend does include a stabilizer, it may include any amount from 0.001 wt % up to 1 wt %, preferably from about 0.01 to about 0.5 weight percent, more preferably, from about 0.01 to about 0.3 weight percent of any of the stabilizers listed above.

In another embodiment of the present disclosure, the compositions further comprise at least one lubricant. Lubricants may be selected from polyol ester, polyvinyl ether, and polyalkylene glycol. Lubricants may also comprise those commonly known as “mineral oils” in the field of compression refrigeration lubrication. Mineral oils comprise paraffins (i.e., straight-chain and branched-carbon-chain, saturated hydrocarbons), naphthenes (i.e., cyclic or ring structure saturated hydrocarbons, which may be paraffins) and aromatics (i.e., unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e. linear and branched alkyl alkylbenzenes), synthetic paraffins and naphthenes, silicones, and polyalphaolefins. Representative conventional lubricants of the present invention are the commercially available BVM 100 N (paraffinic mineral oil sold by BVA Oils), napthenic mineral oil commercially available under the trademark from Suniso® 3GS and Suniso® 5GS by Crompton Co., naphthenic mineral oil commercially available from Pennzoil under the trademark Sontex® 372LT, naphthenic mineral oil commercially available from Calumet Lubricants under the trademark Calumet® RO-30, linear alkylbenzenes commercially available from Shrieve Chemicals under the trademarks Zerol® 75, Zerol® 150 and Zerol® 500 and branched alkylbenzene, sold by Nippon Oil as HAB 22.

Lubricants of the present invention further comprise those which have been designed for use with hydrofluorocarbon refrigerants and are miscible with refrigerants of the present invention under compression refrigeration and air-conditioning apparatus' operating conditions. lubricants include, but are not limited to, polyol esters (POEs) such as Castrol®100 (Castrol, United Kingdom), polyalkylene glycols (PAGs) such as RL-488A from Dow (Dow Chemical, Midland, Mich.), and polyvinyl ethers (PVEs) such as PVE-FVC68D.

In one particular embodiment, the foregoing refrigerant compositions are combined with a PAG lubricant or a PVE lubricant or a POE lubricant for usage in an automotive A/C system having an internal combustion engine or an electric or hybrid electric drive train.

In the compositions of the present invention including a lubricant, the lubricant may be present in an amount of less than 80 weight percent of the total composition. The lubricant may further be present in an amount of less than 60 weight percent of the total composition. In other embodiments, the amount of lubricant may be between about 0.1 and 50 weight percent of the total composition. The lubricant may also be between about 0.1 and 20 weight percent of the total composition. The lubricant may also be between about 0.1 and 5 weight percent of the total composition.

In one aspect of the invention, the inventive refrigerant composition is used to introduce lubricant into the A/C system as well as or alternatively other additives, such as a) acid scavengers, b) performance enhancers, and c) flame suppressants. In one preferred embodiment, the present compositions comprise an acid scavenger.

Examples of the acid scavengers that may be included in the present compositions include, but are not limited, the stabilizers and/or the epoxide component of the stabilizers disclosed in U.S. Pat. No. 8,535,555 and the acid scavengers disclosed in International Application Publication No. WO 2020/222864, the disclosure of each of which is incorporated herein by reference in its entirety.

In some embodiments, an acid scavenger may comprise one or more epoxides, one or more amines and/or one or more hindered amines, such as, for example but not limited to, epoxybutane.

The acid scavenger (e.g., the activated aromatic compound, the siloxane, or both) may be present in any concentration that results in a relatively low total acid number, a relatively low total halides concentration, a relatively low total organic acid concentration, or any combination thereof.

Preferably the acid scavenger is present at a concentration greater than about 0.0050 wt %, more preferably greater than about 0.05 wt % and even more preferably greater than about 0.1 wt % (e.g. greater than about 0.5 wt %) based on the total weight of the refrigerant composition. The acid scavenger preferably is present in a concentration less than about 5 wt %, less than about 4 wt %, less than about 3 wt %, more preferably less than about 2.5 wt % and most preferably greater than about 2 wt % (e. g. less than about 1.8 wt %) based on the total weight of the refrigerant composition.

Preferred additives include those described in U.S. Pat. Nos. 5,152,926; 4,755,316, which are hereby incorporated by reference. In particular, the preferred extreme pressure additives include mixtures of (A) tolyltriazole or substituted derivatives thereof, (B) an amine (e.g. Jeffamine M-600) and (C) a third component which is (i) an ethoxylated phosphate ester (e.g. Antara LP-700 type), or (ii) a phosphate alcohol (e.g. ZELEC 3337 type), or (iii) a Zinc dialkyldithiophosphate (e.g. Lubrizol 5139, 5604, 5178, or 5186 type), or (iv) a mercaptobenzothiazole, or (v) a 2,5-dimercapto-1,3,4-triadiaZole derivative (e. g. Curvan 826) or a mixture thereof. Additional examples of additives which may be used are given in U.S. Pat. No. 5,976,399 (Schnur, 5:12-6:51, hereby incorporated by reference).

Acid number is measured according to ASTM D664-01 in units of mg KOH/g. The total halides concentration, the fluorine ion concentration, and the total organic acid concentration is measured by ion chromatography. Chemical stability of the refrigerant system is measured according to ASHRAE 97: 2007 (RA 2017) “Sealed Glass Tube Method to Test the Chemical Stability of Materials for Use within Refrigerant Systems”. The viscosity of the lubricant is tested at 40° C. according to ASTM D-7042.

Mouli et al. (WO 2008/027595 and WO 2009/042847) teach the use of alkyl silanes as a stabilizer in refrigerant compositions containing fluoroolefins. Phosphates, phosphites, epoxides, and phenolic additives also have been employed in certain refrigerant compositions. These are described for example by Kaneko (U.S. patent application Ser. No. 11/575,256, published as U.S. Publication 2007/0290164) and Singh et al. (U.S. patent application Ser. No. 11/250,219, published as U.S. Publication 2006/0116310). All of these aforementioned applications are expressly incorporated herein by reference.

Preferred flame suppressants include the flame retardants described in patent application “Refrigerant compositions containing fluorine substituted olefins CA 2557873 A1” and incorporated by reference, as well as fluorinated products such as HFC-125, HFC-227ea, HFC-236fa, and/or Krytox® lubricants, also incorporated by reference and described in patent application “Refrigerant compositions comprising fluoroolefins and uses thereof WO2009018117A1.”

Additionally, the present compositions may further comprise at least one tracer compound or mixture of tracer compounds. Tracers may be used to identify the process by which a refrigerant, or refrigerant mixture is produced. The tracer compounds may be specific to the manner of production or may be added as a single tracer or mixture of tracers in particular amounts in order to detect dilution, adulteration, contamination, or other unauthorized practices.

The tracer may be a single compound or two or more tracer compounds from the same class of compounds or from different classes of compounds. In some embodiments, the tracer is present in the compositions at a total concentration of about 1 part per million by weight (ppm) to about 5000 ppm, based on the weight of the total composition. In other embodiments, the tracer is present at a total concentration of about 1 ppm to about 1000 ppm. In other embodiments, the tracer is present at a total concentration of about 2 ppm to about 500 ppm. Alternatively, the tracer is present at a total concentration of about 10 ppm to about 300 ppm.

The tracer compound or compounds in amounts up to 100 ppm, 200 ppm, 300, ppm, 400 ppm, 500 ppm, 600 ppm, 700 ppm, 800 ppm and 900 ppm may be selected from hydrofluorocarbons, hydrofluoroolefins, hydrochlorocarbons, hydrochloroolefins, hydrochlorofluorocarbons, hydrochlorofluoroolefins, hydrochlorocarbons, hydrochloroolefins, chlorofluorocarbons, chlorofluoroolefins, hydrocarbons, perfluorocarbons, perfluoroolefins, and combinations thereof. In particular, the tracers may include, but are not limited to compounds selected from HFC-23 (trifluoromethane), HCFC-31 (chlorofluoromethane), HFC-41 (fluoromethane), HFC-161 (fluoroethane), HFC-152a (1,1-difluoromethane), HFC-143a (1,1,1-trifluoroethane), HFC-227ca (1,1,1,2,2,3,3-heptafluoropropane), HFC-227ea (1,1,1,2,3,3,3-heptafluoropropane), HFC-236fa (1,1,1,3,3,3-hexafluoropropane), HFC-236cb (1,1,1,2,2,3-hexafluoropropane), HFC-236ea (1,1,1,2,3,3-hexafluoropropane), HFC-245cb (1,1,1,2,2-pentafluoropropane), HFC-245fa (1,1,1,3,3-pentafluoropropane) HFC-245eb (1,1,1,2,3-pentafluoropropane), HFC-254eb (1,1,1,2-tetrafluoropropane), HFC-263fb (1,1,1-trifluoropropane), HFC-272ca (2,2-difluoropropane), HFC-281ea (2-fluoropropane), HFC-281fa (1-fluoropropane), HFC-329p (1,1,1,2,2,3,3,4,4-nonafluorobutane), HFC-329mmz (2-trifluoromethyl-1,1,1,3,3,3-hexafluoropropane), HFC-338mf (1,1,1,2,2,4,4,4-octafluorobutane), HFC-338pcc (1,1,2,2,3,3,4,4-octafluorobutane), CFC-12 (dichlorodifluoromethane), CFC-11 (trichlorofluoromethane), CFC-114 (1,2-dichloro-1,1,2,2-tetrafluoroethane), CFC-114a (2,2-dichloro-1,1,1,2-tetrafluoroethane), CFC-115 (chloropentafluoroethane), HCFC-22 (chlorodifluoromethane), HCFC-123 (2,2-dichloro-1,1,1-trifluoroethane), HCFC-124 (2-chloro-1,1,1,2-tetrafluoroethane), HCFC-124a (1-chloro-1,1,2,2-tetrafluoroethane), HCFC-141b (1,1-dichloro-1-fluoroethane), HCFC-142b (1-chloro-1,1-difluoroethane), HCFC-151a (1-chloro-1-fluoroethane), HCFC-244bb (2-chloro-1,1,1,2-tetrafluoropropane), HCC-40 (chloromethane), HFO-1141 (fluoroethylene), HCO-1130 (1,2-dichloroethylene, E- and/or Z-isomer), HCO-1130a (1,1-dichloroethylene), HCFO-1131 (1-chloro-2-fluoroethylene, E- and/or Z-isomer), HCFO-1131a (1-chloro-1-fluoroethylene), HCFO-1122 (2-chloro-1,1-difluoroethylene), HFO-1123 (trifluoroethylene), HFO-1234ye (1,2,3,3-tetrafluoropropene), HFO-1243zf (3,3,3-trifluoropropene), HFO-1225yeZ (1,2,3,3,3-pentafluoropropene), HFO-1225zc (1,1,3,3,3-pentafluoropropene), PFC-116 (hexafluoroethane), PFC-C216 (hexafluorocyclopropane), PFC-218 (octafluoropropane), PFC-C318 (octafluorocyclobutane), PFC-1216 (hexafluoropropene), PFC-31-10mc (decafluorobutane), PFC-31-10my (2-trifluoromethyl-1,1,1,2,3,3,3-heptafluoropropane), 2-chloro-1,1,2-trifluoroethylene (CFO-1113), 1,1,1,3,3-pentafluorobutane (HFC-365mfc), 1,1,1,2,3,4,4,5,5,5-decafluoropentane (HFC-43-10mee), 1,1,1,2,2,3,4,5,5,6,6,7,7,7-tetradecafluoroheptane, hexafluorobutadiene, 3,3,3-trifluoropropyne, deuterated hydrocarbons, deuterated hydrofluorocarbons, perfluorocarbons, fluoroethers, and mixtures thereof.

In some embodiments, the tracer is a blend containing two or more hydrofluorocarbons, or one hydrofluorocarbon in combination with one or more perfluorocarbons. In other embodiments, the tracer is a blend of at least one CFC and at least one HCFC, HFC, or PFC.

In some embodiments according to the present invention, any of the compositions disclosed herein and the degradation products thereof are preferably free of or substantially free of Group A Fluorinated Substances.

In one embodiment, as used herein, “Group A Fluorinated Substances” includes any substance that (i) contains at least one fully fluorinated methyl (—CF₃) or methylene (—CF₂—) carbon atom (without any H/Cl/Br/I attached to it); and (ii) meets the criterion for persistence in soil/sediment and water established in Annex XIII (Section 1.1.1) of the European Union's REACH Regulation (https://reachonline.eu/reach/en/annex-xiii-1-1.1-1.1.1.html as accessed on May 2, 2023) and referenced in the Annex XV Restriction Report dated Mar. 22, 2023, the disclosure of which is hereby incorporated by reference (https://echa.europa.eu/documents/10162/f605d4b5-7c17-7414-8823-b49b9fd43aea as accessed on May 2, 2023). In one embodiment, Group A Fluorinated Substances include, but are not limited to, trifluoroacetic acid (TFA).

In another embodiment, as used herein, “Group A Fluorinated Substances” includes any substance that has a Henrys Law constant ≤250 Pa*m³/mol an contains at least one fully fluorinated methyl (—CF₃) or methylene (—CF₂—) carbon atom (without any H/Cl/Br/I attached to it). In one embodiment, Group A Fluorinated Substances include, but are not limited to, TFA.

According to some embodiments, compositions of the present invention comprise a blend of at least one fluoroolefin and at least one natural thermal management fluid, and are free of or substantially free of Group A Fluorinated Substances, such as TFA. In one embodiment, the phrase “free of” as used herein with respect to the presence of Group A Fluorinated Substances in the present compositions means that the amount of such substances in the compositions is sufficiently low so as to not be detectable, including but not limited to 0%, when measured by gas chromatography with a flame ionization detector, gas chromatography with a mass detector by analysis of a gas sample or liquid sample, and/or ion chromatography by analysis of a water sample after bubbling the thermal fluid through water. Such methodologies are well known to those skilled in the art. In one embodiment, the phrase “substantially free of” as used herein with respect to the presence of Group A Fluorinated Substances in the present compositions means that the amount of such substances in the compositions is >0 wt. % and ≤15 or wt. %, >0 wt. % and ≤10 wt. %, or >0 wt. % and ≤5 wt. %, or >0 wt. % and ≤4 wt. %, or >0 wt. % and ≤3 wt. %, or >0 wt. % and ≤2 wt. %, or >0 wt. % and ≤1 wt. %, and all values and ranges therebetween, when measured by gas chromatographic (GC) techniques, for example gas chromatography (GC) with a flame ionization or electron-capture detector, or GC coupled with a mass detector (gas chromatography/mass spectral (GC/MS) method), by ion chromatograph(IC) or ion chromatography mass spectrometry (IC-MS) techniques, or by high-performance liquid chromatography (HPLC) or high-performance liquid chromatography mass spectrometry (HPLC-MS) techniques. The TFA analytical standard may be used in either gas chromatography or ion chromatography and is available from, for example, Sigma Aldrich.

Further, in some embodiments, degradation products of such compositions of the present invention which comprise a blend of at least one fluoroolefin and at least one natural thermal management fluid are free of or substantially free of Group A Fluorinated Substances, such as TFA. In one embodiment, the phrase “free of” as used herein with respect to the formation of Group A Fluorinated Substances by the present compositions means that the theoretical molar yield of such substances in environmental compartments of air, soil/sediment and water produced during tropospheric degradation of the compositions is sufficiently low so as to not be detectable, including but not limited to 0%, when measured by GC techniques, for example GC with a flame ionization or electron-capture detector or GC/MS method, by IC or IC-MS techniques, or by HPLC or HPLC-MS techniques. In one embodiment, the phrase “substantially free of” as used herein with respect to the formation of Group A Fluorinated Substances by the present compositions means that the theoretical molar yield of such substances in environmental compartments of air, soil/sediment and water produced during tropospheric degradation of the compositions is >0% and ≤5%, or >0% and ≤4%, or >0% and ≤3%, or >0% and ≤2%, or >0% and ≤1%, and all values and ranges therebetween, when measured by GC techniques, for example GC with a flame ionization or electron-capture detector or GC/MS method, by IC or IC-MS techniques, or by HPLC or HPLC-MS techniques.

The compositions of the present invention may be prepared by any convenient method to combine the desired amount of the individual components. A preferred method is to weigh the desired component amounts and thereafter combine the components in an appropriate vessel. Agitation may be used, if desired. In another embodiment, any of the foregoing refrigerant compositions can be prepared by blending at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof; at least one other compound selected from HC-290, HC-1270, R-600, R-600a, isobutene, R-601, R-601a, R-744, R-717, and combinations thereof; and in some cases, at least one other compound selected from HFC-134, HFC-134a, HFC-125, HFC-32, HFC-152a, and combinations thereof.

In a further embodiment, at least a portion of the compositions may be prepared from recycled or reclaimed refrigerant. One or more of the components may be recycled or reclaimed by means of removing contaminants, such as air, water, or residue, which may include lubricant or particulate residue from system components. The means of removing the contaminants may vary widely, but can include distillation, decantation, filtration, and/or drying by use of molecular sieves or other absorbents. Then the recycled or reclaimed component(s) may be combined with the other component(s) as described above, where the other component(s) may be virgin refrigerant, recycle refrigerant or reclaimed refrigerant. Thus, the compositions of the present invention may comprise, at least in part, recycled or reclaimed materials.

### Methods, Apparatus, and Systems

The compositions comprising, consisting of, or consisting essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, are useful in numerous methods and systems that provide cooling (e.g. air-conditioning or refrigeration) and heating.

In one embodiment, provided is a method of cooling comprising evaporating a composition according to the present invention in the vicinity of a body to be cooled and thereafter condensing said composition, wherein said cooling is provided by a refrigeration system, air-conditioner, heat pump, or chiller.

In one embodiment, the refrigeration system may be a residential, commercial, or industrial refrigeration system. These may include, but are not limited to, supermarket and convenience store refrigerated cases for beverages, dairy, and produce and prepared foods. In one embodiment, the refrigeration system is a low or medium temperature refrigeration system, including supermarket and convenience store refrigerator and freezer cabinets and displays, ice machines, self-contained coolers and freezers, such as beverage coolers, walk-in and reach-in coolers and freezers, supermarket rack and distributed systems, and refrigerated or frozen food transport.

In one embodiment, the air conditioner may be a residential, commercial, or industrial air-conditioning system. These may include, but are not limited to, window, ducted, ductless, packaged terminal, and those exterior to, but connected to the building, such as rooftop systems. These may also include residential heat pumps that provide comfort air-conditioning and heating.

In another embodiment, the cooling may be performed in a chiller. Chillers, including both flooded evaporator and direct expansion chillers, may be coupled with an air handling and distribution system to provide comfort air conditioning (cooling and dehumidifying the air) to large commercial buildings, including hotels, office buildings, hospitals, universities and the like. In another embodiment, chillers, most likely air-cooled direct expansion chillers, have found additional utility in naval submarines and surface vessels.

Chillers may be characterized by the compressor used. In one embodiment, the chiller may comprise a centrifugal compressor. In another embodiment, the chiller may comprise a scroll compressor. In another embodiment the chiller may comprise a screw compressor. In yet another embodiment, the chiller may comprise a reciprocating compressor.

The present method for cooling may be particularly useful in high ambient temperature regions, due to the high critical temperature of blends comprising, consisting of, or consisting essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof.

In another embodiment, the method for producing cooling is particularly useful in regions where the ambient temperature can exceed at least 35° C.

In geographic areas with high ambient temperatures, where air conditioning becomes essential, refrigerant compositions with high critical temperatures and high thermal stability are desirable. Currently available hydrofluorocarbon (HFC) refrigerants such as R-410A, R-407C or R-32 have relatively low critical temperatures. As a consequence, these refrigerants do not perform well in extreme hot environments. The energy efficiency of a refrigerant generally decreases as the condensing temperature approaches the refrigerant critical temperature during operation at high ambient temperatures. In hot climates, R-22 has remained the refrigerant of choice for much air conditioning and refrigeration applications as it is not flammable and has a higher critical temperature so that it delivers higher cooling capacity and higher energy efficiency in hot climates as compared to R-410A or R-32. However, R-22 is an ozone depleting substance in the Montreal Protocol to reduce ozone depletion. As such, R-22 has been mandated and legislated for phase out for manufacture for and use in air conditioning and refrigeration. There is interest in finding a refrigerant with the lowest possible direct GWP and also that performs well in hot climate (or high ambient) temperature regions.

In the method for producing cooling the body to be cooled may be defined as any space, location, object, or body for which it is desirable to provide cooling. Examples include spaces, open or enclosed, that require cooling such as a residence, such as an apartment or apartment building, university dormitory, townhouse or other attached house, or a single-family home; or the body to be cooled may be any other building, such as an office building, supermarket, college or university classroom or administration buildings.

In another embodiment, a method for producing air conditioning in high ambient temperatures is provided. The method comprises evaporating a composition comprising, consisting of, or consisting essentially of HFO-1234ze(E), at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, and thereafter condensing said composition. The method is particularly useful in regions where ambient temperatures can exceed 35° C. or more.

In another embodiment, a method is provided for replacing HCFC-22 in high ambient air conditioning apparatus comprising providing a composition comprising, consisting essentially of, or consisting of HFO-1234ze(E), at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, to said apparatus. The method of replacing HCFC-22 is particularly useful in regions where ambient temperatures can exceed 35° C. or more.

Similarly, in some industrial air conditioning applications heat must be released in high ambient temperature environments. HCFC-124 has been used as the working fluid in such applications. HCFC-124 is also controlled under the Montreal protocol as an ozone depleting substance and more environmentally sustainable replacements are desirable. Thus, a method is provided for replacing HCFC-124 in industrial air conditioning apparatus, comprising providing a composition comprising, consisting essentially of, or consisting of HFO-1234ze(E), at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, to said apparatus. The method of replacing HCFC-124 is particularly useful in regions where ambient temperatures can exceed 35° C. or more.

In another embodiment, the method for producing cooling and method for replacing HCFC-22 or HCFC-124 are useful for systems operating in ambient temperatures of 40° C. or higher. In another embodiment, the method for producing cooling is useful for systems operating in ambient temperatures of 45° C. or higher. In another embodiment, the method for producing cooling is useful for systems operating in ambient temperatures of 50° C. or higher. In another embodiment, the method for producing cooling is useful for systems operating in ambient temperatures of 55° C. or higher. In another embodiment, the method for producing cooling is useful for systems operating in ambient temperatures of 60° C. or higher. In another embodiment, the method for producing cooling is useful for systems operating in ambient temperatures from 35-50° C. In another embodiment, the method for producing cooling is useful for systems operating in ambient temperatures from 35-60° C. In another embodiment, the method for producing cooling is useful for systems operating in ambient temperatures from 40-60° C. In another embodiment, the method for producing cooling is useful for systems operating in ambient temperatures from 45-60° C. In another embodiment, the method for producing cooling is useful for systems operating in ambient temperatures from 50-60° C.

In another embodiment, provided is a method of heating comprising evaporating a composition comprising, consisting of, or consisting essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, and thereafter condensing said composition in the vicinity of a body to be heated.

In one embodiment, the heating is accomplished by a heat pump, which may be a residential, light commercial, commercial, or industrial heat pump system. These may include, but are not limited to, residential heat pumps that provide comfort air-conditioning and heating, hot water heat pumps for heating air (by secondary loop) or for heating water for residential or commercial use, heat pumps for heating manufacturing process equipment, and high temperature heat pumps (with condensing temperature of 50 deg C. or higher).

Due to the high critical temperature of blends comprising, consisting of, or consisting essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, it is possible to heat water to higher temperatures than propane or R-454C.

In another embodiment, the present invention relates to a system for cooling or heating comprising a composition comprising, consisting of, or consisting essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, R-601, isobutene, R-601a, R-744, R-717, and combinations thereof, and optionally at least one other compound selected from HFC-134, HFC-134a, HFC-125, HFC-32, HFC-152a, and combinations thereof. The system comprises an evaporator, compressor, condenser, and expansion device, each operably connected to perform a vapor compression cycle. In another embodiment, the system may further comprise a lubricant. The lubricant may be selected from the group consisting of polyalkylene glycol, polyol ester, poly-a-olefin, and polyvinyl ether. In another embodiment, the lubricant is selected from POE or PVE.

The system for cooling or heating may be a refrigeration system, air-conditioner, heat pump, or chiller.

In one embodiment, the refrigeration system may be a residential, commercial, or industrial refrigeration system. These may include, but are not limited to, supermarket and convenience store refrigerated cases for beverages, dairy, and produce and prepared foods. In one embodiment, the refrigeration system is a low or medium temperature refrigeration system, including supermarket and convenience store refrigerator and freezer cabinets and displays, ice machines, self-contained coolers and freezers, such as beverage coolers, walk-in and reach-in coolers and freezers, supermarket rack and distributed systems, and refrigerated or frozen food transport.

In one embodiment, the composition useful for or contained in any of the refrigeration systems described herein comprises, consists of, consists essentially of at least one compound selected from HFO-1234ze(E), HFO-1234ze(Z), HFO-1336mzz(E), HCFO-1233zd(E), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof.

In one embodiment, the air conditioner may be a residential, commercial, or industrial air-conditioning system. These may include, but are not limited to, window, ducted, ductless, packaged terminal, and those exterior to, but connected to the building, such as rooftop systems. These may also include residential heat pumps that provide comfort air-conditioning and heating.

In one embodiment, the composition useful for or contained in any of the air conditioning systems described herein comprises, consists of, consists essentially of HFO-1234ze(E), at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof.

In another embodiment, the system is a chiller. Chillers, including both flooded evaporator and direct expansion chillers, may be coupled with an air handling and distribution system to provide comfort air conditioning (cooling and dehumidifying the air) to large commercial buildings, including hotels, office buildings, hospitals, universities and the like. In another embodiment, chillers, most likely air-cooled direct expansion chillers, have found additional utility in naval submarines and surface vessels.

Chillers may be characterized by the compressor used. In one embodiment, the chiller may comprise a centrifugal compressor. In another embodiment, the chiller may comprise a scroll compressor. In another embodiment the chiller may comprise a screw compressor. In yet another embodiment, the chiller may comprise a reciprocating compressor. When replacing a refrigerant in a chiller, the compressor, often designed for the refrigerant to be used, may need modification. Therefore, for centrifugal chillers, the impeller diameter or impeller tip speed for the new refrigerant must be similar or match that for the original refrigerant to be used as a drop-in replacement.

In one embodiment, the system is a heat pump, which may be a residential, light commercial, commercial, or industrial heat pump system. These may include, but are not limited to, residential heat pumps that provide comfort air-conditioning and heating, hot water heat pumps for heating air (by secondary loop) or for heating water for residential or commercial use, heat pumps for heating manufacturing process equipment, and high temperature heat pumps (with condensing temperature of 50 deg C. or higher).

In one embodiment, the composition useful for or contained in any of the heat pump systems described herein comprises, consists of, consists essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof.

In one embodiment, the composition useful for or contained in any of the high temperature heat pump systems described herein comprises, consists of, consists essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof.

In another embodiment, the system containing the compositions comprising, consisting of, or consisting essentially of HFO-1234ze(E), at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, may be an automobile heat pump for cooling and heating the passenger compartment of an electric or hybrid vehicle. Electric or hybrid vehicles include automobiles with no internal combustion engine (ICE) or those that maintain an ICE but also use electric power and are therefore hybrid electric vehicles (HEV) or plug-in hybrid electric vehicles (PHEV) or mild hybrid electric vehicles (MHEV). Additionally, electric or hybrid vehicles include full electric vehicles (EV), such as battery electric vehicles (BEV). All of these electric or hybrid vehicles use at least one electric motor, wherein the electric motor provides some form of propulsion for the vehicles normally provided by the ICE found in gasoline/diesel powered vehicles.

In one embodiment, the automobile heat pump is a secondary loop system. The secondary loop allows the separation of a flammable refrigerant from the passenger compartment, using a heat transfer fluid to produce cooling or heating in the passenger compartment.

In another embodiment, the automobile heat pump does not include a positive temperature coefficient (PTC) heater. The PTC heater often used in electric vehicles is needed in the absence of an ICE to provide adequate heating to the passenger compartment.

In another embodiment, the compositions comprising, consisting of, or consisting essentially of HFO-1234ze(E), at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, may be used in a method of replacing at least one of R-22, HFC-134a, propane, HFO-1234yf, R-407C, R-404A, R-410A, R-513A, R-454A, R-454B, R-454C, R-448A, R-449A, R-449B, R-449C, R-1234zeE, R-515B, R471A, R-476A, R-482A, R-452A, or R-452C, in refrigeration, air-conditioning, heat pump, or chiller systems comprising providing any of the compositions comprising, consisting of, or consisting essentially of HFO-1234ze(E), at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof to the system in place of R-22, HFC-134a, propane, HFO-1234yf, R-407C, R-404A, R-410A, R-513A, R-454A, R-454B, R-454C, R-448A, R-449A, R-449B, R-449C, R-1234zeE, R-515B, R471A, R-476A, R-482A, R-452A, or R-452C.

In one embodiment, the method for replacement may be a retrofit for existing equipment. Therefore, the method is specific to replacing a refrigerant in equipment that was designed for, or originally contained R-22, HFC-134a, propane, HFO-1234yf, R-407C, R-404A, R-410A, R-513A, R-454A, R-454B, R-454C, R-448A, R-449A, R-449B, R-449C, R-452A, or R-452C. In another embodiment, the replacement is simply providing a new refrigerant for an application or use, wherein the new refrigerant can provide improved performance, or meet regulatory requirements that are not met by the incumbent refrigerant.

The compositions comprising, consisting of, or consisting essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof provide performance that would allow replacement of R-22, HFC-134a, propane, HFO-1234yf, R-407C, R-404A, R-410A, R-513A, R-454A, R-454B, R-454C, R-448A, R-449A, R-449B, R-449C, R-1234zeE, R-515B, R471A, R-476A, R-482A, R-452A, or R-452C.

In another embodiment, the compositions comprising, consisting of, or consisting essentially of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof provide performance that enables the use as refrigerant in refrigeration, air-conditioning, heat pump, or chiller systems. In particular, the refrigeration, air-conditioning, heat pump, or chiller systems comprise mobile or stationary air conditioning, mobile or stationary heat pumps, residential, light commercial, commercial, or industrial air-conditioner, residential, light commercial, commercial, or industrial heat pump, centrifugal chiller, screw chiller, scroll chiller, flooded evaporator chiller, direct expansion chiller, medium or low temperature refrigeration system, beverage cooler, supermarket display case, ice machine, or transport refrigeration or freezer system. Additionally, the compositions comprising HFO-1234ze(E) are useful wherein the system is an automobile heat pump for cooling and heating the passenger compartment of an electric or hybrid vehicle. Further, the compositions may be useful in replacing refrigerants such as R-22, HFC-134a, propane, HFO-1234yf, R-407C, R-404A, R-410A, R-513A, R-454A, R-454B, R-454C, R-448A, R-449A, R-449B, R-449C, R-1234zeE, R-515B, R471A, R-476A, R-482A, R-452A, or R-452C.

The compositions disclosed herein may be useful in air conditioning, heat pumps, chillers, and refrigeration systems. In particular, the compositions may be used in residential air conditioning, industrial air conditioning, residential heat pumps, industrial heat pumps, water heating heat pumps, high temperature heat pumps (with condenser temperature above about 55 degrees C.), flooded evaporator chillers, screw chillers, scroll chillers, centrifugal chillers, residential refrigerators, supermarket refrigeration systems, ice machines, beverage coolers, vending machines, medium temperature refrigeration, low temperature refrigeration, transport refrigeration, among others.

The compositions disclosed herein may also be useful in methods for replacing existing or conventional refrigerants that for reasons of environmental concern are in need of replacement. The replacement may mean that the composition of the present invention is used in place of the existing refrigerant in new equipment for a specific application or use. The replacement may also mean that the composition of the invention is used in existing equipment after the original refrigerant is removed. This type of replacement may be referred to as drop-in replacement or retrofit. In some embodiments, the retrofit may require adjustment of existing equipment or even changing out certain pieces of equipment to allow use of the new refrigerant.

The compositions disclosed herein are useful in methods of replacing R-134a, R-1234zeE, R-515B, R471A, R-476A, R-482A, R-454C, R-404A, and R-449A. The method comprises providing the composition of the present invention comprising, consisting essentially of, or consisting of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof, in place of the refrigerant to be replaced. The method may also comprise, first removing the refrigerant in need of replacement from existing equipment, then charging the composition of the present invention comprising, consisting essentially of, or consisting of at least one compound selected from HFO-1234ze(E), HFO-1234ze(Z), HFO-1336mzz(E), HFO-1336mzz(Z), HCFO-1233zd(E), HCFO-1233zd(Z), CFO-1112, and combinations thereof, at least one other compound selected from HC-290, HC-1270, R-600, R-600a, isobutene, R-601, R-601a, R-744, R-717, and combinations thereof, and optionally at least one other compound selected from HFC-134, HFC-134a, HFC-125, HFC-32, HFC-152a, and combinations thereof.

In another embodiment, the HFO-1234ze compositions of the present invention may be used in a process to transfer heat. The process may include providing an article and contacting the article with a heat transfer media including the HFO-1234ze compositions of the present invention. In some embodiments, the article may include electrical equipment (e.g., circuit board, computer, display, semiconductor chip, or transformer), a heat transfer surface (e.g., heat sink), or article of clothing (e.g., a body suit).

In some embodiments, the HFO-1234ze compositions disclosed herein may be useful as heat transfer fluids for direct-to-chip cooling, for example, for cooling of one or more components of a data center, such as but not limited to, data center servers. In some embodiments, the composition comprising HFO-1234ze(E) or HFO-1234ze(Z), optionally one or more of the additional compounds, and optionally one or more other refrigerant compounds, are particularly suited for cooling of a data center and/or one or more components of a data center, and more particularly as a heat transfer fluid, particularly coolant, for a direct to chip cooling loop for cooling of the data center component(s) (e.g., a data center server). Any of these compositions can be used as a liquid coolant, in place of water, for cooling of one or more components of a data center, such as but not limited to, data center servers, particularly by direct to chip cooling. In such an application, the HFO-1234ze(Z) or HFO-1234ze(E) containing composition circulates through a cold-plate heat exchanger located directly on the electrical component, such as a computer chip. The heat which dissipates from the computer chip is absorbed into the coolant loop, and the heated fluid is then circulated through a piping network until it reaches a lower-temperature heat exchanger, to reject the heat to, for example, a cooled water loop, and/or to the server room's air conditioning system, and/or to outside ambient air.

In some embodiments, according to systems and method of the present invention, one or more non-condensable gases are purged during start up and operation of data center chiller systems and/or direct-to-chip liquid cooling systems. Examples of non-condensable gases include, but are not limited to, air, oxygen containing gases, nitrogen containing gases, CO₂ containing gases and combinations thereof.

The invention will be described in greater detail below by way of specific examples. The following examples are offered for illustrative purposes and are not intended to limit the invention in any manner. Those of skill in the art will readily recognize a variety of non-critical parameters which can be changed or modified to yield essentially the same results.

### EXAMPLES

### Performance Examples for Residential

### Heat Pump Systems Comprising HFO-1234ze(E) Compositions

In the below Tables, “T_condenser” is condenser temperature, “T_evaporator” is evaporator temperature, “COP” is coefficient of performance (analogous to energy efficiency), and “CAP” is volumetric cooling capacity. In Examples 1-10, refrigerant performance has been determined for an exemplary composition of the present invention in residential heat pump systems as compared to HFO-1234ze(E), in cooling or heating modes. It will be understood by those skilled in the art that the weight percents in the refrigerant performance data are nominal weight fractions. The cooling mode data are based on the conditions set forth in Table 2. The heating mode data are based on the conditions set forth in Table 3.

TABLE 2
Residential Heat Pump Cooling Mode Conditions

| | | |
|---|---|---|
| T_condenser | 47° | C. |
| T_evaporator | 7° | C. |
| Subcool temp. | 12.0 | K |
| Superheat temp. | 3.0 | K |

| | |
|---|---|
| Compressor Efficiency | 0.7 |

TABLE 3
Residential Heat Pump Heating Mode Conditions

| | | |
|---|---|---|
| T_condenser | 35° | C. |
| T_evaporator | −5° | C. |
| Subcool temp. | 11.11 | K |
| Superheat temp. | 8.33 | K |

| | |
|---|---|
| Compressor Efficiency | 0.7 |

### Example 1: HFO-1234ze(E)/Butane/HFC-134 (Cooling Mode)

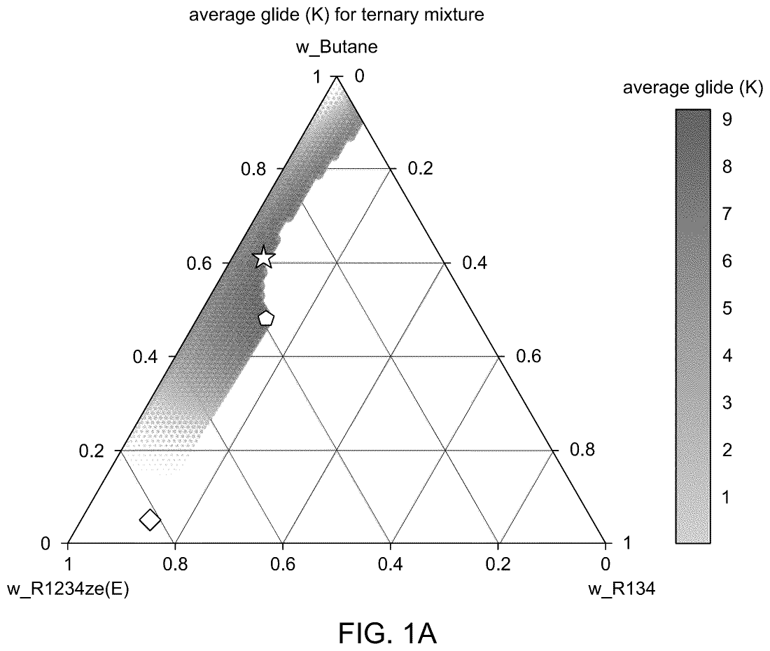

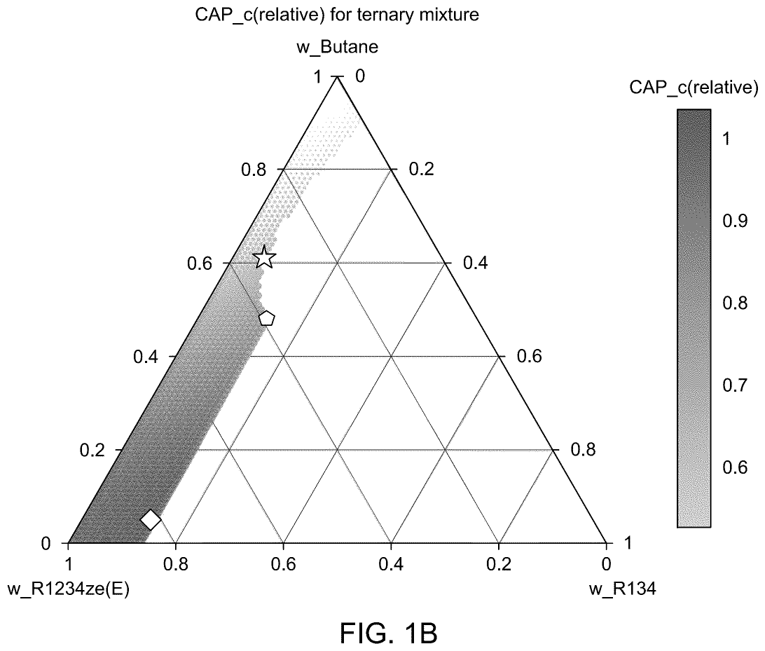

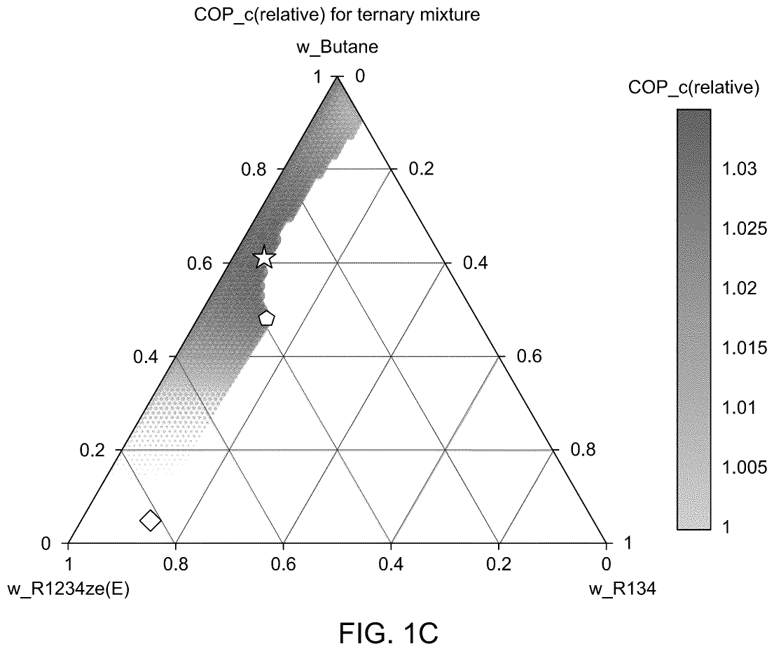

Refrigerant performance has been determined for an exemplary composition of the present invention comprising HFO-1234ze(E), butane and HFC-134 in residential heat pump systems as compared to HFO-1234ze(E), in cooling mode. Performance metric and composition property ranges are summarized in Table 4, where the ASHRAE flammability class remains 2L or 2, the average temperature glide is <1 K and GWP<150. Table 5 tabulates several compositions about the compositions of optimal cooling efficiency and capacity. FIGS. 1A, 1B and 1C provide graphical representations of the average glide, the CAP for cooling relative to the incumbent fluid, and the COP for cooling relative to the incumbent fluid, respectively, for a composition according to Example 1.

TABLE 4
Residential Heat Pump Cooling Mode Condition,
cycle metric performance and fluid property
ranges for 1234zeE/butane/134 in Ex. 1

| | MAXIMA | MINIMA |
|---|---|---|
| w_R1234ze(E) (nominal weight fraction) | 1 | 0.72 |
| w_butane (nominal weight fraction) | 0.15 | 0 |
| w_R134 (nominal weight fraction) | 0.13 | 0 |
| T° c. (deg C.) | 112 | 109 |
| average glide (K) | 1 | 0 |
| GWP AR5 | 147 | 7 |
| COP_c (relative to R1234zeE) | 1.003 | 1 |
| CAP_c (relative to R1234zeE) | 1.04 | 0.98 |

TABLE 5
Residential Heat Pump Cooling Mode Condition, cycle metric performance
and fluid property ranges for 1234zeE/butane/134 in Ex. 1

| | | | Avg. | | COP_c (% | CAP_c (% | ASHRAE |
|---|---|---|---|---|---|---|---|
| wt-% | wt-% | wt-% | Glide | GWP | dev from | dev from | Flammability |
| Butane | R1234ze(E) | R134 | (K) | AR5 | R1234zeE) | R1234zeE) | Class |
| 0 | 1 | 0 | 0 | 1 | 1 | 1 | 2 L |
| 0.005 | 0.86565 | 0.12935 | 0.1166 | 145.7527 | 1.001077869 | 1.032870123 | 2 L |
| 0.01 | 0.92 | 0.07 | 0.0869 | 79.35 | 1.0003964 | 1.018803614 | 2 L |
| 0.02 | 0.87 | 0.11 | 0.14 | 124.13 | 1.000623557 | 1.030265214 | 2 L |
| 0.02 | 0.97 | 0.01 | 0.0184 | 12.23 | 0.999942088 | 1.002416368 | 2 L |
| 0.03 | 0.92 | 00.05 | 0.0871 | 57.01 | 1.000169244 | 1.013641158 | 2 L |
| 0.04 | 0.87 | 0.09 | 0.1562 | 101.79 | 1.0003964 | 1.025197481 | 2 L |
| 0.05 | 0.84 | 0.11 | 0.2022 | 124.19 | 1.0003964 | 1.030975643 | 2 L |
| 0.06 | 0.82 | 0.12 | 0.2423 | 135.4 | 1.0003964 | 1.03353319 | 2 L |
| 0.06 | 0.88 | 0.06 | 0.1558 | 68.26 | 1.0003964 | 1.014067415 | 2 |
| 0.07 | 0.83 | 0.1 | 0.2525 | 113.04 | 1.000623557 | 1.026002635 | 2 |
| 0.0796 | 0.9154 | 0.005 | 0.0971 | 6.7542 | 1.000623557 | 0.991428388 | 2 |
| 0.08 | 0.88 | 0.04 | 0.1826 | 45.92 | 1.000623557 | 1.003553055 | 2 |
| 0.09 | 0.83 | 0.08 | 0.315 | 90.7 | 1.001077869 | 1.015535637 | 2 |
| 0.1 | 0.78 | 0.12 | 0.4472 | 135.48 | 1.001305025 | 1.027660304 | 2 |
| 0.1 | 0.88 | 0.02 | 0.2332 | 23.58 | 1.001305025 | 0.991096854 | 2 |
| 0.11 | 0.83 | 0.06 | 0.4078 | 68.36 | 1.001532182 | 1.002937349 | 2 |
| 0.12 | 0.78 | 0.1 | 0.5872 | 113.14 | 1.001986494 | 1.015062017 | 2 |
| 0.12935 | 0.86565 | 0.005 | 0.4109 | 6.8537 | 1.002440807 | 0.975183227 | 2 |
| 0.13 | 0.83 | 0.04 | 0.5334 | 46.02 | 1.002440807 | 0.988539307 | 2 |
| 0.14 | 0.79 | 0.07 | 0.738 | 79.61 | 1.00289512 | 0.996543482 | 2 |

Results show that the H FOA 234ze(E), butane and HFC-134 compositions of the present invention provide improved CAP and energy efficiency relative to HFO-1234ze(E), at lower costs, for cooling using residential heat pump systems. Additionally, in many cases, the HFO-1234ze(E), butane and HFC-134 compositions of the present invention provide improved coaling capacity and energy efficiency relative to HFO-1234ze(E), at lower costs. Up to 6 wt % butane can be added to blends of these three components, where the ASHRAE flammability classification will remain 2L. Up to 15 wt % butane can be added to blends of these three components, where the ASHRAE flammability classification will remain 2.

### Example 2: HFO-1234ze(E)/Butane/HFC-134 (Heating Mode)

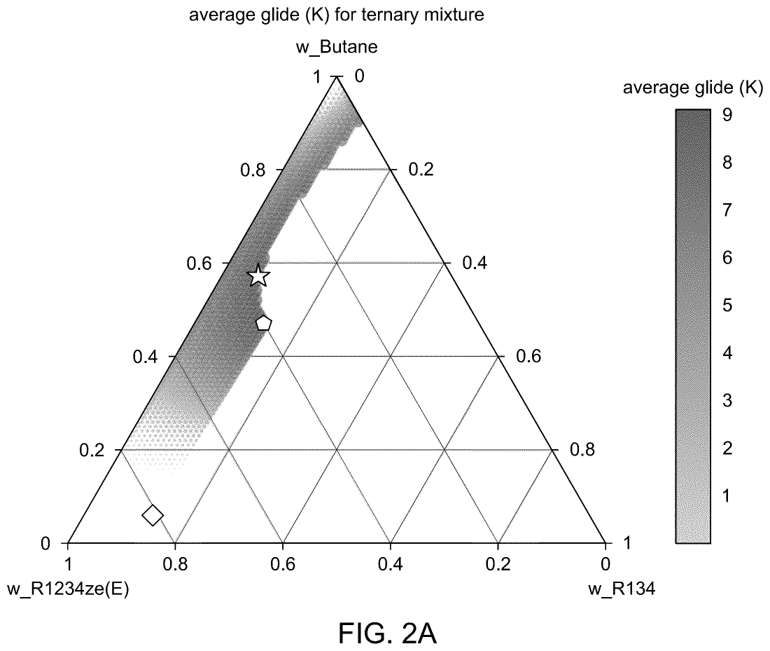

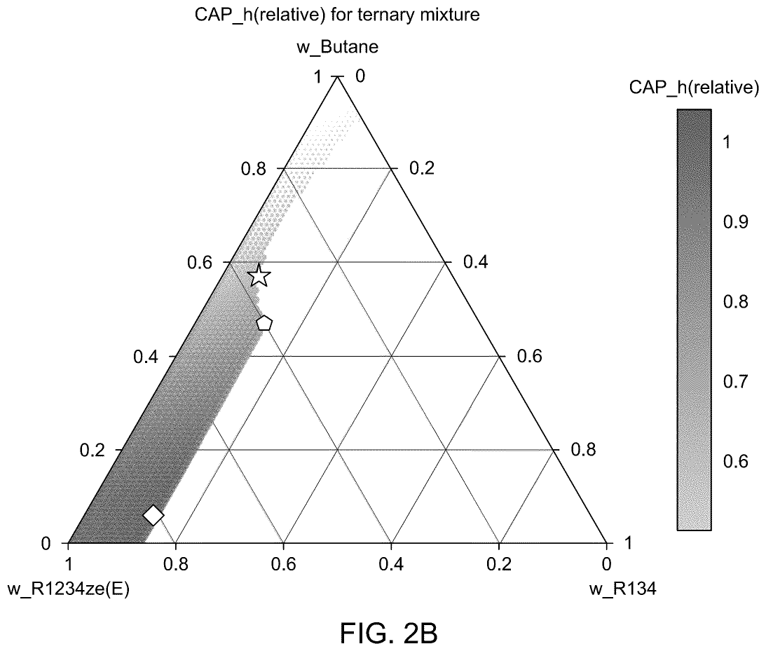

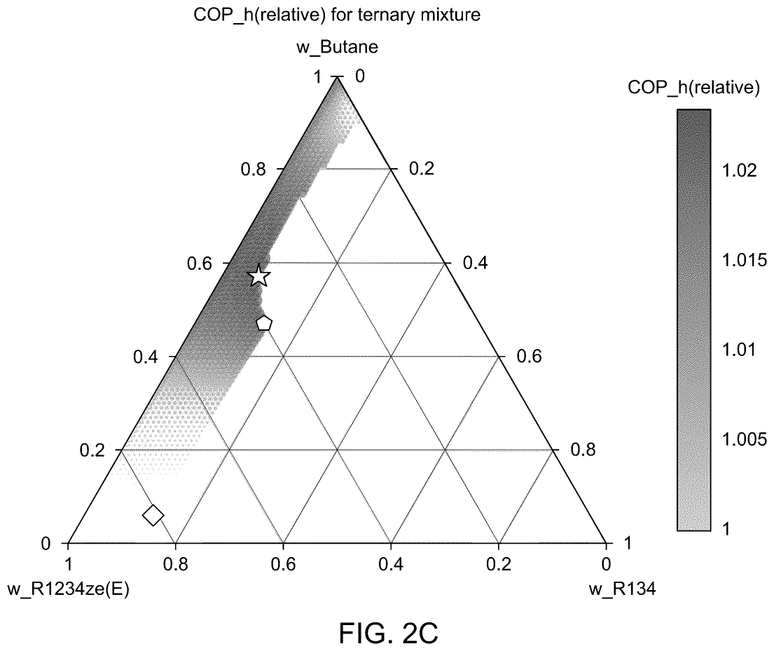

Refrigerant performance has been determined for an exemplary composition of the present invention comprising HFO-1234ze(E), butane and HFC-134 in residential heat pump systems as compared to HFO-1234ze(E), in heating mode. Performance metric and composition property ranges are summarized in Table 6, where the ASHRAE flammability class remains 2L or 2, the average temperature glide is <1 K and GWP<150. Table 7 tabulates several compositions about the compositions of optimal heating efficiency and capacity. FIGS. 2A, 2B and 2C provide graphical representations of the average glide, the CAP for heating relative to the incumbent fluid, and the COP for heating relative to the incumbent fluid, respectively, for a composition according to Example 2.

TABLE 6
Residential Heat Pump Heating Mode Condition,
cycle metric performance and fluid property
ranges for 1234zeE/butane/134 in Ex. 2

| | MAXIMA | MINIMA |
|---|---|---|
| w_R1234ze(E) (nominal weight fraction) | 1 | 0.72 |
| w_butane (nominal weight fraction) | 0.15 | 0 |
| w_R134 (nominal weight fraction) | 0.13 | 0 |
| T° c. (deg C.) | 112 | 109 |
| average glide (K) | 1 | 0 |
| GWP AR5 | 147 | 7 |
| COP_h (% dev from R1234zeE) | 1.003 | 1 |
| CAP_h (% dev from R1234zeE) | 1.04 | 0.98 |

TABLE 7
Residential Heat Pump Heating Mode Condition, cycle metric performance
and fluid property ranges for 1234zeE/butane/134 in Ex. 2

| | | | Avg. | | COP_h (% | CAP_h (% | ASHRAE |
|---|---|---|---|---|---|---|---|
| wt-% | wt-% | wt-% | Glide | GWP | dev from | dev from | Flammability |
| Butane | R1234ze(E) | R134 | (K) | AR5 | R1234zeE) | R1234zeE | Class |
| 0 | 1 | 0 | 0 | 1 | 1 | 1 | 2 L |
| 0.005 | 0.86565 | 0.12935 | 0.1172 | 145.7527 | 1.000451322 | 1.032951723 | 2 L |
| 0.01 | 0.92 | 0.07 | 0.0894 | 79.35 | 1.000261195 | 1.01960481 | 2 L |
| 0.02 | 0.87 | 0.11 | 0.145 | 124.13 | 1.000261195 | 1.031903824 | 2 L |
| 0.02 | 0.97 | 0.01 | 0.0198 | 12.23 | 0.99988094 | 1.003941492 | 2 L |
| 0.03 | 0.92 | 0.05 | 0.0895 | 57.01 | 1.000071067 | 1.015964743 | 2 L |
| 0.04 | 0.87 | 0.09 | 0.1591 | 101.79 | 1.000261195 | 1.028374063 | 2 L |
| 0.05 | 0.84 | 0.11 | 0.2038 | 124.19 | 1.000261195 | 1.034882061 | 2 L |
| 0.06 | 0.82 | 0.12 | 0.2411 | 135.4 | 1.000261195 | 1.03813606 | 2 L |
| 0.06 | 0.88 | 0.06 | 0.15 | 68.26 | 1.000261195 | 1.018225997 | 2 |
| 0.07 | 0.83 | 0.1 | 0.2453 | 113.04 | 1.000451322 | 1.031021384 | 2 |
| 0.0796 | 0.9154 | 0.005 | 0.0764 | 6.7542 | 1.00064145 | 0.995889223 | 2 |
| 0.08 | 0.88 | 0.04 | 0.1652 | 45.92 | 1.00064145 | 1.008408847 | 2 |
| 0.09 | 0.83 | 0.08 | 0.2957 | 90.7 | 1.000831578 | 1.021204234 | 2 |
| 0.1 | 0.78 | 0.12 | 0.4254 | 135.48 | 1.001021705 | 1.034165078 | 2 |
| 0.1 | 0.88 | 0.02 | 0.2028 | 23.58 | 1.001021705 | 0.99627529 | 2 |
| 0.11 | 0.83 | 0.06 | 0.376 | 68.36 | 1.00140196 | 1.00890522 | 2 |
| 0.12 | 0.78 | 0.1 | 0.5536 | 113.14 | 1.001592088 | 1.021755759 | 2 |
| 0.12935 | 0.86565 | 0.005 | 0.3641 | 6.8537 | 1.001972343 | 0.980501667 | 2 |
| 0.13 | 0.83 | 0.04 | 0.4903 | 46.02 | 1.001972343 | 0.994400104 | 2 |
| 0.14 | 0.79 | 0.07 | 0.6942 | 79.61 | 1.002352598 | 1.002948747 | 2 |

Results show that the HFO-1234ze(E), butane and HFC-134 compositions of the present invention provide improved CAP and energy efficiency relative to HFO-1234ze(E), at lower costs, for heating using residential heat pump systems. Additionally, in many cases, the HFO-1234ze(E), butane and HFC-134 compositions of the present invention provide improved heating capacity relative to HFO-1234ze(E), at lower costs. Up to 6 wt % butane can be added to blends of these three components, where the ASHRAE flammability classification will remain 2L. Up to 15 wt % butane can be added to blends of these three components, where the ASHRAE flammability classification will remain 2.

### Example 3: HFO-1234ze(E)/Isobutane/HFC-134 (Cooling Mode)

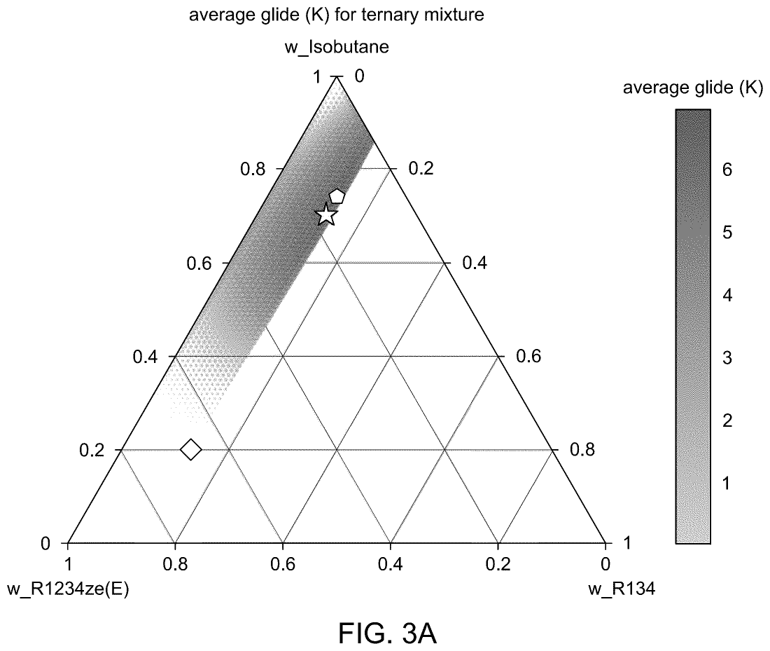

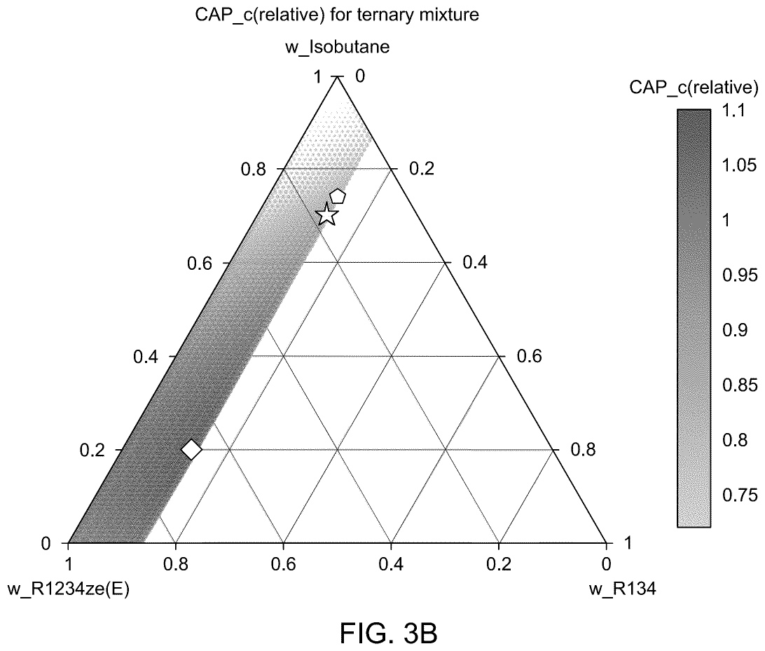

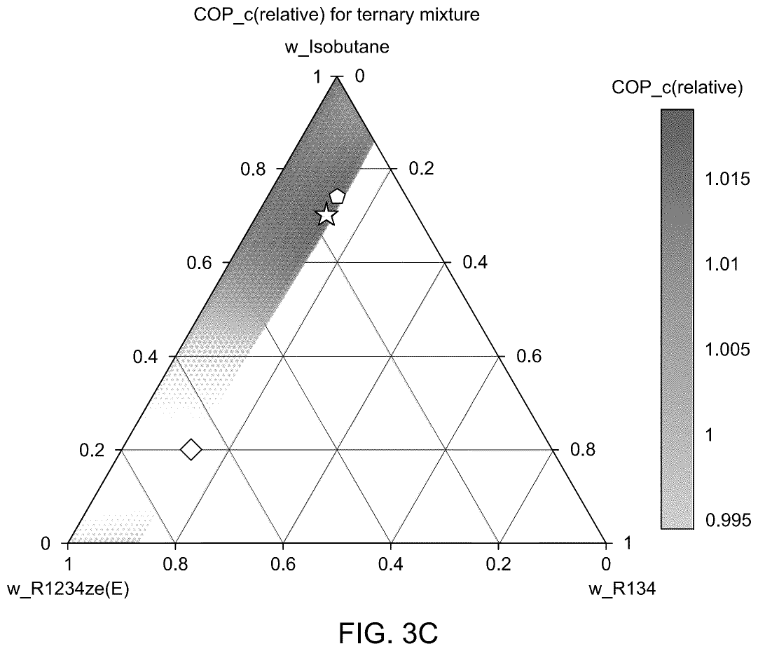

Refrigerant performance has been determined for an exemplary composition of the present invention comprising HFO-1234ze(E), isobutane and HFC-134 in residential heat pump systems as compared to HFO-1234ze(E), in cooling mode. Performance metric and composition property ranges are summarized in Table 8, where the ASHRAE flammability class remains 2L or 2, the average temperature glide is <1 K and GWP<150. Table 9 tabulates several compositions about the compositions of optimal cooling efficiency and capacity. FIGS. 3A, 3B and 3C provide graphical representations of the average glide, the CAP for cooling relative to the incumbent fluid, and the COP for cooling relative to the incumbent fluid, respectively, for a composition according to Example 3.

TABLE 8
Residential Heat Pump Cooling Mode Condition,
cycle metric performance and fluid property
ranges for 1234zeE/isobutane/134 in Ex. 3

| | MAXIMA | MINIMA |
|---|---|---|
| w_R1234ze(E) (nominal weight fraction) | 1 | 0.72 |
| w_isobutane (nominal weight fraction) | 0.15 | 0 |
| w_R134 (nominal weight fraction) | 0.13 | 0 |
| T° c. (deg C.) | 109 | 107 |
| average glide (K) | 0.5 | 0 |
| GWP AR5 | 147 | 7 |
| COP_c (% dev from R1234zeE) | 1.001 | 1 |
| CAP_c (% dev from R1234zeE) | 1.1 | 1.01 |

TABLE 9
Residential Heat Pump Cooling Mode Condition, cycle metric performance
and fluid property ranges for 1234zeE/isobutane/134 in Ex. 3

| | | | Avg. | | COP_c (% | CAP_c (% | ASHRAE |
|---|---|---|---|---|---|---|---|
| wt-% | wt-% | wt-% | Glide | GWP | dev from | dev from | Flammability |
| Isobutane | R1234ze(E) | R134 | (K) | AR5 | R1234zeE) | R1234zeE) | Class |
| 0 | 1 | 0 | 0 | 1 | 1 | 1 | 2 L |
| 0.005 | 0.86565 | 0.12935 | 0.1569 | 145.7527 | 1.000850713 | 1.035475032 | 2 L |
| 0.01 | 0.92 | 0.07 | 0.1548 | 79.35 | 1.000169244 | 1.024108156 | 2 L |
| 0.02 | 0.87 | 0.11 | 0.2756 | 124.13 | 0.999942088 | 1.040874298 | 2 L |
| 0.02 | 0.97 | 0.01 | 0.1241 | 12.23 | 0.999033462 | 1.013120176 | 2 L |
| 0.03 | 0.92 | 0.05 | 0.2428 | 57.01 | 0.998806306 | 1.02969687 | 2 L |
| 0.04 | 0.87 | 0.09 | 0.3578 | 101.79 | 0.99857915 | 1.04665246 | 2 L |
| 0.05 | 0.83 | 0.12 | 0.4487 | 135.38 | 0.998124837 | 1.060813692 | 2 L |
| 0.06 | 0.81 | 0.13 | 0.4961 | 146.59 | 0.997670524 | 1.068817868 | 2 L |
| 0.06 | 0.87 | 0.07 | 0.3705 | 79.45 | 0.997443368 | 1.049494179 | 2 |
| 0.07 | 0.82 | 0.11 | 0.4745 | 124.23 | 0.997216212 | 1.066781302 | 2 |
| 0.07 | 0.92 | 0.01 | 0.2138 | 12.33 | 0.996761899 | 1.032538589 | 2 |
| 0.08 | 0.87 | 0.05 | 0.3315 | 57.11 | 0.996534743 | 1.049730988 | 2 |
| 0.09 | 0.82 | 0.09 | 0.4372 | 101.89 | 0.99608043 | 1.067112836 | 2 |
| 0.1 | 0.77 | 0.13 | 0.5284 | 146.67 | 0.995853274 | 1.084589408 | 2 |
| 0.1 | 0.87 | 0.03 | 0.2551 | 34.77 | 0.995626118 | 1.047647061 | 2 |
| 0.11 | 0.82 | 0.07 | 0.3691 | 79.55 | 0.995398961 | 1.065123633 | 2 |
| 0.12 | 0.77 | 0.11 | 0.4673 | 124.33 | 0.995171805 | 1.082647567 | 2 |
| 0.12 | 0.87 | 0.01 | 0.1521 | 12.43 | 0.995171805 | 1.043479207 | 2 |
| 0.13 | 0.82 | 0.05 | 0.2814 | 57.21 | 0.994944649 | 1.061050502 | 2 |
| 0.14 | 0.78 | 0.08 | 0.3652 | 90.8 | 0.994717492 | 1.074596029 | 2 |

Results show that the HFO-1234ze(E), isobutane and HFC-134 compositions of the present invention provide improved CAP and similar energy efficiency relative to HFO-1234ze(E), at lower costs, for cooling using residential heat pump systems. Additionally, in many cases, the HFO-1234ze(E), isobutane and HFC-134 compositions of the present invention provide improved cooling capacity relative to HFO-1234ze(E), at lower costs. Up to 6 wt % isobutane can be added to blends of these three components, where the ASHRAE flammability classification will remain 2L. Up to 15 wt % isobutane can be added to blends of these three components, where the ASHRAE flammability classification will remain 2.

### Example 4: HFO-1234ze(E)/Isobutane/HFC-134 (Heating Mode)

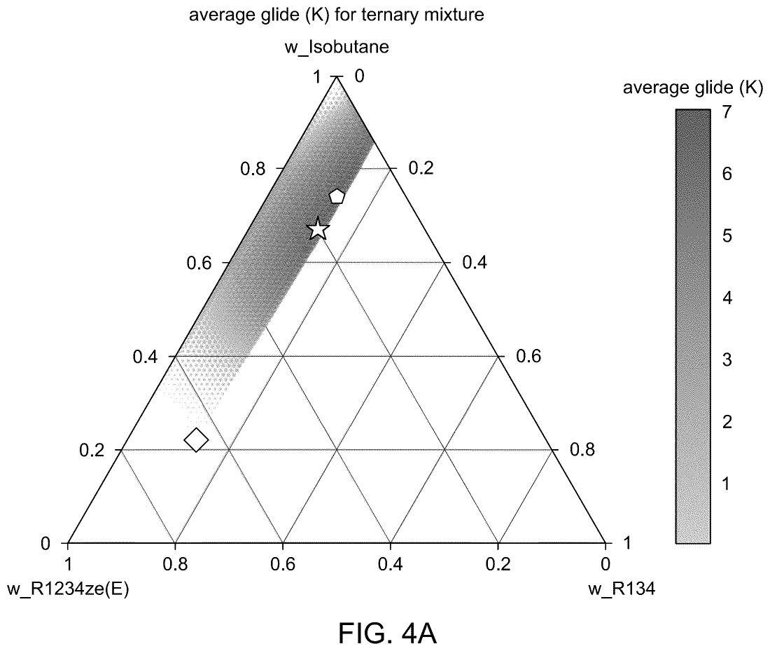

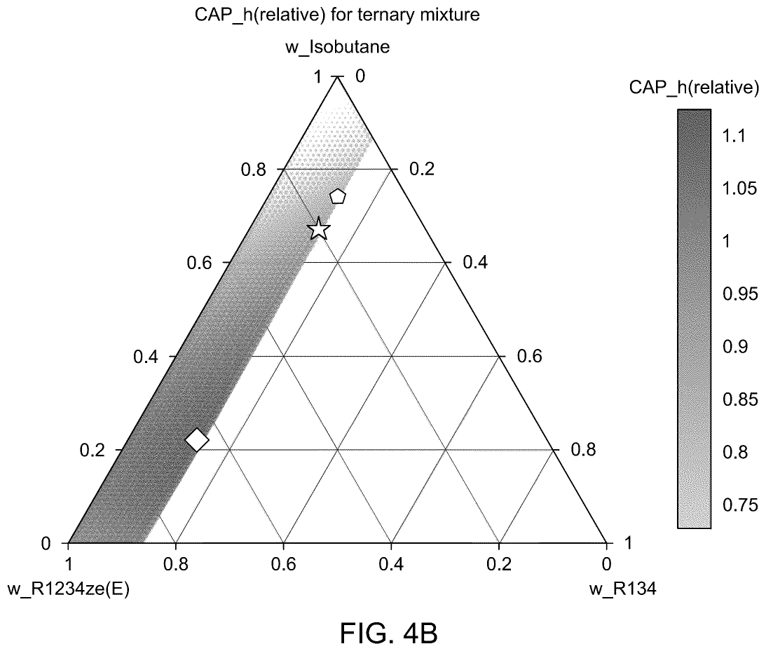

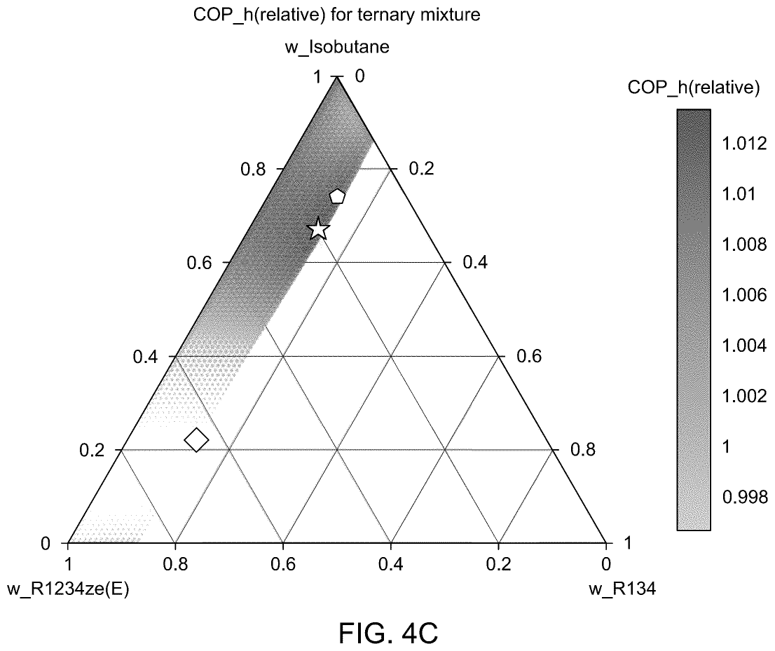

Refrigerant performance has been determined for an exemplary composition of the present invention comprising HFO-1234ze(E), isobutane and HFC-134 in residential heat pump systems as compared to HFO-1234ze(E), in heating mode. Performance metric and composition property ranges are summarized in Table 10, where the ASHRAE flammability class remains 2L or 2, the average temperature glide is <1 K and GWP<150. Table 11 tabulates several compositions about the compositions of optimal heating efficiency and capacity. FIGS. 4A, 4B and 4C provide graphical representations of the average glide, the CAP for heating relative to the incumbent fluid, and the COP for heating relative to the incumbent fluid, respectively, for a composition according to Example 4.

TABLE 10
Residential Heat Pump Heating Mode Condition,
cycle metric performance and fluid property
ranges for 1234zeE/isobutane/134 in Ex. 4

| | MAXIMA | MINIMA |
|---|---|---|
| w_R1234ze(E) (nominal weight fraction) | 1 | 0.72 |
| w_isobutane (nominal weight fraction) | 0.15 | 0 |
| w_R134 (nominal weight fraction) | 0.13 | 0 |
| T° c. (deg C.) | 109 | 107 |
| average glide (K) | 0.6 | 0 |
| GWP AR5 | 147 | 7 |
| COP_h (% dev from R1234zeE) | ~1 | 1 |
| CAP_h (% dev from R1234zeE) | 1.12 | 1 |

TABLE 11
Residential Heat Pump Heating Mode Condition, cycle metric performance
and fluid property ranges for 1234zeE/isobutane/134 in Ex. 4

| | | | Avg. | | COP_h (% | CAP_h (% | ASHRAE |
|---|---|---|---|---|---|---|---|
| wt-% | wt-% | wt-% | Glide | GWP | dev from | dev from | Flammability |
| Butane | R1234ze(E) | R134 | (K) | AR5 | R1234zeE) | R1234zeE | Class |
| 0 | 1 | 1 | 0 | 1 | 1 | 1 | 2 L |
| 0.005 | 0.86565 | 0.12935 | 0.1652 | 145.7527 | 1.000451322 | 1.035929959 | 2 L |
| 0.01 | 0.92 | 0.07 | 0.172 | 79.35 | 1.000071067 | 1.025561284 | 2 L |
| 0.02 | 0.87 | 0.11 | 0.3104 | 124.13 | 0.99988094 | 1.043871923 | 2 L |
| 0.02 | 0.97 | 0.01 | 0.1527 | 12.23 | 0.999500685 | 1.016019896 | 2 L |
| 0.03 | 0.92 | 0.05 | 0.2865 | 57.01 | 0.999310557 | 1.034165078 | 2 L |
| 0.04 | 0.87 | 0.09 | 0.4164 | 101.79 | 0.999120429 | 1.052641175 | 2 L |
| 0.05 | 0.83 | 0.12 | 0.5206 | 135.38 | 0.998930302 | 1.068414799 | 2 L |
| 0.06 | 0.81 | 0.13 | 0.577 | 146.59 | 0.998550047 | 1.077901034 | 2 L |
| 0.06 | 0.87 | 0.07 | 0.4418 | 79.45 | 0.998550047 | 1.058156428 | 2 |
| 0.07 | 0.82 | 0.11 | 0.5574 | 124.23 | 0.998169791 | 1.077128899 | 2 |
| 0.07 | 0.92 | 0.01 | 0.2789 | 12.33 | 0.998169791 | 1.041886432 | 2 |
| 0.08 | 0.87 | 0.05 | 0.4064 | 57.11 | 0.997979664 | 1.060693445 | 2 |
| 0.09 | 0.82 | 0.09 | 0.5209 | 101.89 | 0.997789536 | 1.07977622 | 2 |
| 0.1 | 0.77 | 0.13 | 0.6197 | 146.67 | 0.997409281 | 1.098914148 | 2 |
| 0.1 | 0.87 | 0.03 | 0.3263 | 34.77 | 0.997409281 | 1.06058314 | 2 |
| 0.11 | 0.82 | 0.07 | 0.4466 | 79.55 | 0.997219154 | 1.079721067 | 2 |
| 0.12 | 0.77 | 0.11 | 0.5494 | 124.33 | 0.997029026 | 1.0989693 | 2 |
| 0.12 | 0.87 | 0.01 | 0.2137 | 12.43 | 0.997219154 | 1.057990971 | 2 |
| 0.13 | 0.82 | 0.05 | 0.3471 | 57.21 | 0.997029026 | 1.077239204 | 2 |
| 0.14 | 0.78 | 0.08 | 0.4311 | 90.8 | 0.996838898 | 1.092350997 | 2 |

Results show that the HFO-1234ze(E), isobutane and HFC-134 compositions of the present invention provide improved CAP and similar energy efficiency relative to HFO-1234ze(E), at lower costs, for heating using residential heat pump systems. Additionally, in many cases, the HFO-1234ze(E), isobutane and HFC-134 compositions of the present invention provide improved heating capacity relative to HFO-1234ze(E), at lower costs. Up to 6 wt % isobutane can be added to blends of these three components, where the ASHRAE flammability classification will remain 2L. Up to 15 wt % isobutane can be added to blends of these three components, where the ASHRAE flammability classification will remain 2.

### Example 5: HFO-1234ze(E)/Propane/HFC-134 (Cooling Mode)

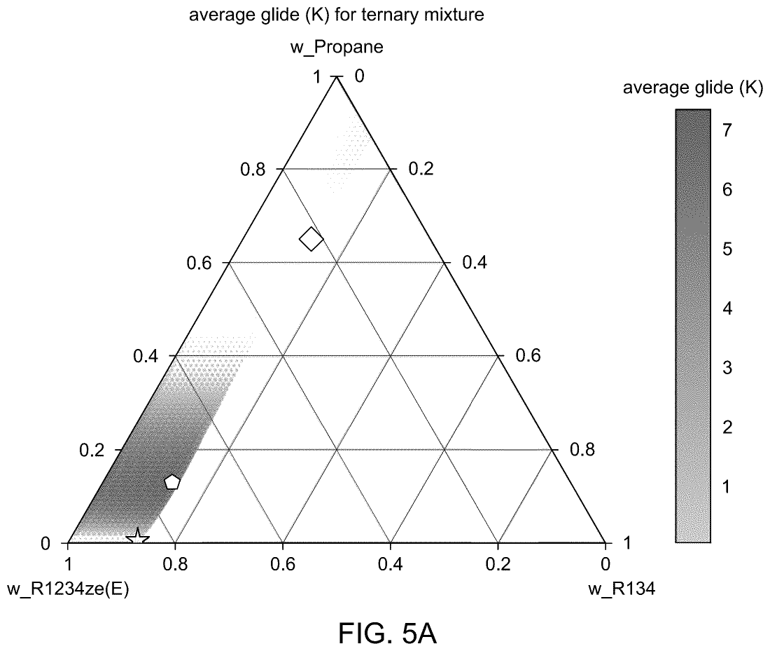

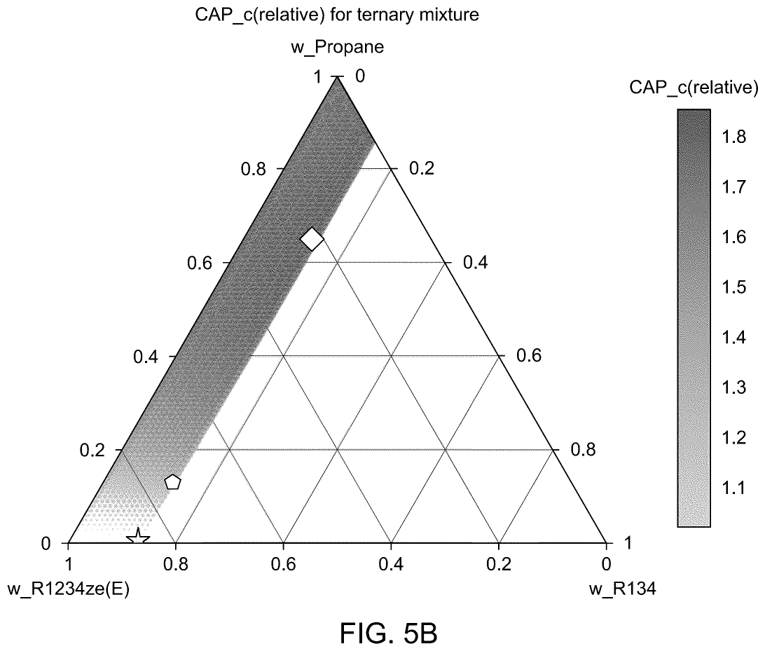

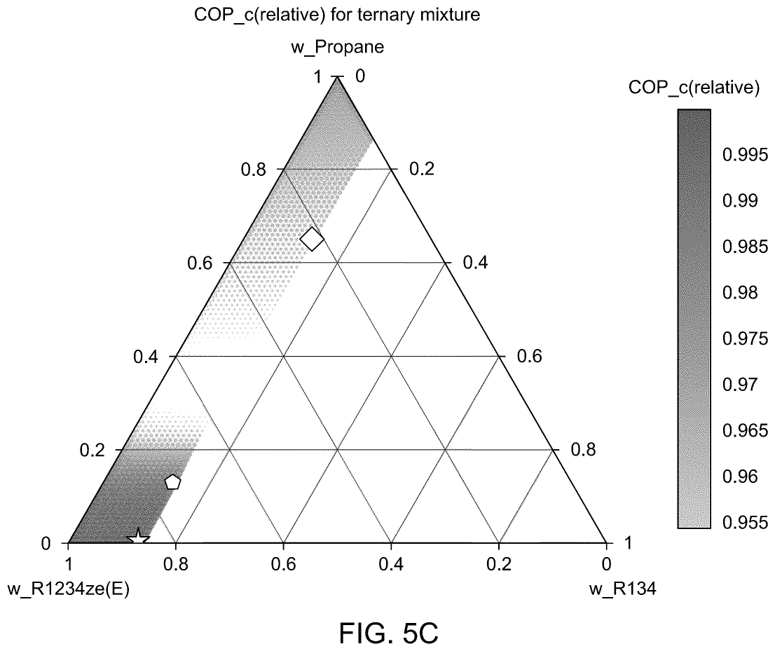

Refrigerant performance has been determined for an exemplary composition of the present invention comprising HFO-1234ze(E), propane and HFC-134 in residential heat pump systems as compared to HFO-1234ze(E), in cooling mode. Performance metric and composition property ranges are summarized in Table 12, where the ASHRAE flammability class remains 2L or 2, the average temperature glide is <8 K and GWP<150. Table 13 tabulates several compositions about the compositions of optimal cooling efficiency and capacity. FIGS. 5A, 5B and 5C provide graphical representations of the average glide, the CAP for cooling relative to the incumbent fluid, and the COP for coaling relative to the incumbent fluid, respectively, fora composition according to Example 5.

TABLE 12
Residential Heat Pump Cooling Mode Condition,
cycle metric performance and fluid property
ranges for 1234zeE/propane/134 in Ex. 5

| | MAXIMA | MINIMA |
|---|---|---|
| w_R1234ze(E) (nominal weight fraction) | 1 | 0.72 |
| w_propane (nominal weight fraction) | 0.15 | 0 |
| w_R134 (nominal weight fraction) | 0.13 | 0 |
| T° c. (deg C.) | 109 | 97 |
| average glide (K) | 7.4 | 0 |
| GWP AR5 | 147 | 7 |
| COP_c (% dev from R1234zeE) | 1 | 0.98 |
| CAP_c (% dev from R1234zeE) | 1.49 | 1 |

TABLE 13
Residential Heat Pump Cooling Mode Condition, cycle metric performance
and fluid property ranges for 1234zeE/propane/134 in Ex. 5

| | | | Avg. | | COP_c (% | CAP_c (% | ASHRAE |
|---|---|---|---|---|---|---|---|
| wt-% | wt-% | wt-% | Glide | GWP | dev from | dev from | Flammability |
| propane | R1234ze(E) | R134 | (K) | AR5 | R1234zeE) | R1234zeE) | Class |
| 0 | 1 | 0 | 0 | 1 | 1 | 1 | 2 L |
| 0.005 | 0.86565 | 0.12935 | 0.7956 | 145.7577 | 0.999942088 | 1.052667431 | 2 L |
| 0.01 | 0.92 | 0.07 | 1.3838 | 79.36 | 0.998351993 | 1.058350869 | 2 L |
| 0.02 | 0.87 | 0.11 | 2.5897 | 124.15 | 0.997216212 | 1.108696657 | 2 L |
| 0.02 | 0.97 | 0.01 | 2.3922 | 12.25 | 0.996761899 | 1.080374191 | 2 L |
| 0.03 | 0.92 | 0.05 | 3.4494 | 57.04 | 0.996307587 | 1.129583292 | 2 L |
| 0.04 | 0.87 | 0.09 | 4.3801 | 101.83 | 0.99608043 | 1.178176686 | 2 L |
| 0.05 | 0.83 | 0.12 | 5.1679 | 135.43 | 0.995853274 | 1.222839036 | 2 L |
| 0.06 | 0.82 | 0.12 | 5.7557 | 135.46 | 0.995626118 | 1.256466044 | 2 L |
| 0.06 | 0.87 | 0.07 | 5.586 | 79.51 | 0.995398961 | 1.239131558 | 2 |
| 0.07 | 0.82 | 0.11 | 6.1972 | 124.3 | 0.995171805 | 1.284788509 | 2 |
| 0.07 | 0.92 | 0.01 | 5.7842 | 12.4 | 0.994717492 | 1.246851561 | 2 |
| 0.08 | 0.87 | 0.05 | 6.3273 | 57.19 | 0.994490336 | 1.291561273 | 2 |
| 0.09 | 0.82 | 0.09 | 6.7766 | 101.98 | 0.994036023 | 1.335039573 | 2 |
| 0.1 | 0.87 | 0.03 | 6.7084 | 34.87 | 0.992673086 | 1.335892089 | 2 |
| 0.11 | 0.82 | 0.07 | 7.0279 | 79.66 | 0.99176446 | 1.377381186 | 2 |
| 0.12 | 0.77 | 0.11 | 7.27 | 124.45 | 0.990628679 | 1.417496786 | 2 |
| 0.12 | 0.87 | 0.01 | 6.8165 | 12.55 | 0.990174366 | 1.373023884 | 2 |
| 0.13 | 0.82 | 0.05 | 7.0299 | 57.34 | 0.988584272 | 1.412713225 | 2 |
| 0.14 | 0.77 | 0.09 | 7.1737 | 102.13 | 0.986994178 | 1.450981707 | 2 |
| 0.15 | 0.73 | 0.12 | 7.2162 | 135.73 | 0.985176927 | 1.48351939 | 2 |

Results show that the HFO-1234ze(E), propane and HFC-134 compositions of the present invention provide improved CAP and similar energy efficiency relative to HFO-1234ze(E), at lower costs, for cooling using residential heat pump systems. Additionally, in many cases, the HFO-1234ze(E), propane and HFC-134 compositions of the present invention provide significantly improved cooling capacity relative to HFO-1234ze(E), at lower costs. Up to 6 wt % propane can be added to blends of these three components, where the ASHRAE flammability classification will remain 2L. Up to 15 wt % propane can be added to blends of these three components, where the ASHRAE flammability classification will remain 2.

### Example 6: HFO-1234ze(E)/Propane/HFC-134 (Heating Mode)

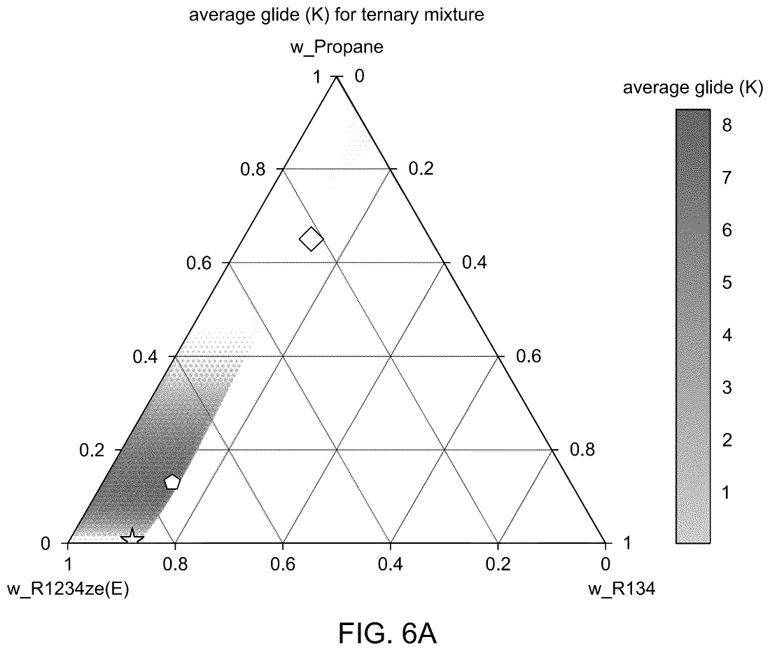

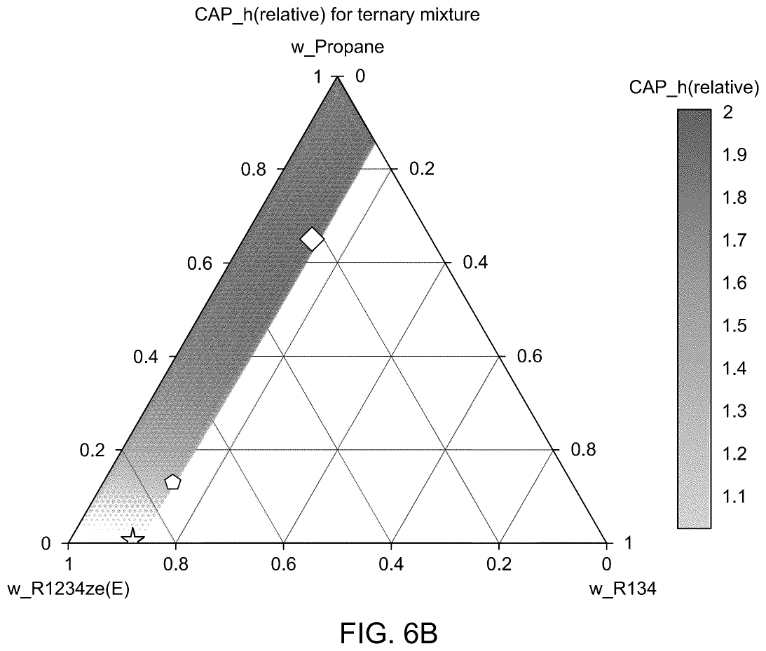

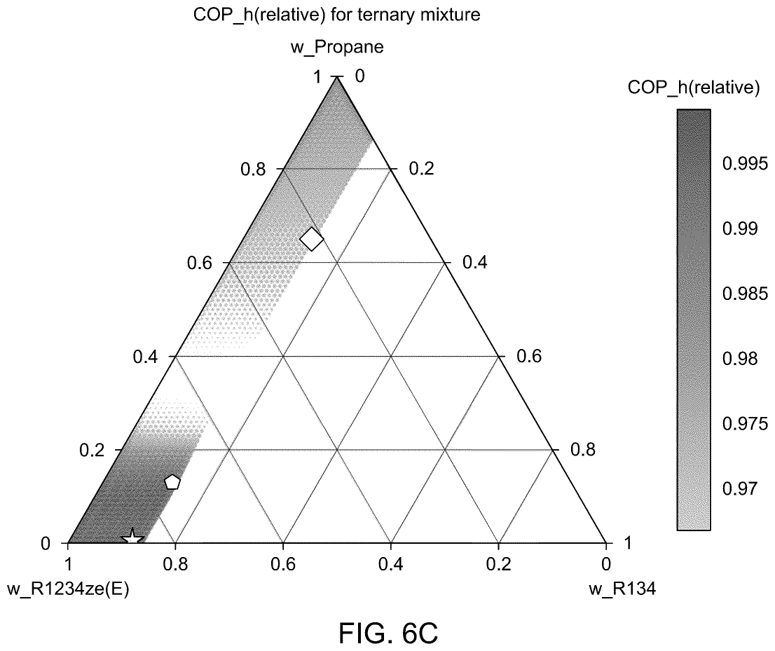

Refrigerant performance has been determined for an exemplary composition of the present invention comprising HFO-1234ze(E), propane and HFC-134 in residential heat pump systems as compared to HFO-1234ze(E), in heating mode. Performance metric and composition property ranges are summarized in Table 14, where the ASHRAE flammability class remains 2L or 2, the average temperature glide is <9 K and GWP<150. Table 15 tabulates several compositions about the compositions of optimal heating efficiency and capacity. FIGS. 6A, 6B and 6C provide graphical representations of the average glide, the CAP for heating relative to the incumbent fluid, and the COP for heating relative to the incumbent fluid, respectively, for a composition according to Example 6.

TABLE 14
Residential Heat Pump Heating Mode Condition,
cycle metric performance and fluid property
ranges for 1234zeE/propane/134 in Ex. 6

| | MAXIMA | MINIMA |
|---|---|---|
| w_R1234ze(E) (nominal weight fraction) | 1 | 0.72 |
| w_propane (nominal weight fraction) | 0.15 | 0 |
| w_R134 (nominal weight fraction) | 0.13 | 0 |
| T° c. (deg C.) | 109 | 97 |
| average glide (K) | 8.3 | 0 |
| GWP AR5 | | |
| COP_h (% dev from R1234zeE) | 1 | ~1 |
| CAP_h (% dev from R1234zeE) | 1.55 | 1.02 |

TABLE 15
Residential Heat Pump Heating Mode Condition, cycle metric performance
and fluid property ranges for 1234zeE/propane/134 in Ex. 6

| | | | Avg. | | COP_h (% | CAP_h (% | ASHRAE |
|---|---|---|---|---|---|---|---|
| wt-% | wt-% | wt-% | Glide | GWP | dev from | dev from | Flammability |
| Propane | R1234ze(E) | R134 | (K) | AR5 | R1234zeE) | R1234zeE) | Class |
| 0 | 1 | 0 | 0 | 1 | 1 | 1 | 2 L |
| 0.005 | 0.86565 | 0.12935 | 0.8705 | 145.7577 | 0.999120429 | 1.054736972 | 2 L |
| 0.01 | 0.92 | 0.07 | 1.5287 | 79.36 | 0.997789536 | 1.063009851 | 2 L |
| 0.02 | 0.87 | 0.11 | 2.8649 | 124.15 | 0.996458643 | 1.118217533 | 2 L |
| 0.02 | 0.97 | 0.01 | 2.6557 | 12.25 | 0.996648771 | 1.089538218 | 2 L |
| 0.03 | 0.92 | 0.05 | 3.8264 | 57.04 | 0.996078388 | 1.143642849 | 2 L |
| 0.04 | 0.87 | 0.09 | 4.8597 | 101.83 | 0.996078388 | 1.197251107 | 2 L |
| 0.05 | 0.83 | 0.12 | 5.7383 | 135.43 | 0.996458643 | 1.246888384 | 2 L |
| 0.06 | 0.82 | 0.12 | 6.3999 | 135.46 | 0.996838898 | 1.285274544 | 2 L |
| 0.06 | 0.87 | 0.07 | 6.216 | 79.51 | 0.996838898 | 1.26729482 | 2 |
| 0.07 | 0.82 | 0.11 | 6.9026 | 124.3 | 0.997219154 | 1.318035147 | 2 |
| 0.07 | 0.92 | 0.01 | 6.4556 | 12.4 | 0.997029026 | 1.278215021 | 2 |
| 0.08 | 0.87 | 0.05 | 7.0668 | 57.19 | 0.997409281 | 1.32812806 | 2 |
| 0.09 | 0.82 | 0.09 | 7.5775 | 101.98 | 0.997789536 | 1.376772591 | 2 |
| 0.1 | 0.87 | 0.03 | 7.5247 | 34.87 | 0.997219154 | 1.380136895 | 2 |
| 0.11 | 0.82 | 0.07 | 7.8939 | 79.66 | 0.997029026 | 1.426740782 | 2 |
| 0.12 | 0.77 | 0.11 | 8.1805 | 124.45 | 0.996838898 | 1.471965856 | 2 |
| 0.12 | 0.87 | 0.01 | 7.6829 | 12.55 | 0.996078388 | 1.424203766 | 2 |
| 0.13 | 0.82 | 0.05 | 7.9358 | 57.34 | 0.995508005 | 1.46898762 | 2 |
| 0.14 | 0.77 | 0.09 | 8.1143 | 102.13 | 0.994747495 | 1.512282355 | 2 |
| 0.15 | 0.73 | 0.12 | 8.1827 | 135.73 | 0.99360673 | 1.549344855 | 2 |

Results show that the H FOA 234ze(E), propane and HFC-134 compositions of the present invention provide improved CAP and similar energy efficiency relative to HFO-1234ze(E), at lower costs, for heating using residential heat pump systems. Additionally, in many cases, the HFO-1234ze(E), propane and HFC-134 compositions of the present invention provide significantly improved heating capacity relative to HFO-1234ze(E), at lower costs. Up to 6 wt % propane can be added to blends of these three components, where the ASHRAE flammability classification will remain 2L. Up to 15 wt % propane can be added to blends of these three components, where the ASHRAE flammability classification will remain 2.

### Example 7: HFO-1234ze(E)/Isobutane

In Example 7, refrigerant performance has been determined for an exemplary composition of the present invention comprising HFO-1234ze(E) and isobutane in residential heat pump systems as compared to HFO-1234ze(E), in cooling or heating modes. It will be understood by those skilled in the art that the weight percents in the refrigerant performance data are nominal weight fractions. Table 16 tabulates several compositions about the compositions of optimal cooling/heating efficiency and capacity, where the average temperature glide is <1 K and GWP is ˜1, and flammability classes are 2L or 2.

TABLE 16
Residential Heat Pump Cooling Mode Condition, cycle metric performance
and fluid property ranges for 1234zeE/Isobutane in Ex. 7

| | | Avg. | Avg. | | | |
|---|---|---|---|---|---|---|
| | | Cooling | Heating | | | |
| wt-% | wt-% | Glide | Glide | GWP | del_h_comb | LFL |
| isobutane | R1234ze(E) | (K) | (K) | AR5 | (kcal/g) | (kg/m\hat{ }3) |
| 0.01 | 0.99 | 0.0587 | 0.0738 | 1.02 | 2.3052 | 0.26073625 |
| 0.02 | 0.98 | 0.1046 | 0.1325 | 1.04 | 2.3904 | 0.248169496 |
| 0.03 | 0.97 | 0.1387 | 0.1774 | 1.06 | 2.4756 | 0.236758406 |
| 0.04 | 0.96 | 0.1624 | 0.2099 | 1.08 | 2.5608 | 0.226350572 |
| 0.05 | 0.95 | 0.1767 | 0.2312 | 1.1 | 2.646 | 0.216819259 |
| 0.06 | 0.94 | 0.1829 | 0.2426 | 1.12 | 2.7312 | 0.208058211 |
| 0.07 | 0.93 | 0.1821 | 0.2453 | 1.14 | 2.8164 | 0.199977683 |
| 0.08 | 0.92 | 0.1755 | 0.2407 | 1.16 | 2.9016 | 0.19250135 |
| 0.09 | 0.91 | 0.1641 | 0.2298 | 1.18 | 2.9868 | 0.185563889 |
| 0.1 | 0.9 | 0.1492 | 0.214 | 1.2 | 3.072 | 0.179109066 |
| 0.11 | 0.89 | 0.1317 | 0.1944 | 1.22 | 3.1572 | 0.173088208 |
| 0.12 | 0.88 | 0.1127 | 0.172 | 1.24 | 3.2424 | 0.167458975 |
| 0.13 | 0.87 | 0.0933 | 0.1482 | 1.26 | 3.3276 | 0.162184361 |

| | | ASHRAE | COP_c (% | CAP_c (% | COP_h (% | CAP_h (% |
|---|---|---|---|---|---|---|
| wt-% | wt-% | Flammability | dev from | dev from | dev from | dev from |
| isobutane | R1234ze(E) | Class | R1234zeE) | R1234zeE) | R1234zeE) | R1234zeE) |
| 0.01 | 0.99 | 2 L | 0.999487775 | 1.005305449 | 0.999690812 | 1.006754271 |
| 0.02 | 0.98 | 2 L | 0.999033462 | 1.010183733 | 0.999500685 | 1.013041659 |
| 0.03 | 0.97 | 2 L | 0.998351993 | 1.014683121 | 0.999120429 | 1.01894298 |
| 0.04 | 0.96 | 2 L | 0.997897681 | 1.018803614 | 0.998930302 | 1.024347928 |
| 0.05 | 0.95 | 2 | 0.997443368 | 1.022592572 | 0.998550047 | 1.029366808 |
| 0.06 | 0.94 | 2 | 0.996989056 | 1.025955273 | 0.998359919 | 1.033999621 |
| 0.07 | 0.93 | 2 | 0.996761899 | 1.029033802 | 0.998169791 | 1.038191213 |
| 0.08 | 0.92 | 2 | 0.996307587 | 1.031733435 | 0.997789536 | 1.04205189 |
| 0.09 | 0.91 | 2 | 0.995853274 | 1.034101534 | 0.997599409 | 1.045526499 |
| 0.1 | 0.9 | 2 | 0.995626118 | 1.036185461 | 0.997409281 | 1.048615041 |
| 0.11 | 0.89 | 2 | 0.995398961 | 1.037985217 | 0.997409281 | 1.051372667 |
| 0.12 | 0.88 | 2 | 0.995171805 | 1.039453438 | 0.997219154 | 1.053799379 |
| 0.13 | 0.87 | 2 | 0.994944649 | 1.04068485 | 0.997029026 | 1.055895175 |

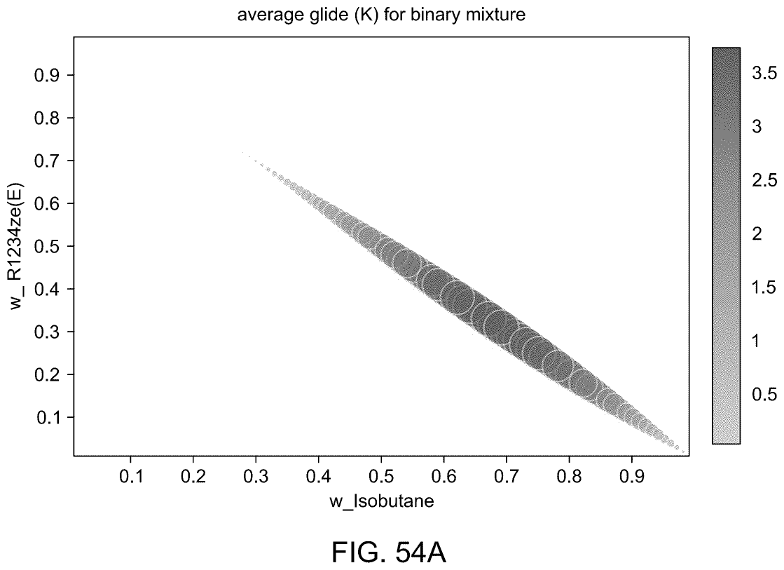

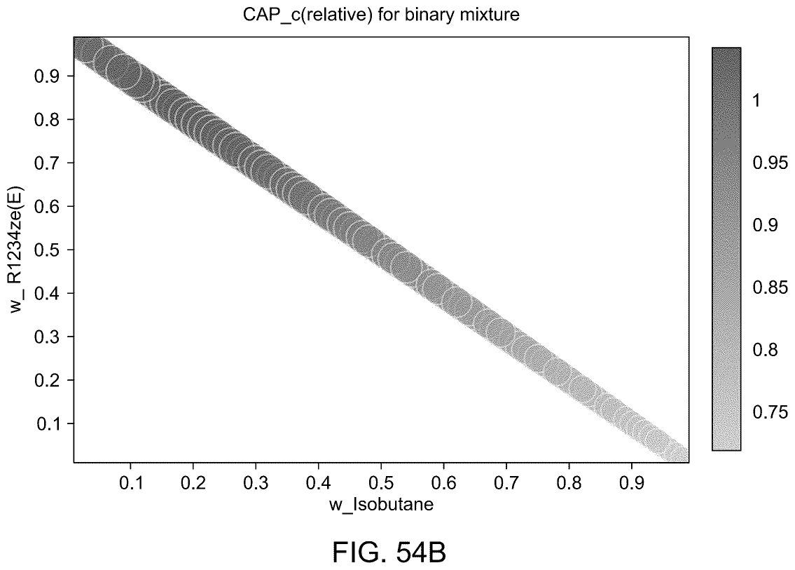

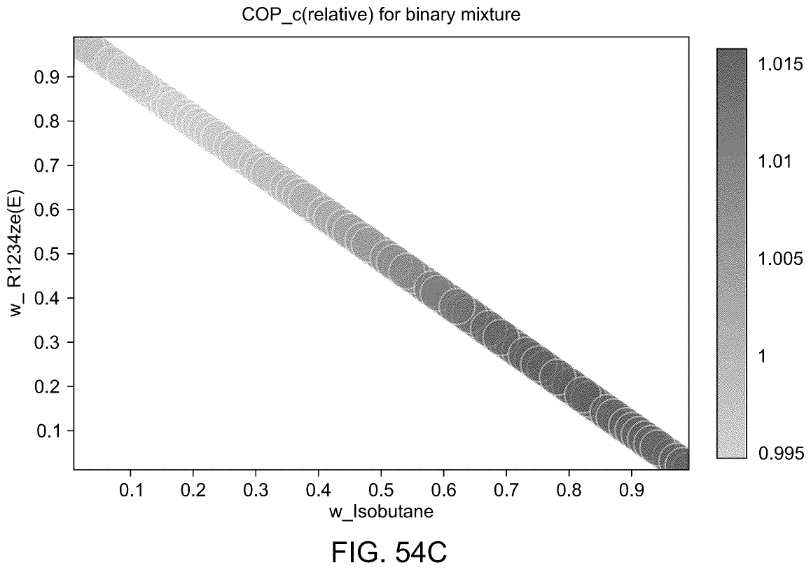

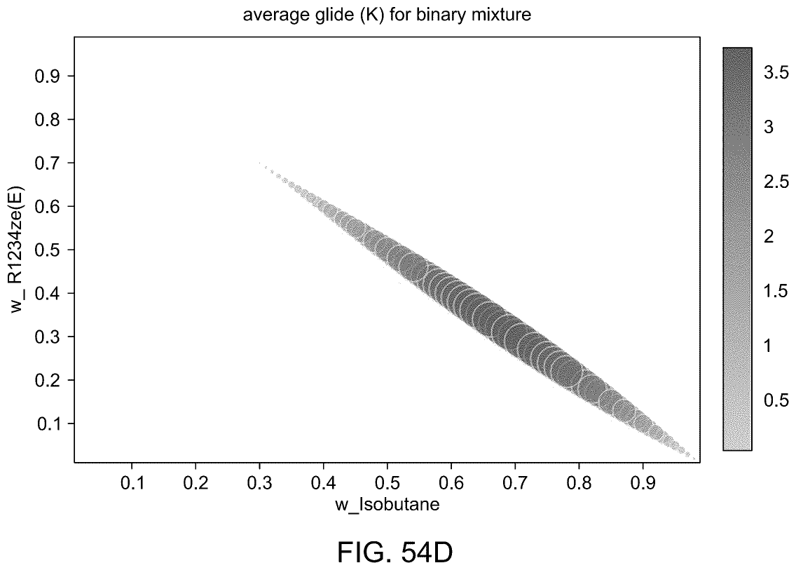

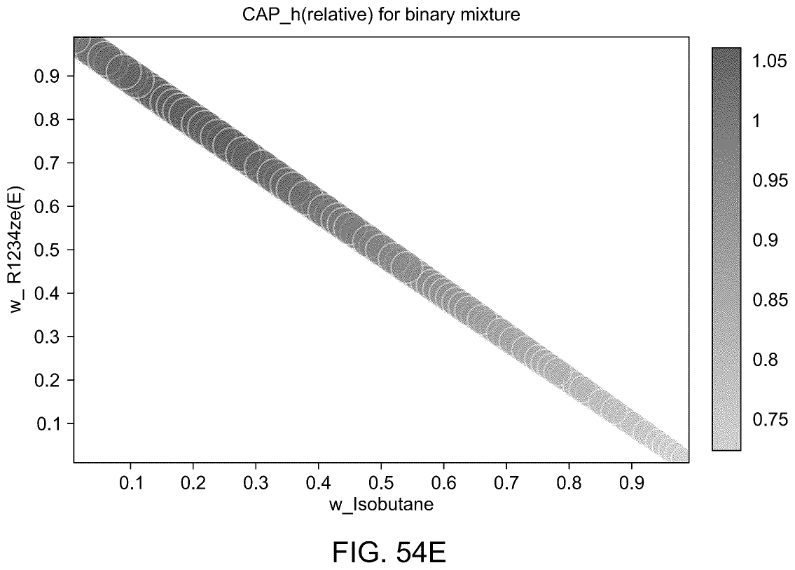

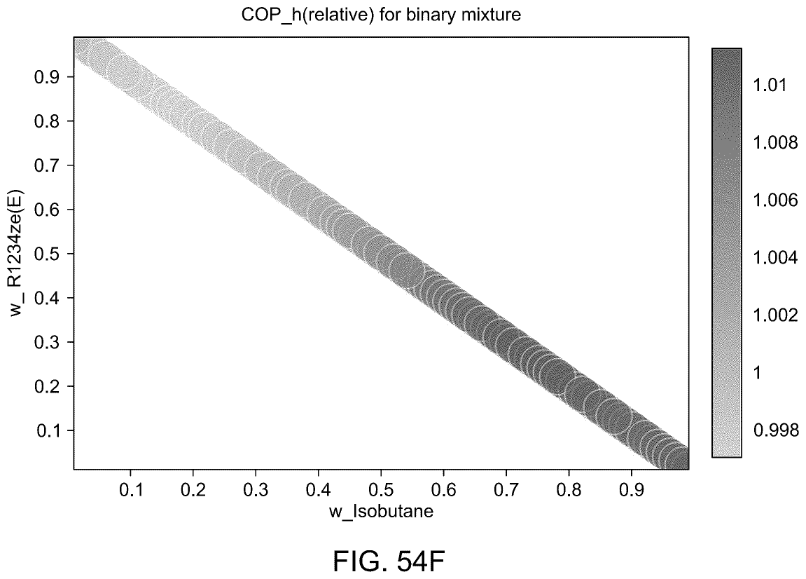

Results show that the HFO-1234ze(E) and isobutane compositions of the present invention provide improved CAP and energy efficiency relative to HFO-1234ze(E) for cooling and heating using residential heat pump systems. Additionally, in many cases, the HFO-1234ze(E) and isobutane compositions of the present invention provide improved cooling capacity and similar energy efficiency relative to HFO-1234ze(E). The compositions have a flammability of class 2L from 0 to 4 wt-% isobutane and class 2 from 0 to 13 wt-% isobutane. The maximum class 2L CAP of the composition for cooling is 2% greater than HFO-1234ze(E). The maximum class 2 CAP of the composition for cooling is 4% greater than HFO-1234zeE. The maximum class 2L CAP of the composition for heating is 2.4% greater than HFO-1234ze(E). The maximum class 2 CAP of the composition for heating is 5.6% greater than HFO-1234ze(E). FIGS. 54A, 54B and 54C provide graphical representations of the average glide, the CAP for cooling relative to the incumbent fluid, and the COP for cooling relative to the incumbent fluid, respectively, for a composition according to Example 7, and FIGS. 54D, 54E and 54F provide graphical representations of the average glide, the CAP for heating relative to the incumbent fluid, and the COP for heating relative to the incumbent fluid, respectively, for a composition according to Example 7.

### Example 8: HFO-1234ze(E)/Butane

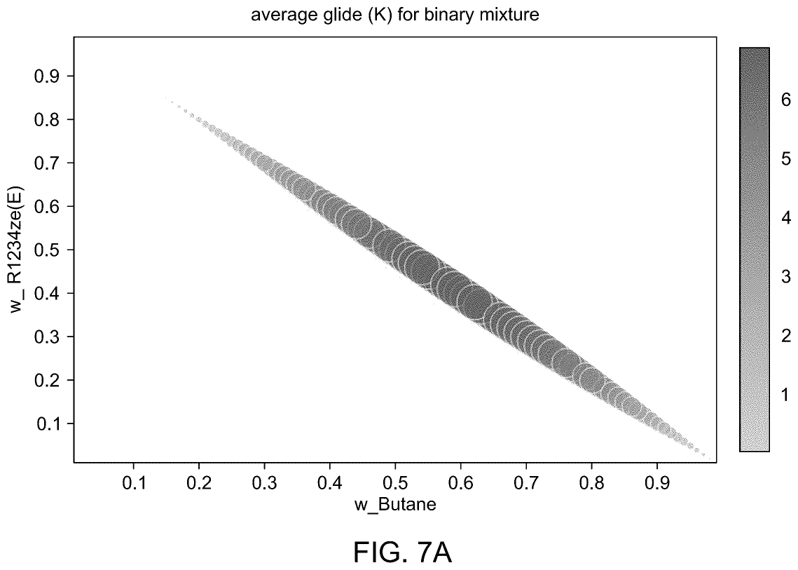

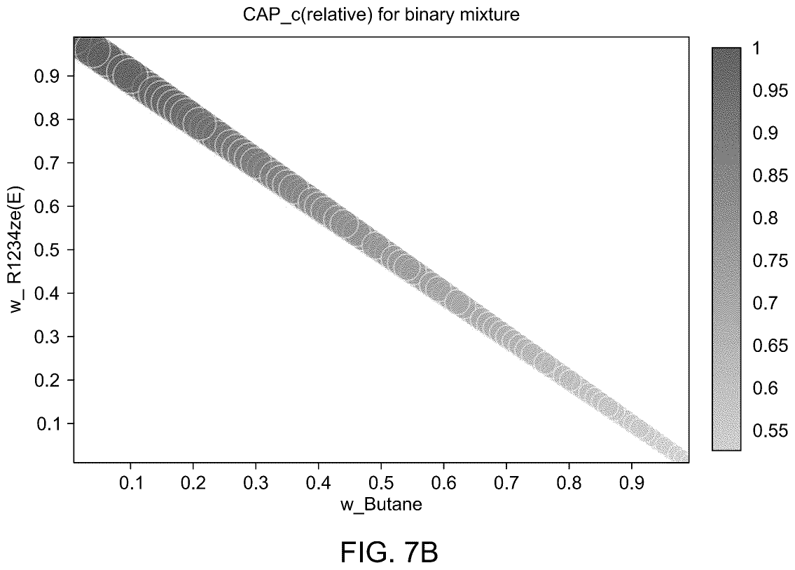

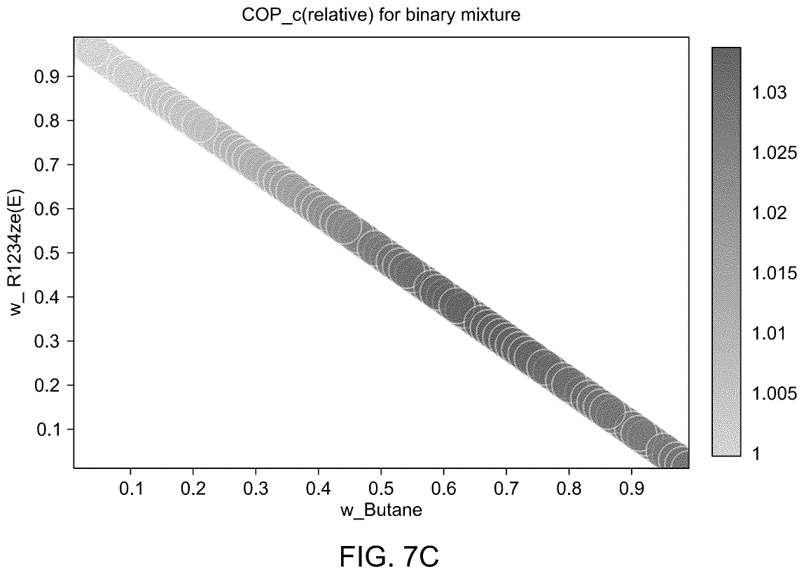

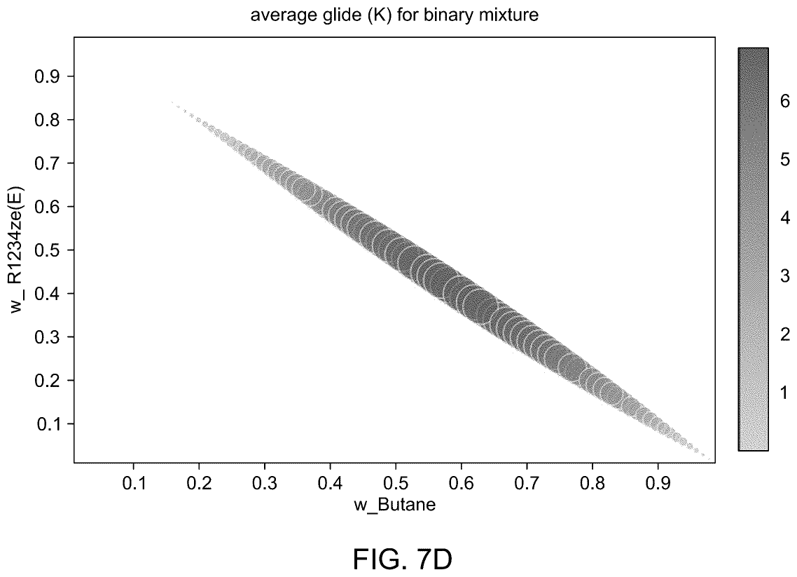

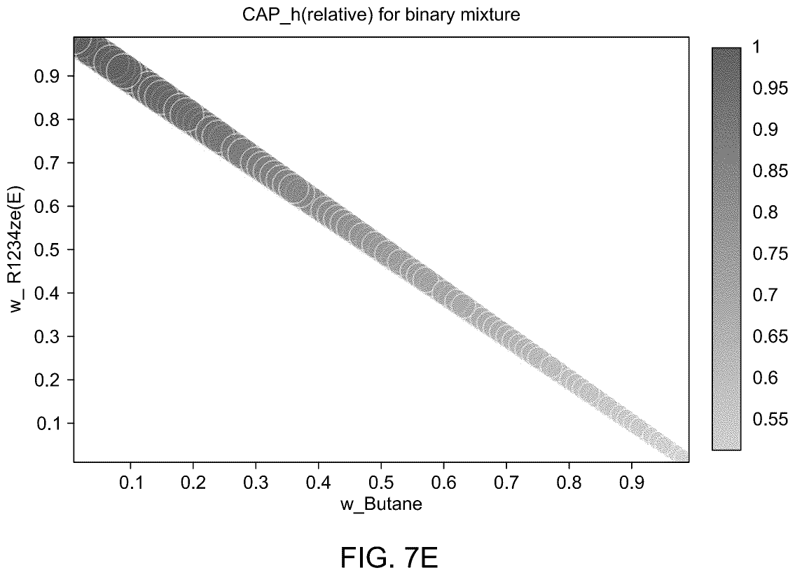

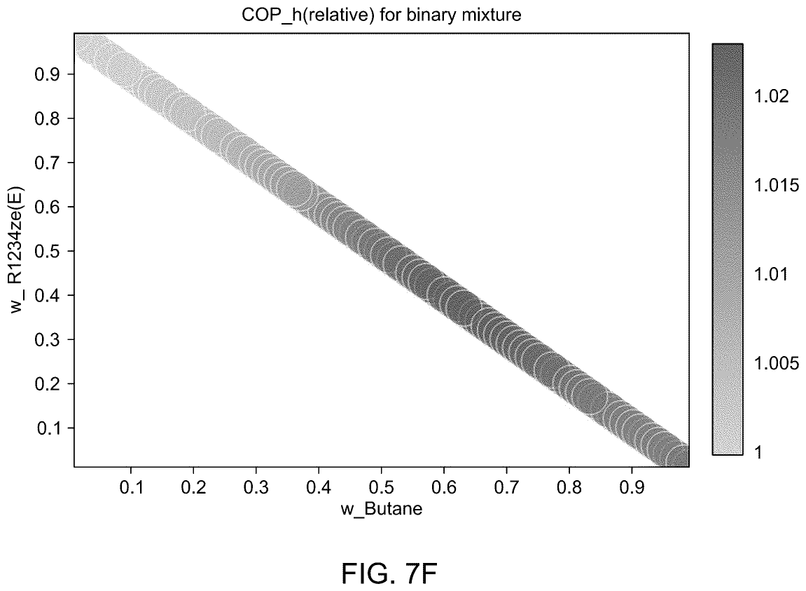

Refrigerant performance has been determined for an exemplary composition of the present invention comprising HFO-1234ze(E) and butane in residential heat pump systems as compared to HFO-1234ze(E), in coaling or heating modes. Performance metric and composition property ranges are summarized in Table 17, where the ASHRAE flammability class remains 2L or 2, the average temperature glide is <0.1 K or <0.2K and GWP is about 1. Table 18 tabulates several compositions about the compositions of optimal cooling/heating efficiency and capacity. FIGS. 7A, 7B and 7C provide graphical representations of the average glide, the CAP for coaling relative to the incumbent fluid, and the COP for coaling relative to the incumbent fluid, respectively, for a composition according to Example 8, and FIGS. 7D, 7E and 7F provide graphical representations of the average glide, the CAP for heating relative to the incumbent fluid, and the COP for heating relative to the incumbent fluid, respectively, for a composition according to Example 8.

TABLE 17
Residential Heat Pump Cooling/Heating Mode Condition, cycle
metric performance and fluid property ranges for 1234zeE/butane
in Ex. 8, Class 2L Flammability and Class 2 Flammability

| | Flammability = 2L | | Flammability = 2 | |
|---|---|---|---|---|
| | MAXIMA | MINIMA | MAXIMA | MINIMA |
| w_R1234ze(E) | 100 | 96 | 95 | 87 |
| w_butane | 4 | 0 | 13 | 5 |
| T° c. (deg C.) | 109.7 | 109.4 | 112 | 109.9 |
| avg glide_c (K) | <0.01 | <0.01 | 0.4 | 0.02 |
| avg glide_h (K) | <0.01 | <0.01 | 0.4 | 0.01 |
| COP_c (% dev) | 100 | ~100 | ~100 | ~100 |
| CAP_c (% dev) | 100 | 99.8 | 99.6 | 97.3 |
| COP_h (% dev) | 100 | ~100 | ~100 | ~100 |
| CAP_h (% dev) | ~100 | 100 | ~100 | 97.8 |

TABLE 18
Residential Heat Pump Cooling/Heating Mode Conditions, cycle metric
performance and fluid property ranges for 1234zeE/butane in Ex. 8

| | | Avg. | Avg. | | | |
|---|---|---|---|---|---|---|
| | | Cooling | Heating | | | |
| wt-% | wt-% | Glide | Glide | GWP | del_h_comb | LFL |
| butane | R1234ze(E) | (K) | (K) | AR5 | (kcal/g) | (kg/m\hat{ }3) |
| 0.01 | 0.99 | 0.0013 | 0.0026 | 1.02 | 2.3055 | 0.260708957 |
| 0.02 | 0.98 | 0.002 | 0.003 | 1.04 | 2.391 | 0.248120049 |
| 0.03 | 0.97 | 0.0038 | 0.0033 | 1.06 | 2.4765 | 0.236690906 |
| 0.04 | 0.96 | 0.0086 | 0.0054 | 1.08 | 2.562 | 0.226268318 |
| 0.05 | 0.95 | 0.0177 | 0.011 | 1.1 | 2.6475 | 0.216724924 |
| 0.06 | 0.94 | 0.0329 | 0.0217 | 1.12 | 2.733 | 0.20795398 |
| 0.07 | 0.93 | 0.0552 | 0.0391 | 1.14 | 2.8185 | 0.199865349 |
| 0.08 | 0.92 | 0.0861 | 0.0646 | 1.16 | 2.904 | 0.192382395 |
| 0.09 | 0.91 | 0.1264 | 0.0994 | 1.18 | 2.9895 | 0.185439543 |
| 0.1 | 0.9 | 0.1772 | 0.1446 | 1.2 | 3.075 | 0.178980354 |
| 0.11 | 0.89 | 0.2393 | 0.2013 | 1.22 | 3.1605 | 0.17295599 |
| 0.12 | 0.88 | 0.3133 | 0.2702 | 1.24 | 3.246 | 0.167323972 |
| 0.13 | 0.87 | 0.3996 | 0.352 | 1.26 | 3.3315 | 0.162047181 |

| | | ASHRAE | COP_c (% | CAP_c (% | COP_h (% | CAP_h (% |
|---|---|---|---|---|---|---|
| wt-% | wt-% | Flammability | dev from | dev from | dev from | dev from |
| isobutane | R1234ze(E) | Class | R1234zeE) | R1234zeE) | R1234zeE) | R1234zeE) |
| 0.01 | 0.99 | 2 L | 0.999942088 | 1.000000906 | 0.99988094 | 1.000742645 |
| 0.02 | 0.98 | 2 L | 0.999714931 | 0.999574649 | 0.99988094 | 1.001018408 |
| 0.03 | 0.97 | 2 L | 0.999714931 | 0.998722133 | 0.99988094 | 1.00085295 |
| 0.04 | 0.96 | 2 L | 0.999942088 | 0.997585445 | 1.000071067 | 1.000246273 |
| 0.05 | 0.95 | 2 | 0.999942088 | 0.996069862 | 1.000071067 | 0.999253527 |
| 0.06 | 0.94 | 2 | 1.000169244 | 0.994222745 | 1.000261195 | 0.997874714 |
| 0.07 | 0.93 | 2 | 1.000169244 | 0.992044093 | 1.000451322 | 0.996109833 |
| 0.08 | 0.92 | 2 | 1.000623557 | 0.98958127 | 1.00064145 | 0.994014037 |
| 0.09 | 0.91 | 2 | 1.000850713 | 0.986834275 | 1.000831578 | 0.991532173 |
| 0.1 | 0.9 | 2 | 1.001077869 | 0.983803108 | 1.001021705 | 0.988664241 |
| 0.11 | 0.89 | 2 | 1.001532182 | 0.980440408 | 1.00140196 | 0.985520547 |
| 0.12 | 0.88 | 2 | 1.001986494 | 0.976888259 | 1.001592088 | 0.982045938 |
| 0.13 | 0.87 | 2 | 1.002440807 | 0.973004576 | 1.001972343 | 0.978240413 |

Results show that the HFO-1234ze(E) and butane compositions of the present invention provide improved CAP and energy efficiency relative to HFO-1234ze(E), at lower costs, for coaling and heating using residential heat pump systems. Up to 4 wt % butane can be added to blends of these two components, where the ASHRAE flammability classification will remain 2L. Up to 13 wt % butane can be added to blends of these two components, where the ASHRAE flammability classification will remain 2.

### Example 9: HFO-1234ze(E)/Propane

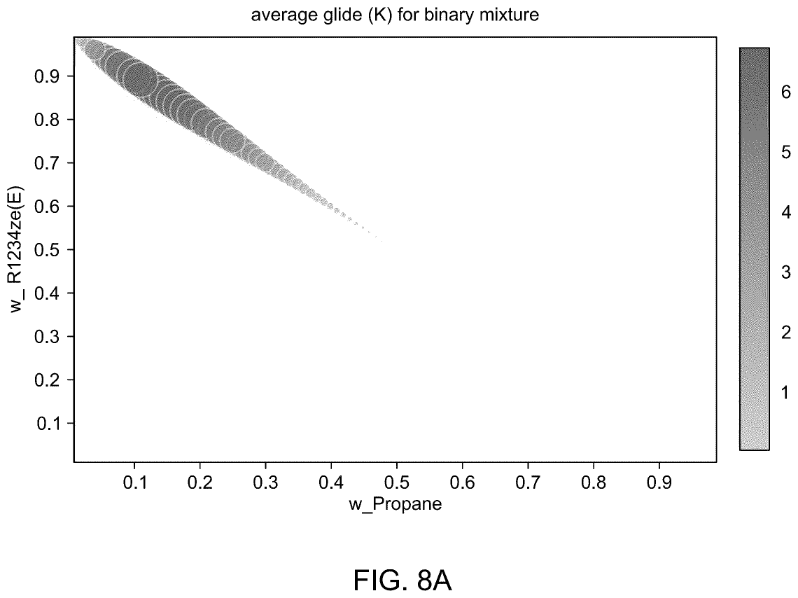

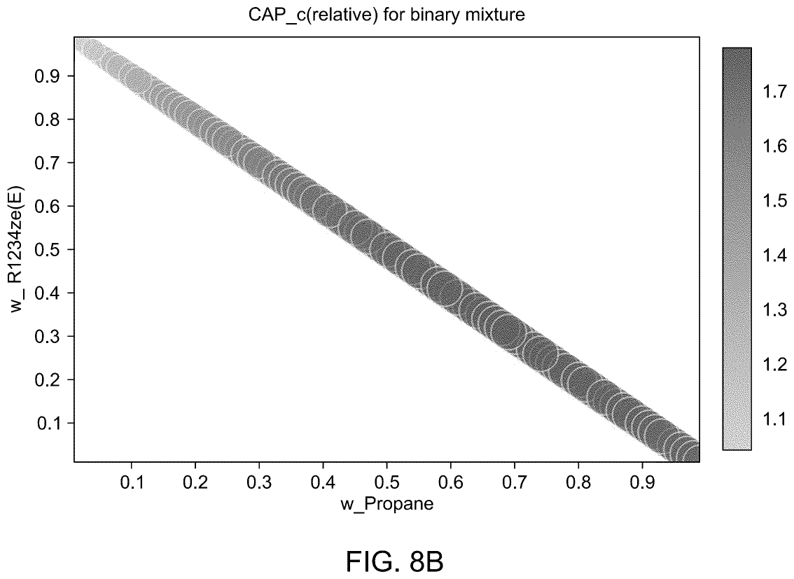

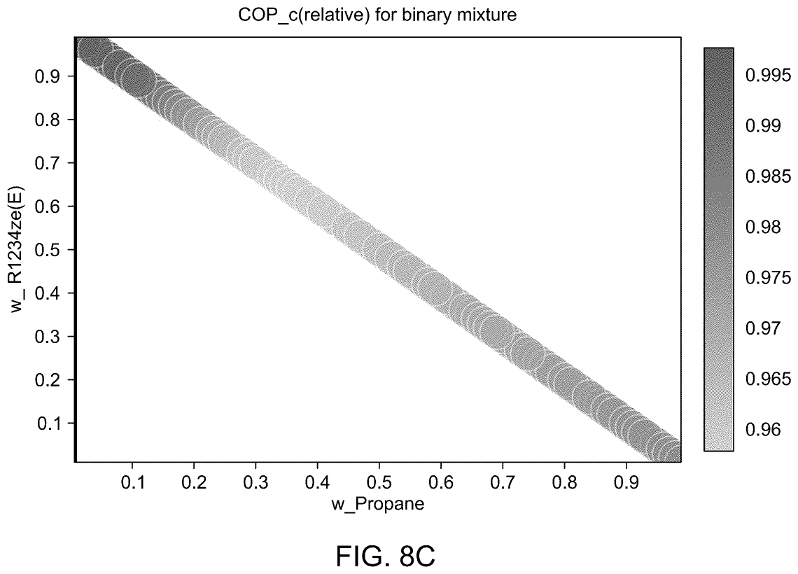

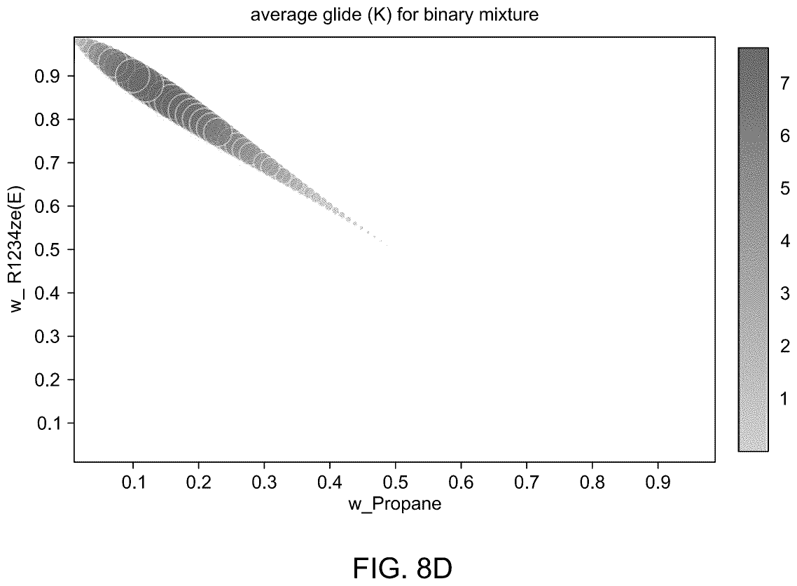

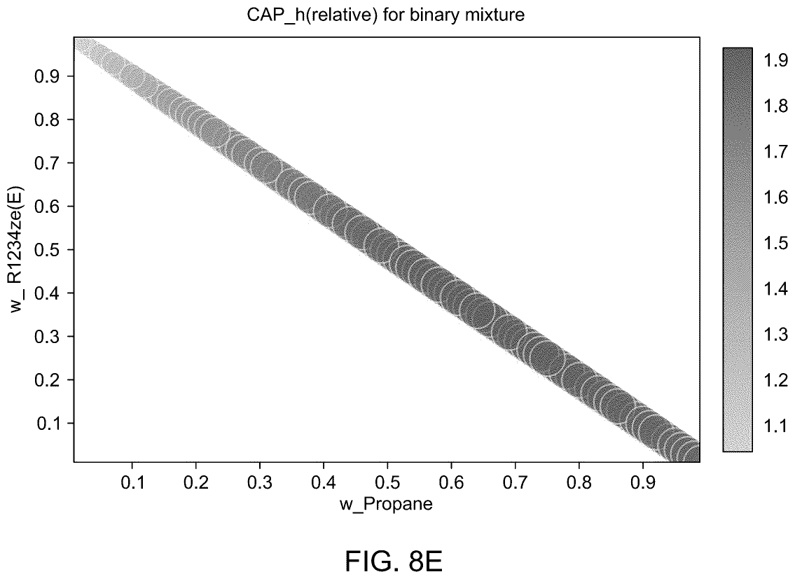

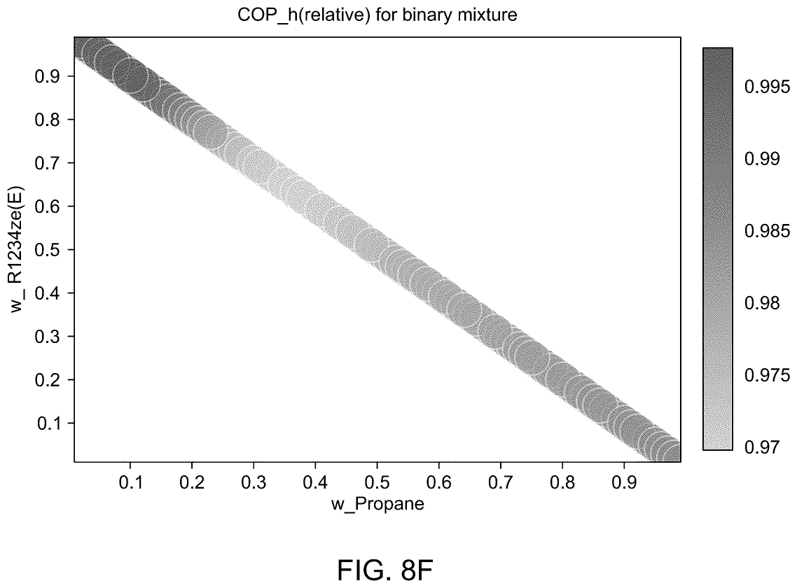

Refrigerant performance has been determined for an exemplary composition of the present invention comprising HFO-1234ze(E) and propane in residential heat pump systems as compared to HFO-1234ze(E), in coaling or heating modes. Performance metric and composition property ranges are summarized in Table 19, where the ASHRAE flammability class remains 2L or 2, the average temperature glide is <7 K or <8 K and GWP is about 1. Table 20 tabulates several compositions about the compositions of optimal cooling/heating efficiency and capacity. FIGS. 8A, 8B and 8C provide graphical representations of the average glide, the CAP for cooling relative to the incumbent fluid, and the COP for cooling relative to the incumbent fluid, respectively, for a composition according to Example 9, and FIGS. 8D, 8E and 8F provide graphical representations of the average glide, the CAP for heating relative to the incumbent fluid, and the COP for heating relative to the incumbent fluid, respectively, for a composition according to Example 9.

TABLE 19
Residential Heat Pump Cooling/Heating Mode Condition, cycle
metric performance and fluid property ranges for 1234zeE/propane
in Ex. 9, Class 2L Flammability and Class 2 Flammability

| | Flammability = 2L | | Flammability = 2 | |
|---|---|---|---|---|
| | MAXIMA | MINIMA | MAXIMA | MINIMA |
| w_R1234ze(E) | 100 | 96 | 95 | 87 |
| w_Propane | 4 | 0 | 13 | 5 |
| T° c. (deg C.) | 109.36 | 105.9 | 105.1 | 98.9 |
| avg glide_c (K) | 4.1 | 0 | 6.8 | 4.7 |
| avg glide_h (K) | 4.5 | 0 | 7.7 | 5.3 |
| COP_c (% dev) | 100 | 99.6 | 99.5 | 98.9 |
| CAP_c (% dev) | 114.8 | 100 | 139 | 118.2 |
| COP_h (% dev) | 100 | 99.6 | 99.6 | 99.5 |
| CAP_h (% dev) | 116.7 | 100 | 144.4 | 120.4 |

TABLE 20
Residential Heat Pump Cooling/Heating Mode Conditions, cycle metric
performance and fluid property ranges for 1234zeE/propane in Ex. 9

| | | Avg. | Avg. | | | |
|---|---|---|---|---|---|---|
| | | Cooling | Heating | | | |
| wt-% | wt-% | Glide | Glide | GWP | del_h_comb | LFL |
| propane | R1234ze(E) | (K) | (K) | AR5 | (kcal/g) | (kg/m\hat{ }3) |
| 0.01 | 0.99 | 1.2714 | 1.412 | 1.03 | 2.3068 | 0.256643934 |
| 0.02 | 0.98 | 2.3637 | 2.6254 | 1.06 | 2.3936 | 0.24085849 |
| 0.03 | 0.97 | 3.2957 | 3.6624 | 1.09 | 2.4804 | 0.226902366 |
| 0.04 | 0.96 | 4.0844 | 4.5425 | 1.12 | 2.5672 | 0.214474988 |
| 0.05 | 0.95 | 4.745 | 5.2827 | 1.15 | 2.654 | 0.203338212 |
| 0.06 | 0.94 | 5.2911 | 5.8983 | 1.18 | 2.7408 | 0.193300915 |
| 0.07 | 0.93 | 5.735 | 6.4026 | 1.21 | 2.8276 | 0.184207938 |
| 0.08 | 0.92 | 6.0875 | 6.8075 | 1.24 | 2.9144 | 0.175932004 |
| 0.09 | 0.91 | 6.3585 | 7.1234 | 1.27 | 3.0012 | 0.168367725 |
| 0.1 | 0.9 | 6.5567 | 7.3599 | 1.3 | 3.088 | 0.161427092 |
| 0.11 | 0.89 | 6.6901 | 7.5255 | 1.33 | 3.1748 | 0.155036032 |
| 0.12 | 0.88 | 6.7659 | 7.6278 | 1.36 | 3.2616 | 0.149131756 |
| 0.13 | 0.87 | 6.7907 | 7.6738 | 1.39 | 3.3484 | 0.143660691 |

| | | ASHRAE | COP_c (% | CAP_c (% | COP_h (% | CAP_h (% |
|---|---|---|---|---|---|---|
| wt-% | wt-% | Flammability | dev from | dev from | dev from | dev from |
| propane | R1234ze(E) | Class | R1234zeE) | R1234zeE) | R1234zeE) | R1234zeE) |
| 0.01 | 0.99 | 2 L | 0.997897681 | 1.039358714 | 0.997789536 | 1.043927076 |
| 0.02 | 0.98 | 2 L | 0.996761899 | 1.077295663 | 0.996648771 | 1.086449676 |
| 0.03 | 0.97 | 2 L | 0.99608043 | 1.113669665 | 0.996078388 | 1.1273177 |
| 0.04 | 0.96 | 2 L | 0.995626118 | 1.148433361 | 0.996268516 | 1.166586301 |
| 0.05 | 0.95 | 2 | 0.995398961 | 1.181539387 | 0.996458643 | 1.204090021 |
| 0.06 | 0.94 | 2 | 0.995171805 | 1.212940381 | 0.996838898 | 1.239884013 |
| 0.07 | 0.93 | 2 | 0.994717492 | 1.242731069 | 0.997029026 | 1.273913123 |
| 0.08 | 0.92 | 2 | 0.99426318 | 1.270911449 | 0.997219154 | 1.306232506 |
| 0.09 | 0.91 | 2 | 0.993354555 | 1.297481521 | 0.997219154 | 1.336842159 |
| 0.1 | 0.9 | 2 | 0.992445929 | 1.322488648 | 0.997219154 | 1.36585239 |
| 0.11 | 0.89 | 2 | 0.991310148 | 1.346074915 | 0.996648771 | 1.393208044 |
| 0.12 | 0.88 | 2 | 0.990174366 | 1.368287685 | 0.996078388 | 1.419129733 |
| 0.13 | 0.87 | 2 | 0.988584272 | 1.38917432 | 0.995317878 | 1.443562304 |

Results show that the HFO-1234ze(E) and propane compositions of the present invention provide improved CAP and energy efficiency relative to HFO-1234ze(E), at lower costs, for coaling and heating using residential heat pump systems. Up to 4 wt % propane can be added to blends of these two components, where the ASHRAE flammability classification will remain 2L. Up to 13 wt % propane can be added to blends of these two components, where the ASHRAE flammability classification will remain 2.

### Example 10: HFO-1234ze(E)/Propylene

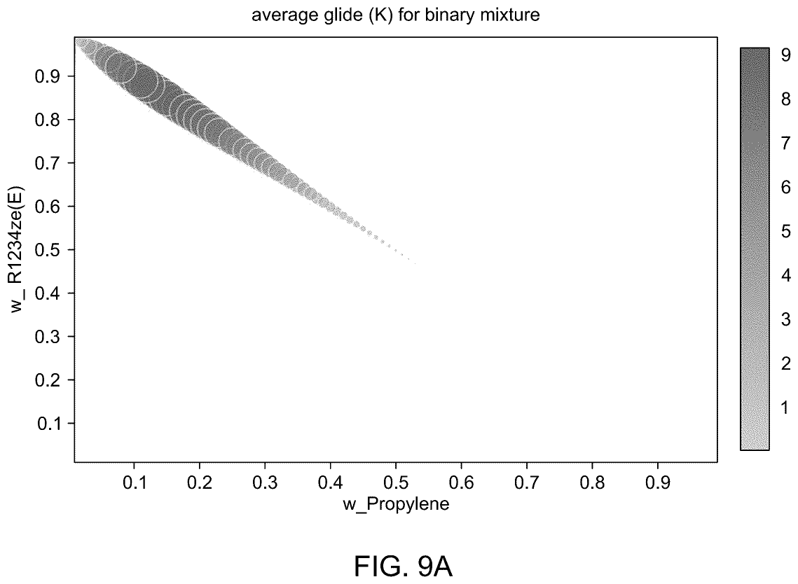

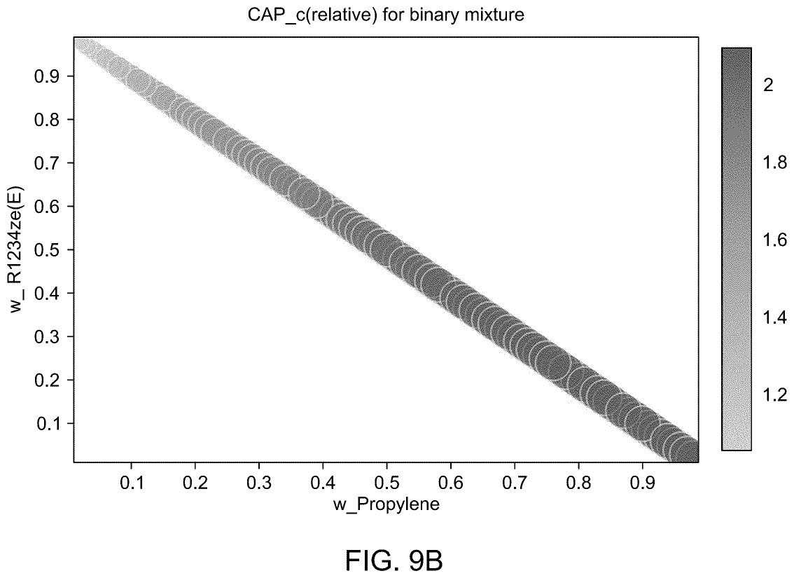

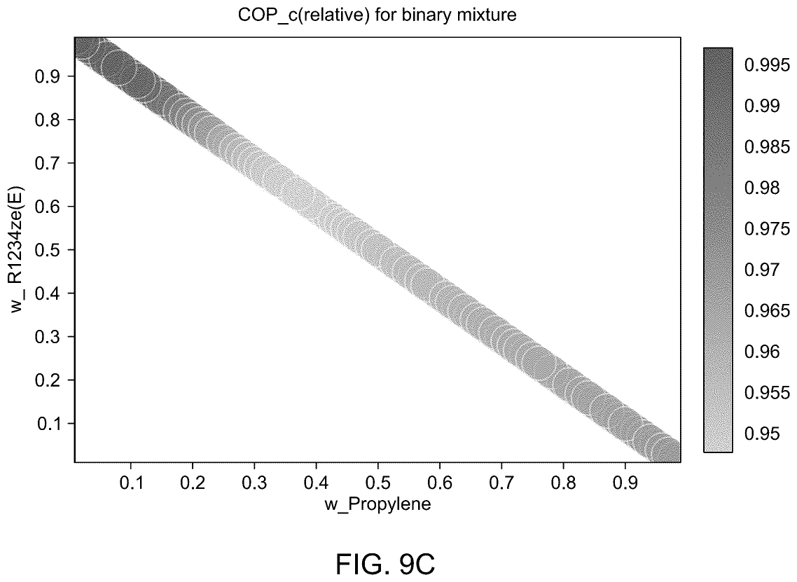

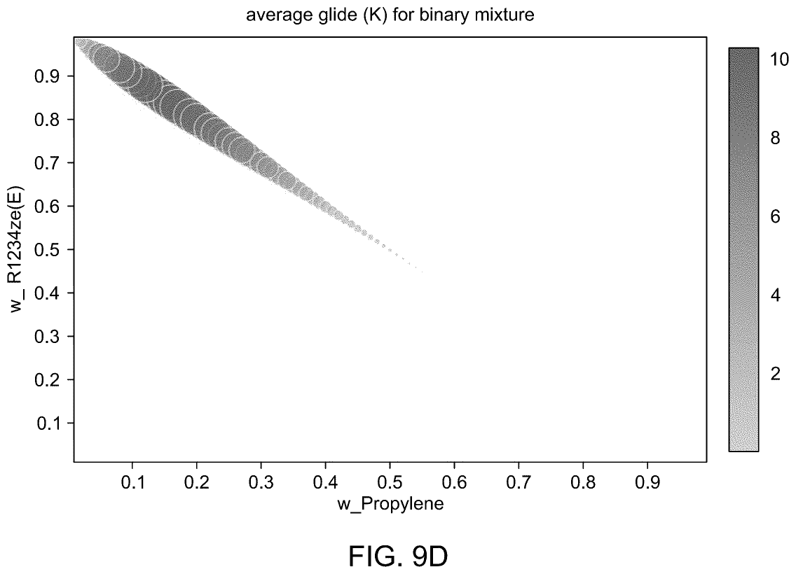

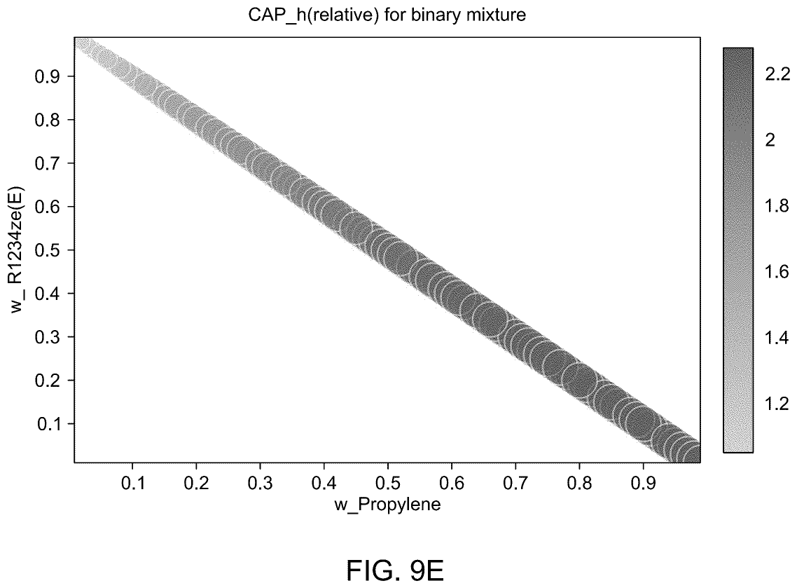

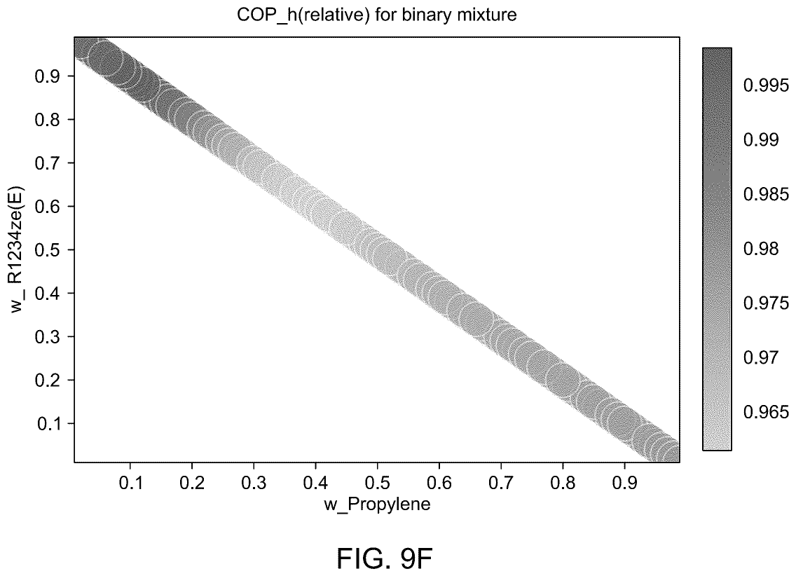

Refrigerant performance has been determined for an exemplary composition of the present invention comprising HFO-1234ze(E) and propylene in residential heat pump systems as compared to HFO-1234ze(E), in coaling or heating modes. Performance metric and composition property ranges are summarized in Table 21, where the ASHRAE flammability class remains 2L or 2, the average temperature glide is <10 K or <11 K and GWP is about 1. Table 22 tabulates several compositions about the compositions of optimal cooling/heating efficiency and capacity. FIGS. 9A, 9B and 9C provide graphical representations of the average glide, the CAP for coaling relative to the incumbent fluid, and the COP for cooling relative to the incumbent fluid, respectively, for a composition according to Example 10, and FIGS. 9D, 9E and 9F provide graphical representations of the average glide, the CAP for heating relative to the incumbent fluid, and the COP for heating relative to the incumbent fluid, respectively, for a composition according to Example 10.

TABLE 21
Residential Heat Pump Cooling/Heating Mode Condition, cycle metric
performance and fluid property ranges for 1234zeE/propylene
in Ex. 10, Class 2L Flammability and Class 2 Flammability

| | Flammability = 2L | | Flammability = 2 | |
|---|---|---|---|---|
| | MAXIMA | MINIMA | MAXIMA | MINIMA |
| w_R1234ze(E) | 100 | 96 | 95 | 87 |
| w_Propylene | 4 | 0 | 13 | 5 |
| T° c. (deg C.) | 109.36 | 105.8 | 104.9 | 98 |
| avg glide_c (K) | 5.4 | 0 | 9.2 | 6.3 |
| avg glide_h (K) | 6 | 0 | 10.3 | 6.9 |
| COP_c (% dev) | 100 | 99.5 | 99.5 | 99.1 |
| CAP_c (% dev) | 118.3 | 100 | 148.8 | 122.5 |
| COP_h (% dev) | 100 | 99.4 | 99.9 | 99.5 |
| CAP_h (% dev) | 120.4 | 100 | 155.3 | 125.1 |

TABLE 22
Residential Heat Pump Cooling/Heating Mode Conditions, cycle metric
performance and fluid property ranges for 1234zeE/propylene in Ex. 10

| | | Avg. | Avg. | | | |
|---|---|---|---|---|---|---|
| | | Cooling | Heating | | | |
| wt-% | wt-% | Glide | Glide | GWP | del_h_comb | LFL |
| propylene | R1234ze(E) | (K) | (K) | AR5 | (kcal/g) | (kg/m\hat{ }3) |
| 0.01 | 0.99 | 1.6773 | 1.856 | 1.005 | 2.3071 | 0.255416581 |
| 0.02 | 0.98 | 3.1194 | 3.449 | 1.01 | 2.3942 | 0.238705491 |
| 0.03 | 0.97 | 4.3516 | 4.8102 | 1.015 | 2.4813 | 0.224046823 |
| 0.04 | 0.96 | 5.3972 | 5.9668 | 1.02 | 2.5684 | 0.211084343 |
| 0.05 | 0.95 | 6.2772 | 6.943 | 1.025 | 2.6555 | 0.199539748 |
| 0.06 | 0.94 | 7.0099 | 7.7594 | 1.03 | 2.7426 | 0.18919246 |
| 0.07 | 0.93 | 7.6118 | 8.4343 | 1.035 | 2.8297 | 0.179865401 |
| 0.08 | 0.92 | 8.0972 | 8.9832 | 1.04 | 2.9168 | 0.17141477 |
| 0.09 | 0.91 | 8.479 | 9.42 | 1.045 | 3.0039 | 0.163722578 |
| 0.1 | 0.9 | 8.7684 | 9.7566 | 1.05 | 3.091 | 0.156691107 |
| 0.11 | 0.89 | 8.9757 | 10.0041 | 1.055 | 3.1781 | 0.150238732 |
| 0.12 | 0.88 | 9.11 | 10.1719 | 1.06 | 3.2652 | 0.144296745 |
| 0.13 | 0.87 | 9.1794 | 10.2689 | 1.065 | 3.3523 | 0.13880689 |

| | | ASHRAE | COP_c (% | CAP_c (% | COP_h (% | CAP_h (% |
|---|---|---|---|---|---|---|
| wt-% | wt-% | Flammability | dev from | dev from | dev from | dev from |
| propylene | R1234ze(E) | Class | R1234zeE) | R1234zeE) | R1234zeE) | R1234zeE) |
| 0.01 | 0.99 | 2 L | 0.996989056 | 1.048120681 | 0.996268516 | 1.053413311 |
| 0.02 | 0.98 | 2 L | 0.995398961 | 1.09491432 | 0.994557367 | 1.105477299 |
| 0.03 | 0.97 | 2 L | 0.994717492 | 1.14005029 | 0.994177112 | 1.15588671 |
| 0.04 | 0.96 | 2 L | 0.994717492 | 1.183433866 | 0.99436724 | 1.204531241 |
| 0.05 | 0.95 | 2 | 0.994944649 | 1.224922963 | 0.99512775 | 1.251245434 |
| 0.06 | 0.94 | 2 | 0.995171805 | 1.264517581 | 0.996078388 | 1.295918983 |
| 0.07 | 0.93 | 2 | 0.995171805 | 1.302122995 | 0.996838898 | 1.33860704 |
| 0.08 | 0.92 | 2 | 0.995171805 | 1.337786568 | 0.997599409 | 1.379254454 |
| 0.09 | 0.91 | 2 | 0.994944649 | 1.371555662 | 0.998169791 | 1.417806072 |
| 0.1 | 0.9 | 2 | 0.99426318 | 1.403430277 | 0.998550047 | 1.454372199 |
| 0.11 | 0.89 | 2 | 0.993354555 | 1.433505136 | 0.998359919 | 1.489007988 |
| 0.12 | 0.88 | 2 | 0.992218773 | 1.461827601 | 0.998169791 | 1.521713438 |
| 0.13 | 0.87 | 2 | 0.990628679 | 1.488492398 | 0.997409281 | 1.552598854 |

Results show that the HFO-1234ze(E) and propylene compositions of the present invention provide improved CAP and energy efficiency relative to HFO-1234ze(E), at lower costs, for cooling and heating using residential heat pump systems. Up to 4 wt % propylene can be added to blends of these two components, where the ASHRAE flammability classification will remain 2L. Up to 13 wt % propylene can be added to blends of these two components, where the ASHRAE flammability classification will remain 2.

In summary, the COP for the compositions of Examples 1-10 remains about the same as that for the incumbent refrigerant, namely neat HFO-1234ze(E). For Examples 7-10, the cooling and heating capacities are the greatest at the max hydrocarbon concentration (i.e., 13 wt-% hydrocarbon). In particular, at 13 wt % isobutane (Example 8), the cooling and heating capacities are 4% and 6% greater, respectively, than HFO-1234ze(E). At 13 wt % propane (Example 9), the cooling and heating capacities are 39% and 44% greater, respectively, than HFO-1234ze(E). At 13 wt % propylene (Example 10), the cooling and heating capacities are 49% and 55% greater, respectively, than HFO-1234ze(E).

### Performance Examples for High Temperature

### Heat Pump Systems Comprising HFO Compositions

In the below Tables, “T_condenser” is condenser temperature, “T_evaporator” is evaporator temperature, “COP” is coefficient of performance (analogous to energy efficiency), and “CAP” is volumetric heating capacity. In Examples 11-21, refrigerant performance has been determined for an exemplary composition of the present invention in high temperature heat pumps as compared to HFO-1234ze(Z), HFO-1336mzz(E) or HCFO-1233zd(E). It will be understood by those skilled in the art that the weight percents in the refrigerant performance data are nominal weight fractions. The data for Examples 11-16 and 19-21 are based on the conditions set forth in Table 23, and the data for Examples 17-18 are based on the conditions set forth in Table 24.

TABLE 23
High Temp Heat Pump Operating Conditions
for Examples 11-16, 19-21

| T_condenser | 130° C. |
|---|---|
| T_evaporator | 50° C. |
| Compressor Efficiency | 0.85 |

TABLE 24
High Temp Heat Pump Operating Conditions for Examples 17-18

| T_condenser | 110° C. |
|---|---|
| T_evaporator | 50° C. |
| Compressor Efficiency | 0.85 |

### Example 11: HFO-1234ze(Z)/Pentane

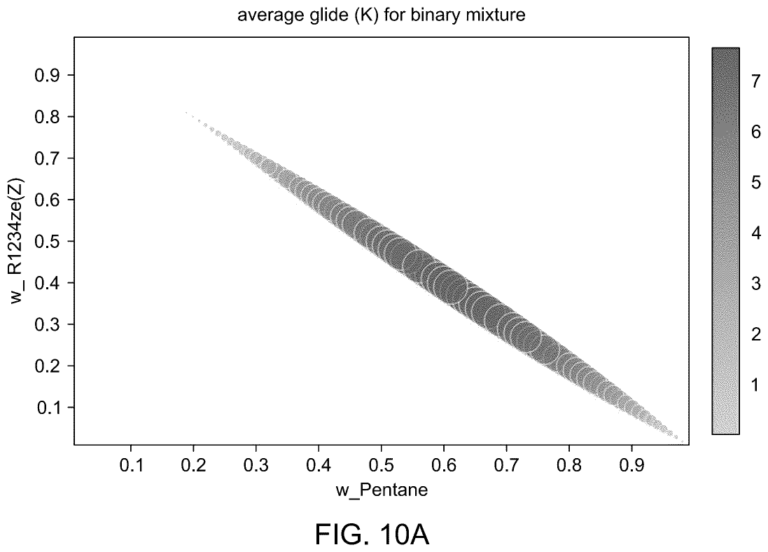

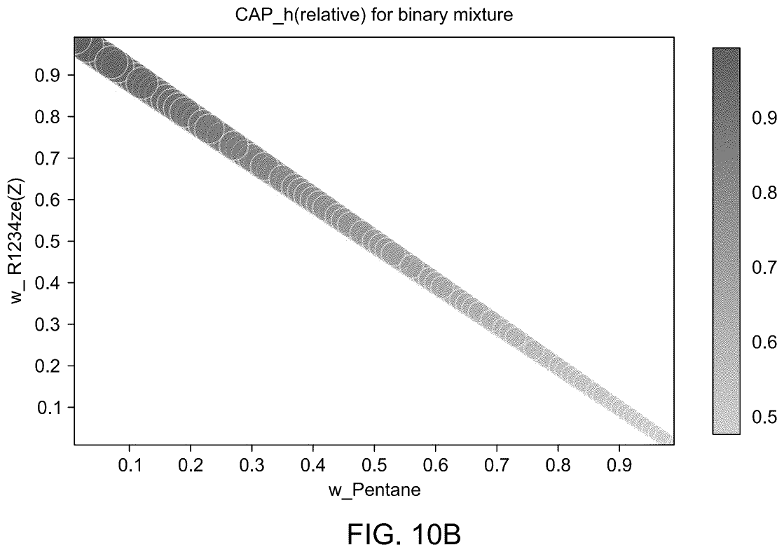

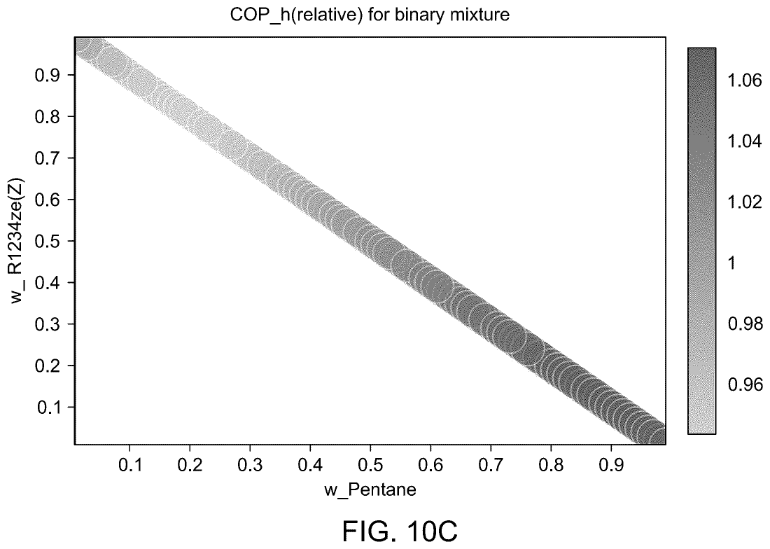

Refrigerant performance has been determined for an exemplary composition of the present invention comprising HFO-1234ze(Z) and pentane in high temperature heat pump systems as compared to HFO-1234ze(Z). Performance metric and composition property ranges are summarized in Table 25, where the ASHRAE flammability class remains 2L or 2, the average temperature glide is <1 K and GWP<3. Table 26 tabulates several compositions about the compositions of optimal heating efficiency and capacity. FIGS. 10A, 10B and 10C provide graphical representations of the average glide, the CAP for heating relative to the incumbent fluid, and the COP for heating relative to the incumbent fluid, respectively, for a composition according to Example 11.

TABLE 25
High Temperature Heat Pump Conditions, cycle metric performance
and fluid property ranges for 1234zeZ/pentane in Ex. 11

| | MAXIMA | MINIMA |
|---|---|---|
| w_R1234ze(Z) (nominal weight fraction) | 1 | 0.87 |
| w_pentane (nominal weight fraction) | 0.13 | 0 |
| T° c. (deg C.) | 150 | 149 |
| average glide (K) | 0.14 | 0 |
| GWP AR5 | 2 | 1 |
| COP_h (% dev from R1234ze(Z)) | 1 | 0.95 |
| CAP_h (% dev from R1234ze(Z)) | 1 | 0.93 |

TABLE 26
High Temperature Heat Pump Conditions, cycle metric performance
and fluid property ranges for 1234zeZ/pentane in Ex. 11

| | | Avg. | | COP_h (% | CAP_h (% | ASHRAE |
|---|---|---|---|---|---|---|
| wt-% | wt-% | Glide | GWP | dev from | dev from | Flammability |
| Pentane | R1234ze(Z) | (K) | AR5 | R1234zeZ) | R1234zeZ) | Class |
| 0 | 1 | 0 | 1 | 1 | 1 | 2 L |
| 0.01 | 0.99 | 0.0072 | 1.1 | 0.994261 | 0.99528225 | 2 L |
| 0.02 | 0.98 | 0.0102 | 1.2 | 0.988741 | 0.990481058 | 2 L |
| 0.03 | 0.97 | 0.0103 | 1.3 | 0.983222 | 0.985531375 | 2 L |
| 0.04 | 0.96 | 0.009 | 1.4 | 0.978491 | 0.980532195 | 2 L |
| 0.05 | 0.95 | 0.0075 | 1.5 | 0.97376 | 0.975483518 | 2 |
| 0.06 | 0.94 | 0.0071 | 1.6 | 0.969424 | 0.970335848 | 2 |
| 0.07 | 0.93 | 0.0091 | 1.7 | 0.965482 | 0.965188178 | 2 |
| 0.08 | 0.92 | 0.0146 | 1.8 | 0.961933 | 0.959941514 | 2 |
| 0.09 | 0.91 | 0.025 | 1.9 | 0.95878 | 0.954744347 | 2 |
| 0.1 | 0.9 | 0.0417 | 2 | 0.955626 | 0.949497683 | 2 |
| 0.11 | 0.89 | 0.066 | 2.1 | 0.95326 | 0.944251019 | 2 |
| 0.12 | 0.88 | 0.0991 | 2.2 | 0.950895 | 0.939053852 | 2 |
| 0.13 | 0.87 | 0.1426 | 2.3 | 0.948924 | 0.933807188 | 2 |

Results show that the HFO-1234ze(Z) and pentane compositions of the present invention provide similar CAP and similar energy efficiency relative to HFO-1234ze(Z), at lower costs, for heating using high temperature heat pump systems. Additionally, in many cases, the HFO-1234ze(Z) and pentane compositions of the present invention provide similar heating capacity relative to HFO-1234ze(Z), at lower costs. Up to 4 wt % pentane can be added to blends of these three components, where the ASHRAE flammability classification will remain 2L. Up to 14 wt % pentane can be added to blends of these three components, where the ASHRAE flammability classification will remain 2.

### Example 12: HCFO-1233zd(E)/Butane/HFC-134

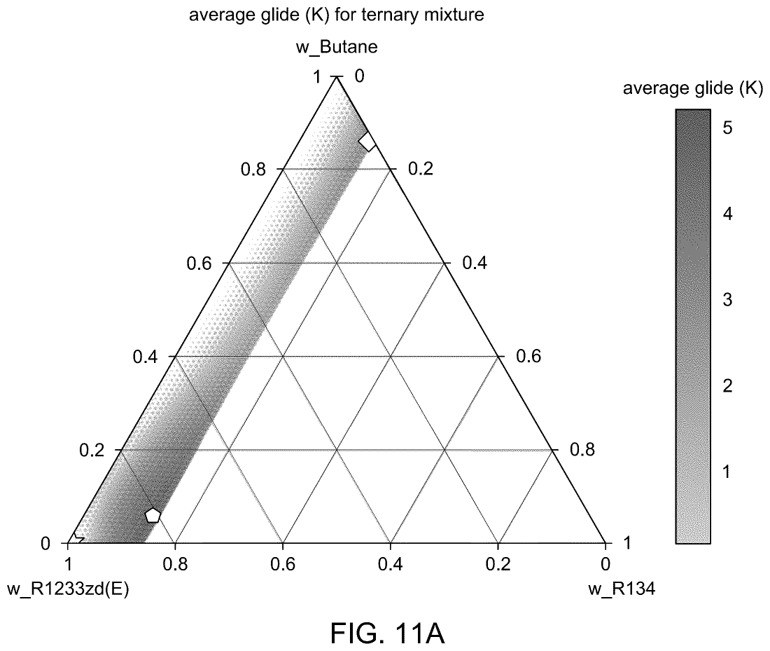

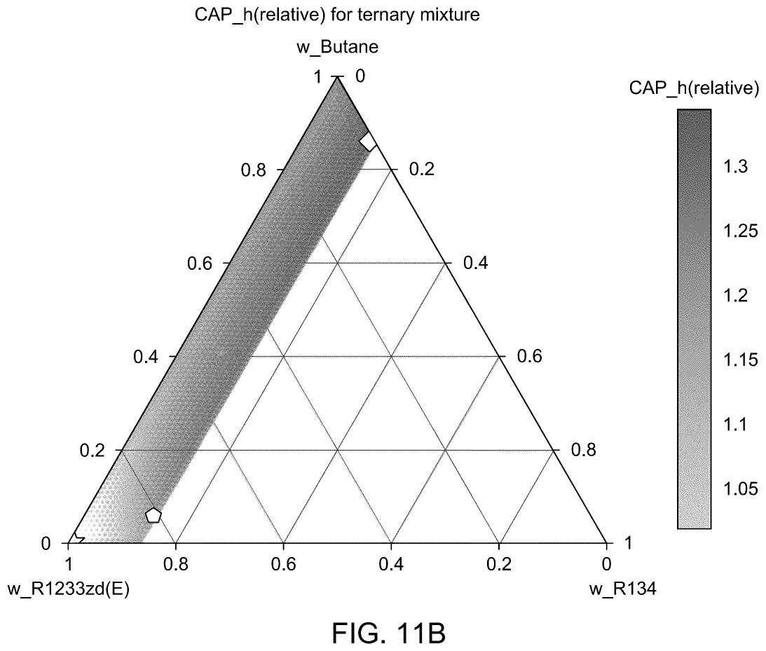

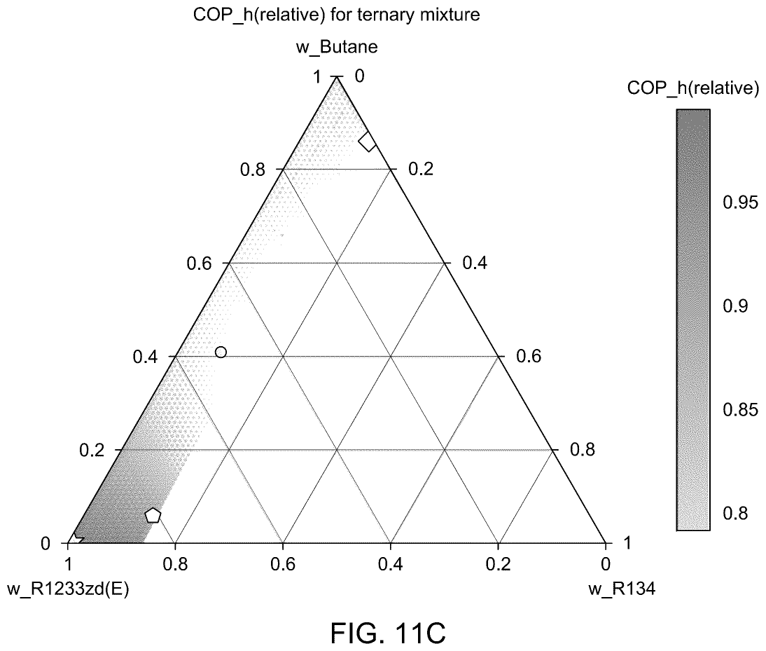

Refrigerant performance has been determined for an exemplary composition of the present invention comprising HCFO-1233zd(E), butane and HFC-134 in high temperature heat pump systems as compared to HCFO-1233zd(E). Performance metric and composition property ranges are summarized in Table 27, where the ASHRAE flammability class remains 1, 2L or 2, the average temperature glide is <6 K and GWP<150. Table 28 tabulates several compositions about the compositions of optimal heating efficiency and capacity. FIGS. 11A, 11B and 11C provide graphical representations of the average glide, the CAP for heating relative to the incumbent fluid, and the COP for heating relative to the incumbent fluid, respectively, for a composition according to Example 12.

TABLE 27
High Temperature Heat Pump Conditions, cycle metric performance
and fluid property ranges for 1233zdE/butane/134 in Ex. 12

| | MAXIMA | MINIMA |
|---|---|---|
| w_R1233zd(E) (nominal weight fraction) | 0.73 | 1 |
| w_butane (nominal weight fraction) | 0.14 | 0 |
| w_R134 (nominal weight fraction) | 0.13 | 0 |
| T° c. (degC.) | 165 | 150 |
| average glide (K) | 0 | 5.2 |
| GWP AR5 | 147 | 7 |
| COP_h (% dev from R1233zdE) | 1 | 0.88 |
| CAP_h (% dev from R1233zdE) | 1.27 | 1.02 |

TABLE 28
High Temperature Heat Pump Conditions, cycle metric performance
and fluid property ranges for 1233zdE/butane/134 in Ex. 12

| | | | Avg. | | COP_h (% | CAP_h (% | ASHRAE |
|---|---|---|---|---|---|---|---|
| wt-% | wt-% | wt-% | Glide | GWP | dev from | dev from | Flammability |
| Butane | R1233zd(E) | R134 | (K) | AR5 | R1233zdE | R1233zdE | Class |
| 0.005 | 0.86565 | 0.12935 | 4.8786 | 145.7527 | 0.962421347 | 1.193257784 | 1 |
| 0.01 | 0.92 | 0.07 | 3.2863 | 79.35 | 0.97804024 | 1.115739094 | 1 |
| 0.02 | 0.87 | 0.11 | 4.6054 | 124.13 | 0.958702563 | 1.180368118 | 1 |
| 0.02 | 0.97 | 0.01 | 1.0158 | 12.23 | 0.986221566 | 1.036232745 | 1 |
| 0.03 | 0.92 | 0.05 | 2.8805 | 57.01 | 0.97097455 | 1.105198479 | 1 |
| 0.04 | 0.87 | 0.09 | 4.2595 | 101.79 | 0.95238063 | 1.169345647 | 1 |
| 0.05 | 0.82 | 0.13 | 5.2195 | 146.57 | 0.930439803 | 1.228192391 | 1 |
| 0.05 | 0.92 | 0.03 | 2.3501 | 34.67 | 0.96390886 | 1.092850902 | 1 |
| 0.06 | 0.87 | 0.07 | 3.8043 | 79.45 | 0.946430575 | 1.156817374 | 1 |
| 0.07 | 0.82 | 0.11 | 4.8383 | 124.23 | 0.925605383 | 1.21542319 | 1 |
| 0.07 | 0.92 | 0.01 | 1.7216 | 12.33 | 0.957586927 | 1.078997523 | 1 |
| 0.08 | 0.87 | 0.05 | 3.2573 | 57.11 | 0.941224277 | 1.142903763 | 1 |
| 0.09 | 0.82 | 0.09 | 4.3768 | 101.89 | 0.921514721 | 1.201630043 | 1 |
| 0.1 | 0.77 | 0.13 | 5.1276 | 146.67 | 0.898830137 | 1.254152419 | 1 |
| 0.1 | 0.87 | 0.03 | 2.6323 | 34.77 | 0.936389858 | 1.127905974 | 1 |
| 0.11 | 0.82 | 0.07 | 3.8443 | 79.55 | 0.918167815 | 1.186812951 | 1 |
| 0.12 | 0.77 | 0.11 | 4.6882 | 124.33 | 0.896598867 | 1.239756951 | 2 |
| 0.12 | 0.87 | 0.01 | 1.9395 | 12.43 | 0.931927316 | 1.11188424 | 2 |
| 0.13 | 0.82 | 0.05 | 3.2477 | 57.21 | 0.914820909 | 1.171092377 | 2 |
| 0.14 | 0.77 | 0.09 | 4.1914 | 101.99 | 0.894739475 | 1.224638699 | 2 |

Results show that the HCFO-1233zd(E), butane and HFC-134 compositions of the present invention provide improved CAP and similar energy efficiency relative to HCFO-1233zd(E), at lower costs, for heating using high temperature heat pump systems. Additionally, in many cases, the HCFO-1233zd(E), butane and HFC-134 compositions of the present invention provide improved heating capacity relative to HCFO-1233zd(E), at lower costs. It was determined that up to 11 wt % butane can be added to a mixture of these components and maintain an ASHRAE flammability classification of 1.

### Example 13: HFO-1234ze(Z)/Pentane/t-DCE

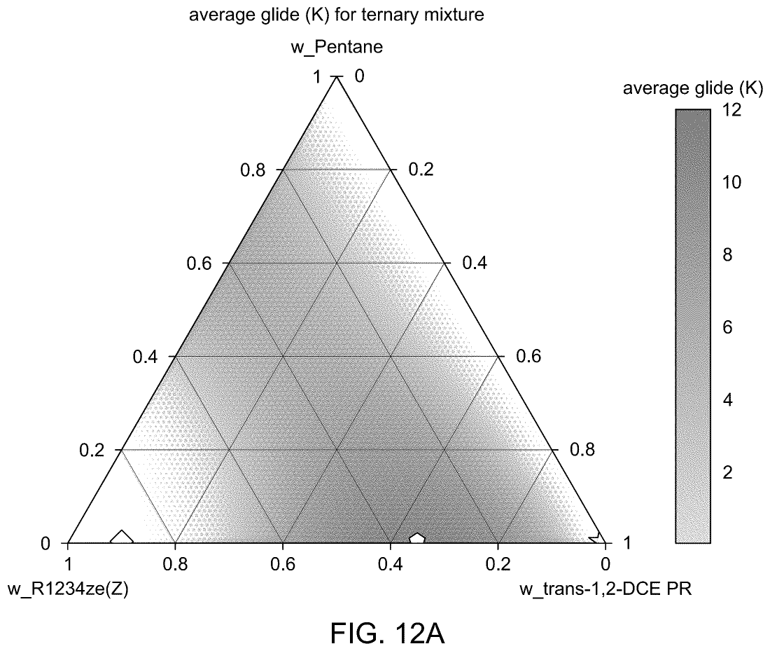

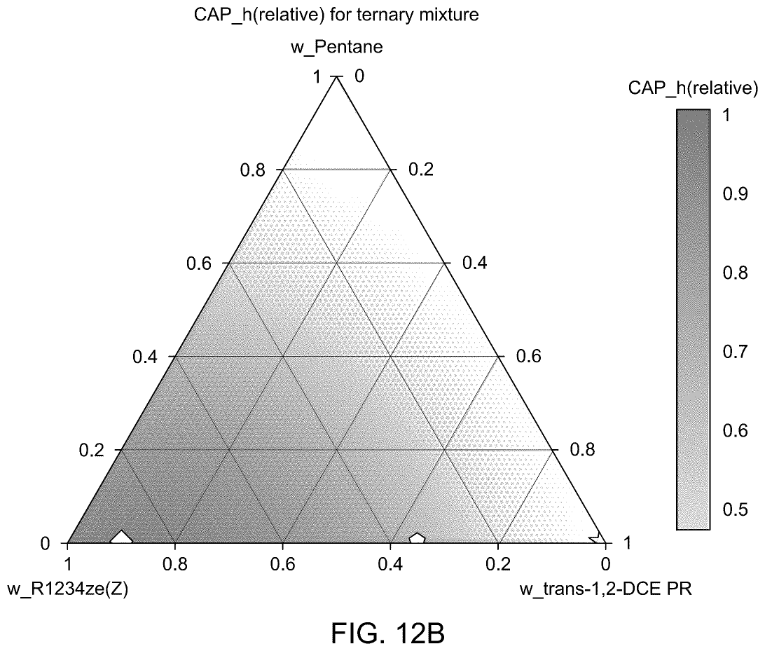

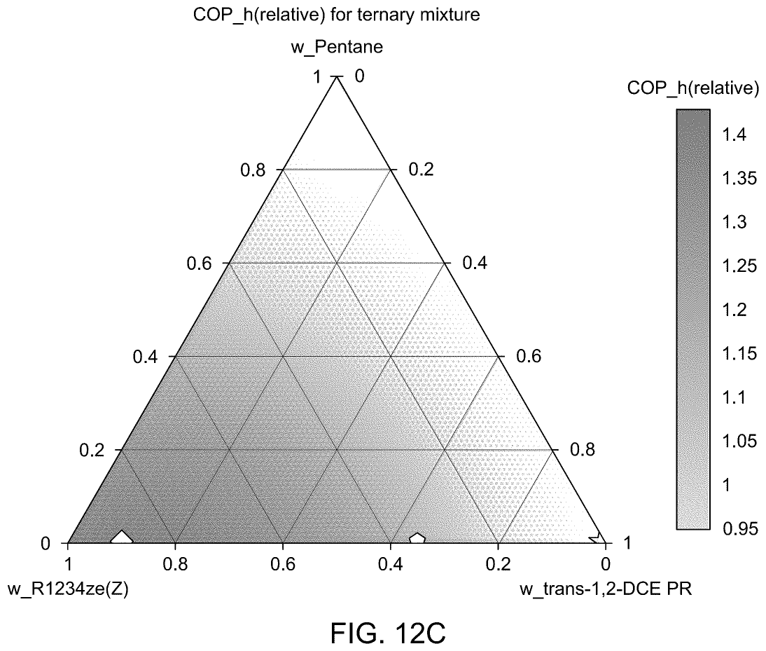

Refrigerant performance has been determined for an exemplary composition of the present invention comprising HFO-1234ze(Z), pentane and trans-1,2-dichloroethylene (t-DCE) in high temperature heat pump systems as compared to HFO-1234ze(Z). Performance metric and composition property ranges are summarized in Table 29, where the ASHRAE flammability class remains 1, 2L or 2, the average temperature glide is <12 K and GWP<4. Table 30 tabulates several compositions about the compositions of optimal heating efficiency and capacity. FIGS. 12A, 12B and 12C provide graphical representations of the average glide, the CAP for heating relative to the incumbent fluid, and the COP for heating relative to the incumbent fluid, respectively, for a composition according to Example 13.

TABLE 29
High Temperature Heat Pump Conditions, cycle metric performance
and fluid property ranges for 1234zeZ/pentane/t-DCE in Ex. 13

| | MAXIMA | MINIMA |
|---|---|---|
| w_R1234ze(Z) (nominal weight fraction) | 1 | 0 |
| w_pentane (nominal weight fraction) | 0.24 | 0 |
| w_t-DCE (nominal weight fraction) | 1 | 0 |
| T° c. (degC.) | 241 | 149 |
| average glide (K) | 12 | 0 |
| GWP AR5 | 3 | 0.1 |
| COP_h (% dev from R1234zeZ) | 1.43 | 0.96 |
| CAP_h (% dev from R1234zeZ) | 1 | 0.53 |

TABLE 30
High Temperature Heat Pump Conditions, cycle metric performance
and fluid property ranges for 1234zeZ/pentane/t-DCE in Ex. 13

| | | | Avg. | | COP_h (% | CAP_h (% | ASHRAE |
|---|---|---|---|---|---|---|---|
| wt-% | wt-% | wt-% | Glide | GWP | dev from | dev from | Flammability |
| Pentane | R1234ze(Z) | t-DCE | (K) | AR5 | R1234zeZ | R1234zeZ | Class |
| 0.005 | 0.8955 | 0.0995 | 0.8289 | 0.95051 | 1.060886381 | 1.00839891 | 1 |
| 0.01 | 0.86 | 0.13 | 1.2646 | 0.970013 | 1.077838486 | 1.004835138 | 1 |
| 0.03 | 0.28 | 0.69 | 11.324 | 0.610069 | 1.337245115 | 0.722158744 | 1 |
| 0.04 | 0.42 | 0.54 | 11.0163 | 0.860054 | 1.285206095 | 0.812737943 | 1 |
| 0.05 | 0.63 | 0.32 | 6.3464 | 1.180032 | 1.17836841 | 0.924551281 | 1 |
| 0.07 | 0.57 | 0.36 | 7.6531 | 1.340036 | 1.198474395 | 0.893318781 | 1 |
| 0.005 | 0.0597 | 0.9353 | 4.4918 | 0.114794 | 1.408207414 | 0.566936687 | 2 |
| 0.02 | 0.21 | 0.77 | 10.3652 | 0.430077 | 1.360110745 | 0.673602354 | 2 |
| 0.04 | 0.13 | 0.83 | 7.909 | 0.570083 | 1.373514734 | 0.621581187 | 2 |
| 0.05 | 0.72 | 0.23 | 3.8366 | 1.270023 | 1.12790633 | 0.961178935 | 2 |
| 0.06 | 0.78 | 0.16 | 2.2971 | 1.440016 | 1.083357776 | 0.973800626 | 2 |
| 0.07 | 0.87 | 0.06 | 0.6692 | 1.640006 | 1.012001241 | 0.974246098 | 2 |
| 0.09 | 0.03 | 0.88 | 3.0076 | 1.020088 | 1.385736019 | 0.560700086 | 2 |
| 0.1 | 0.13 | 0.77 | 7.5721 | 1.230077 | 1.350649105 | 0.628312755 | 2 |
| 0.11 | 0.21 | 0.68 | 9.4429 | 1.420068 | 1.32344689 | 0.680779395 | 2 |
| 0.12 | 0.3 | 0.58 | 10.2101 | 1.620058 | 1.29111962 | 0.737502762 | 2 |
| 0.1393 | 0.005 | 0.8557 | 1.5013 | 1.537386 | 1.375485909 | 0.549662293 | 2 |
| 0.15 | 0.26 | 0.59 | 9.5872 | 1.910059 | 1.29111962 | 0.712308875 | 2 |
| 0.1791 | 0.005 | 0.8159 | 1.5179 | 1.975182 | 1.35971651 | 0.553226065 | 2 |
| 0.21 | 0.11 | 0.68 | 6.1312 | 2.420068 | 1.313591015 | 0.620690244 | 2 |

Results show that the HFO-1234ze(Z), pentane and t-DCE compositions of the present invention provide improved COP relative to HFO-1234ze(Z), at lower costs, for heating using high temperature heat pump systems. It was determined that 10 wt-% and 24 wt-% pentane can be added to a mixture of these components and maintain an ASHRAE flammability classification of 1 and 2, respectively.

### Example 14: HFO-1234ze(Z)/Butane

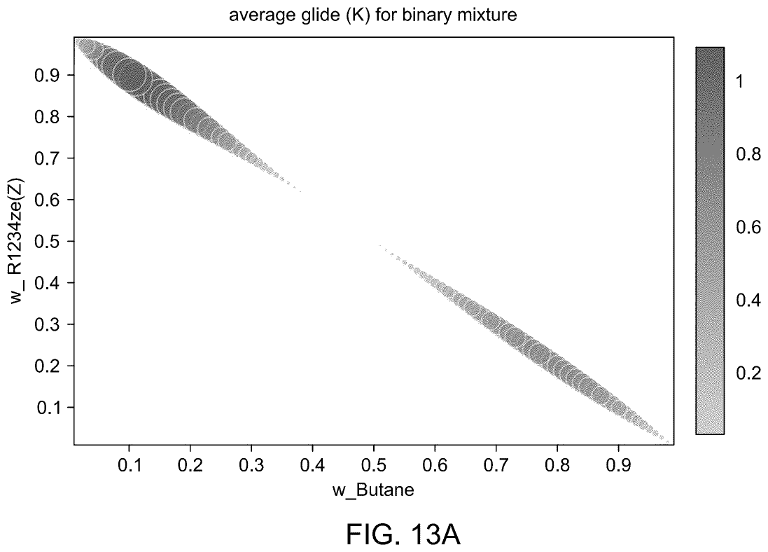

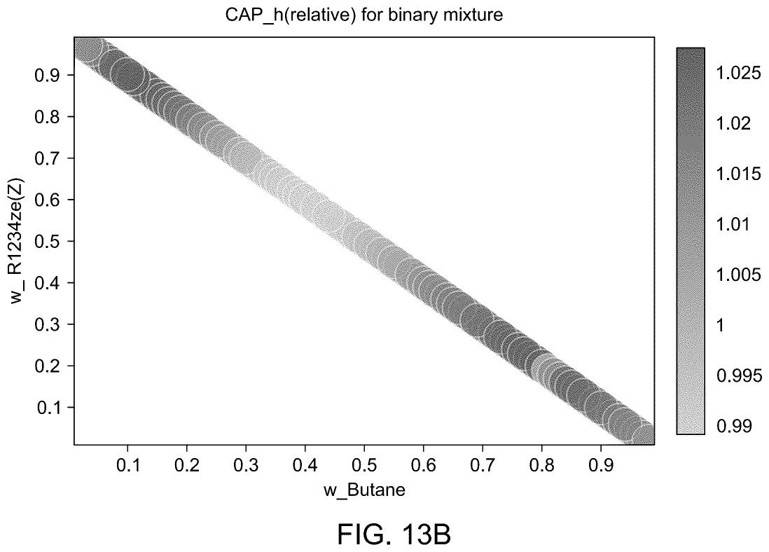

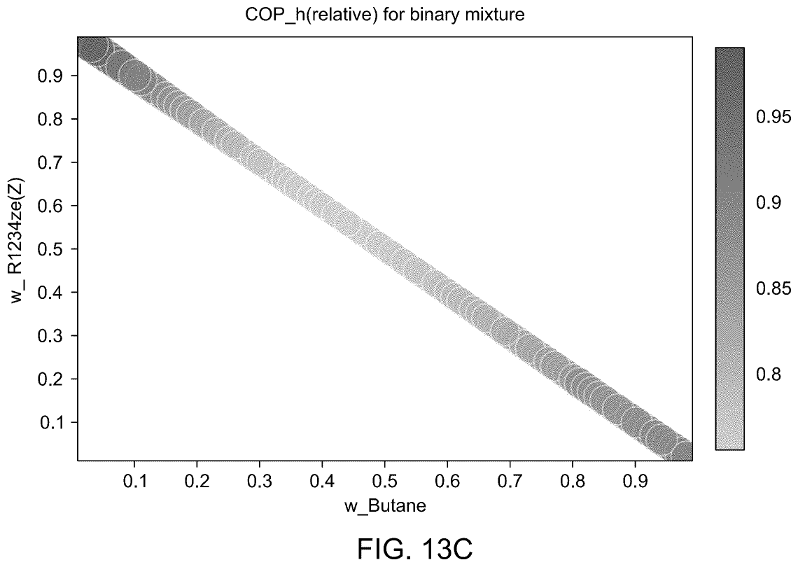

Refrigerant performance has been determined for an exemplary composition of the present invention comprising HFO-1234ze(Z) and butane in high temperature heat pump systems as compared to HFO-1234ze(Z). Performance metric and composition property ranges are summarized in Table 31, where the ASHRAE flammability class remains 2L or 2, the average temperature glide is <1 K or less than 1.5 K and GWP is about 1. Table 32 tabulates several compositions about the compositions of optimal heating efficiency and capacity. FIGS. 13A, 13B and 13C provide graphical representations of the average glide, the CAP for heating relative to the incumbent fluid, and the COP for heating relative to the incumbent fluid, respectively, for a composition according to Example 14.

TABLE 31
High Temperature Heat Pump Conditions, cycle metric performance
and fluid property ranges for 1234zeZ/butane in Ex. 14

| | Flammability = 2L | | Flammability = 2 | |
|---|---|---|---|---|
| | MAXIMA | MINIMA | MAXIMA | MINIMA |
| w_R1234ze(Z) | 100 | 96 | 95 | 87 |
| w butane | 4 | 0 | 13 | 5 |
| T° c. (degC.) | 150.12 | 147.5 | 146.8 | 142.4 |
| avg glide_h (K) | 0.7 | 0 | 1.1 | 0.8 |
| COP_h (% dev) | 100 | 96.3 | 95.4 | 88.5 |
| CAP_h (% dev) | 101.6 | 100 | 102.7 | 101.9 |

TABLE 32
High Temperature Heat Pump Conditions, cycle metric performance
and fluid property ranges for 1234zeZ/butane in Ex. 14

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| butane | R1234zeZ | (K) | AR5 | (kcal/g) | (kg/m\hat{ }3) | Class | R1234zeZ | R1234zeZ |
| 0.01 | 0.99 | 0.2055 | 1.02 | 2.3154 | 0.26043938 | 2L | 0.990712551 | 1.004884635 |
| 0.02 | 0.98 | 0.3842 | 1.04 | 2.4008 | 0.247878329 | 2L | 0.981645146 | 1.009190859 |
| 0.03 | 0.97 | 0.5381 | 1.06 | 2.4862 | 0.236473174 | 2L | 0.972183506 | 1.013051612 |
| 0.04 | 0.96 | 0.6691 | 1.08 | 2.5716 | 0.226071381 | 2L | 0.963116101 | 1.0163679 |
| 0.05 | 0.95 | 0.7789 | 1.1 | 2.657 | 0.216546123 | 2 | 0.954048696 | 1.019238716 |
| 0.06 | 0.94 | 0.8694 | 1.12 | 2.7424 | 0.207791085 | 2 | 0.945375526 | 1.02166406 |
| 0.07 | 0.93 | 0.9422 | 1.14 | 2.8278 | 0.199716475 | 2 | 0.936308121 | 1.023643934 |
| 0.08 | 0.92 | 0.9988 | 1.16 | 2.9132 | 0.192245938 | 2 | 0.927634951 | 1.025178335 |
| 0.09 | 0.91 | 1.0409 | 1.18 | 2.9986 | 0.185314131 | 2 | 0.918961781 | 1.026366259 |
| 0.1 | 0.9 | 1.0697 | 1.2 | 3.084 | 0.178864807 | 2 | 0.910288611 | 1.027108712 |
| 0.11 | 0.89 | 1.0866 | 1.22 | 3.1694 | 0.172849286 | 2 | 0.902009676 | 1.027554183 |
| 0.12 | 0.88 | 1.0929 | 1.24 | 3.2548 | 0.167225224 | 2 | 0.893730741 | 1.027653177 |
| 0.13 | 0.87 | 1.0898 | 1.26 | 3.3402 | 0.161955613 | 2 | 0.885451806 | 1.027405693 |

Results show that the HFO-1234ze(Z) and butane compositions of the present invention provide improved CAP and similar energy efficiency relative to HFO-1234ze(Z), at lower costs, for heating using high temperature heat pump systems. Additionally, in many cases, the HFO-1234ze(Z) and butane compositions of the present invention provide improved heating capacity relative to HFO-1234ze(Z), at lower costs. Up to 4 wt % butane can be added to blends of these two components, where the ASHRAE flammability classification will remain 2L. Up to 13 wt % butane can be added to blends of these two components, where the ASHRAE flammability classification will remain 2.

### Example 15: HFO-1234ze(Z)/Isobutane

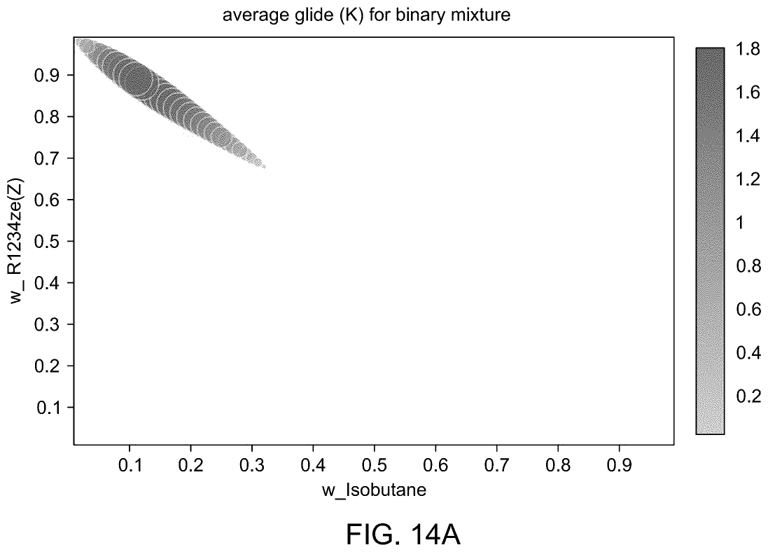

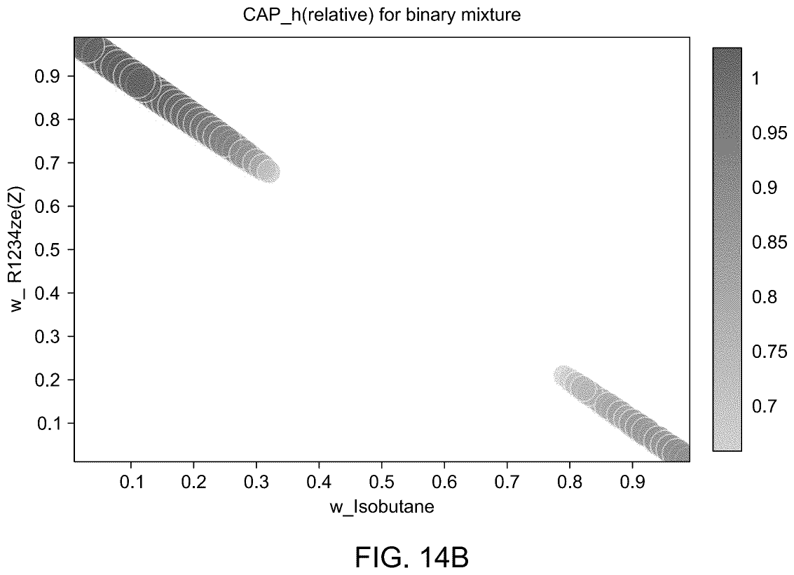

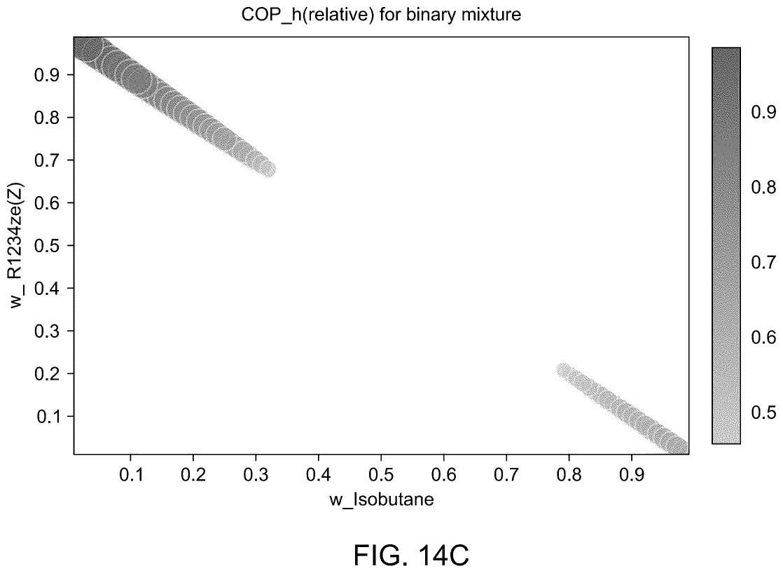

Refrigerant performance has been determined for an exemplary composition of the present invention comprising HFO-1234ze(Z) and isobutane in high temperature heat pump systems as compared to HFO-1234ze(Z). Performance metric and composition property ranges are summarized in Table 33, where the ASHRAE flammability class remains 2L or 2, the average temperature glide is <1 K or less than 2 K and GWP is about 1. Table 34 tabulates several compositions about the compositions of optimal heating efficiency and capacity. FIGS. 14A, 14B and 14C provide graphical representations of the average glide, the CAP for heating relative to the incumbent fluid, and the COP for heating relative to the incumbent fluid, respectively, for a composition according to Example 15.

TABLE 33
High Temperature Heat Pump Conditions, cycle metric performance
and fluid property ranges for 1234zeZ/isobutane in Ex. 15

| | Flammability = 2L | | Flammability = 2 | |
|---|---|---|---|---|
| | MAXIMA | MINIMA | MAXIMA | MINIMA |
| w_R1234ze(Z) | 100 | 96 | 95 | 87 |
| w_isobutane | 4 | 0 | 13 | 5 |
| T° c. (degC.) | 150.12 | 146.8 | 146 | 140 |
| avg glide_h (K) | 1.1 | 0 | 1.8 | 1.24 |
| COP_h (% dev) | 100 | 95.4 | 94.2 | 84.5 |
| CAP_h (% dev) | 102 | 100 | 102.9 | 102.2 |

TABLE 34
High Temperature Heat Pump Conditions, cycle metric performance
and fluid property ranges for 1234zeZ/isobutane in Ex. 15

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| isobutane | R1234zeZ | (K) | AR5 | (kcal/g) | (kg/m\hat{ }3) | Class | R1234zeZ | R1234zeZ |
| 0.01 | 0.99 | 0.3198 | 1.02 | 2.3151 | 0.260466616 | 2L | 0.988741376 | 1.006270546 |
| 0.02 | 0.98 | 0.601 | 1.04 | 2.4002 | 0.24792768 | 2L | 0.977308561 | 1.011715198 |
| 0.03 | 0.97 | 0.846 | 1.06 | 2.4853 | 0.23654055 | 2L | 0.965481511 | 1.016417396 |
| 0.04 | 0.96 | 1.0573 | 1.08 | 2.5704 | 0.226153493 | 2L | 0.954048696 | 1.020377143 |
| 0.05 | 0.95 | 1.2373 | 1.1 | 2.6555 | 0.216640302 | 2 | 0.942221646 | 1.02354494 |
| 0.06 | 0.94 | 1.3884 | 1.12 | 2.7406 | 0.207895153 | 2 | 0.930394596 | 1.025970285 |
| 0.07 | 0.93 | 1.5126 | 1.14 | 2.8257 | 0.199828642 | 2 | 0.918567546 | 1.027653177 |
| 0.08 | 0.92 | 1.6122 | 1.16 | 2.9108 | 0.192364725 | 2 | 0.906740496 | 1.028593617 |
| 0.09 | 0.91 | 1.689 | 1.18 | 2.9959 | 0.185438309 | 2 | 0.894519211 | 1.028791604 |
| 0.1 | 0.9 | 1.7451 | 1.2 | 3.081 | 0.178993353 | 2 | 0.882297926 | 1.028197642 |
| 0.11 | 0.89 | 1.7823 | 1.22 | 3.1661 | 0.172981341 | 2 | 0.870076642 | 1.026910724 |
| 0.12 | 0.88 | 1.8022 | 1.24 | 3.2512 | 0.167360068 | 2 | 0.857855357 | 1.024881354 |
| 0.13 | 0.87 | 1.8065 | 1.26 | 3.3363 | 0.162092638 | 2 | 0.845239837 | 1.022109532 |

Results show that the HFO-1234ze(Z) and isobutane compositions of the present invention provide improved CAP and similar energy efficiency relative to HFO-1234ze(Z), at lower costs, for heating using high temperature heat pump systems. Additionally, in many cases, the HFO-1234ze(Z) and isobutane compositions of the present invention provide improved heating capacity relative to HFO-1234ze(Z), at lower costs. Up to 4 wt % isobutane can be added to blends of these two components, where the ASHRAE flammability classification will remain 2L. Up to 13 wt % isobutane can be added to blends of these two components, where the ASHRAE flammability classification will remain 2.

### Example 16: HFO-1336mzz(E)/Pentane

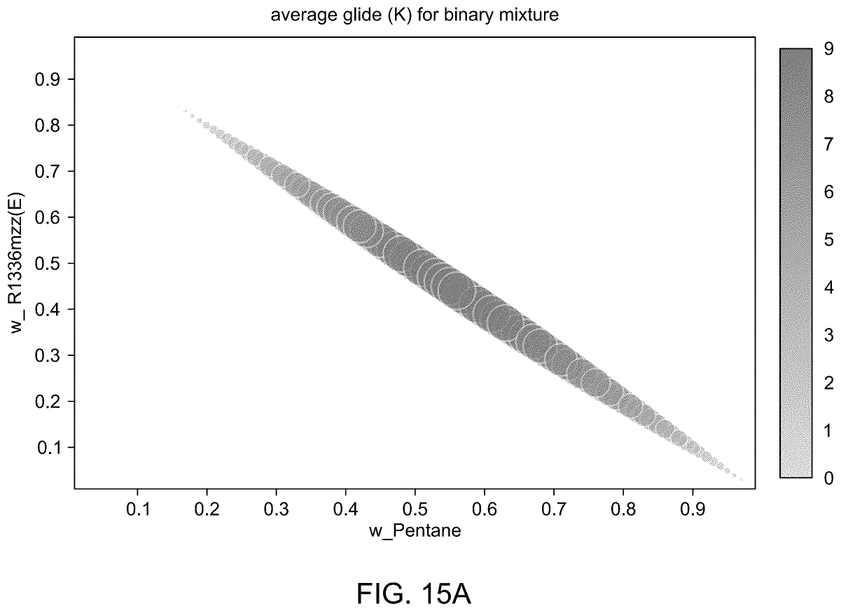

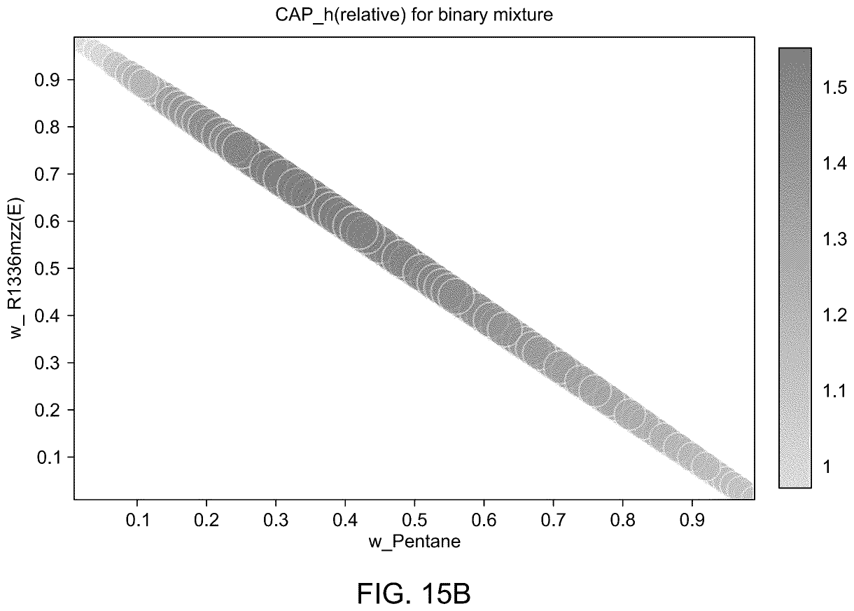

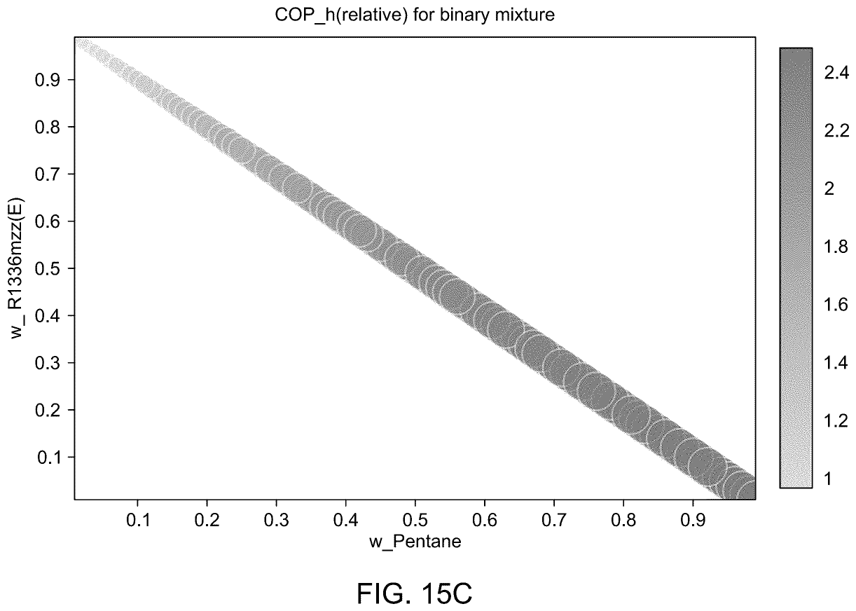

Refrigerant performance has been determined for an exemplary composition of the present invention comprising HFO-1336mzz(E) and pentane in high temperature heat pump systems as compared to HFO-1336mzz(E). Performance metric and composition property ranges are summarized in Table 35, where the ASHRAE flammability class remains 1 or 2L, the average temperature glide is <0.1 K and GWP is about 16. Table 36 tabulates several compositions about the compositions of optimal heating efficiency and capacity. FIGS. 15A, 15B and 15C provide graphical representations of the average glide, the CAP for heating relative to the incumbent fluid, and the COP for heating relative to the incumbent fluid, respectively, fora composition according to Example 16.

TABLE 35
High Temperature Heat Pump Conditions, cycle metric performance
and fluid property ranges for 1336mzzE/pentane in Ex. 16

| | Flammability = 1 | | Flammability = 2L | |
|---|---|---|---|---|
| | MAXIMA | MINIMA | MAXIMA | MINIMA |
| w_R1336mzz(E) | 100 | 93 | 92 | 91 |
| w_pentane | 7 | 0 | 9 | 8 |
| T° c. (degC.) | 131.2 | 130.3 | 131.9 | 131.5 |
| avg glide_h (K) | <0.1 | 0 | 0.1 | <0.1 |
| COP_h (% dev) | 110.9 | 96.6 | 118.3 | 115.4 |
| CAP_h (% dev) | 111.4 | 97.1 | 118.2 | 111.7 |

TABLE 36
High Temperature Heat Pump Conditions, cycle metric performance
and fluid property ranges for 1336mzzE/pentane in Ex. 16

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| pentane | R1336mzzE | (K) | AR5 | (kcal/g) | (kg/m\hat{ }3) | Class | R1336mzzE | R1336mzzE |
| 0.01 | 0.99 | 0.0005 | 15.95 | 1.97414 | 0.33554898 | 1 | 0.973314043 | 0.976945024 |
| 0.02 | 0.98 | 0.0003 | 15.9 | 2.06228 | 0.316865366 | 1 | 0.96595439 | 0.971462467 |
| 0.03 | 0.97 | 0.0005 | 15.85 | 2.15042 | 0.300152646 | 1 | 0.976993869 | 0.984410634 |
| 0.04 | 0.96 | 0.0016 | 15.8 | 2.23856 | 0.285114587 | 1 | 1.005512522 | 0.980444529 |
| 0.05 | 0.95 | 0.0048 | 15.75 | 2.3267 | 0.271511489 | 1 | 1.038630959 | 1.013339872 |
| 0.06 | 0.94 | 0.0114 | 15.7 | 2.41484 | 0.259147315 | 1 | 1.078189091 | 1.038303004 |
| 0.07 | 0.93 | 0.0234 | 15.65 | 2.50298 | 0.247860181 | 1 | 1.108547657 | 1.113775653 |
| 0.08 | 0.92 | 0.0432 | 15.6 | 2.59112 | 0.237515231 | 2L | 1.153625529 | 1.116925207 |
| 0.09 | 0.91 | 0.0737 | 15.55 | 2.67926 | 0.227999218 | 2L | 1.183064139 | 1.182015992 |

Results show that the HFO-1336mzz(E) and pentane compositions of the present invention provide improved CAP and similar energy efficiency relative to HFO-1336mzz(E), at lower costs, for heating using high temperature heat pump systems. Additionally, in many cases, the HFO-1336mzz(E) and pentane compositions of the present invention provide improved heating capacity relative to HFO-1336mzz(E), at lower costs. Up to 7 wt % pentane can be added to blends of these two components, where the ASHRAE flammability classification will remain 1. Up to 9 wt % pentane can be added to blends of these two components, where the ASHRAE flammability classification will remain 2L.

### Example 17: HFO-1336mzz(E)/Butane

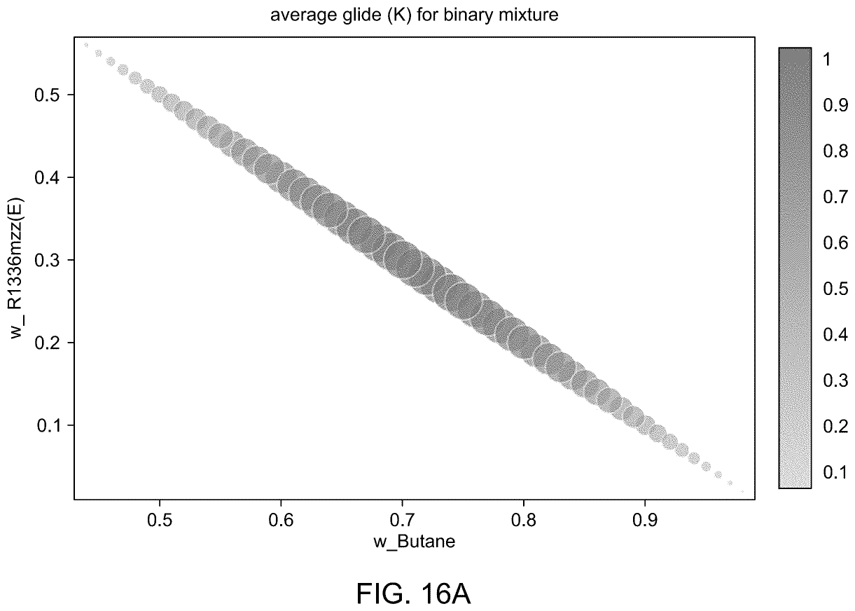

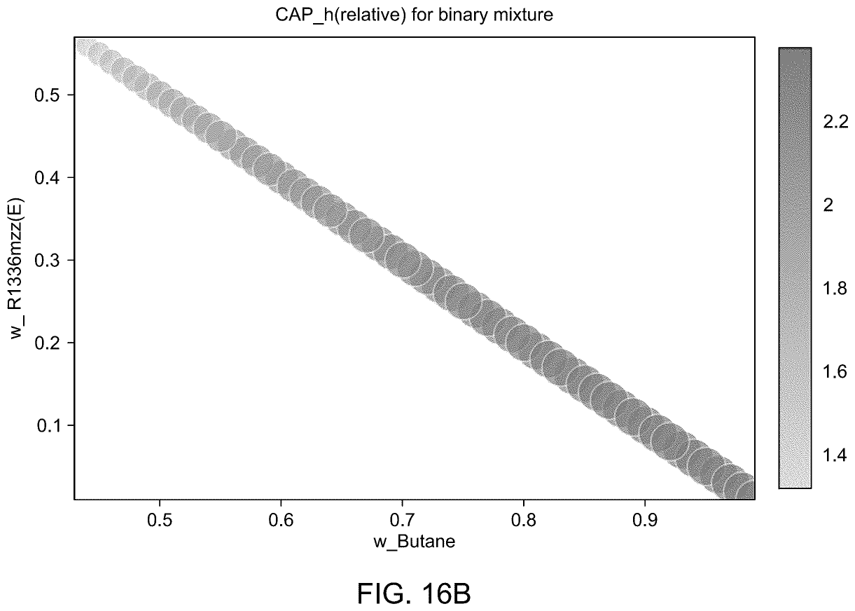

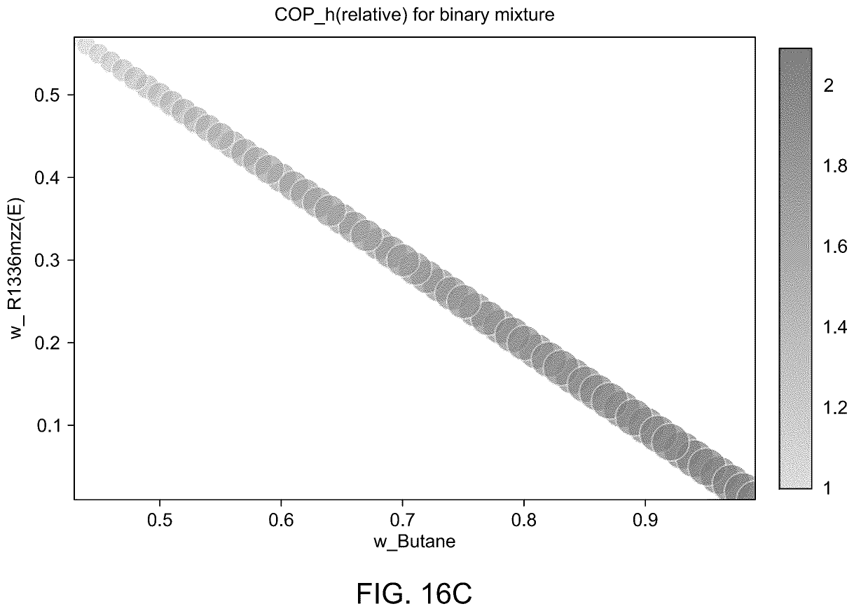

Refrigerant performance has been determined for an exemplary composition of the present invention comprising HFO-1336mzz(E) and butane in high temperature heat pump systems as compared to HFO-1336mzz(E). Performance metric and composition property ranges are summarized in Table 37, where the ASHRAE flammability class remains 1 or 2L, the average temperature glide is <1.5 K and GWP is about 16. Table 38 tabulates several compositions about the compositions of optimal heating efficiency and capacity. FIGS. 16A, 16B and 16C provide graphical representations of the average glide, the CAP for heating relative to the incumbent fluid, and the COP for heating relative to the incumbent fluid, respectively, for a composition according to Example 17.

TABLE 37
High Temperature Heat Pump Conditions, cycle metric performance
and fluid property ranges for 1336mzzE/butane in Ex. 17

| | Flammability = 1 | | Flammability = 2L | |
|---|---|---|---|---|
| | MAXIMA | MINIMA | MAXIMA | MINIMA |
| w_R1336mzz(E) | 100 | 93 | 92 | 91 |
| w butane | 7 | 0 | 9 | 8 |
| T° c. (degC.) | 130.38 | 126.4 | 125.6 | 126 |
| avg glide_h (K) | 1.2 | 0 | 1.2 | 1.2 |
| COP_h (% dev) | 100 | 95.7 | 95.2 | 94.8 |
| CAP_h (% dev) | 109.3 | 100 | 111.2 | 110.3 |

TABLE 38
High Temperature Heat Pump Conditions, cycle metric performance
and fluid property ranges for 1336mzzE/butane in Ex. 17

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| butane | R1336mzzE | (K) | AR5 | (kcal/g) | (kg/m\hat{ }3) | Class | R1336mzzE | R1336mzzE |
| 0.01 | 0.99 | 0.3182 | 15.87 | 1.97484 | 0.332508087 | 1 | 0.993303453 | 1.01622038 |
| 0.02 | 0.98 | 0.5751 | 15.74 | 2.06368 | 0.311485328 | 1 | 0.986555031 | 1.031288776 |
| 0.03 | 0.97 | 0.7786 | 15.61 | 2.15252 | 0.292962812 | 1 | 0.980127962 | 1.04529124 |
| 0.04 | 0.96 | 0.9355 | 15.48 | 2.24136 | 0.27651954 | 1 | 0.974022247 | 1.058276224 |
| 0.05 | 0.95 | 1.052 | 15.35 | 2.3302 | 0.261824012 | 1 | 0.967916532 | 1.070437534 |
| 0.06 | 0.94 | 1.1336 | 15.22 | 2.41904 | 0.248611638 | 1 | 0.962453524 | 1.081823621 |
| 0.07 | 0.93 | 1.1852 | 15.09 | 2.50788 | 0.236668674 | 1 | 0.957311869 | 1.092531388 |
| 0.08 | 0.92 | 1.2113 | 14.96 | 2.59672 | 0.225820562 | 2L | 0.952491567 | 1.102657738 |
| 0.09 | 0.91 | 1.2156 | 14.83 | 2.68556 | 0.215923347 | 2L | 0.948313973 | 1.112251122 |

Results show that the HFO-1336mzz(E) and butane compositions of the present invention provide improved CAP and similar energy efficiency relative to HFO-1336mzz(E), at lower costs, for heating using high temperature heat pump systems. Additionally, in many cases, the HFO-1336mzz(E) and butane compositions of the present invention provide improved heating capacity relative to HFO-1336mzz(E), at lower costs. Up to 7 wt % butane can be added to blends of these two components, where the ASHRAE flammability classification will remain 1. Up to 9 wt % butane can be added to blends of these two components, where the ASHRAE flammability classification will remain 2L.

### Example 18: HFO-1336mzz(E)/Isobutane

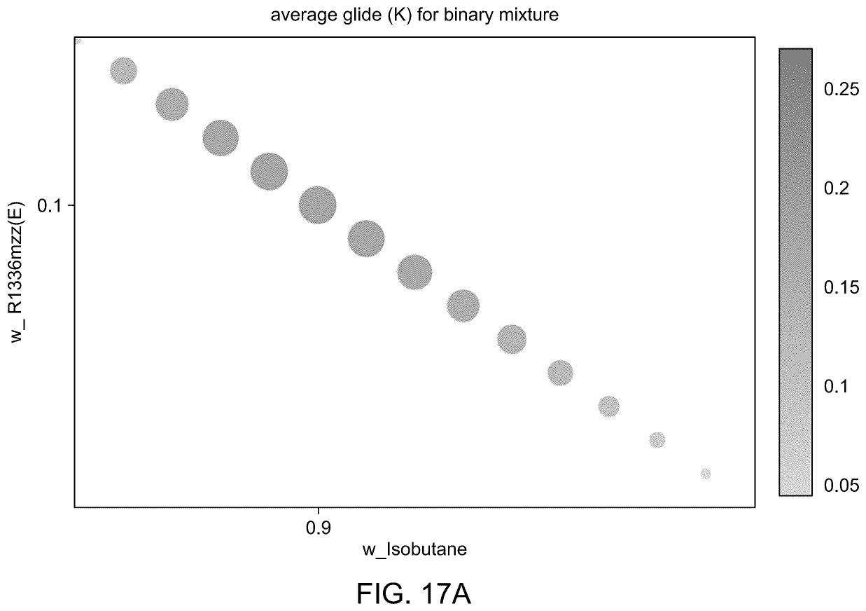

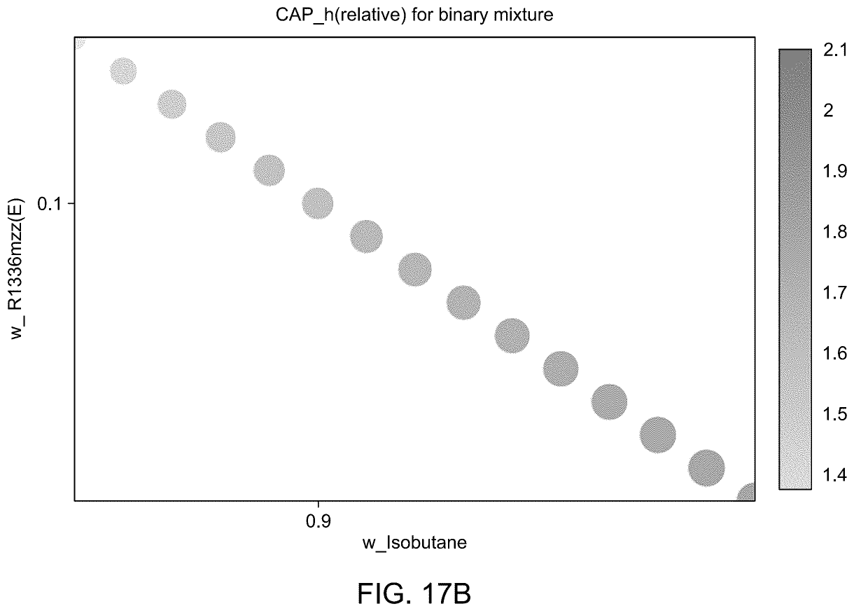

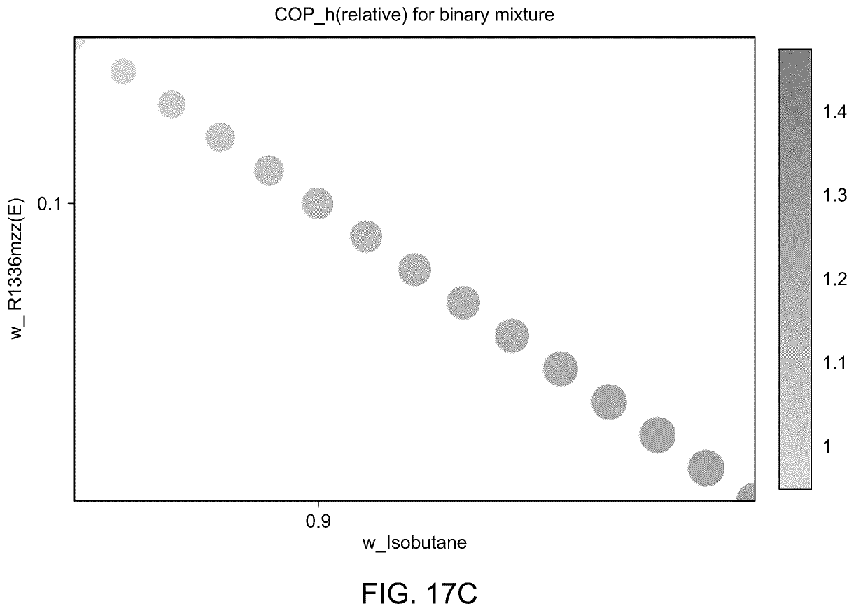

Refrigerant performance has been determined for an exemplary composition of the present invention comprising HFO-1336mzz(E) and isobutane in high temperature heat pump systems as compared to HFO-1336mzz(E). Performance metric and composition property ranges are summarized in Table 39, where the ASHRAE flammability class remains 1 or 2L, the average temperature glide is <3 K and GWP is about 16. Table 40 tabulates several compositions about the compositions of optimal heating efficiency and capacity. FIGS. 17A, 17B and 17C provide graphical representations of the average glide, the CAP for heating relative to the incumbent fluid, and the COP for heating relative to the incumbent fluid, respectively, for a composition according to Example 18.

TABLE 39
High Temperature Heat Pump Conditions, cycle metric performance
and fluid property ranges for 1336mzzE/isobutane in Ex. 18

| | Flammability = 1 | | Flammability = 2L | |
|---|---|---|---|---|
| | MAXIMA | MINIMA | MAXIMA | MINIMA |
| w_R1336mzz(E) | 100 | 93 | 92 | 91 |
| w_isobutane | 7 | 0 | 9 | 8 |
| T° c. (degC.) | 130.38 | 125.2 | 124.4 | 123.7 |
| avg glide_h (K) | 2.2 | 0 | 2.5 | 2.3 |
| COP_h (% dev) | 100 | 93.8 | 92.8 | 91.8 |
| CAP_h (% dev) | 110.5 | 100 | 112.6 | 111.6 |

TABLE 40
High Temperature Heat Pump Conditions, cycle metric performance
and fluid property ranges for 1336mzzE/isobutane in Ex. 18

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| isobutane | R1336mzzE | (K) | AR5 | (kcal/g) | (kg/m\hat{ }3) | Class | R1336mzzE | R1336mzzE |
| 0.01 | 0.99 | 0.4092 | 15.87 | 1.97454 | 0.332552485 | 1 | 0.991696686 | 1.01757702 |
| 0.02 | 0.98 | 0.7932 | 15.74 | 2.06308 | 0.311563259 | 1 | 0.983341497 | 1.03448657 |
| 0.03 | 0.97 | 1.1454 | 15.61 | 2.15162 | 0.293066229 | 1 | 0.974664954 | 1.050620898 |
| 0.04 | 0.96 | 1.4614 | 15.48 | 2.24016 | 0.276642397 | 1 | 0.965667058 | 1.0658831 |
| 0.05 | 0.95 | 1.7387 | 15.35 | 2.3287 | 0.261961705 | 1 | 0.956669162 | 1.08007937 |
| 0.06 | 0.94 | 1.9763 | 15.22 | 2.41724 | 0.248760626 | 1 | 0.947349913 | 1.093209709 |
| 0.07 | 0.93 | 2.1745 | 15.09 | 2.50578 | 0.236826204 | 1 | 0.93770931 | 1.105177213 |
| 0.08 | 0.92 | 2.3343 | 14.96 | 2.59432 | 0.22598448 | 2L | 0.927747353 | 1.115981883 |
| 0.09 | 0.91 | 2.4577 | 14.83 | 2.68286 | 0.216091954 | 2L | 0.917785397 | 1.125672169 |

Results show that the HFO-1336mzz(E) and isobutane compositions of the present invention provide improved CAP and similar energy efficiency relative to HFO-1336mzz(E), at lower costs, for heating using high temperature heat pump systems. Additionally, in many cases, the HFO-1336mzz(E) and isobutane compositions of the present invention provide improved heating capacity relative to HFO-1336mzz(E), at lower costs. Up to 7 wt % isobutane can be added to blends of these two components, where the ASHRAE flammability classification will remain 1. Up to 9 wt % isobutane can be added to blends of these two components, where the ASHRAE flammability classification will remain 2L.

### Example 19: HCFO-1233zd(E)/Butane

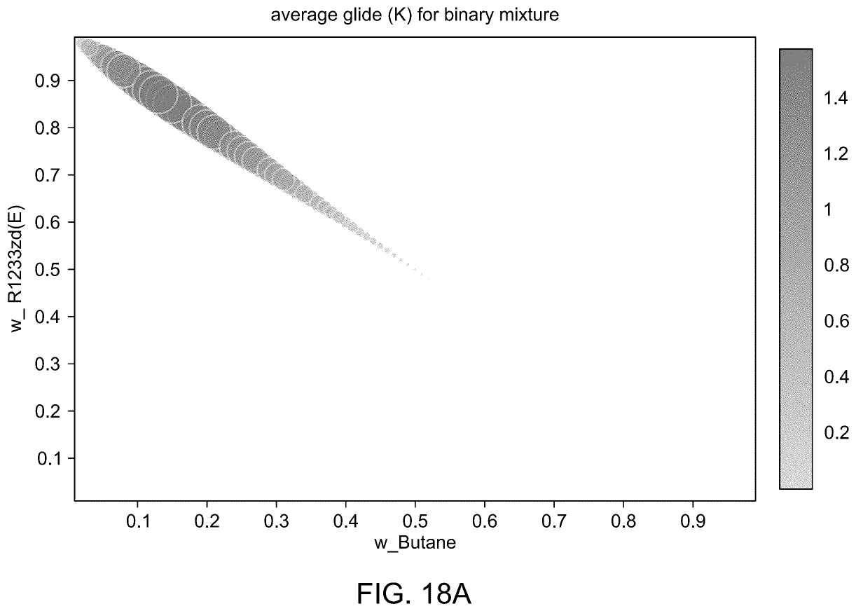

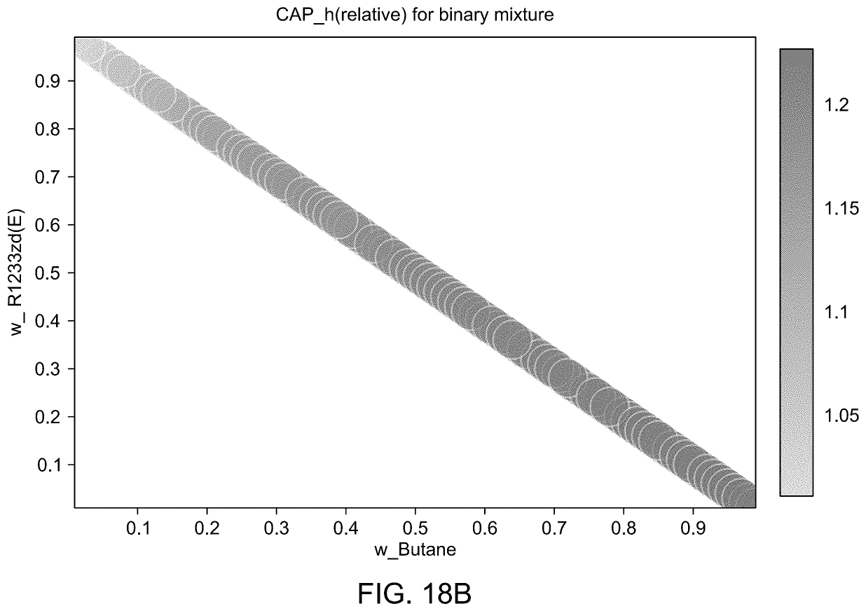

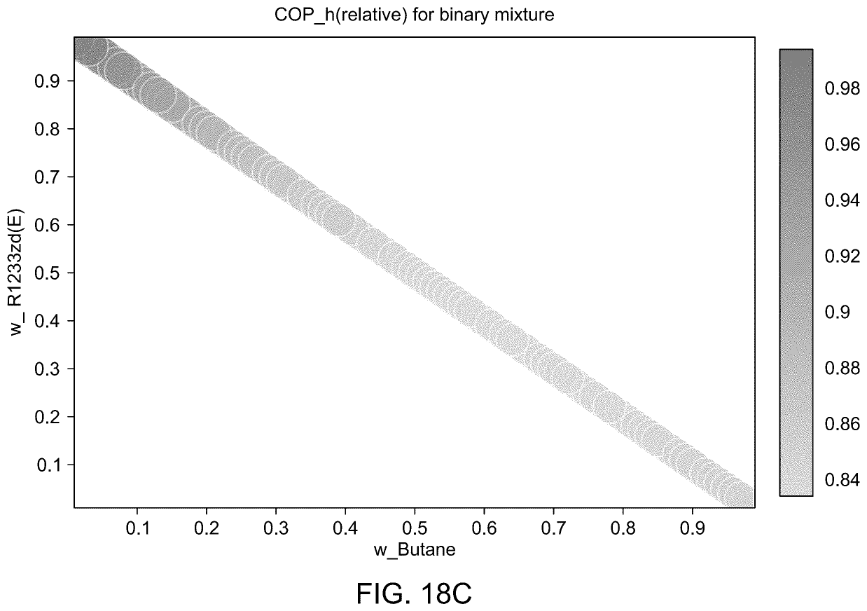

Refrigerant performance has been determined for an exemplary composition of the present invention comprising HCFO-1233zd(E) and butane in high temperature heat pump systems as compared to HCFO-1233zd(E). Performance metric and composition property ranges are summarized in Table 41, where the ASHRAE flammability class remains 1, the average temperature glide is <about 1.5 K and GWP is about 1. Table 42 tabulates several compositions about the compositions of optimal heating efficiency and capacity. FIGS. 18A, 18B and 18C provide graphical representations of the average glide, the CAP for heating relative to the incumbent fluid, and the COP for heating relative to the incumbent fluid, respectively, for a composition according to Example 19.

TABLE 41
High Temperature Heat Pump Conditions, cycle metric performance
and fluid property ranges for 1233zdE/butane in Ex. 19

Flammability = 1

| | MAXIMA | MINIMA |
|---|---|---|
| w_R1233zd(E) | 100 | 89 |
| w_butane | 11 | 0 |
| T° c. (degC.) | 166.45 | 158.9 |
| avg glide_h (K) | 1.5 | 0 |
| COP_h (% dev) | 100 | 93.9 |
| CAP_h (% dev) | 109.2 | 100 |

TABLE 42
High Temperature Heat Pump Conditions, cycle metric performance
and fluid property ranges for 1233zdE/butane in Ex. 19

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| butane | R1233zdE | (K) | AR5 | (kcal/g) | (kg/m\hat{ }3) | Class | R1336mzzE | R1336mzzE |
| 0.01 | 0.99 | 0.2806 | 1.02 | 2.1966 | 0.299087405 | 1 | 0.994031012 | 1.010694342 |
| 0.02 | 0.98 | 0.5233 | 1.04 | 2.2832 | 0.282239664 | 1 | 0.988080958 | 1.020813332 |
| 0.03 | 0.97 | 0.732 | 1.06 | 2.3698 | 0.267188787 | 1 | 0.982130903 | 1.030450465 |
| 0.04 | 0.96 | 0.9103 | 1.08 | 2.4564 | 0.253661867 | 1 | 0.976552727 | 1.039545509 |
| 0.05 | 0.95 | 1.0612 | 1.1 | 2.543 | 0.241438597 | 1 | 0.97097455 | 1.048218929 |
| 0.06 | 0.94 | 1.1876 | 1.12 | 2.6296 | 0.230339183 | 1 | 0.965396374 | 1.056410493 |
| 0.07 | 0.93 | 1.292 | 1.14 | 2.7162 | 0.22021544 | 1 | 0.959818198 | 1.064240663 |
| 0.08 | 0.92 | 1.3767 | 1.16 | 2.8028 | 0.210944138 | 1 | 0.9546119 | 1.071649209 |
| 0.09 | 0.91 | 1.4437 | 1.18 | 2.8894 | 0.20242196 | 1 | 0.949405602 | 1.078696363 |
| 0.10 | 0.9 | 1.495 | 1.2 | 2.976 | 0.194561637 | 1 | 0.944199304 | 1.085382124 |
| 0.11 | 0.89 | 1.5322 | 1.22 | 3.0626 | 0.187288951 | 1 | 0.939364885 | 1.091766725 |

Results show that the HCFO-1233zd(E) and butane compositions of the present invention provide improved CAP and similar energy efficiency relative to HCFO-1233zd(E), at lower costs, for heating using high temperature heat pump systems. Additionally, in many cases, the HCFO-1233zd(E) and butane compositions of the present invention provide improved heating capacity relative to HCFO-1233zd(E), at lower costs. Up to 11 wt % butane can be added to blends of these two components, where the ASHRAE flammability classification will remain 1.

### Example 20: HCFO-1233zd(E)/Isobutane

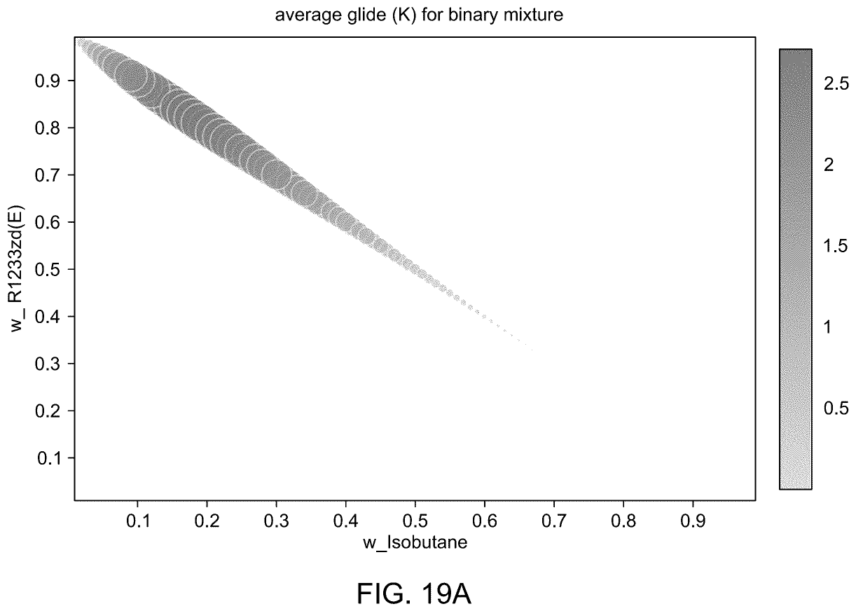

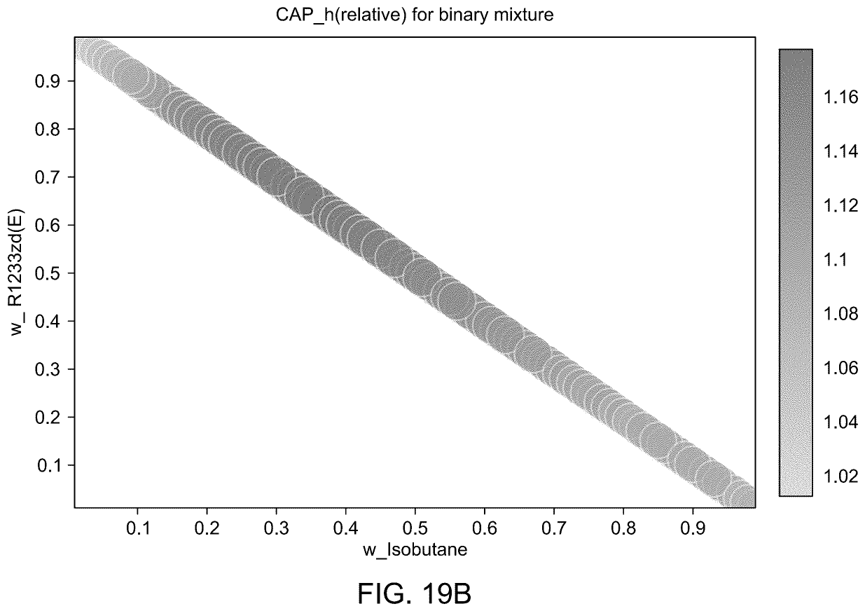

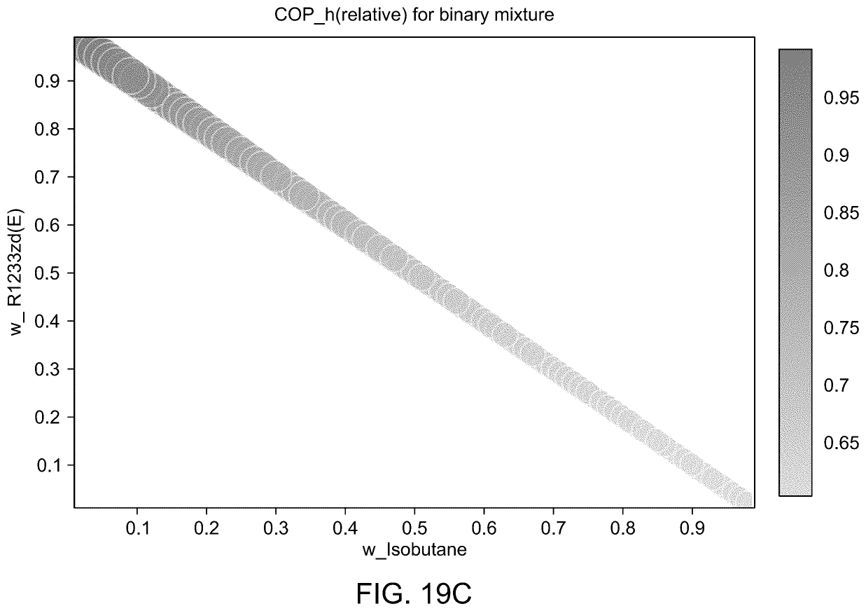

Refrigerant performance has been determined for an exemplary composition of the present invention comprising HCFO-1233zd(E) and isobutane in high temperature heat pump systems as compared to HCFO-1233zd(E). Performance metric and composition property ranges are summarized in Table 43, where the ASHRAE flammability class remains 1, the average temperature glide is <about 2.5 K and GWP is about 1. Table 44 tabulates several compositions about the compositions of optimal heating efficiency and capacity. FIGS. 19A, 19B and 19C provide graphical representations of the average glide, the CAP for heating relative to the incumbent fluid, and the COP for heating relative to the incumbent fluid, respectively, for a composition according to Example 20.

TABLE 43
High Temperature Heat Pump Conditions, cycle metric performance
and fluid property ranges for 1233zdE/isobutane in Ex. 20

Flammability = 1

| | MAXIMA | MINIMA |
|---|---|---|
| w_R1233zd(E) | 100 | 89 |
| w_isobutane | 11 | 0 |
| T° c. (degC.) | 166.45 | 156.8 |
| avg glide_h (K) | 2.5 | 0 |
| COP_h (% dev) | 100 | 92.1 |
| CAP_h (% dev) | 110.9 | 100 |

TABLE 44
High Temperature Heat Pump Conditions, cycle metric performance
and fluid property ranges for 1233zdE/isobutane in Ex. 20

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| isobutane | R1233zdE | (K) | AR5 | (kcal/g) | (kg/m\hat{ }3) | Class | R1336mzzE | R1336mzzE |
| 0.01 | 0.99 | 0.414 | 1.02 | 2.1963 | 0.299123326 | 1 | 0.992543499 | 1.012802465 |
| 0.02 | 0.98 | 0.7801 | 1.04 | 2.2826 | 0.282303646 | 1 | 0.985477809 | 1.024969346 |
| 0.03 | 0.97 | 1.1025 | 1.06 | 2.3689 | 0.267274806 | 1 | 0.97804024 | 1.036533905 |
| 0.04 | 0.96 | 1.3851 | 1.08 | 2.4552 | 0.253765248 | 1 | 0.97097455 | 1.047496144 |
| 0.05 | 0.95 | 1.6316 | 1.1 | 2.5415 | 0.241555679 | 1 | 0.963536982 | 1.05779583 |
| 0.06 | 0.94 | 1.8451 | 1.12 | 2.6278 | 0.230467069 | 1 | 0.956471292 | 1.06761366 |
| 0.07 | 0.93 | 2.0286 | 1.14 | 2.7141 | 0.220351823 | 1 | 0.949033724 | 1.076829168 |
| 0.08 | 0.92 | 2.1849 | 1.16 | 2.8004 | 0.211087164 | 1 | 0.941968034 | 1.08556282 |
| 0.09 | 0.91 | 2.3164 | 1.18 | 2.8867 | 0.202570133 | 1 | 0.934902344 | 1.093814616 |
| 0.10 | 0.9 | 2.4255 | 1.2 | 2.973 | 0.194713744 | 1 | 0.927836654 | 1.101524322 |
| 0.11 | 0.89 | 2.5141 | 1.22 | 3.0593 | 0.187444001 | 1 | 0.920770964 | 1.108812404 |

Results show that the HCFO-1233zd(E) and isobutane compositions of the present invention provide improved CAP and similar energy efficiency relative to HCFO-1233zd(E), at lower costs, for heating using high temperature heat pump systems. Additionally, in many cases, the HCFO-1233zd(E) and isobutane compositions of the present invention provide improved heating capacity relative to HCFO-1233zd(E), at lower costs. Up to 11 wt % isobutane can be added to blends of these two components, where the ASHRAE flammability classification will remain 1.

### Example 21: HCFO-1233zd(E)/Pentane

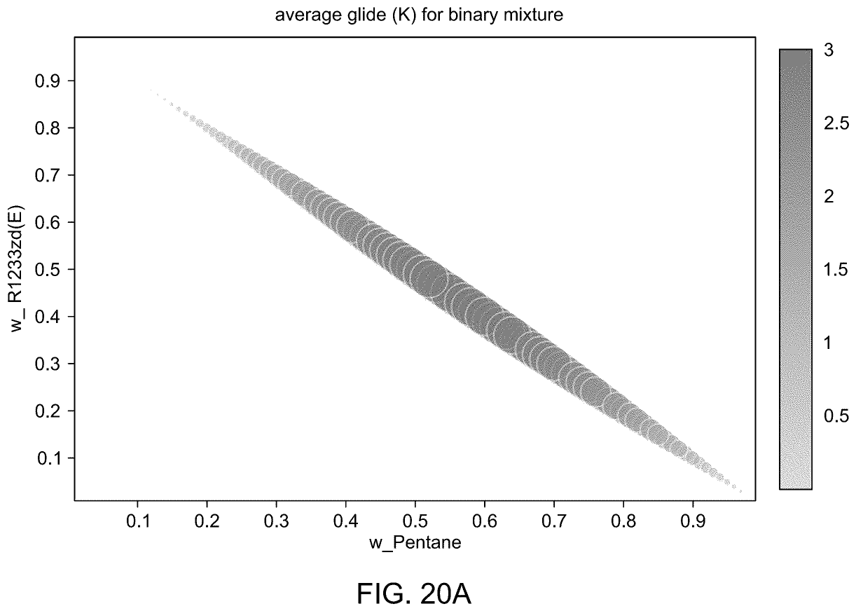

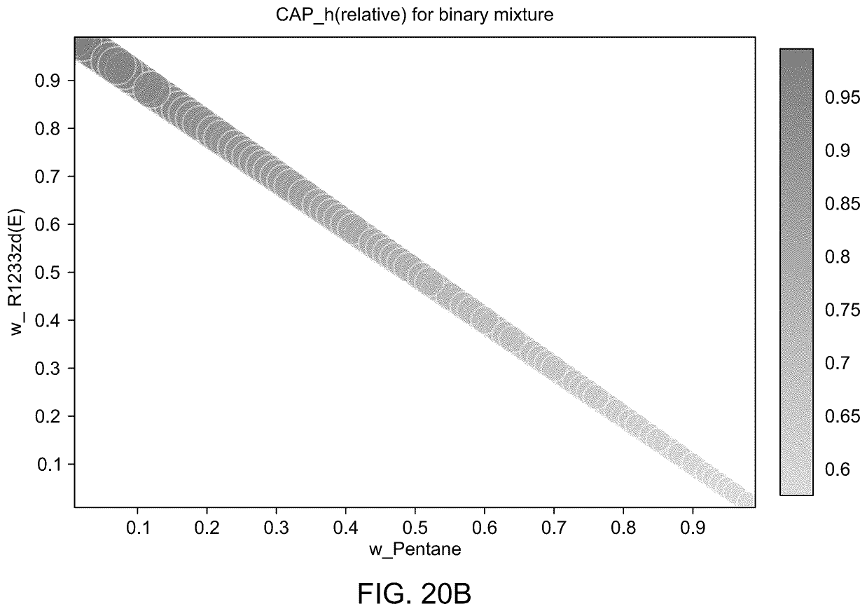

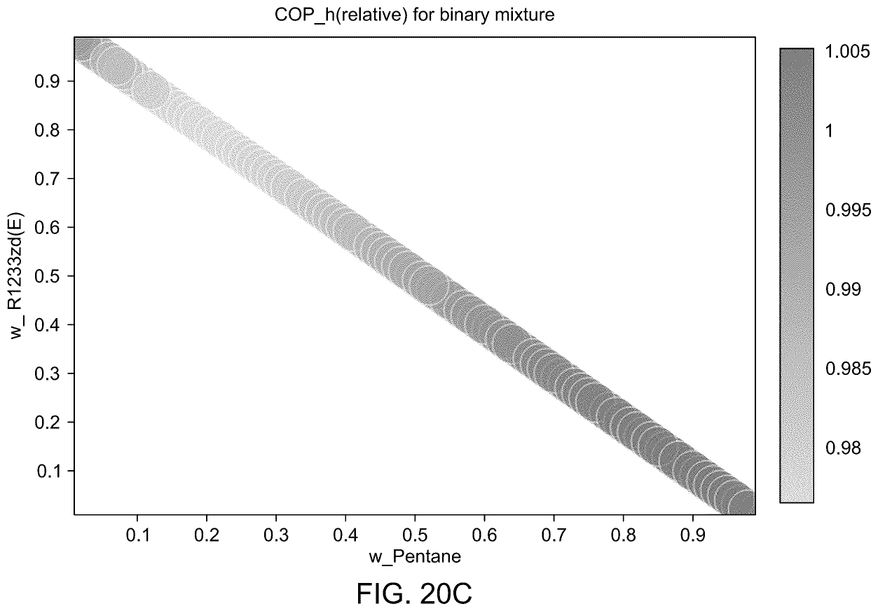

Refrigerant performance has been determined for an exemplary composition of the present invention comprising HCFO-1233zd(E) and pentane in high temperature heat pump systems as compared to HCFO-1233zd(E). Performance metric and composition property ranges are summarized in Table 45, where the ASHRAE flammability class remains 1, the average temperature glide is <0.3 K and GWP is less than 2.5. Table 46 tabulates several compositions about the compositions of optimal heating efficiency and capacity. FIGS. 20A, 20B and 20C provide graphical representations of the average glide, the CAP for heating relative to the incumbent fluid, and the COP for heating relative to the incumbent fluid, respectively, for a composition according to Example 21.

TABLE 45
High Temperature Heat Pump Conditions, cycle metric performance
and fluid property ranges for 1233zdE/pentane in Ex. 21

Flammability = 1

| | MAXIMA | MINIMA |
|---|---|---|
| w_R1233zd(E) | 100 | 88 |
| w_pentane | 12 | 0 |
| T° c. (degC.) | 167.5 | 166.45 |
| avg glide_h (K) | 0.3 | 0 |
| COP_h (% dev) | 100 | 98 |
| CAP_h (% dev) | 100 | 94.2 |

TABLE 46
High Temperature Heat Pump Conditions, cycle metric performance
and fluid property ranges for 1233zdE/pentane in Ex. 21

| | | Avg. | | del_h_{—} | | ASHRAE | COP_h (% | CAP_h (% |
|---|---|---|---|---|---|---|---|---|
| wt-% | wt-% | Glide | GWP | comb | LFL | Flammability | dev from | dev from |
| pentane | R1233zdE | (K) | AR5 | (kcal/g) | (kg/m\hat{ }3) | Class | R1336mzzE | R1336mzzE |
| 0.01 | 0.99 | 0.0031 | 1.1 | 2.1959 | 0.301545474 | 1 | 0.997377918 | 0.995515857 |
| 0.02 | 0.98 | 0.0085 | 1.2 | 2.2818 | 0.286649704 | 1 | 0.995146648 | 0.990877987 |
| 0.03 | 0.97 | 0.0167 | 1.3 | 2.3677 | 0.273156305 | 1 | 0.992915377 | 0.986240117 |
| 0.04 | 0.96 | 0.0281 | 1.4 | 2.4536 | 0.260876139 | 1 | 0.990684107 | 0.981481782 |
| 0.05 | 0.95 | 0.0433 | 1.5 | 2.5395 | 0.249652618 | 1 | 0.988824715 | 0.976723448 |
| 0.06 | 0.94 | 0.0624 | 1.6 | 2.6254 | 0.239354989 | 1 | 0.986965322 | 0.971844649 |
| 0.07 | 0.93 | 0.0859 | 1.7 | 2.7113 | 0.229873217 | 1 | 0.985477809 | 0.96696585 |
| 0.08 | 0.92 | 0.1141 | 1.8 | 2.7972 | 0.22111404 | 1 | 0.983990295 | 0.962026819 |
| 0.09 | 0.91 | 0.1469 | 1.9 | 2.8831 | 0.212997886 | 1 | 0.98287466 | 0.957087789 |
| 0.10 | 0.9 | 0.1847 | 2 | 2.969 | 0.205456456 | 1 | 0.981759025 | 0.952088526 |
| 0.11 | 0.89 | 0.2274 | 2.1 | 3.0549 | 0.19843079 | 1 | 0.980643389 | 0.947029031 |
| 0.12 | 0.88 | 0.2751 | 2.2 | 3.1408 | 0.191869728 | 1 | 0.979899632 | 0.941969536 |

Results show that the HCFO-1233zd(E) and pentane compositions of the present invention provide similar CAP and similar energy efficiency relative to HCFO-1233zd(E), at lower costs, for heating using high temperature heat pump systems. Up to 12 wt % pentane can be added to blends of these two components, where the ASHRAE flammability classification will remain 1.

### Performance Examples for Medium Temperature

### Refrigeration Systems Comprising HFO Compositions

In the below Tables, “T_condenser” is condenser temperature, “T_evaporator” is evaporator temperature, “COP” is coefficient of performance (analogous to energy efficiency), and “CAP” is volumetric cooling capacity. In Examples 22-29, refrigerant performance has been determined for an exemplary composition of the present invention in medium temperature refrigeration systems as compared to HFO-1234ze(Z) or HFO-1336mzz(E). It will be understood by those skilled in the art that the weight percents in the refrigerant performance data are nominal weight fractions. The data are based on the conditions set forth in Table 47.

TABLE 47
Medium Temperature Refrigeration Conditions

| | | |
|---|---|---|
| T_condenser | 40° | C. |
| T_evaporator | −7.0° | C. |
| T_return | 18° | C. |

| | |
|---|---|
| Compressor Efficiency | 0.7 |

### Example 22: HFO-1336mzz(E)/Butane/HFC-134

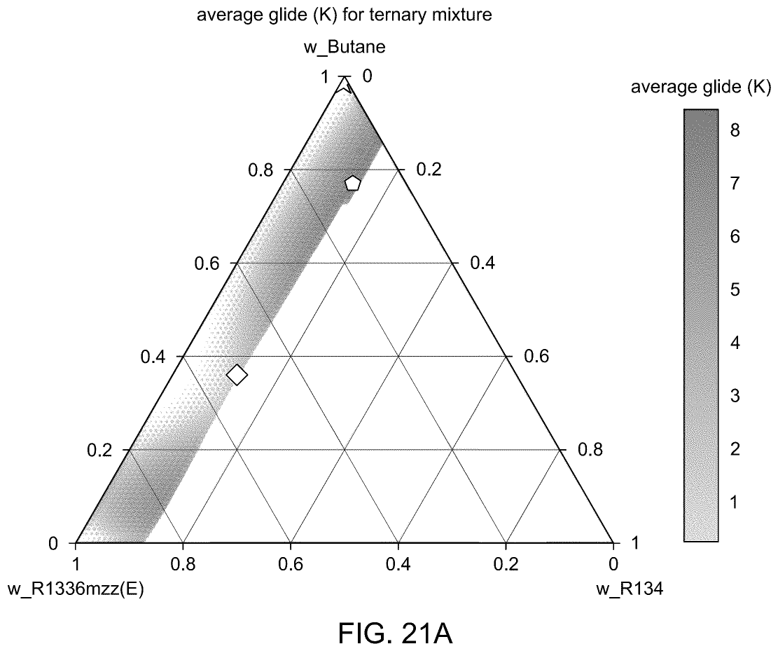

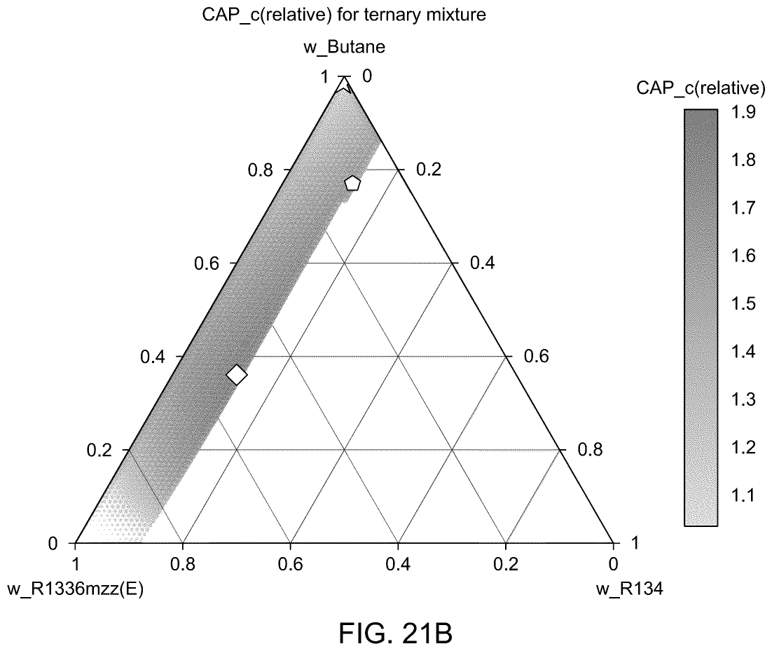

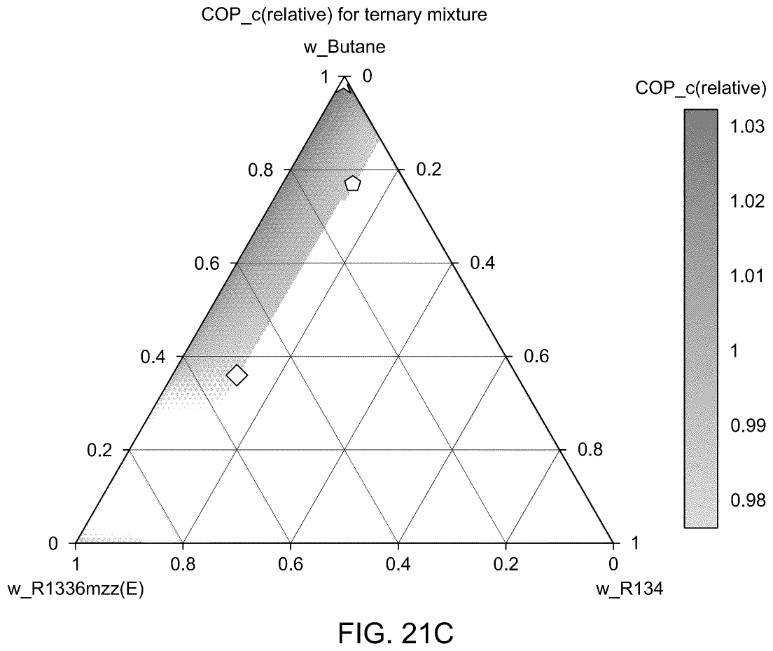

Refrigerant performance has been determined for an exemplary composition of the present invention comprising HFO-1336mzz(E), butane and HFC-134 in medium temperature refrigeration systems as compared to HFO-1336mzz(E). Performance metric and composition property ranges are summarized in Table 48, where the ASHRAE flammability class remains 1, 2L or 2, the average temperature glide is <8 K and GWP<150. Table 49 tabulates several compositions about the compositions of optimal coaling efficiency and capacity. FIGS. 21A, 21B and 21C provide graphical representations of the average glide, the CAP for cooling relative to the incumbent fluid, and the COP for coaling relative to the incumbent fluid, respectively, for a composition according to Example 22.

TABLE 48
Medium Temp Refrigeration System, cycle metric performance
and fluid property ranges for 1336mzzE/butane/134 in Ex. 22

| | MAXIMA | MINIMA |
|---|---|---|
| w_R1336mzz(E) (nominal weight fraction) | 1 | 0.71 |
| w_butane (nominal weight fraction) | 0.17 | 0 |
| w_R134 (nominal weight fraction) | 0.12 | 0 |
| T° c. (degC.) | 130 | 121 |
| average glide (K) | 7.2 | 0 |
| GWP AR5 | 148 | 19 |
| COP_c (% dev from R1336mzzE) | 1 | 0.98 |
| CAP_c (% dev from R1336mzzE) | 1.72 | 1.04 |

TABLE 49
Medium Temp Refrigeration System, cycle metric performance
and fluid property ranges for 1336mzzE/butane/134 in Ex. 22

| | | | Avg. | | COP_c (% | CAP_c (% | ASHRAE |
|---|---|---|---|---|---|---|---|
| wt-% | wt-% | wt-% | Glide | GWP | dev from | dev from | Flammability |
| Butane | R1336mzz(E) | R134 | (K) | AR5 | R1336mzzE | R1336mzzE | Class |
| 0 | 1 | 0 | 0 | 16 | 1 | 1 | 1 |
| 0.005 | 0.8756 | 0.1194 | 4.4908 | 147.7526 | 0.989160396 | 1.254912259 | 1 |
| 0.01 | 0.96 | 0.03 | 2.1075 | 48.99 | 0.991327571 | 1.092888407 | 1 |
| 0.02 | 0.93 | 0.05 | 3.5122 | 70.94 | 0.986683625 | 1.168161068 | 1 |
| 0.03 | 0.9 | 0.07 | 4.6848 | 92.89 | 0.983897258 | 1.244758175 | 1 |
| 0.04 | 0.87 | 0.09 | 5.6551 | 114.84 | 0.982349276 | 1.322017505 | 1 |
| 0.05 | 0.84 | 0.11 | 6.4464 | 136.79 | 0.981730083 | 1.399497576 | 1 |
| 0.0597 | 0.9353 | 0.005 | 3.7008 | 20.7439 | 0.984206854 | 1.203479619 | 1 |
| 0.06 | 0.92 | 0.02 | 4.2184 | 37.3 | 0.983278065 | 1.235928538 | 1 |
| 0.07 | 0.89 | 0.04 | 5.0701 | 59.25 | 0.98203968 | 1.308552308 | 1 |
| 0.08 | 0.86 | 0.06 | 5.7749 | 81.2 | 0.981420487 | 1.38161756 | 2L |
| 0.09 | 0.83 | 0.08 | 6.3437 | 103.15 | 0.981110891 | 1.45424133 | 2L |
| 0.1 | 0.81 | 0.09 | 6.5789 | 114.06 | 0.981110891 | 1.503687301 | 2L |
| 0.11 | 0.77 | 0.12 | 7.1138 | 147.05 | 0.980801294 | 1.597502202 | 2 |
| 0.11 | 0.88 | 0.01 | 4.4844 | 25.61 | 0.984206854 | 1.350051605 | 2 |
| 0.12 | 0.85 | 0.03 | 5.0285 | 47.56 | 0.983278065 | 1.417377592 | 2 |
| 0.13 | 0.82 | 0.05 | 5.4672 | 69.51 | 0.98203968 | 1.484041357 | 2 |
| 0.14 | 0.79 | 0.07 | 5.8067 | 91.46 | 0.981110891 | 1.550042899 | 2 |
| 0.15 | 0.76 | 0.09 | 6.0549 | 113.41 | 0.979872505 | 1.615161477 | 2 |
| 0.16 | 0.73 | 0.11 | 6.2216 | 135.36 | 0.97863412 | 1.67917635 | 2 |
| 0.17 | 0.71 | 0.12 | 6.1706 | 146.27 | 0.978014927 | 1.719351202 | 2 |

Results show that the HFO-1336mzz(E), butane and HFC-134 compositions of the present invention provide improved COP or similar energy efficiency relative to HFO-1336mzz(E), at lower costs, in medium temperature refrigeration systems. Additionally, in many cases, the HFO-1336mzz(E), butane and HFC-134 compositions of the present invention provide improved coaling capacity relative to HFO-1336mzz(E), at lower costs. It was determined that up to 7 wt %, 10 wt % and 17 wt % butane can be added to a mixture of these components and maintain an ASHRAE flammability classification of 1, 2L and 2 respectively. The max CAP_c (72% greater than that of R-1336mzzE) in this range is at 17/71/112 wt-% butane/R-1336mzzE/HFO-134 and is a class 2.

### Example 23: HFO-1234ze(Z)/Isobutane

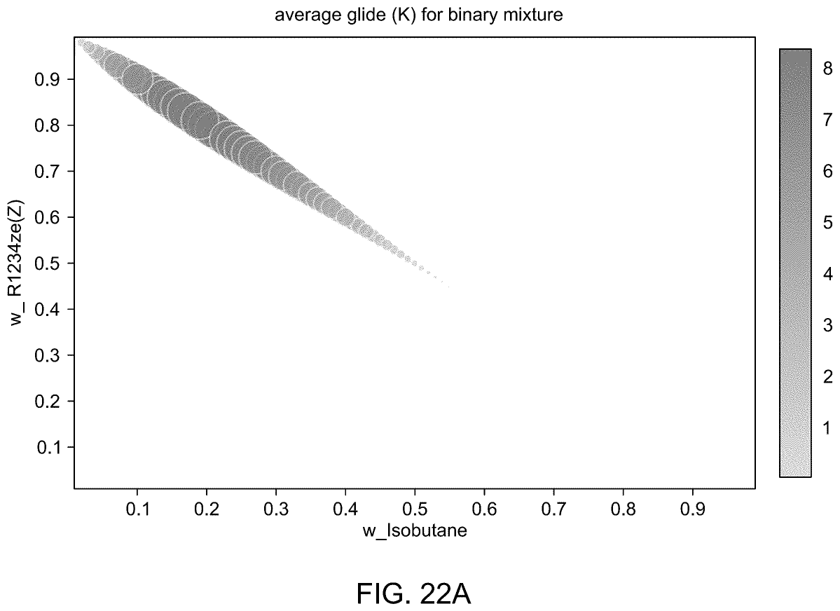

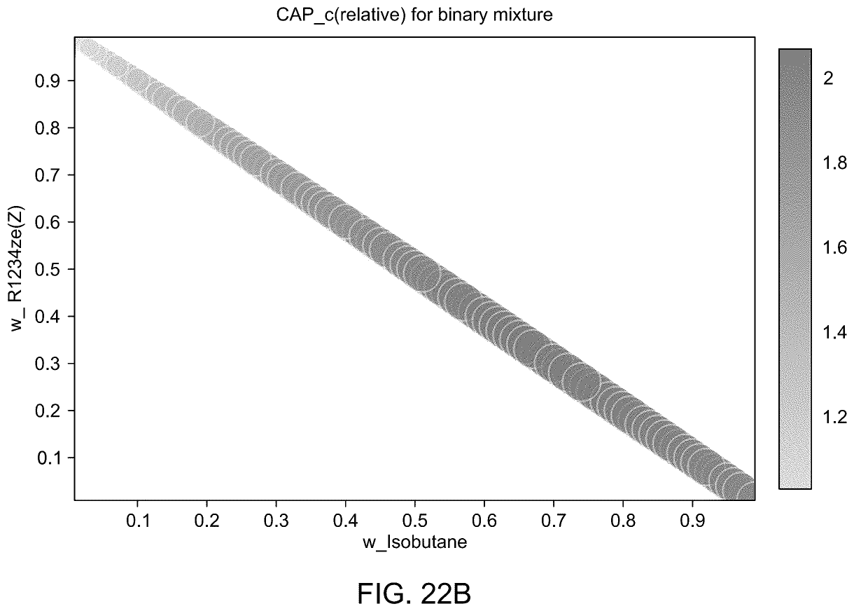

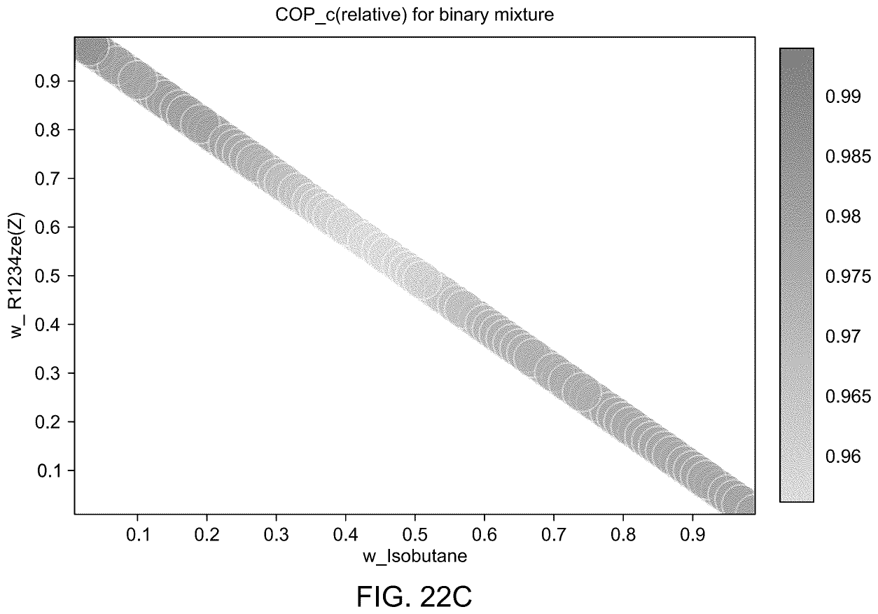

Refrigerant performance has been determined for an exemplary composition of the present invention comprising HFO-1234ze(Z) and isobutane in medium temperature refrigeration systems as compared to HFO-1234ze(Z). Performance metric and composition property ranges are summarized in Table 50, where the ASHRAE flammability class remains 2L or 2, the average temperature glide is <9 K and GWP<2. Table 51 tabulates several compositions about the compositions of optimal coaling efficiency and capacity. FIGS. 22A, 22B and 22C provide graphical representations of the average glide, the CAP for cooling relative to the incumbent fluid, and the COP for coaling relative to the incumbent fluid, respectively, for a composition according to Example 23.

TABLE 50
Medium Temp Refrigeration System, cycle metric performance
and fluid property ranges for 1234zeZ/isobutane in Ex. 23

| | MAXIMA | MINIMA |
|---|---|---|
| w_R1234ze(Z) (nominal weight fraction) | 1 | 0.87 |
| w_isobutane (nominal weight fraction) | 0.13 | 0 |
| T° c. (degC.) | 149 | 140 |
| average glide (K) | 7.8 | 0 |
| GWP AR5 | 1.2 | 1 |
| COP_c (% dev from R1234zeZ) | 1 | 0.98 |
| CAP_c (% dev from R1234zeZ) | 1.39 | 1.03 |

TABLE 51
Medium Temp Refrigeration System, cycle metric performance
and fluid property ranges for 1234zeZ/isobutane in Ex. 23

| | | Avg. | | COP_c (% | CAP_c (% | ASHRAE |
|---|---|---|---|---|---|---|
| wt-% | wt-% | Glide | GWP | dev from | dev from | Flammability |
| Isobutane | R1234ze(Z) | (K) | AR5 | R1234zeZ | R1234zeZ | Class |
| 0 | 1 | 0 | 1 | 1 | 1 | 2L |
| 0.01 | 0.99 | 1.1053 | 1.02 | 0.993980121 | 1.031128544 | 2L |
| 0.02 | 0.98 | 2.0976 | 1.04 | 0.989513463 | 1.06250975 | 2L |
| 0.03 | 0.97 | 2.9873 | 1.06 | 0.985940138 | 1.093668394 | 2L |
| 0.04 | 0.96 | 3.7837 | 1.08 | 0.983260143 | 1.124604476 | 2L |
| 0.05 | 0.95 | 4.495 | 1.1 | 0.981175703 | 1.155317996 | 2 |
| 0.06 | 0.94 | 5.1283 | 1.12 | 0.979984595 | 1.185808954 | 2 |
| 0.07 | 0.93 | 5.6899 | 1.14 | 0.979091263 | 1.215854789 | 2 |
| 0.08 | 0.92 | 6.1855 | 1.16 | 0.978495709 | 1.245455501 | 2 |
| 0.09 | 0.91 | 6.6201 | 1.18 | 0.978197932 | 1.27483365 | 2 |
| 0.1 | 0.9 | 6.998 | 1.2 | 0.978197932 | 1.303544115 | 2 |
| 0.11 | 0.89 | 7.3232 | 1.22 | 0.978495709 | 1.331809456 | 2 |
| 0.12 | 0.88 | 7.5992 | 1.24 | 0.978495709 | 1.359407112 | 2 |
| 0.13 | 0.87 | 7.829 | 1.26 | 0.978793486 | 1.386337083 | 2 |

Results show that the HFO-1234ze(Z) and isobutane compositions of the present invention provide improved CAP or similar energy efficiency relative to HFO-1234ze(Z), at lower costs, in medium temperature refrigeration systems. Additionally, in many cases, the HFO-1234ze(Z) and isobutane compositions of the present invention provide improved cooling capacity relative to HFO-1234ze(Z), at lower costs. It was determined that up to 4 wt % and 13 wt % isobutane can be added to a mixture of these components and maintain an ASHRAE flammability classification of 2L and 2 respectively. The max CAP_c (39% greater than that of R-1234zeZ) in this range is at 13/87 wt-% isobutane/R-1234zeZ and is a class 2.

### Example 24: HFO-1234ze(Z)/Butane

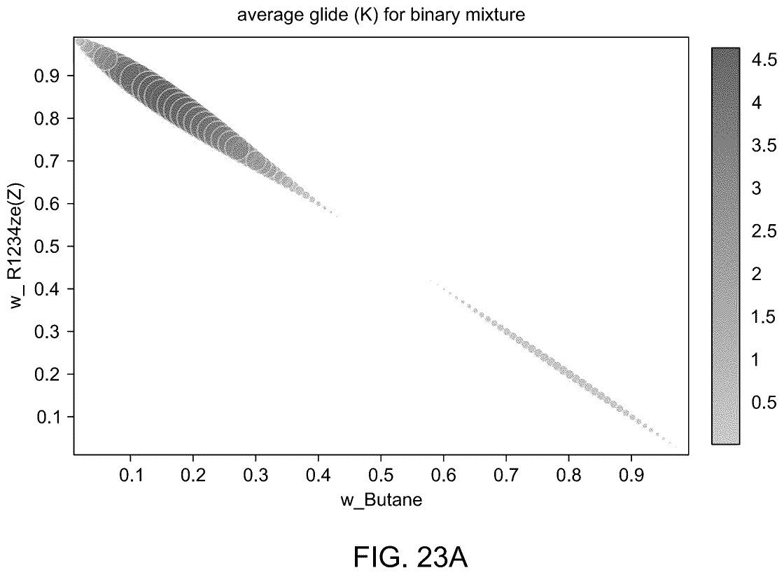

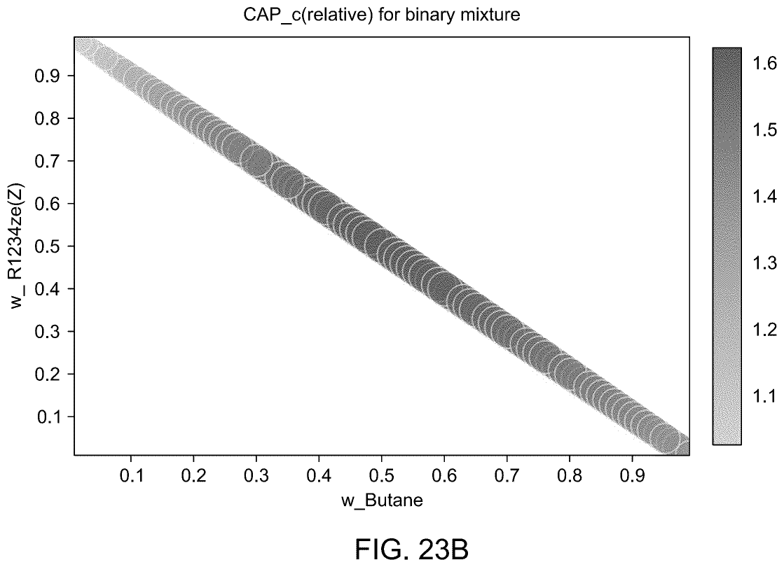

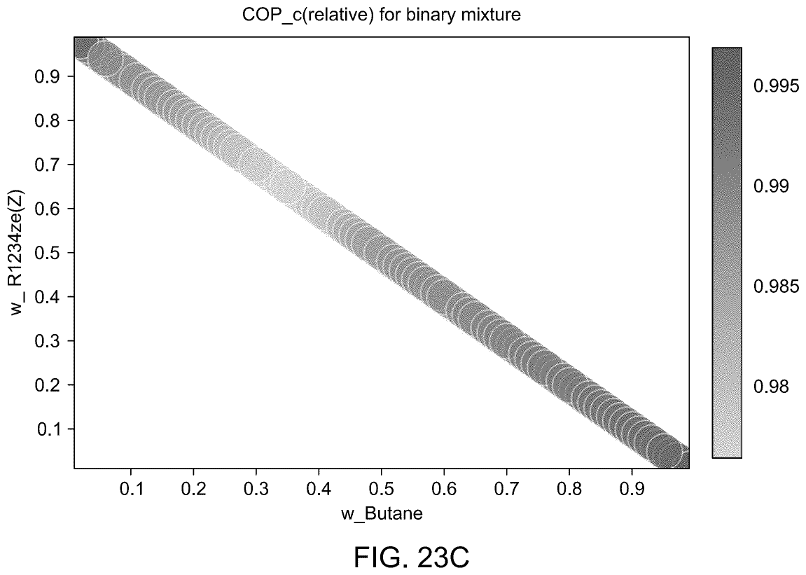

Refrigerant performance has been determined for an exemplary composition of the present invention comprising HFO-1234ze(Z) and butane in medium temperature refrigeration systems as compared to HFO-1234ze(Z). Performance metric and composition property ranges are summarized in Table 52, where the ASHRAE flammability class remains 2L or 2, the average temperature glide is <9 K and GWP<2. Table 53 tabulates several compositions about the compositions of optimal cooling efficiency and capacity. FIGS. 23A, 23B and 23C provide graphical representations of the average glide, the CAP for cooling relative to the incumbent fluid, and the COP for cooling relative to the incumbent fluid, respectively, for a composition according to Example 24.

TABLE 52
Medium Temp Refrigeration System, cycle metric performance
and fluid property ranges for 1234zeZ/butane in Ex. 24

| | MAXIMA | MINIMA |
|---|---|---|
| w_R1234ze(Z) (nominal weight fraction) | 1 | 0.87 |
| w_butane (nominal weight fraction) | 0.13 | 0 |
| T° c. (degC.) | 149 | 142 |
| average glide (K) | 4.6 | 0 |
| GWP AR5 | 1 | 1 |
| COP_c (% dev from R1234zeZ) | 1 | 0.99 |
| CAP_c (% dev from R1234zeZ) | 1.29 | 1 |

TABLE 53
Medium Temp Refrigeration System, cycle metric performance
and fluid property ranges for 1234zeZ/butane in Ex. 24

| | | Avg. | | COP_c (% | CAP_c (% | ASHRAE |
|---|---|---|---|---|---|---|
| wt-% | wt-% | Glide | GWP | dev from | dev from | Flammability |
| Butane | R1234ze(Z) | (K) | AR5 | R1234zeZ | R1234zeZ | Class |
| 0 | 1 | 0 | 1 | 1 | 1 | 2L |
| 0.01 | 0.99 | 0.7128 | 1.02 | 0.996957892 | 1.025119377 | 2L |
| 0.02 | 0.98 | 1.347 | 1.04 | 0.994277898 | 1.049823731 | 2L |
| 0.03 | 0.97 | 1.9091 | 1.06 | 0.992491235 | 1.074305522 | 2L |
| 0.04 | 0.96 | 2.4046 | 1.08 | 0.991002349 | 1.09834219 | 2L |
| 0.05 | 0.95 | 2.8389 | 1.1 | 0.990109018 | 1.121711173 | 2 |
| 0.06 | 0.94 | 3.2163 | 1.12 | 0.989215686 | 1.144857594 | 2 |
| 0.07 | 0.93 | 3.5411 | 1.14 | 0.988620132 | 1.167113768 | 2 |
| 0.08 | 0.92 | 3.8171 | 1.16 | 0.988322355 | 1.18914738 | 2 |
| 0.09 | 0.91 | 4.0477 | 1.18 | 0.988024578 | 1.210290746 | 2 |
| 0.1 | 0.9 | 4.236 | 1.2 | 0.987726801 | 1.230766426 | 2 |
| 0.11 | 0.89 | 4.3848 | 1.22 | 0.987429023 | 1.250796982 | 2 |
| 0.12 | 0.88 | 4.4971 | 1.24 | 0.987429023 | 1.269937292 | 2 |
| 0.13 | 0.87 | 4.5752 | 1.26 | 0.987131246 | 1.288409917 | 2 |

Results show that the HFO-1234ze(Z) and butane compositions of the present invention provide improved CAP and similar energy efficiency relative to HFO-1234ze(Z), at lower costs, in medium temperature refrigeration systems. Additionally, in many cases, the HFO-1234ze(Z) and butane compositions of the present invention provide improved cooling capacity relative to HFO-1234ze(Z), at lower costs. It was determined that up to 4 wt % and 13 wt % butane can be added to a mixture of these components and maintain an ASHRAE flammability classification of 2L and 2 respectively. The max CAP_c (29% greater than that of R-1234zeZ) in this range is at 13/87 wt-% butane/R-1234zeZ and is a class 2.

### Example 25: HFO-1234ze(Z)/Pentane

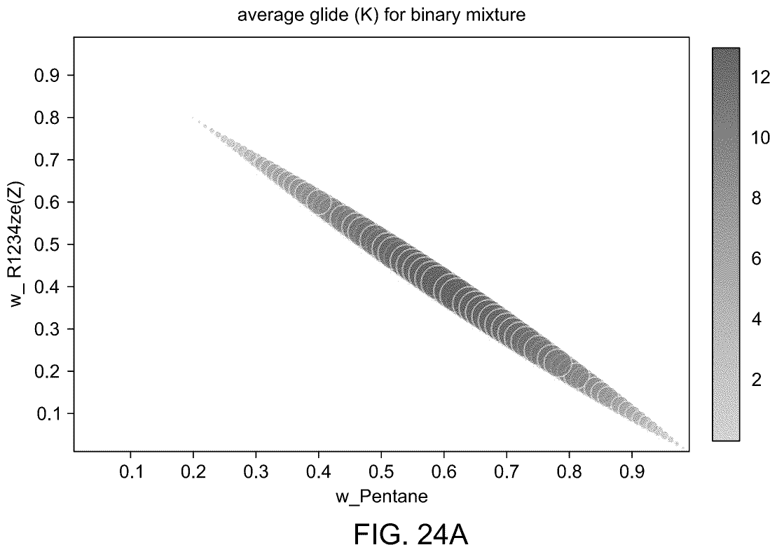

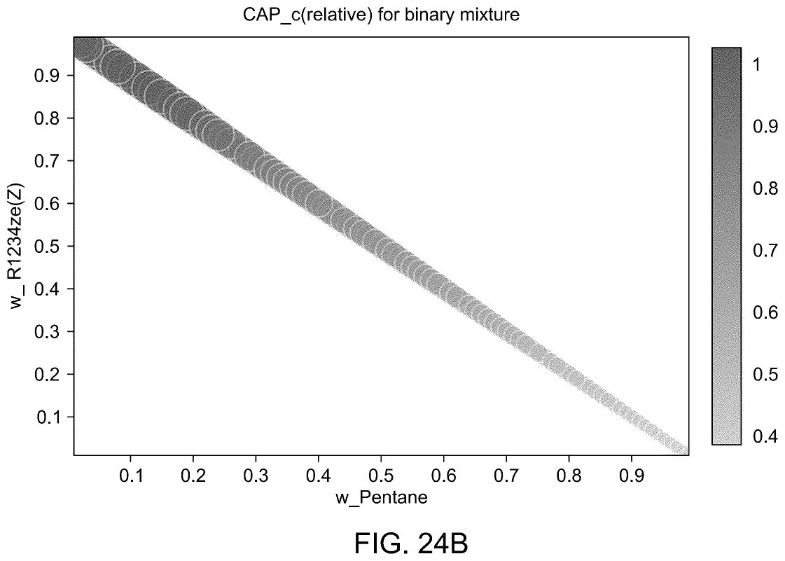

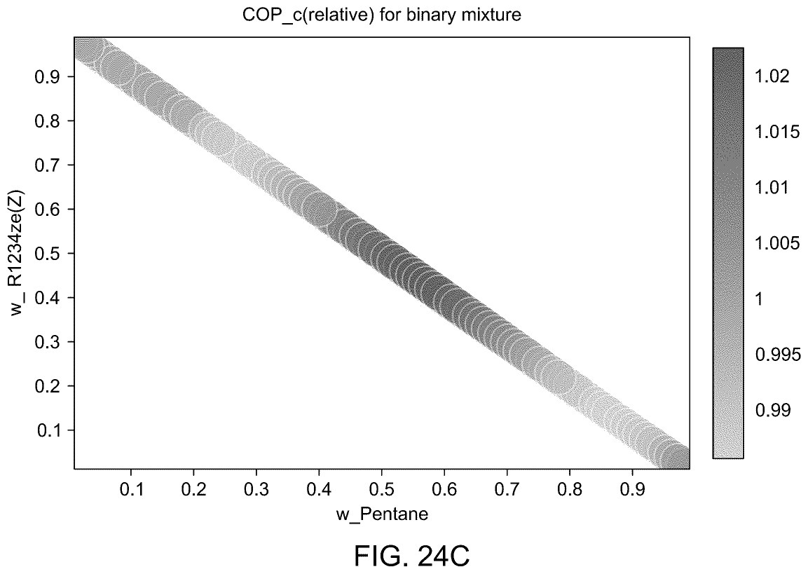

Refrigerant performance has been determined for an exemplary composition of the present invention comprising HFO-1234ze(Z) and pentane in medium temperature refrigeration systems as compared to HFO-1234ze(Z). Performance metric and composition property ranges are summarized in Table 54, where the ASHRAE flammability class remains 2L or 2, the average temperature glide is <1 K and GWP<3. Table 55 tabulates several compositions about the compositions of optimal cooling efficiency and capacity. FIGS. 24A, 24B and 24C provide graphical representations of the average glide, the CAP for cooling relative to the incumbent fluid, and the COP for coaling relative to the incumbent fluid, respectively, for a composition according to Example 25.

TABLE 54
Medium Temp Refrigeration System, cycle metric performance
and fluid property ranges for 1234zeZ/pentane in Ex. 25

| | MAXIMA | MINIMA |
|---|---|---|
| w_R1234ze(Z) (nominal weight fraction) | 1 | 0.87 |
| w_pentane (nominal weight fraction) | 0.13 | 0 |
| T° c. (degC.) | 150 | 149 |
| condenser glide (K) | 0.1 | 0 |
| GWP AR5 | 2.3 | 1 |
| COP_c (% dev from R1234zeZ) | 1 | 1 |
| CAP_c (% dev from R1234zeZ) | 1.03 | 1 |

TABLE 55
Medium Temp Refrigeration System, cycle metric performance
and fluid property ranges for 1234zeZ/pentane in Ex. 25

| | | Avg. | | COP_c (% | CAP_c (% | ASHRAE |
|---|---|---|---|---|---|---|
| wt-% | wt-% | Glide | GWP | dev from | dev from | Flammability |
| Pentane | R1234ze(Z) | (K) | AR5 | R1234zeZ | R1234zeZ | Class |
| 0 | 1 | 0 | 1 | 1 | 1 | 2L |
| 0.01 | 0.99 | 0.0541 | 1.1 | 0.999637886 | 1.005533944 | 2L |
| 0.02 | 0.98 | 0.0875 | 1.2 | 0.999340109 | 1.010430303 | 2L |
| 0.03 | 0.97 | 0.1039 | 1.3 | 0.999042332 | 1.014881537 | 2L |
| 0.04 | 0.96 | 0.1065 | 1.4 | 0.998744555 | 1.018442525 | 2L |
| 0.05 | 0.95 | 0.0987 | 1.5 | 0.998446778 | 1.02155839 | 2 |
| 0.06 | 0.94 | 0.0836 | 1.6 | 0.998149001 | 1.02422913 | 2 |
| 0.07 | 0.93 | 0.0645 | 1.7 | 0.998149001 | 1.026009624 | 2 |
| 0.08 | 0.92 | 0.0445 | 1.8 | 0.998149001 | 1.027567557 | 2 |
| 0.09 | 0.91 | 0.027 | 1.9 | 0.998149001 | 1.028457804 | 2 |
| 0.1 | 0.9 | 0.0152 | 2 | 0.998149001 | 1.028902927 | 2 |
| 0.11 | 0.89 | 0.0127 | 2.1 | 0.998149001 | 1.028680365 | 2 |
| 0.12 | 0.88 | 0.0232 | 2.2 | 0.998446778 | 1.02801268 | 2 |
| 0.13 | 0.87 | 0.0507 | 2.3 | 0.998446778 | 1.02667731 | 2 |

Results show that the HFO-1234ze(Z) and pentane compositions of the present invention provide improved CAP and similar energy efficiency relative to HFO-1234ze(Z), at lower costs, in medium temperature refrigeration systems. Additionally, in many cases, the HFO-1234ze(Z) and pentane compositions of the present invention provide improved coaling capacity relative to HFO-1234ze(Z), at lower costs. It was determined that up to 4 wt % and 13 wt % pentane can be added to a mixture of these components and maintain an ASHRAE flammability classification of 2L and 2 respectively. The max CAP_c (3% greater than that of R-1234ze(Z) in this range is at 13/87 wt-% Pentane/R-1234zeZ and is a class 2.

### Example 26: HFO-1234ze(E)/Butane

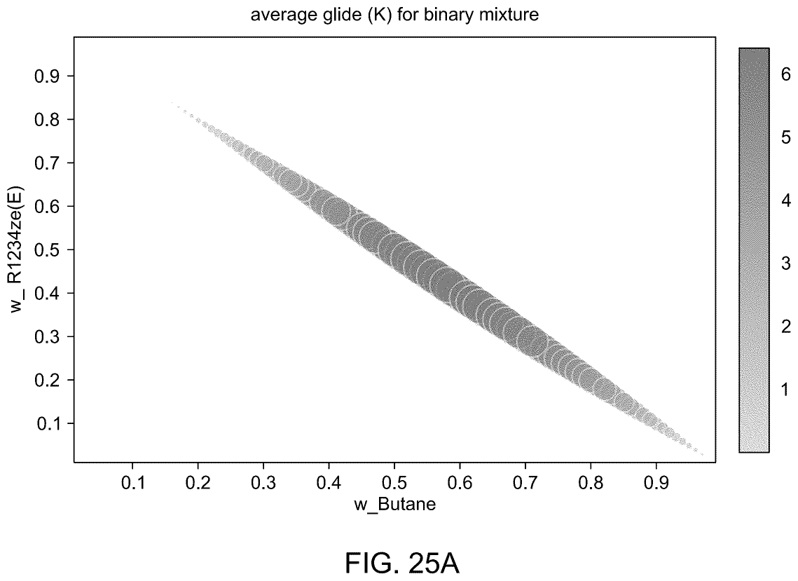

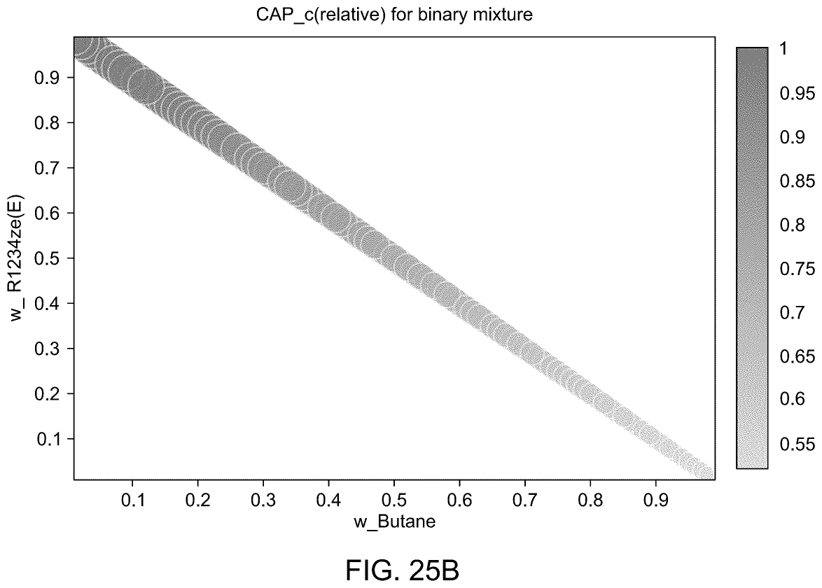

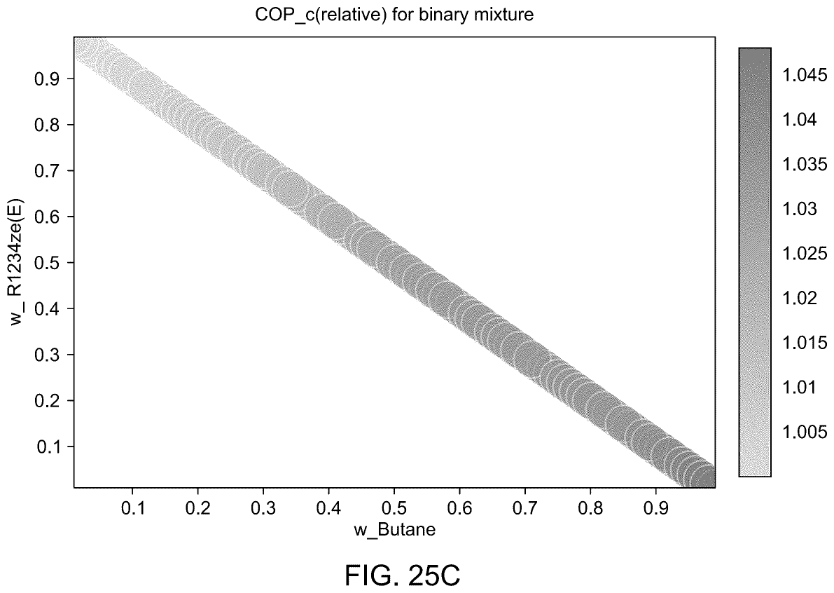

Refrigerant performance has been determined for an exemplary composition of the present invention comprising HFO-1234ze(E) and butane in medium temperature refrigeration systems as compared to HFO-1234ze(E). Performance metric and composition property ranges are summarized in Table 56, where the ASHRAE flammability class remains 2L or 2, the average temperature glide is <0.1 K and GWP<2. Table 57 tabulates several compositions about the compositions of optimal cooling efficiency and capacity. FIGS. 25A, 25B and 25C provide graphical representations of the average glide, the CAP for cooling relative to the incumbent fluid, and the COP for cooling relative to the incumbent fluid, respectively, for a composition according to Example 26.

TABLE 56
Medium Temp Refrigeration System, cycle metric performance
and fluid property ranges for 1234zeE/butane in Ex. 26

| | Flammability = 2L | | Flammability = 2 | |
|---|---|---|---|---|
| | MAXIMA | MINIMA | MAXIMA | MINIMA |
| w_R1234ze(E) | 100 | 96 | 95 | 87 |
| w_butane | 4 | 0 | 13 | 5 |
| T° c. (degC.) | 109.7 | 109.36 | 112 | 109.9 |
| avg glide_h (K) | <0.1 | 0 | 0.3 | <0.1 |
| COP_c (% dev) | 100 | 100 | 100 | 100 |
| CAP_c (% dev) | 100 | 100 | 100 | 98.1 |

TABLE 57
Medium Temp Refrigeration System, cycle metric performance
and fluid property ranges for 1234zeE/butane in Ex. 26

| | | Avg. | | del_h_{—} | | ASHRAE | COP_c (% | CAP_c (% |
|---|---|---|---|---|---|---|---|---|
| wt-% | wt-% | Glide | GWP | comb | LFL | flammability | dev from | dev from |
| Butane | R1234ze(E) | (K) | AR5 | (kcal/g) | (kg/m\hat{ }3) | class | R1234zeE | R1234zeE |
| 0.01 | 0.99 | 0.0024 | 1.02 | 2.3055 | 0.260708957 | 2L | 1.000052704 | 1.000900818 |
| 0.02 | 0.98 | 0.0031 | 1.04 | 2.391 | 0.248120049 | 2L | 1.000052704 | 1.00131915 |
| 0.03 | 0.97 | 0.0041 | 1.06 | 2.4765 | 0.236690906 | 2L | 1.000052704 | 1.001402816 |
| 0.04 | 0.96 | 0.007 | 1.08 | 2.562 | 0.226268318 | 2L | 1.000366298 | 1.001068151 |
| 0.05 | 0.95 | 0.0133 | 1.1 | 2.6475 | 0.216724924 | 2 | 1.000679893 | 1.000315153 |
| 0.06 | 0.94 | 0.0246 | 1.12 | 2.733 | 0.20795398 | 2 | 1.000993487 | 0.999143824 |
| 0.07 | 0.93 | 0.0422 | 1.14 | 2.8185 | 0.199865349 | 2 | 1.001307082 | 0.997637829 |
| 0.08 | 0.92 | 0.0674 | 1.16 | 2.904 | 0.192382395 | 2 | 1.001620676 | 0.995797169 |
| 0.09 | 0.91 | 0.1015 | 1.18 | 2.9895 | 0.185439543 | 2 | 1.002247865 | 0.993621843 |
| 0.1 | 0.9 | 0.1454 | 1.2 | 3.075 | 0.178980354 | 2 | 1.002875054 | 0.991028186 |
| 0.11 | 0.89 | 0.2002 | 1.22 | 3.1605 | 0.17295599 | 2 | 1.003188648 | 0.988099863 |
| 0.12 | 0.88 | 0.2667 | 1.24 | 3.246 | 0.167323972 | 2 | 1.003815837 | 0.984836874 |
| 0.13 | 0.87 | 0.3456 | 1.26 | 3.3315 | 0.162047181 | 2 | 1.004443026 | 0.98123922 |

Results show that the HFO-1234ze(E) and butane compositions of the present invention provide similar CAP or similar energy efficiency relative to HFO-1234ze(E), at lower costs, in medium temperature refrigeration systems. It was determined that up to 4 wt % and 13 wt % butane can be added to a mixture of these components and maintain an ASHRAE flammability classification of 2L and 2, respectively.

### Example 27: HFO-1234ze(E)/Isobutane

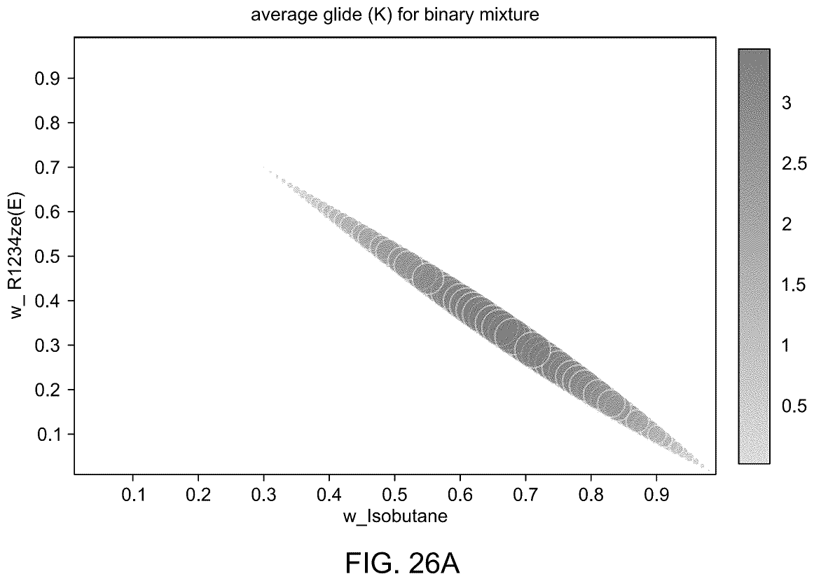

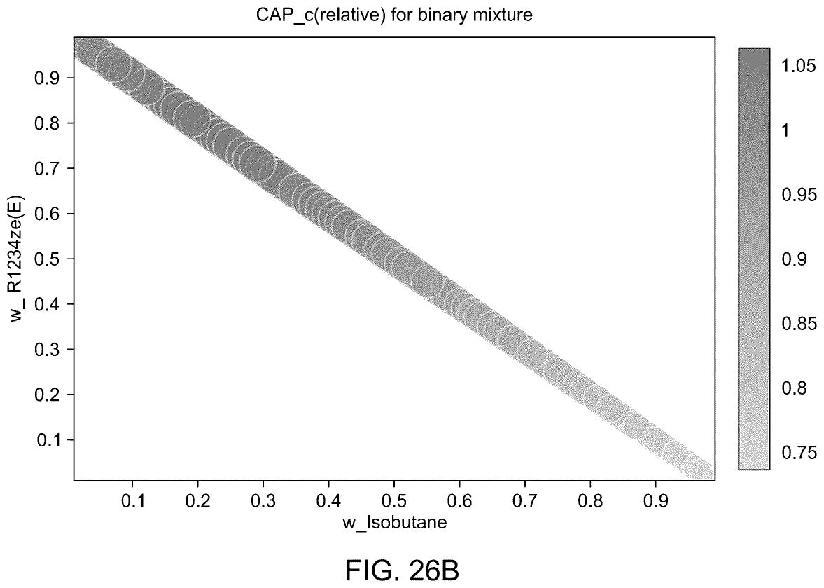

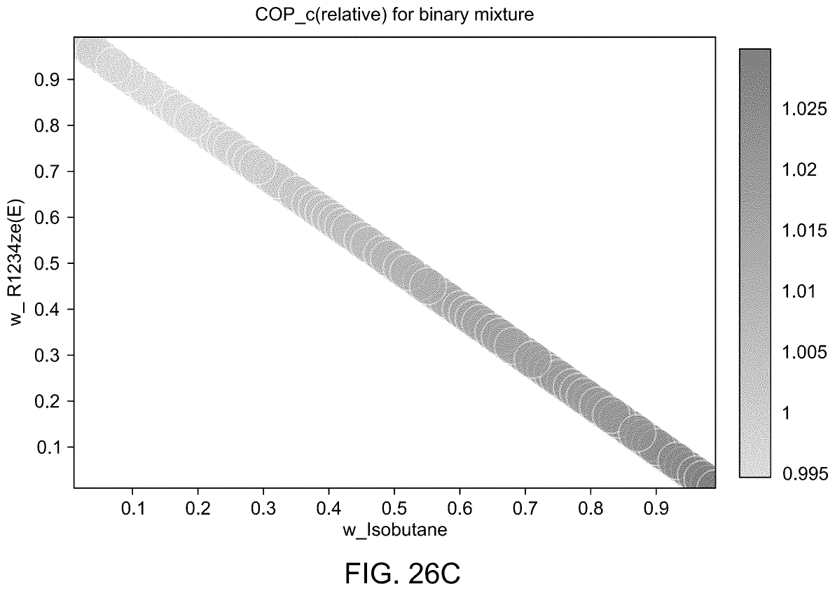

Refrigerant performance has been determined for an exemplary composition of the present invention comprising HFO-1234ze(E) and isobutane in medium temperature refrigeration systems as compared to HFO-1234ze(E). Performance metric and composition property ranges are summarized in Table 58, where the ASHRAE flammability class remains 2L or 2, the average temperature glide is <about 0.2 K and GWP<2. Table 59 tabulates several compositions about the compositions of optimal cooling efficiency and capacity. FIGS. 26A, 26B and 26C provide graphical representations of the average glide, the CAP for cooling relative to the incumbent fluid, and the COP for cooling relative to the incumbent fluid, respectively, for a composition according to Example 27.

TABLE 58
Medium Temp Refrigeration System, cycle metric performance
and fluid property ranges for 1234zeE/isobutane in Ex. 27

| | Flammability = 2L | | Flammability = 2 | |
|---|---|---|---|---|
| | MAXIMA | MINIMA | MAXIMA | MINIMA |
| w_R1234ze(E) | 100 | 96 | 95 | 87 |
| w_isobutane | 4 | 0 | 13 | 5 |
| T° c. (degC.) | 109.36 | 108.6 | 108.4 | 107.8 |
| avg glide_h (K) | 0.2 | 0 | 0.2 | 0.1 |
| COP_c (% dev) | 100 | 99.7 | 99.6 | 99.4 |
| CAP_c (% dev) | 102.3 | 100 | 105.5 | 102.8 |

TABLE 59
Medium Temp Refrigeration System, cycle metric performance
and fluid property ranges for 1234zeE/isobutane in Ex. 27

| | | Avg. | | del_h_{—} | | ASHRAE | COP_c (% | CAP_c (% |
|---|---|---|---|---|---|---|---|---|
| wt-% | wt-% | Glide | GWP | comb | LFL | flammability | dev from | dev from |
| Isobutane | R1234ze(E) | (K) | AR5 | (kcal/g) | (kg/m\hat{ }3) | class | R1234zeE | R1234zeE |
| 0.01 | 0.99 | 0.0619 | 1.02 | 2.3052 | 0.26073625 | 2L | 0.99911192 | 1.006255466 |
| 0.02 | 0.98 | 0.1115 | 1.04 | 2.3904 | 0.248169496 | 2L | 0.998484732 | 1.012195778 |
| 0.03 | 0.97 | 0.1498 | 1.06 | 2.4756 | 0.236758406 | 2L | 0.997857543 | 1.017717759 |
| 0.04 | 0.96 | 0.1777 | 1.08 | 2.5608 | 0.226350572 | 2L | 0.997230354 | 1.022905074 |
| 0.05 | 0.95 | 0.1962 | 1.1 | 2.646 | 0.216819259 | 2 | 0.996603165 | 1.027757724 |
| 0.06 | 0.94 | 0.2065 | 1.12 | 2.7312 | 0.208058211 | 2 | 0.99628957 | 1.032359374 |
| 0.07 | 0.93 | 0.2095 | 1.14 | 2.8164 | 0.199977683 | 2 | 0.995662381 | 1.036542693 |
| 0.08 | 0.92 | 0.2061 | 1.16 | 2.9016 | 0.19250135 | 2 | 0.995348787 | 1.040391346 |
| 0.09 | 0.91 | 0.1975 | 1.18 | 2.9868 | 0.185563889 | 2 | 0.995035193 | 1.043989 |
| 0.1 | 0.9 | 0.1845 | 1.2 | 3.072 | 0.179109066 | 2 | 0.995035193 | 1.047168322 |
| 0.11 | 0.89 | 0.1683 | 1.22 | 3.1572 | 0.173088208 | 2 | 0.994721598 | 1.050096645 |
| 0.12 | 0.88 | 0.1497 | 1.24 | 3.2424 | 0.167458975 | 2 | 0.994721598 | 1.052773969 |
| 0.13 | 0.87 | 0.1297 | 1.26 | 3.3276 | 0.162184361 | 2 | 0.994721598 | 1.055032961 |

Results show that the HFO-1234ze(E) and isobutane compositions of the present invention provide similar CAP or similar energy efficiency relative to HFO-1234ze(E), at lower costs, in medium temperature refrigeration systems. It was determined that up to 4 wt % and 13 wt % isobutane can be added to a mixture of these components and maintain an ASHRAE flammability classification of 2L and 2, respectively.

### Example 28: HFO-1234ze(E)/Propane

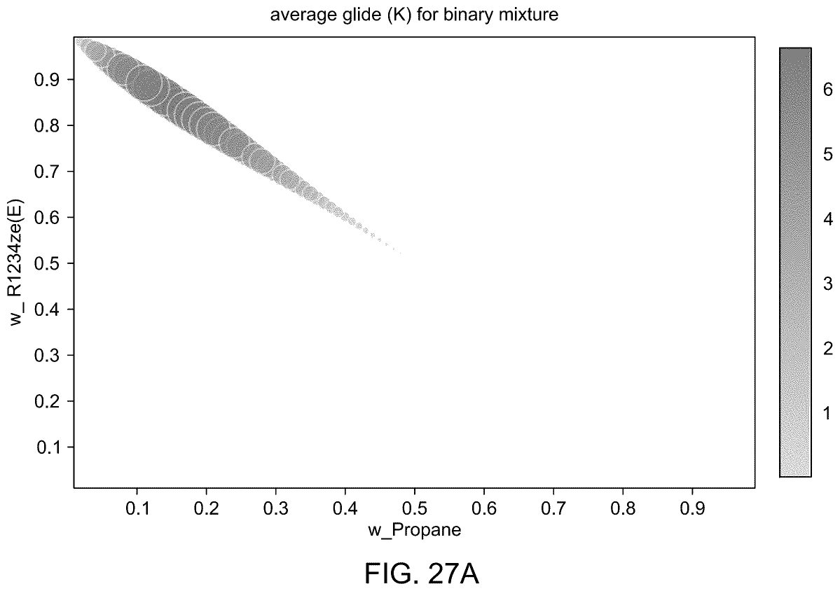

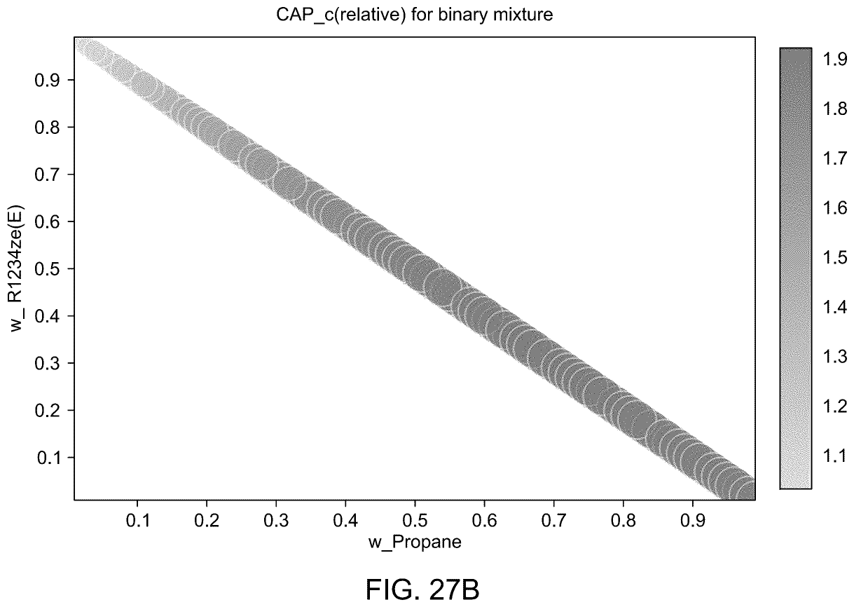

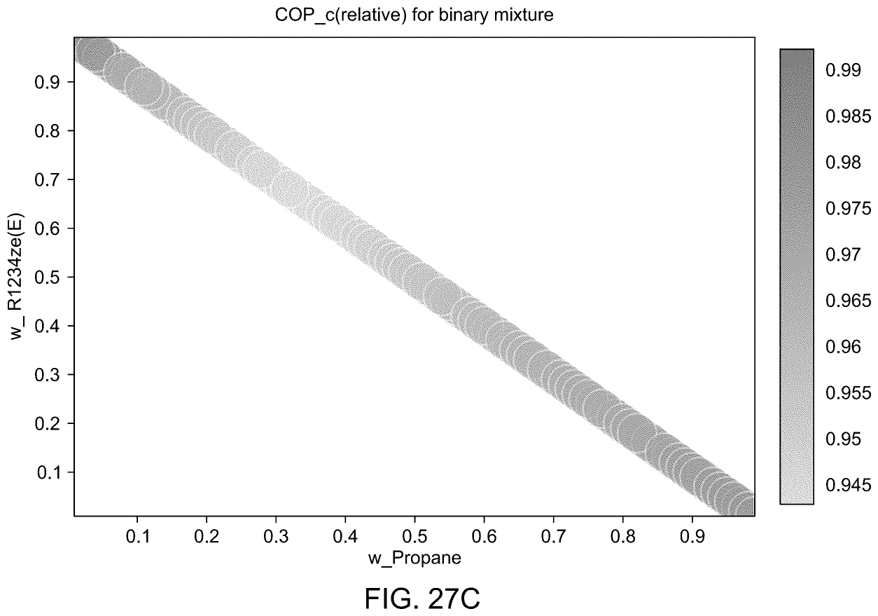

Refrigerant performance has been determined for an exemplary composition of the present invention comprising HFO-1234ze(E) and propane in medium temperature refrigeration systems as compared to HFO-1234ze(E). Performance metric and composition property ranges are summarized in Table 60, where the ASHRAE flammability class remains 2L or 2, the average temperature glide is <4 K or <6 K and GWP<2. Table 61 tabulates several compositions about the compositions of optimal coaling efficiency and capacity. FIGS. 27A, 27B and 27C provide graphical representations of the average glide, the CAP for cooling relative to the incumbent fluid, and the COP for coaling relative to the incumbent fluid, respectively, for a composition according to Example 28.

TABLE 60
Medium Temp Refrigeration System, cycle metric performance
and fluid property ranges for 1234zeE/propane in Ex. 28

| | Flammability = 2L | | Flammability = 2 | |
|---|---|---|---|---|
| | MAXIMA | MINIMA | MAXIMA | MINIMA |
| w_R1234ze(E) | 100 | 96 | 95 | 87 |
| w_propane | 4 | 0 | 13 | 5 |
| T° c. (degC.) | 109.36 | 105.9 | 105.1 | 98.9 |
| avg glide_h (K) | 3.8 | 0 | 6.6 | 4.4 |
| COP_c (% dev) | 100 | 97.7 | 97.4 | 96.2 |
| CAP_c (% dev) | 113.3 | 100 | 138.4 | 116.4 |

TABLE 61
Medium Temp Refrigeration System, cycle metric performance
and fluid property ranges for 1234zeE/propane in Ex. 28

| | | Avg. | | del_h_{—} | | ASHRAE | COP_c (% | CAP_c (% |
|---|---|---|---|---|---|---|---|---|
| wt-% | wt-% | Glide | GWP | comb | LFL | flammability | dev from | dev from |
| Propane | R1234ze(E) | (K) | AR5 | (kcal/g) | (kg/m\hat{ }3) | class | R1234zeE | R1234zeE |
| 0.01 | 0.99 | 1.1637 | 1.03 | 2.3068 | 0.256643934 | 2L | 0.992212843 | 1.034283701 |
| 0.02 | 0.98 | 2.1644 | 1.06 | 2.3936 | 0.24085849 | 2L | 0.986254548 | 1.06775025 |
| 0.03 | 0.97 | 3.0227 | 1.09 | 2.4804 | 0.226902366 | 2L | 0.981237037 | 1.100631134 |
| 0.04 | 0.96 | 3.7562 | 1.12 | 2.5672 | 0.214474988 | 2L | 0.977473903 | 1.132675355 |
| 0.05 | 0.95 | 4.3799 | 1.15 | 2.654 | 0.203338212 | 2 | 0.974337959 | 1.163882912 |
| 0.06 | 0.94 | 4.9065 | 1.18 | 2.7408 | 0.193300915 | 2 | 0.971829203 | 1.194421138 |
| 0.07 | 0.93 | 5.3469 | 1.21 | 2.8276 | 0.184207938 | 2 | 0.969634042 | 1.224039034 |
| 0.08 | 0.92 | 5.7105 | 1.24 | 2.9144 | 0.175932004 | 2 | 0.96806607 | 1.252903933 |
| 0.09 | 0.91 | 6.0051 | 1.27 | 3.0012 | 0.168367725 | 2 | 0.966498098 | 1.280932168 |
| 0.1 | 0.9 | 6.2377 | 1.3 | 3.088 | 0.161427092 | 2 | 0.96524372 | 1.308040072 |
| 0.11 | 0.89 | 6.4143 | 1.33 | 3.1748 | 0.155036032 | 2 | 0.963989342 | 1.334311313 |
| 0.12 | 0.88 | 6.5399 | 1.36 | 3.2616 | 0.149131756 | 2 | 0.963048559 | 1.359662224 |
| 0.13 | 0.87 | 6.6194 | 1.39 | 3.3484 | 0.143660691 | 2 | 0.962107775 | 1.384092805 |

Results show that the HFO-1234ze(E) and propane compositions of the present invention provide improved CAP or similar energy efficiency relative to HFO-1234ze(E), at lower costs, in medium temperature refrigeration systems. It was determined that up to 4 wt % and 13 wt % propane can be added to a mixture of these components and maintain an ASHRAE flammability classification of 2L and 2, respectively. The max CAP_c (38.4% greater than that of HFO-1234ze(E) in this range is at 131/87 wt-% propane/HFO-1234ze(E) and is a class 2.

### Example 29: HFO-1234ze(E)/Propylene

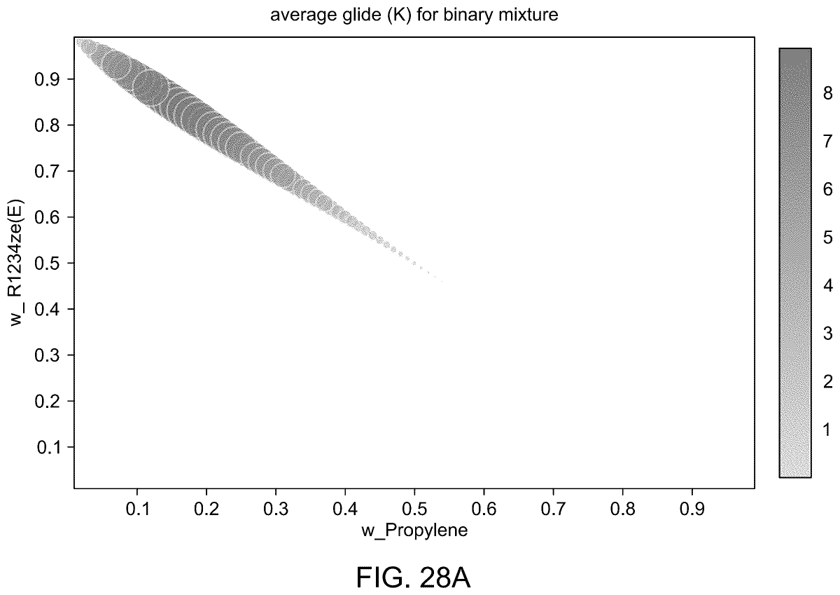

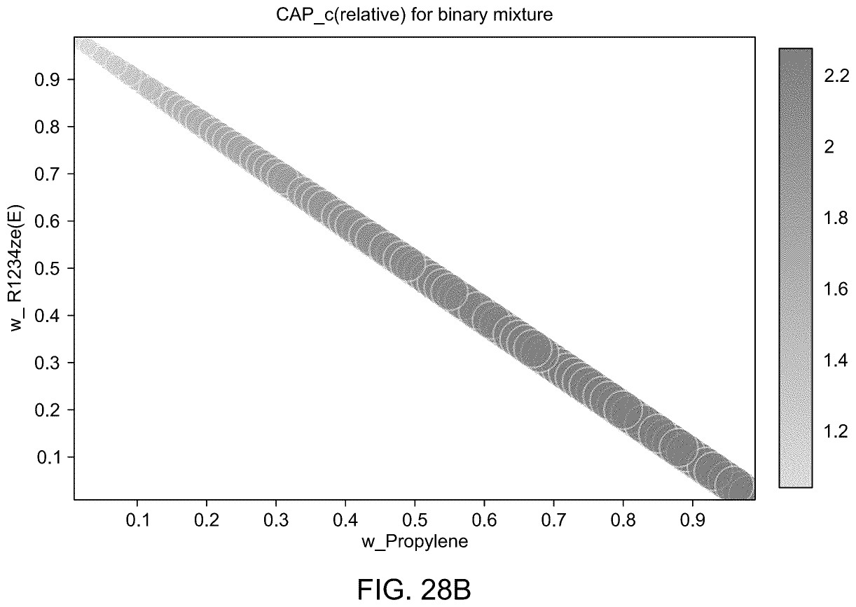

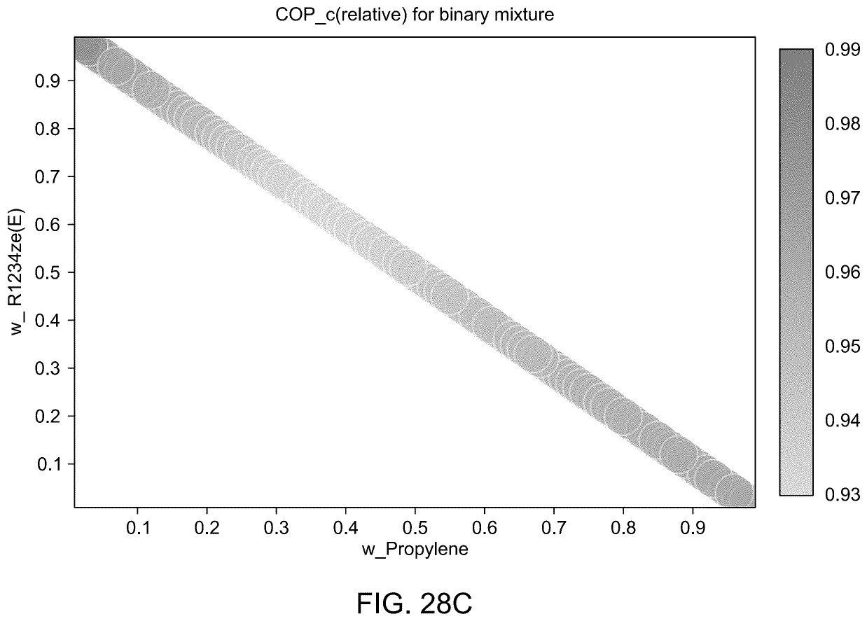

Refrigerant performance has been determined for an exemplary composition of the present invention comprising HFO-1234ze(E) and propylene in medium temperature refrigeration systems as compared to HFO-1234ze(E). Performance metric and composition property ranges are summarized in Table 62, where the ASHRAE flammability class remains 2L or 2, the average temperature glide is <5 K or <10 K and GWP<2. Table 63 tabulates several compositions about the compositions of optimal cooling efficiency and capacity. FIGS. 28A, 28B and 28C provide graphical representations of the average glide, the CAP for cooling relative to the incumbent fluid, and the COP for cooling relative to the incumbent fluid, respectively, for a composition according to Example 29.

TABLE 62
Medium Temp Refrigeration System, cycle metric performance
and fluid property ranges for 1234zeE/propylene in Ex. 29

| | Flammability = 2L | | Flammability = 2 | |
|---|---|---|---|---|
| | MAXIMA | MINIMA | MAXIMA | MINIMA |
| w_R1234ze(E) | 100 | 96 | 95 | 87 |
| w_propylene | 4 | 0 | 13 | 5 |
| T° c. (degC.) | 109.36 | 105.8 | 104.9 | 98 |
| avg glide_h (K) | 4.9 | 0 | 5.7 | 8.8 |
| COP_c (% dev) | 100 | 97.2 | 96.8 | 95.6 |
| CAP_c (% dev) | 115.9 | 100 | 147 | 119.7 |

TABLE 63
Medium Temp Refrigeration System, cycle metric performance
and fluid property ranges for 1234zeE/propylene in Ex. 29

| | | Avg. | | | | ASHRAE | COP_c (% | CAP_c (% |
|---|---|---|---|---|---|---|---|---|
| wt-% | wt-% | Glide | GWP | del_h_comb | LFL | flammability | dev from | dev from |
| Propylene | R1234ze(E) | (K) | AR5 | (kcal/g) | (kg/m\hat{ }3) | class | R1234zeE | R1234zeE |
| 0.01 | 0.99 | 1.5315 | 1.005 | 2.3071 | 0.255416581 | 2 L | 0.990017681 | 1.040809678 |
| 0.02 | 0.98 | 2.8431 | 1.01 | 2.3942 | 0.238705491 | 2 L | 0.98217782 | 1.080969537 |
| 0.03 | 0.97 | 3.9652 | 1.015 | 2.4813 | 0.224046823 | 2 L | 0.976219526 | 1.120460065 |
| 0.04 | 0.96 | 4.9236 | 1.02 | 2.5684 | 0.211084343 | 2 L | 0.971515609 | 1.159197595 |
| 0.05 | 0.95 | 5.7399 | 1.025 | 2.6555 | 0.199539748 | 2 | 0.967752475 | 1.197098462 |
| 0.06 | 0.94 | 6.4323 | 1.03 | 2.7426 | 0.18919246 | 2 | 0.96524372 | 1.234329998 |
| 0.07 | 0.93 | 7.016 | 1.035 | 2.8297 | 0.179865401 | 2 | 0.963048559 | 1.270641204 |
| 0.08 | 0.92 | 7.5038 | 1.04 | 2.9168 | 0.17141477 | 2 | 0.961166992 | 1.306199412 |
| 0.09 | 0.91 | 7.9063 | 1.045 | 3.0039 | 0.163722578 | 2 | 0.959912614 | 1.340920957 |
| 0.1 | 0.9 | 8.2327 | 1.05 | 3.091 | 0.156691107 | 2 | 0.958658236 | 1.374638505 |
| 0.11 | 0.89 | 8.4904 | 1.055 | 3.1781 | 0.150238732 | 2 | 0.957717453 | 1.40751939 |
| 0.12 | 0.88 | 8.686 | 1.06 | 3.2652 | 0.144296745 | 2 | 0.95677667 | 1.439396278 |
| 0.13 | 0.87 | 8.825 | 1.065 | 3.3523 | 0.13880689 | 2 | 0.956149481 | 1.470269169 |

Results show that the HFO-1234ze(E) and propylene compositions of the present invention provide improved CAP or similar energy efficiency relative to HFO-1234ze(E), at lower costs, in medium temperature refrigeration systems. It was determined that up to 4 wt % and 13 wt % propylene can be added to a mixture of these components and maintain an ASHRAE flammability classification of 2L and 2, respectively. The max CAP_c (47% greater than that of HFO-1234ze(E) in this range is at 13/87 wt-% propylene/HFO-1234ze(E) and is a class 2.

### Performance Examples for Residential Heat

### Puma Systems Comprising Hydrocarbon Compositions

### Example 30: Isobutane/HFO-1234ze(E)

Refrigerant performance has been determined for an exemplary composition of the present invention comprising isobutane and HFO-1234ze(E) in residential heat pump systems as compared to isobutane, in cooling or heating modes. The cooling mode data are based on the conditions set forth in Table 2. The heating mode data are based on the conditions set forth in Table 3. Table 64 tabulates several compositions about the compositions of optimal cooling/heating efficiency and capacity, where the average temperature glide is <4 K and GWP<3.

TABLE 64
Residential Heat Pump Cooling Mode Condition, cycle metric performance
and fluid property ranges for Isobutane/1234zeE in Ex. 30

| | | average | average | | | |
|---|---|---|---|---|---|---|
| | | glide | glide | | | |
| | | cooling | heating | GWP | del_h_comb | LFL |
| w_Isobutane | w_R1234ze(E) | (K) | (K) | AR5 | (kcal/g) | (kg/m\hat{ }3) |
| 1 | 0 | 0 | 0 | 3 | 11.83 | 0.041 |
| 0.96 | 0.04 | 0.8712 | 0.8816 | 2.92 | 11.45010718 | 0.042044295 |
| 0.92 | 0.08 | 1.6298 | 1.6457 | 2.84 | 11.06551938 | 0.043582227 |
| 0.88 | 0.12 | 2.2738 | 2.2914 | 2.76 | 10.68093158 | 0.045236942 |
| 0.84 | 0.16 | 2.802 | 2.818 | 2.68 | 10.29634378 | 0.047022267 |
| 0.76 | 0.24 | 3.5068 | 3.5129 | 2.52 | 9.527168185 | 0.051051906 |
| 0.72 | 0.28 | 3.6833 | 3.6821 | 2.44 | 9.142580386 | 0.053337314 |
| 0.64 | 0.36 | 3.6925 | 3.6738 | 2.28 | 8.373404788 | 0.058582351 |
| 0.6 | 0.4 | 3.5329 | 3.5048 | 2.2 | 7.988816988 | 0.06161171 |
| 0.56 | 0.44 | 3.2728 | 3.2351 | 2.12 | 7.604229189 | 0.064971456 |
| 0.52 | 0.48 | 2.9229 | 2.8751 | 2.04 | 7.21964139 | 0.068718756 |
| 0.48 | 0.52 | 2.4982 | 2.4401 | 1.96 | 6.835053591 | 0.072924773 |
| 0.44 | 0.56 | 2.0203 | 1.9517 | 1.88 | 6.450465791 | 0.077679227 |
| 0.4 | 0.6 | 1.5192 | 1.4408 | 1.8 | 6.065877992 | 0.083096867 |
| 0.36 | 0.64 | 1.0341 | 0.9499 | 1.72 | 5.681290193 | 0.089326856 |
| 0.32 | 0.68 | 0.6103 | 0.5296 | 1.64 | 5.296702394 | 0.096566715 |
| 0.28 | 0.72 | 0.289 | 0.2256 | 1.56 | 4.912114595 | 0.105083648 |
| 0.24 | 0.76 | 0.0934 | 0.06 | 1.48 | 4.527526795 | 0.115248243 |
| 0.2 | 0.8 | 0.02 | 0.0227 | 1.4 | 4.142938996 | 0.127589829 |
| 0.17 | 0.83 | 0.0295 | 0.058 | 1.34 | 3.854498147 | 0.138732133 |

| | | ASHRAE | | | | |
|---|---|---|---|---|---|---|
| | | flammability | COP_c | CAP_c | COP_h | CAP_h |
| w_Isobutane | w_R1234ze(E) | class | (relative) | (relative) | (relative) | (relative) |
| 1 | 0 | 3 | 1 | 1 | 1 | 1 |
| 0.96 | 0.04 | 3 | 0.999220783 | 1.028644199 | 0.999260364 | 1.029930074 |
| 0.92 | 0.08 | 3 | 0.999220783 | 1.057400705 | 0.999072356 | 1.059844418 |
| 0.88 | 0.12 | 3 | 0.999444373 | 1.08602408 | 0.999260364 | 1.089528059 |
| 0.84 | 0.16 | 3 | 0.999667962 | 1.114447756 | 0.999448372 | 1.119057899 |
| 0.76 | 0.24 | 3 | 0.999891551 | 1.16996379 | 1.000012394 | 1.176656467 |
| 0.72 | 0.28 | 3 | 0.999444373 | 1.196923014 | 1.000012394 | 1.204725196 |
| 0.64 | 0.36 | 3 | 0.997432068 | 1.24891105 | 0.998884349 | 1.259093938 |
| 0.6 | 0.4 | 3 | 0.995866943 | 1.274072993 | 0.997756303 | 1.285547753 |
| 0.56 | 0.44 | 3 | 0.993854639 | 1.298702409 | 0.99644025 | 1.311540164 |
| 0.52 | 0.48 | 3 | 0.991842335 | 1.322932428 | 0.995124197 | 1.337224973 |
| 0.48 | 0.52 | 3 | 0.989606441 | 1.346763051 | 0.993620136 | 1.362602179 |
| 0.44 | 0.56 | 3 | 0.987594137 | 1.370061147 | 0.992116075 | 1.387517982 |
| 0.4 | 0.6 | 3 | 0.985581833 | 1.392627016 | 0.99098803 | 1.411510977 |
| 0.36 | 0.64 | 3 | 0.984016708 | 1.413728434 | 0.989859984 | 1.433812158 |
| 0.32 | 0.68 | 3 | 0.982675172 | 1.432433477 | 0.988919946 | 1.453114215 |
| 0.28 | 0.72 | 3 | 0.981333636 | 1.447677088 | 0.987979908 | 1.467956036 |
| 0.24 | 0.76 | 3 | 0.980215689 | 1.458527344 | 0.98703987 | 1.477414813 |
| 0.2 | 0.8 | 3 | 0.979321331 | 1.464584849 | 0.986099832 | 1.480952242 |
| 0.17 | 0.83 | 3 | 0.979097742 | 1.465783036 | 0.985911825 | 1.479644931 |

Results show that the HFO-1234ze(E) and isobutane compositions of the present invention provide improved CAP and energy efficiency relative to isobutane for cooling and heating using residential heat pump systems. Additionally, in many cases, the HFO-1234ze(E) and isobutane compositions of the present invention provide improved cooling capacity and energy efficiency relative to isobutane. Max CAP for cooling is 47% greater than Isobutane at 17/83 wt-% isobutane/R-1234zeE. Max CAP for heating is 48% greater than isobutane at 20/80 wt-% Isobutane/R-1234zeE. Adding 76 wt-% of R-1234zeE to isobutane reduces the heat of combustion to 4.54 kcal/g (8169 Btu/lbm), which is the 2L requirement. Adding 70 wt-% of R-1234zeE to isobutane increases the LFL to 0.099 kg/m\hat{ }3 (0.0062 lb/ft\hat{ }3), which is the 2L requirement.

### Example 31: Butane/HFO-1234ze(E)

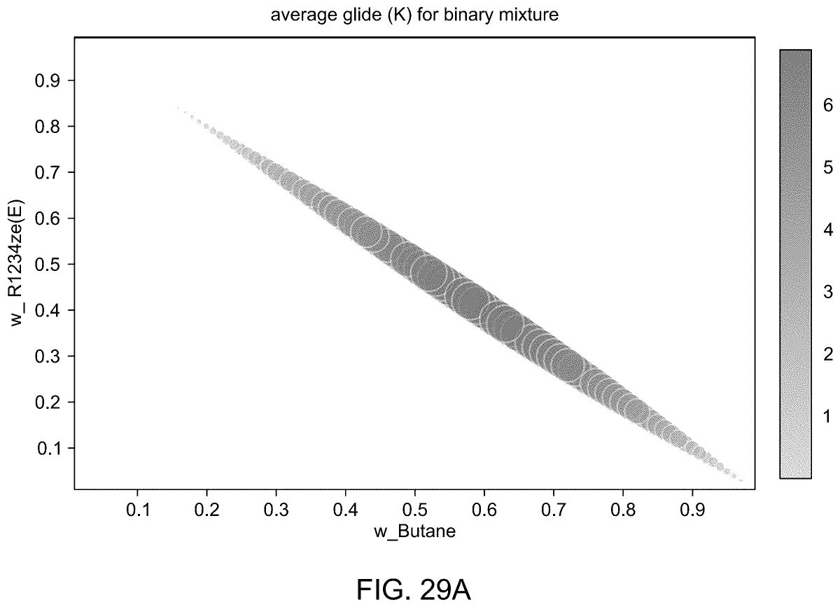

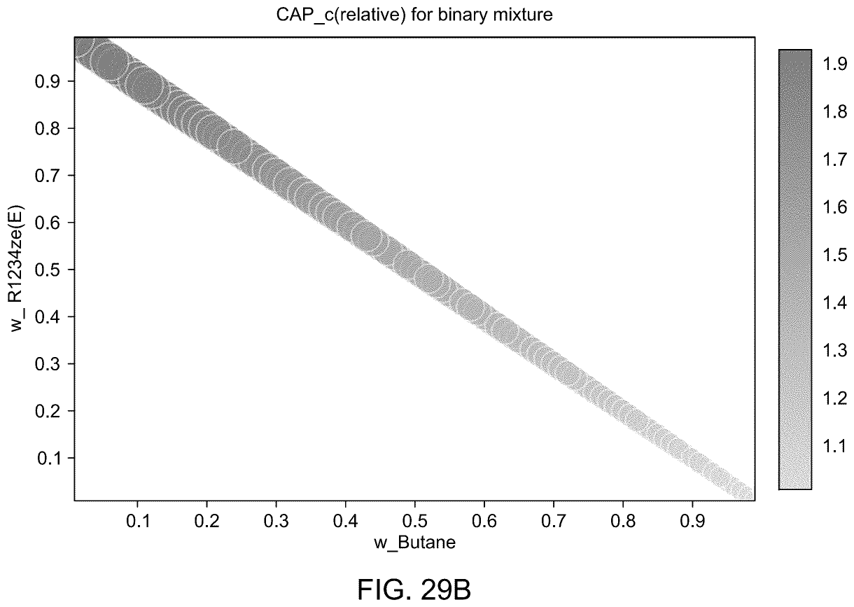

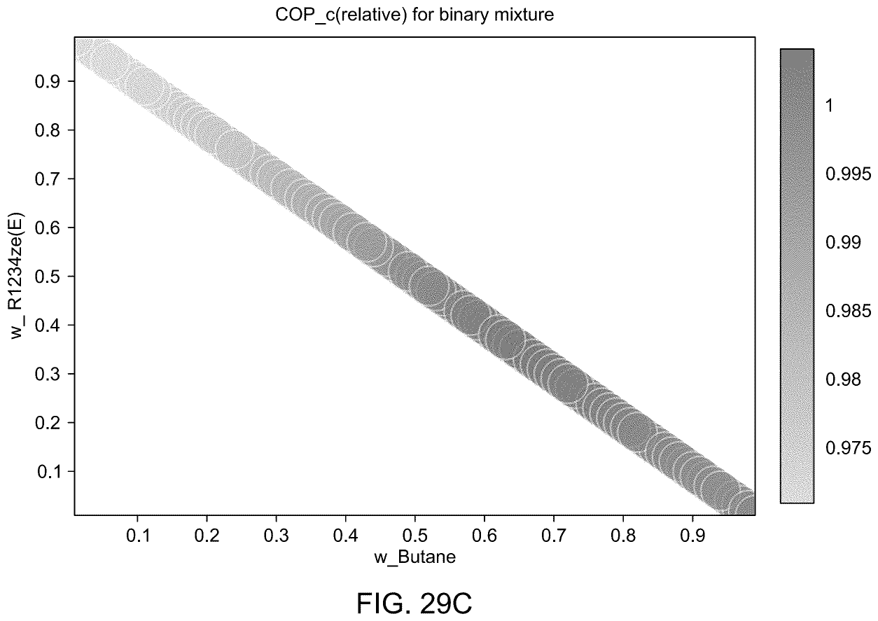

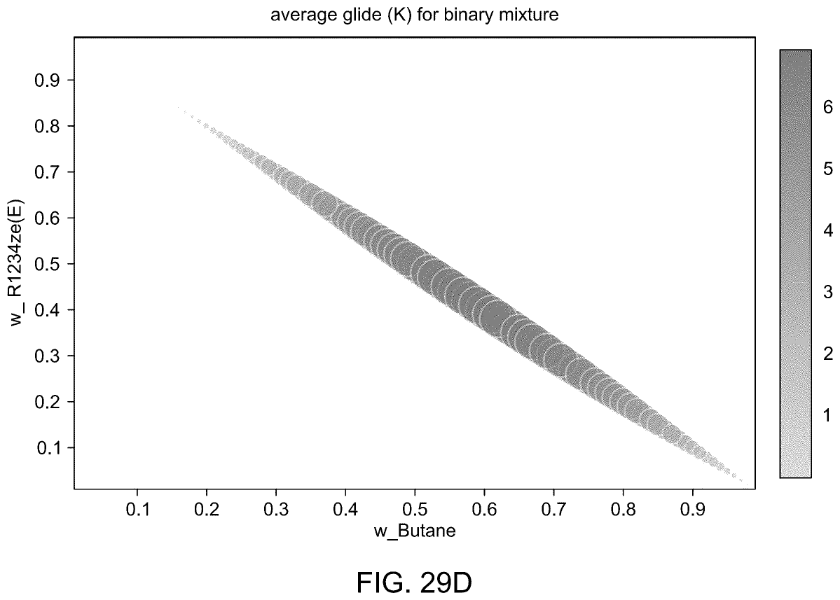

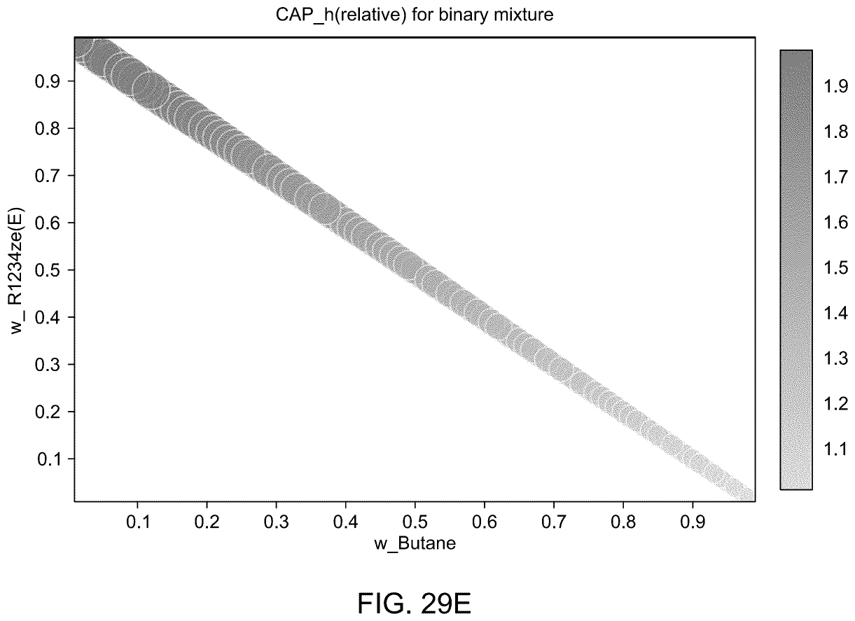

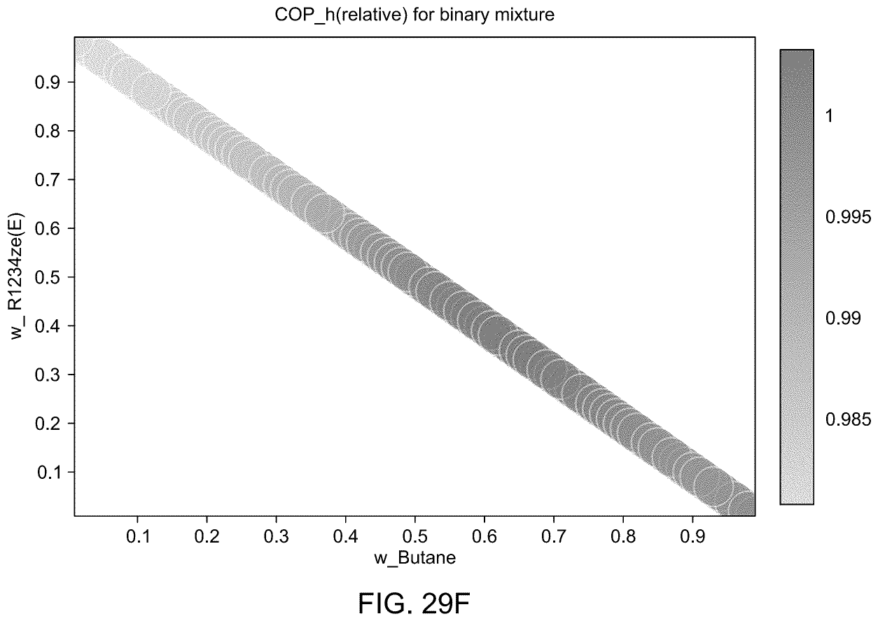

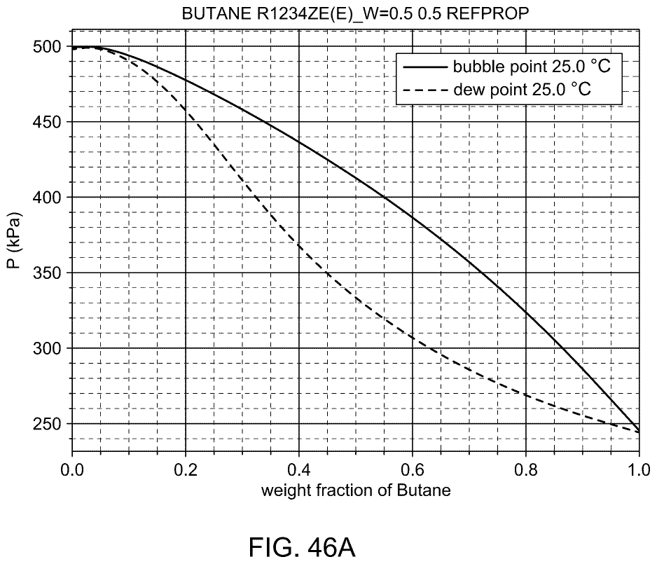

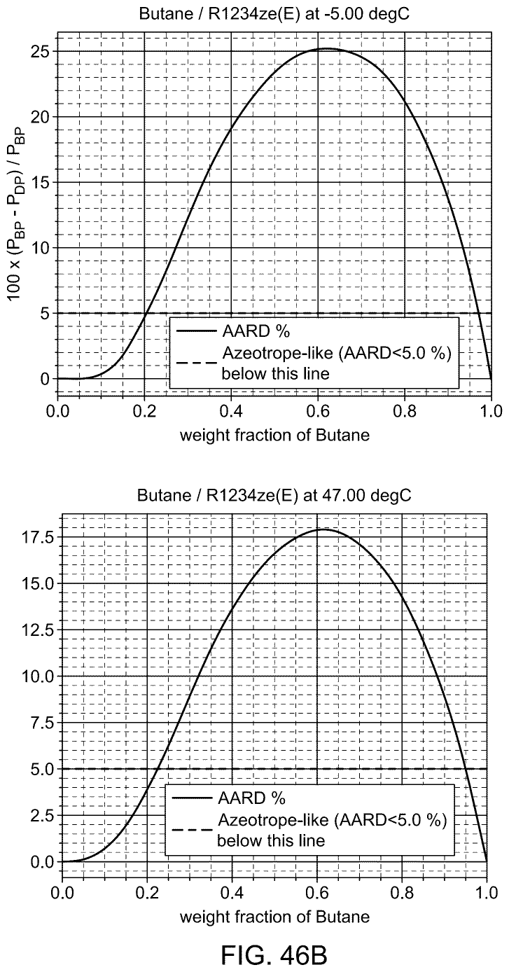

Refrigerant performance has been determined for an exemplary composition of the present invention comprising butane and HFO-1234ze(E) in residential heat pump systems as compared to butane, in cooling or heating modes. The cooling mode data are based on the conditions set forth in Table 2. The heating mode data are based on the conditions set forth in Table 3. Table 65 tabulates several compositions about the compositions of optimal cooling/heating efficiency and capacity, where the average temperature glide is <4 K and GWP<3. FIGS. 29A, 29B and 29C provide graphical representations of the average glide, the CAP for cooling relative to the incumbent fluid, and the COP for cooling relative to the incumbent fluid, respectively, for a composition according to Example 31, and FIGS. 29D, 29E and 29F provide graphical representations of the average glide, the CAP for heating relative to the incumbent fluid, and the COP for heating relative to the incumbent fluid, respectively, for a composition according to Example 31. FIGS. 46A and 46B show near azeotropic behavior from 0 to about 20 wt-% of butane in HFO-1234ze(E) with an azeotrope near 5 wt-% butane at −5° C. that drifts toward pure HFO-1234ze(E) as temperature is increased for compositions according to Example 31.

TABLE 65
Residential Heat Pump Conditions, cycle metric performance
and fluid property ranges for Butane/1234zeE in Ex. 31

| | | Avg. | Avg. | | | | | |
|---|---|---|---|---|---|---|---|---|
| | | glide | glide | | | | | |
| | | cooling | heating | GWP | del_h_comb | del_h_comb | LFL | LFL |
| w_Butane | w_R1234ze(E) | (K) | (K) | AR5 | (kcal/g) | (relative) | (kg/m\hat{ }3) | (relative) |
| 0.99 | 0.01 | 0.3191 | 0.3247 | 2.98 | 10.6845 | 0.992061281 | 0.043653447 | 1.01519643 |
| 0.94 | 0.06 | 1.8114 | 1.8383 | 2.88 | 10.257 | 0.952367688 | 0.045589995 | 1.060232437 |
| 0.89 | 0.11 | 3.1267 | 3.1665 | 2.78 | 9.8295 | 0.912674095 | 0.047706337 | 1.109449695 |
| 0.84 | 0.16 | 4.2581 | 4.3046 | 2.68 | 9.402 | 0.872980501 | 0.05002873 | 1.163458846 |
| 0.79 | 0.21 | 5.198 | 5.2468 | 2.58 | 8.9745 | 0.833286908 | 0.052588808 | 1.222995525 |
| 0.74 | 0.26 | 5.9392 | 5.9869 | 2.48 | 8.547 | 0.793593315 | 0.055425025 | 1.288954063 |
| 0.69 | 0.31 | 6.4744 | 6.519 | 2.38 | 8.1195 | 0.753899721 | 0.058584607 | 1.362432721 |
| 0.64 | 0.36 | 6.7976 | 6.8377 | 2.28 | 7.692 | 0.714206128 | 0.062126199 | 1.444795332 |
| 0.59 | 0.41 | 6.9039 | 6.9391 | 2.18 | 7.2645 | 0.674512535 | 0.06612354 | 1.537756737 |
| 0.54 | 0.46 | 6.7906 | 6.8212 | 2.08 | 6.837 | 0.634818942 | 0.070670649 | 1.643503474 |
| 0.49 | 0.51 | 6.4577 | 6.4843 | 1.98 | 6.4095 | 0.595125348 | 0.075889321 | 1.76486794 |
| 0.44 | 0.56 | 5.9099 | 5.9326 | 1.88 | 5.982 | 0.555431755 | 0.081940193 | 1.905585874 |
| 0.39 | 0.61 | 5.1597 | 5.177 | 1.78 | 5.5545 | 0.515738162 | 0.08903957 | 2.070687684 |
| 0.34 | 0.66 | 4.235 | 4.242 | 1.68 | 5.127 | 0.476044568 | 0.097485838 | 2.267112514 |
| 0.29 | 0.71 | 3.1907 | 3.1791 | 1.58 | 4.6995 | 0.436350975 | 0.107702462 | 2.504708424 |
| 0.24 | 0.76 | 2.1255 | 2.0885 | 1.48 | 4.272 | 0.396657382 | 0.120311211 | 2.797935135 |
| 0.19 | 0.81 | 1.1825 | 1.1265 | 1.38 | 3.8445 | 0.356963788 | 0.13626362 | 3.168921389 |
| 0.14 | 0.86 | 0.4986 | 0.4472 | 1.28 | 3.417 | 0.317270195 | 0.157093037 | 3.653326431 |
| 0.09 | 0.91 | 0.1264 | 0.0994 | 1.18 | 2.9895 | 0.277576602 | 0.185439543 | 4.312547504 |
| 0.04 | 0.96 | 0.0086 | 0.0054 | 1.08 | 2.562 | 0.237883008 | 0.226268318 | 5.262053901 |

| | | ASHRAE | | | | |
|---|---|---|---|---|---|---|
| | | flammability | COP_c | CAP_c | COP_h | CAP_h |
| w_Butane | w_R1234ze(E) | class | (relative) | (relative) | (relative) | (relative) |
| 0.99 | 0.01 | 3 | 0.999417671 | 1.008916598 | 0.999427216 | 1.009343723 |
| 0.94 | 0.06 | 3 | 0.998314561 | 1.054510638 | 0.997935255 | 1.057288096 |
| 0.89 | 0.11 | 3 | 0.998535183 | 1.101475239 | 0.997935255 | 1.106652234 |
| 0.84 | 0.16 | 3 | 0.999858915 | 1.149627662 | 0.998867731 | 1.156999286 |
| 0.79 | 0.21 | 3 | 1.001403269 | 1.198602421 | 1.000359691 | 1.208001614 |
| 0.74 | 0.26 | 3 | 1.002947623 | 1.247942664 | 1.001851652 | 1.259550006 |
| 0.69 | 0.31 | 3 | 1.003830111 | 1.297374278 | 1.002970623 | 1.311426036 |
| 0.64 | 0.36 | 3 | 1.003830111 | 1.346897263 | 1.003343613 | 1.363302066 |
| 0.59 | 0.41 | 3 | 1.002947623 | 1.396328877 | 1.002970623 | 1.415396521 |
| 0.54 | 0.46 | 3 | 1.000962025 | 1.445851861 | 1.001665157 | 1.467818615 |
| 0.49 | 0.51 | 3 | 0.997873317 | 1.4958317 | 0.999613711 | 1.521223622 |
| 0.44 | 0.56 | 3 | 0.993902121 | 1.546816618 | 0.996816285 | 1.576157608 |
| 0.39 | 0.61 | 3 | 0.989710303 | 1.599354839 | 0.993645868 | 1.633275847 |
| 0.34 | 0.66 | 3 | 0.985297863 | 1.654177332 | 0.990475451 | 1.693342829 |
| 0.29 | 0.71 | 3 | 0.981547289 | 1.711101353 | 0.988051015 | 1.756249341 |
| 0.24 | 0.76 | 3 | 0.978679203 | 1.76866497 | 0.986186064 | 1.820029555 |
| 0.19 | 0.81 | 3 | 0.976252361 | 1.823030608 | 0.984694103 | 1.879659686 |
| 0.14 | 0.86 | 3 | 0.974046141 | 1.869264243 | 0.983202143 | 1.928914611 |
| 0.09 | 0.91 | 2 | 0.972060543 | 1.903802413 | 0.981710182 | 1.963425823 |
| 0.04 | 0.96 | 2 L | 0.971178055 | 1.924543589 | 0.980964201 | 1.980681428 |

Results show that the HFO-1234ze(E) and butane compositions of the present invention provide improved CAP and energy efficiency relative to butane for cooling and heating using residential heat pump systems. Additionally, in many cases, the HFO-1234ze(E) and butane compositions of the present invention provide improved cooling capacity and energy efficiency relative to butane. Adding 76 wt-% of HFO-1234ze(E) to butane reduces the heat of combustion to 4.272 kcal/g (7684 Btu/lbm), which meets the 2L requirement. Adding 71 wt-% of HFO-1234ze(E) to butane increases the LFL to 0.1077 kg/m\hat{ }3 (0.0067 lb/ft\hat{ }3), which meets the 2L requirement.

### Example 32: Propane/HFO-1234ze(E)

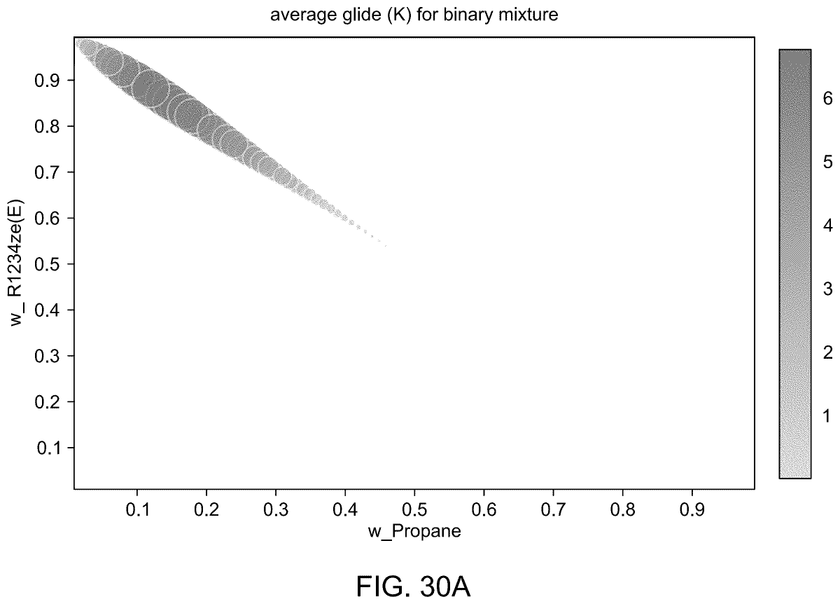

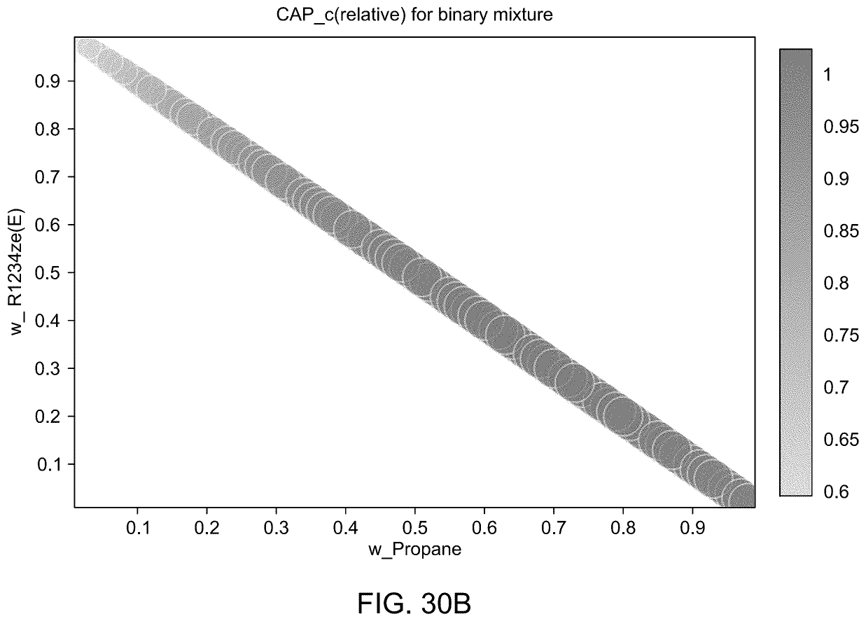

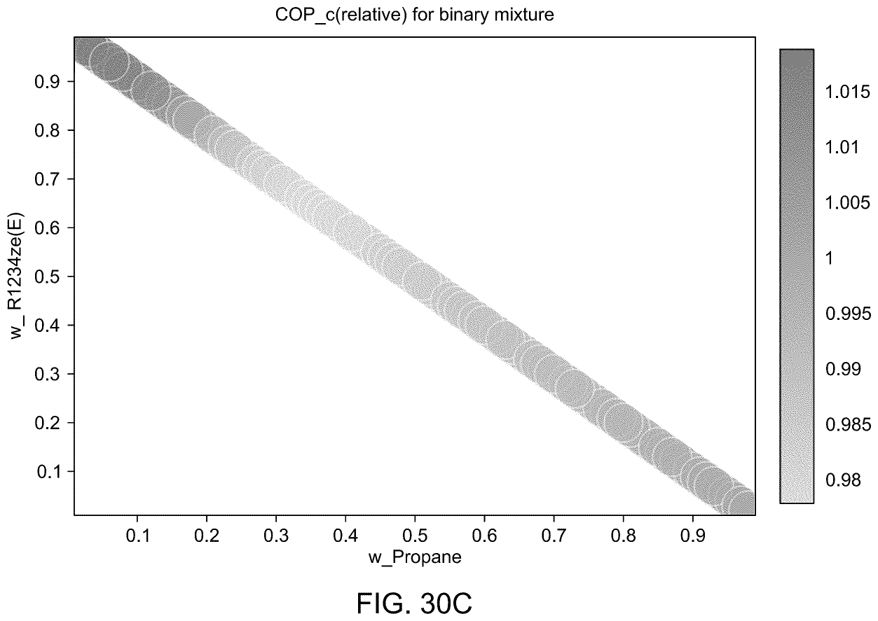

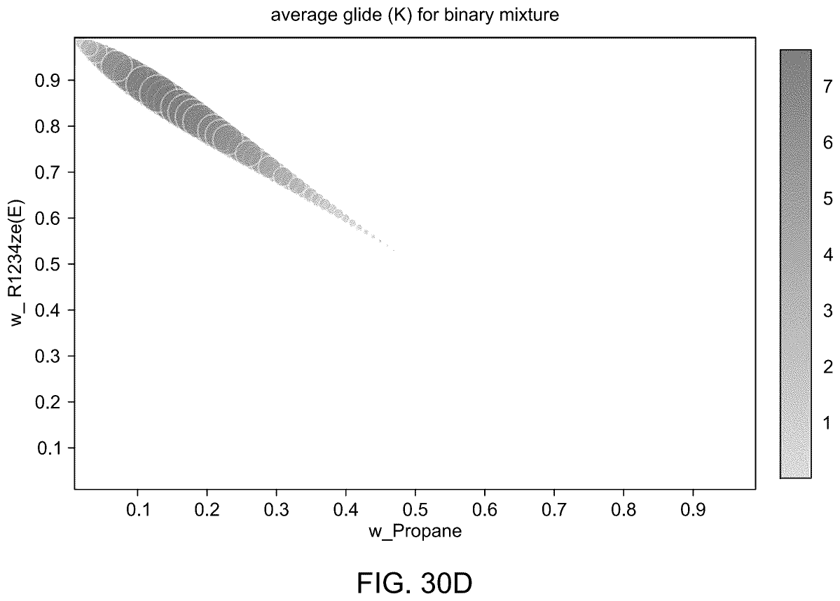

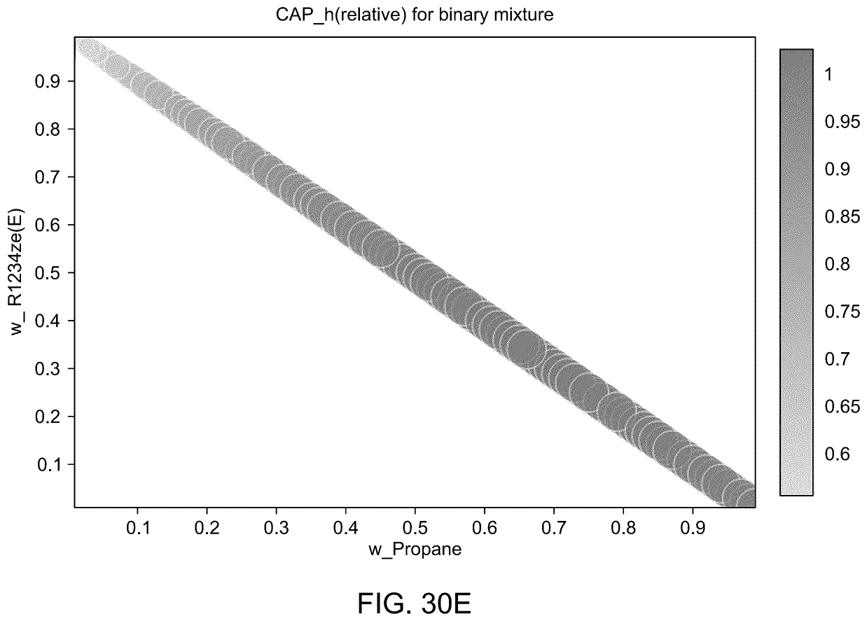

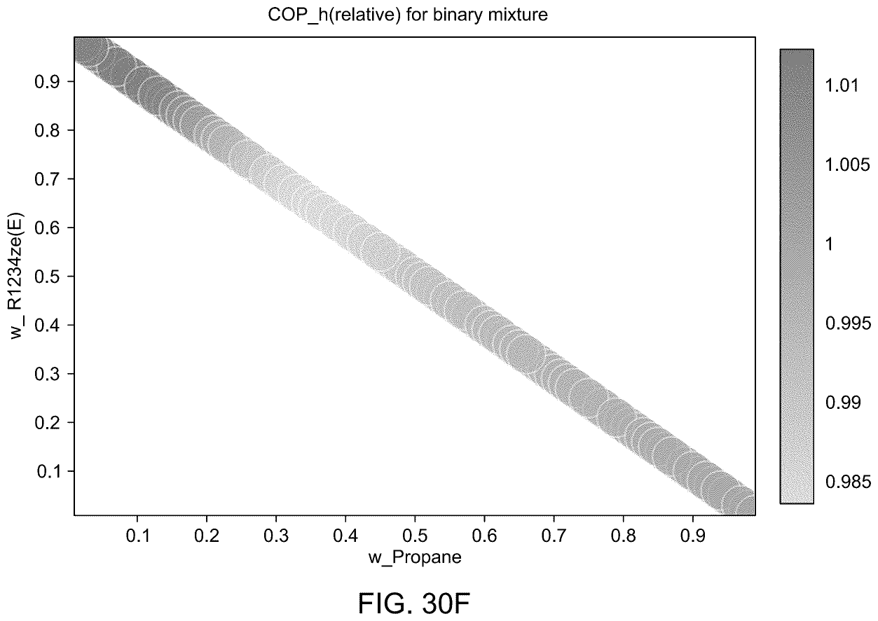

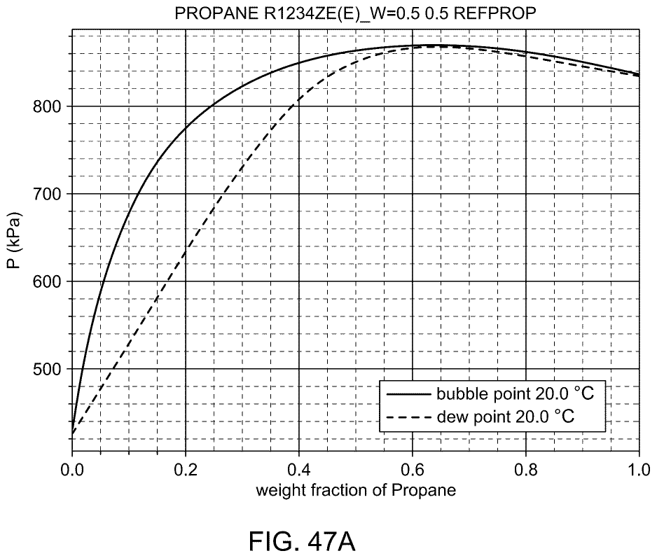

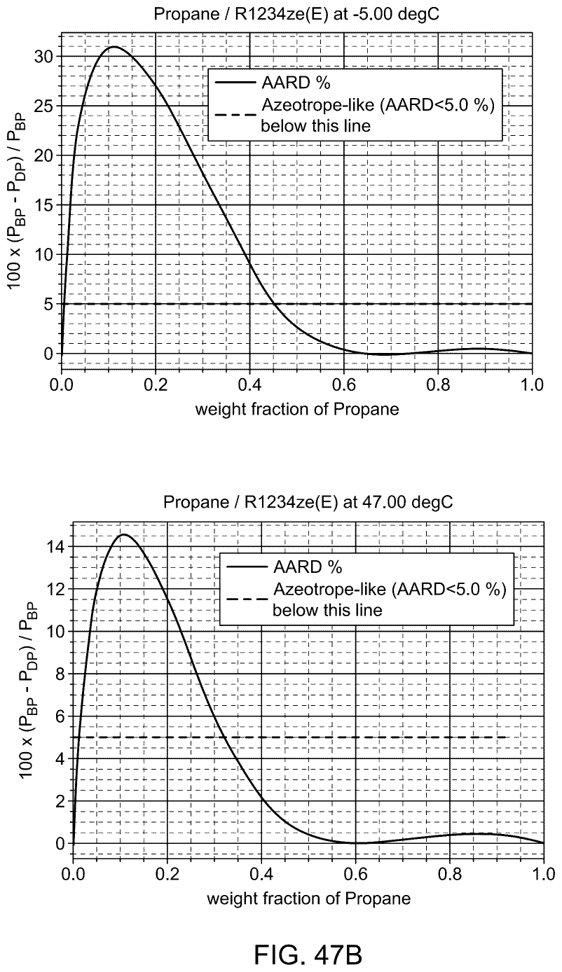

Refrigerant performance has been determined for an exemplary composition of the present invention comprising propane and HFO-1234ze(E) in residential heat pump systems as compared to propane, in cooling or heating modes. The cooling mode data are based on the conditions set forth in Table 2. The heating mode data are based on the conditions set forth in Table 3. Table 66 tabulates several compositions about the compositions of optimal cooling/heating efficiency and capacity, where the average temperature glide is <8 K and GWP<4. FIGS. 30A, 30B and 30C provide graphical representations of the average glide, the CAP for cooling relative to the incumbent fluid, and the COP for cooling relative to the incumbent fluid, respectively, for a composition according to Example 32, and FIGS. 30D, 30E and 30F provide graphical representations of the average glide, the CAP for heating relative to the incumbent fluid, and the COP for heating relative to the incumbent fluid, respectively, for a composition according to Example 32. FIGS. 47A and 47B show near azeotropic behavior for 45 to 100 wt-% propane at the lowest application temperature −5° C. and 33 to 100 wt-% at the highest temperature 47° C. for residential heat pumps, with an actual azeotrope at about 62 wt-% propane and 20° C. for compositions according to Example 32.

TABLE 66
Residential Heat Pump Cooling Mode Condition, cycle metric performance
and fluid property ranges for Propane/1234zeE in Ex. 32

| | | Avg. | Avg. | | | | | |
|---|---|---|---|---|---|---|---|---|
| | | glide | glide | | | | | |
| | | cooling | heating | GWP | del_h_comb | del_h_comb | LFL | LFL |
| w_Propane | w_R1234ze(E) | (K) | (K) | AR5 | (kcal/g) | (relative) | (kg/m\hat{ }3) | (relative) |
| 0.99 | 0.01 | 0.0178 | 0.0172 | 3.97 | 10.8132 | 0.992036697 | 0.034575324 | 1.01692129 |
| 0.94 | 0.06 | 0.0866 | 0.0827 | 3.82 | 10.3792 | 0.952220183 | 0.036172215 | 1.063888664 |
| 0.89 | 0.11 | 0.123 | 0.1152 | 3.67 | 9.9452 | 0.91240367 | 0.037923755 | 1.115404572 |
| 0.84 | 0.16 | 0.1291 | 0.1174 | 3.52 | 9.5112 | 0.872587156 | 0.039853555 | 1.172163389 |
| 0.79 | 0.21 | 0.1095 | 0.095 | 3.37 | 9.0772 | 0.832770642 | 0.041990286 | 1.235008403 |
| 0.74 | 0.26 | 0.0726 | 0.0576 | 3.22 | 8.6432 | 0.792954128 | 0.044369116 | 1.304973997 |
| 0.69 | 0.31 | 0.0318 | 0.021 | 3.07 | 8.2092 | 0.753137615 | 0.047033663 | 1.383343033 |
| 0.64 | 0.36 | 0.0083 | 0.0101 | 2.92 | 7.7752 | 0.713321101 | 0.050038692 | 1.471726224 |
| 0.59 | 0.41 | 0.0338 | 0.0634 | 2.77 | 7.3412 | 0.673504587 | 0.053453917 | 1.572174018 |
| 0.54 | 0.46 | 0.1541 | 0.2369 | 2.62 | 6.9072 | 0.633688073 | 0.05736948 | 1.687337655 |
| 0.49 | 0.51 | 0.4286 | 0.6031 | 2.47 | 6.4732 | 0.59387156 | 0.061904025 | 1.820706603 |
| 0.44 | 0.56 | 0.9203 | 1.2297 | 2.32 | 6.0392 | 0.554055046 | 0.067216921 | 1.97696826 |
| 0.39 | 0.61 | 1.6692 | 2.1407 | 2.17 | 5.6052 | 0.514238532 | 0.073527389 | 2.162570274 |
| 0.34 | 0.66 | 2.6663 | 3.2992 | 2.02 | 5.1712 | 0.474422018 | 0.081145503 | 2.386632439 |
| 0.29 | 0.71 | 3.8459 | 4.6173 | 1.87 | 4.7372 | 0.434605505 | 0.090524694 | 2.662490987 |
| 0.24 | 0.76 | 5.0823 | 5.9546 | 1.72 | 4.3032 | 0.394788991 | 0.10235543 | 3.010453835 |
| 0.19 | 0.81 | 6.1681 | 7.0905 | 1.57 | 3.8692 | 0.354972477 | 0.117743399 | 3.463041158 |
| 0.14 | 0.86 | 6.7704 | 7.6699 | 1.42 | 3.4352 | 0.315155963 | 0.138576844 | 4.075789524 |
| 0.09 | 0.91 | 6.3585 | 7.1234 | 1.27 | 3.0012 | 0.27533945 | 0.168367725 | 4.951991918 |
| 0.04 | 0.96 | 4.0844 | 4.5425 | 1.12 | 2.5672 | 0.235522936 | 0.214474988 | 6.308087877 |

| | | ASHRAE | | | | |
|---|---|---|---|---|---|---|
| | | flammability | COP_c | CAP_c | COP_h | CAP_h |
| w_Butane | w_R1234ze(E) | class | (relative) | (relative) | (relative) | (relative) |
| 0.99 | 0.01 | 3 | 0.999620069 | 1.001187614 | 0.999891741 | 1.001312523 |
| 0.94 | 0.06 | 3 | 0.998228486 | 1.006813791 | 0.99912022 | 1.007573114 |
| 0.89 | 0.11 | 3 | 0.996836904 | 1.011869196 | 0.998348698 | 1.013216464 |
| 0.84 | 0.16 | 3 | 0.995445321 | 1.016217931 | 0.997577177 | 1.018125003 |
| 0.79 | 0.21 | 3 | 0.993821808 | 1.019724099 | 0.996805655 | 1.022151768 |
| 0.74 | 0.26 | 3 | 0.992430226 | 1.022224622 | 0.995841254 | 1.025061621 |
| 0.69 | 0.31 | 3 | 0.990806713 | 1.023447704 | 0.995069732 | 1.026560635 |
| 0.64 | 0.36 | 3 | 0.9891832 | 1.02304001 | 0.99410533 | 1.026207926 |
| 0.59 | 0.41 | 3 | 0.987559687 | 1.020539487 | 0.992948048 | 1.023356859 |
| 0.54 | 0.46 | 3 | 0.985704244 | 1.015239466 | 0.991597886 | 1.017066875 |
| 0.49 | 0.51 | 3 | 0.98338494 | 1.006161481 | 0.989283322 | 1.006162277 |
| 0.44 | 0.56 | 3 | 0.980833705 | 0.992517323 | 0.986582997 | 0.989702506 |
| 0.39 | 0.61 | 3 | 0.978514401 | 0.973980838 | 0.984268433 | 0.96777574 |
| 0.34 | 0.66 | 3 | 0.97805054 | 0.951068439 | 0.984075552 | 0.941263752 |
| 0.29 | 0.71 | 3 | 0.980833705 | 0.924350895 | 0.986968757 | 0.910754391 |
| 0.24 | 0.76 | 3 | 0.987791618 | 0.893420515 | 0.993333809 | 0.87580677 |
| 0.19 | 0.81 | 3 | 0.997532695 | 0.856211647 | 1.001434784 | 0.834157671 |
| 0.14 | 0.86 | 3 | 1.007505703 | 0.808511455 | 1.008764237 | 0.781633367 |
| 0.09 | 0.91 | 2 | 1.014231684 | 0.744585044 | 1.011657442 | 0.712443545 |
| 0.04 | 0.96 | 2 L | 1.016550989 | 0.659050854 | 1.010693041 | 0.621709058 |

Results show that the HFO-1234ze(E) and propane compositions of the present invention provide similar CAP and energy efficiency relative to propane for cooling and heating using residential heat pump systems. Adding 71 wt-% of HFO-1234ze(E) to butane reduces the heat of combustion to 4.303 kcal/g (7741 Btu/lbm), which meets the 2L requirement. Adding 76 wt-% of HFO-1234ze(E) to butane increases the LFL to 0.1024 kg/m\hat{ }3 (0.0064 lb/ft\hat{ }3), which meets the 2L requirement.

### Example 42: Propylene/HFO-1234ze(E)

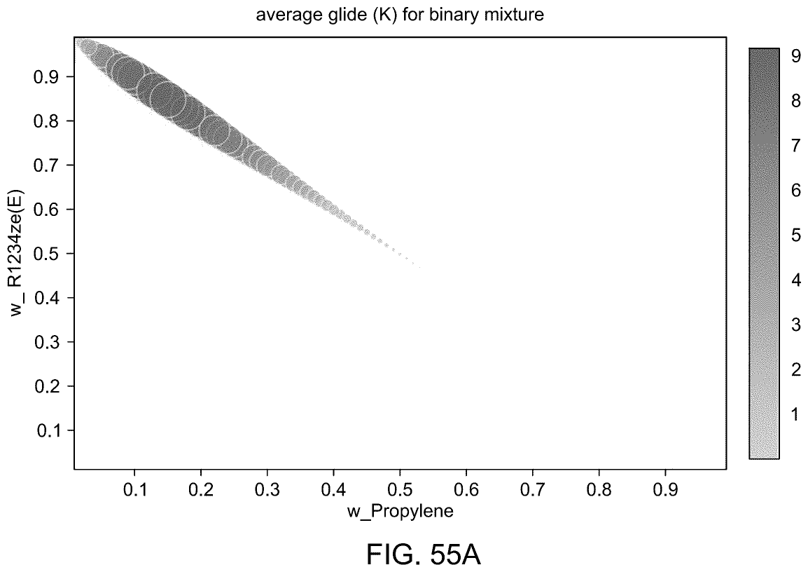

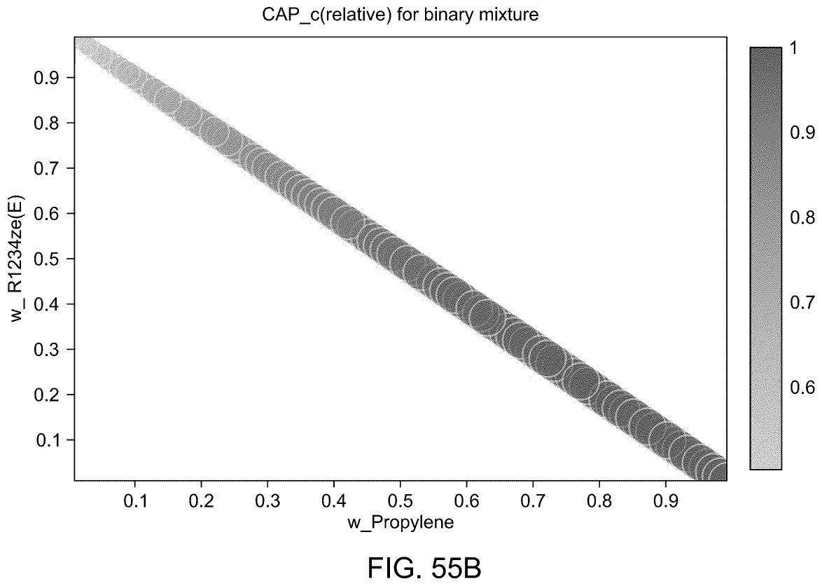

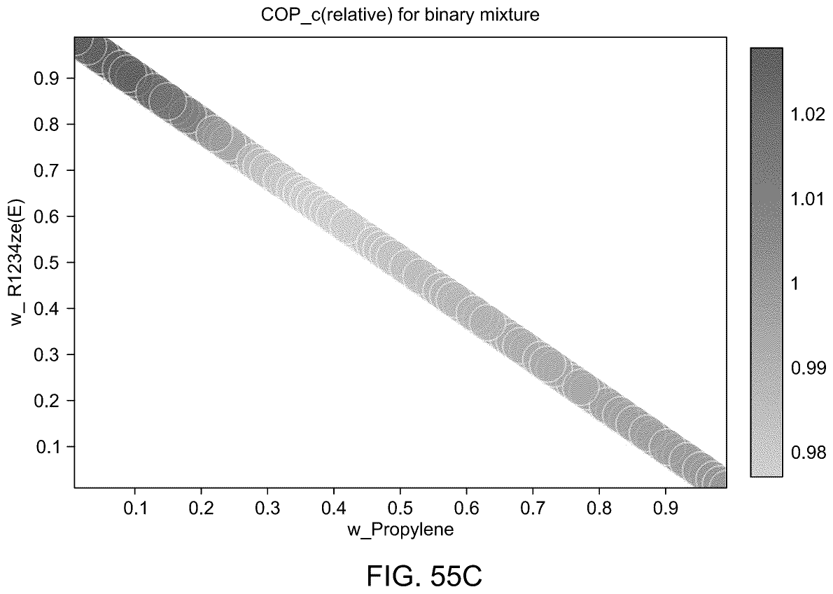

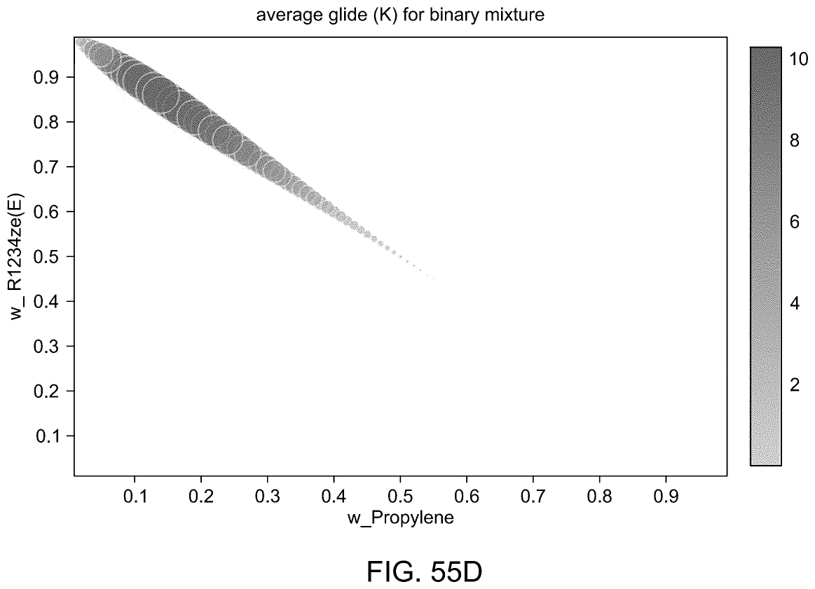

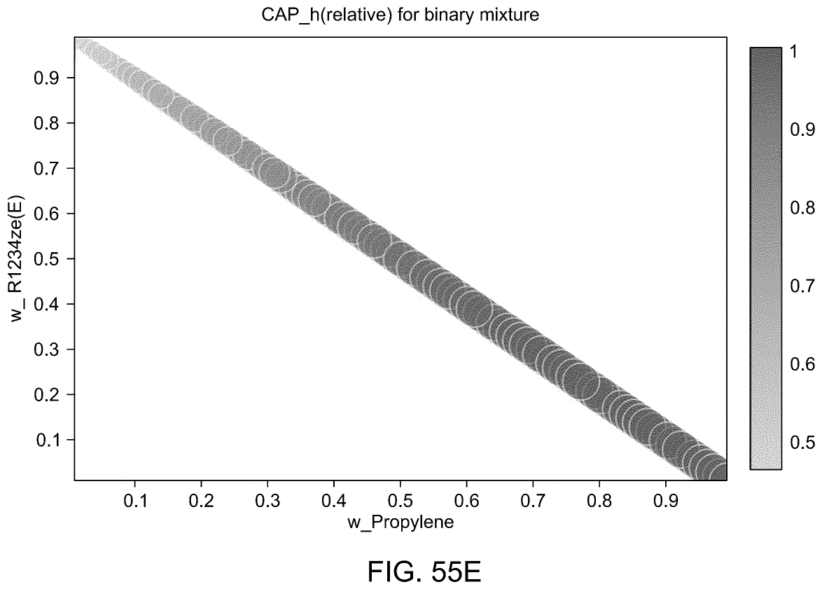

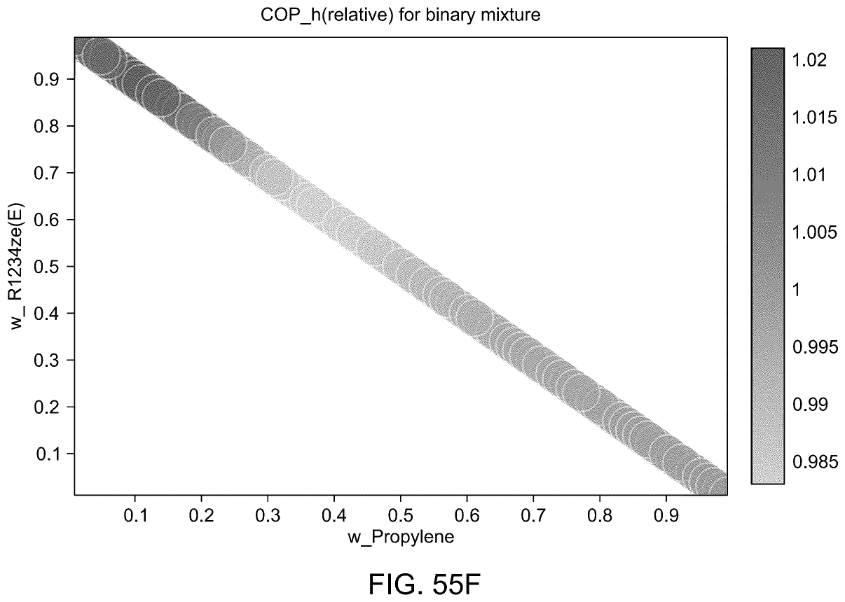

Refrigerant performance has been determined for an exemplary composition of the present invention comprising propylene and HFO-1234ze(E) in residential heat pump systems as compared to propylene, in cooling or heating modes. The cooling mode data are based on the conditions set forth in Table 2. The heating mode data are based on the conditions set forth in Table 3. Table 76 tabulates several compositions about the compositions of optimal cooling/heating efficiency and capacity, where the average temperature glide is <10 K and GWP<2. FIGS. 55A, 55B and 55C provide graphical representations of the average glide, the CAP for cooling relative to the incumbent fluid, and the COP for cooling relative to the incumbent fluid, respectively, for a composition according to Example 42, and FIGS. 55D, 55E and 55F provide graphical representations of the average glide, the CAP for heating relative to the incumbent fluid, and the COP for heating relative to the incumbent fluid, respectively, for a composition according to Example 42.

TABLE 76
Residential Heat Pump Cooling Mode Condition, cycle metric performance
and fluid property ranges for propylene/1234zeE in Ex. 42

| | | average | | | | |
|---|---|---|---|---|---|---|
| | | glide | average | | | |
| | | cooling | glide | GWP | del_h_comb | LFL |
| w_propylene | w_R1234ze(E) | (K) | heating(K) | AR5 | (kcal/g) | (kg/m\hat{ }3) |
| 0.99 | 0.01 | 0.0046 | 0.0041 | 1.495 | 10.8429 | 0.032492853 |
| 0.94 | 0.06 | 0.0182 | 0.0156 | 1.47 | 10.4074 | 0.034007188 |
| 0.89 | 0.11 | 0.0187 | 0.0146 | 1.445 | 9.9719 | 0.035669574 |
| 0.84 | 0.16 | 0.0111 | 0.0073 | 1.42 | 9.5364 | 0.03750284 |
| 0.79 | 0.21 | 0.0037 | 0.0034 | 1.395 | 9.1009 | 0.039534759 |
| 0.74 | 0.26 | 0.0091 | 0.0178 | 1.37 | 8.6654 | 0.041799472 |
| 0.69 | 0.31 | 0.0461 | 0.0731 | 1.345 | 8.2299 | 0.044339416 |
| 0.64 | 0.36 | 0.1422 | 0.203 | 1.32 | 7.7944 | 0.047208009 |
| 0.59 | 0.41 | 0.3367 | 0.4565 | 1.295 | 7.3589 | 0.050473451 |
| 0.54 | 0.46 | 0.6813 | 0.8981 | 1.27 | 6.9234 | 0.054224213 |
| 0.49 | 0.51 | 1.2357 | 1.5957 | 1.245 | 6.4879 | 0.058577176 |
| 0.44 | 0.56 | 2.0486 | 2.5872 | 1.22 | 6.0524 | 0.063690028 |
| 0.39 | 0.61 | 3.1321 | 3.8566 | 1.195 | 5.6169 | 0.069780774 |
| 0.34 | 0.66 | 4.4499 | 5.3421 | 1.17 | 5.1814 | 0.077159633 |
| 0.29 | 0.71 | 5.9158 | 6.9422 | 1.145 | 4.7459 | 0.086283553 |
| 0.24 | 0.76 | 7.3828 | 8.5002 | 1.12 | 4.3104 | 0.097854597 |
| 0.19 | 0.81 | 8.6083 | 9.7625 | 1.095 | 3.8749 | 0.113009755 |
| 0.14 | 0.86 | 9.1915 | 10.3029 | 1.07 | 3.4394 | 0.133719455 |
| 0.09 | 0.91 | 8.479 | 9.42 | 1.045 | 3.0039 | 0.163722578 |
| 0.04 | 0.96 | 5.3972 | 5.9668 | 1.02 | 2.5684 | 0.211084343 |

| | | ASHRAE | | | | |
|---|---|---|---|---|---|---|
| | | flammability | COP_c | CAP_c | COP_h | CAP_h |
| w_propylene | w_R1234ze(E) | class | (relative) | (relative) | (relative) | (relative) |
| 0.99 | 0.01 | 3 | 0.999806478 | 1.000343303 | 0.99992094 | 1.000449543 |
| 0.94 | 0.06 | 3 | 0.998401269 | 1.001679782 | 0.999337669 | 1.00231995 |
| 0.89 | 0.11 | 3 | 0.99699606 | 1.002314043 | 0.998559974 | 1.003461628 |
| 0.84 | 0.16 | 3 | 0.99559085 | 1.002132825 | 0.997976703 | 1.003704538 |
| 0.79 | 0.21 | 3 | 0.994185641 | 1.000932259 | 0.997199008 | 1.002854353 |
| 0.74 | 0.26 | 3 | 0.992780431 | 0.998508475 | 0.996615737 | 1.000643871 |
| 0.69 | 0.31 | 3 | 0.991375222 | 0.99452169 | 0.995838043 | 0.996635854 |
| 0.64 | 0.36 | 3 | 0.989735811 | 0.988541512 | 0.994671501 | 0.990320191 |
| 0.59 | 0.41 | 3 | 0.987862199 | 0.979978985 | 0.993116111 | 0.980870988 |
| 0.54 | 0.46 | 3 | 0.985520183 | 0.968063934 | 0.990977451 | 0.967292314 |
| 0.49 | 0.51 | 3 | 0.982475563 | 0.95198088 | 0.987866672 | 0.948709691 |
| 0.44 | 0.56 | 3 | 0.979196741 | 0.931412693 | 0.98456147 | 0.925050247 |
| 0.39 | 0.61 | 3 | 0.977323128 | 0.906789763 | 0.98300608 | 0.897188459 |
| 0.34 | 0.66 | 3 | 0.978259934 | 0.87901818 | 0.984755893 | 0.866266003 |
| 0.29 | 0.71 | 3 | 0.984114974 | 0.848618943 | 0.99039418 | 0.832598663 |
| 0.24 | 0.76 | 3 | 0.994419842 | 0.814753921 | 0.999726516 | 0.795239089 |
| 0.19 | 0.81 | 3 | 1.00753513 | 0.774818112 | 1.010614242 | 0.751563853 |
| 0.14 | 0.86 | 3 | 1.01947941 | 0.723941297 | 1.018974459 | 0.696690461 |
| 0.09 | 0.91 | 2 | 1.025802852 | 0.655984731 | 1.020724272 | 0.624448997 |
| 0.04 | 0.96 | 2 L | 1.02556865 | 0.566010238 | 1.016835799 | 0.530515661 |

Results show that the HFO-1234ze(E) and propylene compositions of the present invention provide improved CAP and energy efficiency relative to propylene for cooling and heating using residential heat pump systems. Additionally, in many cases, the HFO-1234ze(E) and propylene compositions of the present invention provide improved cooling capacity and energy efficiency relative to isobutane. Adding 76 wt-% of R-1234zeE to propylene reduces the heat of combustion to below 4.54 kcal/g (8169 Btu/lbm), which is the 2L requirement. Adding 81 wt-% of R-1234zeE to propylene increases the LFL to above 0.099 kg/m\hat{ }3 (0.0062 lb/ft\hat{ }3), which is the 2L requirement.

### Performance Examples for High Temperature Heat

### Puma Systems Comprising Hydrocarbon Compositions

### Example 33: Isobutene/HFO-1234ze(Z)

Refrigerant performance has been determined for an exemplary composition of the present invention comprising isobutene and HFO-1234ze(Z) in high temperature heat pumps as compared to isobutene. It will be understood by those skilled in the art that the weight percents in the refrigerant performance data are nominal weight fractions. The data are based on the conditions set forth in Table 23. Table 67 tabulates several compositions about the compositions of optimal heating efficiency and capacity, where the average temperature glide is <4 K and GWP˜1.

TABLE 67
High Temperature Heat Pump Heating Mode Conditions,
cycle metric performance and fluid property
ranges for Isobutene/1234zeZ in Ex. 33

| | | average | | | |
|---|---|---|---|---|---|
| w_{—} | w_{—} | glide | GWP | del_h_comb | LFL |
| Isobutene | R1234ze(Z) | (K) | AR5 | (kcal/g) | (kg/m\hat{ }3) |
| 0.99 | 0.01 | 0.0104 | 1 | 10.641436 | 0.043365792 |
| 0.94 | 0.06 | 0.0502 | 1 | 10.216616 | 0.045291666 |
| 0.89 | 0.11 | 0.0708 | 1 | 9.791796 | 0.047396546 |
| 0.84 | 0.16 | 0.0746 | 1 | 9.366976 | 0.049706605 |
| 0.79 | 0.21 | 0.0653 | 1 | 8.942156 | 0.052253382 |
| 0.74 | 0.26 | 0.0474 | 1 | 8.517336 | 0.055075226 |
| 0.69 | 0.31 | 0.0273 | 1 | 8.092516 | 0.058219245 |
| 0.64 | 0.36 | 0.0128 | 1 | 7.667696 | 0.061743954 |
| 0.59 | 0.41 | 0.0134 | 1 | 7.242876 | 0.065722953 |
| 0.54 | 0.46 | 0.0394 | 1 | 6.818056 | 0.070250119 |
| 0.49 | 0.51 | 0.1006 | 1 | 6.393236 | 0.07544711 |
| 0.44 | 0.56 | 0.2034 | 1 | 5.968416 | 0.081474459 |
| 0.39 | 0.61 | 0.3482 | 1 | 5.543596 | 0.088548455 |
| 0.34 | 0.66 | 0.5279 | 1 | 5.118776 | 0.096967641 |
| 0.29 | 0.71 | 0.7275 | 1 | 4.693956 | 0.107156036 |
| 0.24 | 0.76 | 0.9235 | 1 | 4.269136 | 0.119736786 |
| 0.19 | 0.81 | 1.0803 | 1 | 3.844316 | 0.135664611 |
| 0.14 | 0.86 | 1.1441 | 1 | 3.419496 | 0.156480176 |

| | | ASHRAE | | |
|---|---|---|---|---|
| | | flammability | COP_h | CAP_h |
| w_Isobutene | w_R1234ze(Z) | class | (relative) | (relative) |
| 0.99 | 0.01 | 3 | 0.998117287 | 0.999398407 |
| 0.94 | 0.06 | 3 | 0.987418397 | 0.995726878 |
| 0.89 | 0.11 | 3 | 0.976719507 | 0.99114778 |
| 0.84 | 0.16 | 3 | 0.96557483 | 0.98561986 |
| 0.79 | 0.21 | 3 | 0.954430153 | 0.979225624 |
| 0.74 | 0.26 | 3 | 0.943731263 | 0.972006326 |
| 0.69 | 0.31 | 3 | 0.93347816 | 0.964126978 |
| 0.64 | 0.36 | 3 | 0.924116631 | 0.955835098 |
| 0.59 | 0.41 | 3 | 0.91653825 | 0.947460712 |
| 0.54 | 0.46 | 3 | 0.911188805 | 0.939375098 |
| 0.49 | 0.51 | 3 | 0.90895987 | 0.931990787 |
| 0.44 | 0.56 | 3 | 0.910743018 | 0.925596551 |
| 0.39 | 0.61 | 3 | 0.917429825 | 0.920357403 |
| 0.34 | 0.66 | 3 | 0.929020289 | 0.916025824 |
| 0.29 | 0.71 | 3 | 0.945514411 | 0.911983017 |
| 0.24 | 0.76 | 3 | 0.967803765 | 0.90728016 |
| 0.19 | 0.81 | 3 | 0.994550991 | 0.900762165 |
| 0.14 | 0.86 | 3 | 1.025756087 | 0.890985172 |

Results show that the HFO-1234ze(Z) and isobutene compositions of the present invention provide similar CAP and similar energy efficiency relative to isobutene, for heating using high temperature heat pump systems. Additionally, in many cases, the HFO-1234ze(Z) and isobutene compositions of the present invention provide similar heating capacity relative to isobutene. Adding 73 wt % of HFO-1234ze(Z) to isobutene reduces the heat of combustion to below 4.54 kcal/g (8169 Btu/lbm), which is an 2L requirement, while the heating capacity remains within 10% of the CAP of isobutene.

### Example 34: Pentane/HFO-1234ze(Z)

Refrigerant performance has been determined for an exemplary composition of the present invention comprising pentane and HFO-1234ze(Z) in high temperature heat pumps as compared to pentane. The data are based on the conditions set forth in Table 23. Table 68 tabulates several compositions about the compositions of optimal heating efficiency and capacity, where the average temperature glide is <4 K and GWP˜1.

TABLE 68
High Temperature Heat Pump Heating Mode Conditions,
cycle metric performance and fluid property
ranges for Pentane/1234zeZ in Ex. 34

| | | average | | | |
|---|---|---|---|---|---|
| w_{—} | w_{—} | glide | GWP | del_h_comb | LFL |
| Pentane | R1234ze(Z) | (K) | AR5 | (kcal/g) | (kg/m\hat{ }3) |
| 0.99 | 0.01 | 0.4358 | 10.9 | 10.6153 | 0.049481646 |
| 0.94 | 0.06 | 2.3911 | 10.4 | 10.1918 | 0.051618427 |
| 0.89 | 0.11 | 3.9966 | 9.9 | 9.7683 | 0.053948083 |
| 0.84 | 0.16 | 5.2813 | 9.4 | 9.3448 | 0.056497964 |
| 0.79 | 0.21 | 6.2709 | 8.9 | 8.9213 | 0.059300845 |
| 0.74 | 0.26 | 6.987 | 8.4 | 8.4978 | 0.062396347 |
| 0.69 | 0.31 | 7.4473 | 7.9 | 8.0743 | 0.065832818 |
| 0.64 | 0.36 | 7.6653 | 7.4 | 7.6508 | 0.069669878 |
| 0.59 | 0.41 | 7.6497 | 6.9 | 7.2273 | 0.073981907 |
| 0.54 | 0.46 | 7.405 | 6.4 | 6.8038 | 0.078862913 |
| 0.49 | 0.51 | 6.9309 | 5.9 | 6.3803 | 0.084433469 |
| 0.44 | 0.56 | 6.2245 | 5.4 | 5.9568 | 0.0908508 |
| 0.39 | 0.61 | 5.2855 | 4.9 | 5.5333 | 0.098323865 |
| 0.34 | 0.66 | 4.1347 | 4.4 | 5.1098 | 0.107136537 |
| 0.29 | 0.71 | 2.8518 | 3.9 | 4.6863 | 0.117684483 |
| 0.24 | 0.76 | 1.6199 | 3.4 | 4.2628 | 0.130536202 |
| 0.19 | 0.81 | 0.6956 | 2.9 | 3.8393 | 0.146538973 |
| 0.14 | 0.86 | 0.1979 | 2.4 | 3.4158 | 0.167013602 |

| | | ASHRAE | | |
|---|---|---|---|---|
| | | flammability | COP_h | CAP_h |
| w_Pentane | w_R1234ze(Z) | class | (relative) | (relative) |
| 0.99 | 0.01 | 3 | 1.001012699 | 1.011255715 |
| 0.94 | 0.06 | 3 | 1.004716039 | 1.066325138 |
| 0.89 | 0.11 | 3 | 1.005827041 | 1.120236313 |
| 0.84 | 0.16 | 3 | 1.004716039 | 1.173410422 |
| 0.79 | 0.21 | 3 | 1.001383033 | 1.22637394 |
| 0.74 | 0.26 | 3 | 0.996198358 | 1.279758638 |
| 0.69 | 0.31 | 3 | 0.989532347 | 1.333880404 |
| 0.64 | 0.36 | 3 | 0.981384999 | 1.389265713 |
| 0.59 | 0.41 | 3 | 0.97212665 | 1.446125155 |
| 0.54 | 0.46 | 3 | 0.961386965 | 1.504774617 |
| 0.49 | 0.51 | 3 | 0.949536279 | 1.564898213 |
| 0.44 | 0.56 | 3 | 0.936944924 | 1.626180057 |
| 0.39 | 0.61 | 3 | 0.923983235 | 1.687356605 |
| 0.34 | 0.66 | 3 | 0.910651213 | 1.747480201 |
| 0.29 | 0.71 | 3 | 0.898800526 | 1.806024368 |
| 0.24 | 0.76 | 3 | 0.890282845 | 1.863410287 |
| 0.19 | 0.81 | 3 | 0.886949839 | 1.919743253 |
| 0.14 | 0.86 | 3 | 0.889912511 | 1.975339152 |

Results show that the HFO-1234ze(Z) and pentane compositions of the present invention provide improved CAP and similar energy efficiency relative to pentane, for heating using high temperature heat pump systems. Additionally, in many cases, the HFO-1234ze(Z) and pentane compositions of the present invention provide improved heating capacity relative to pentane. Adding 73 wt-% of HFO-1234ze(Z) to pentane reduces the heat of combustion to below 4.54 kcal/g (8169 Btu/lbm), which is an 2L requirement, while the heating capacity is increased to 83% of the CAP of pentane.

### Example 35: Isobutane/HFO-1234ze(Z)

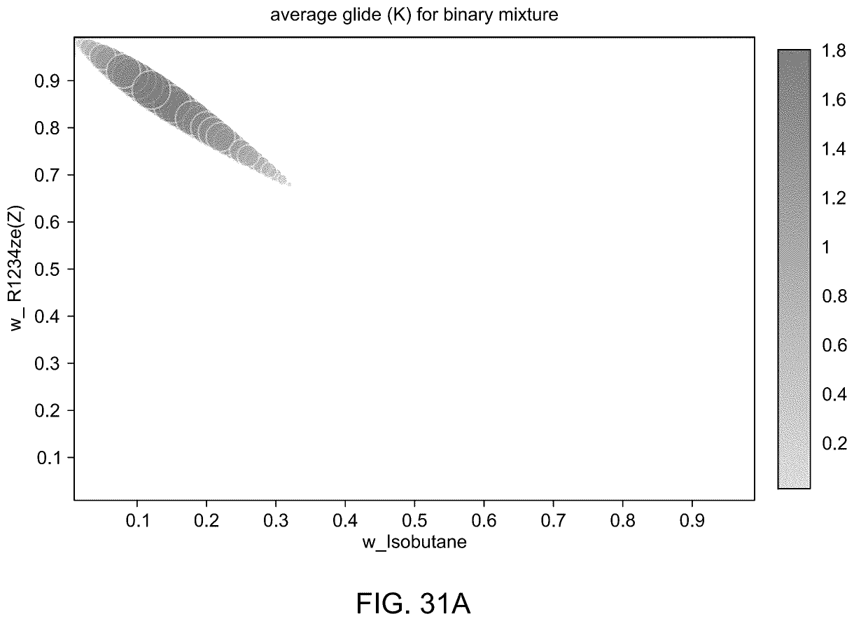

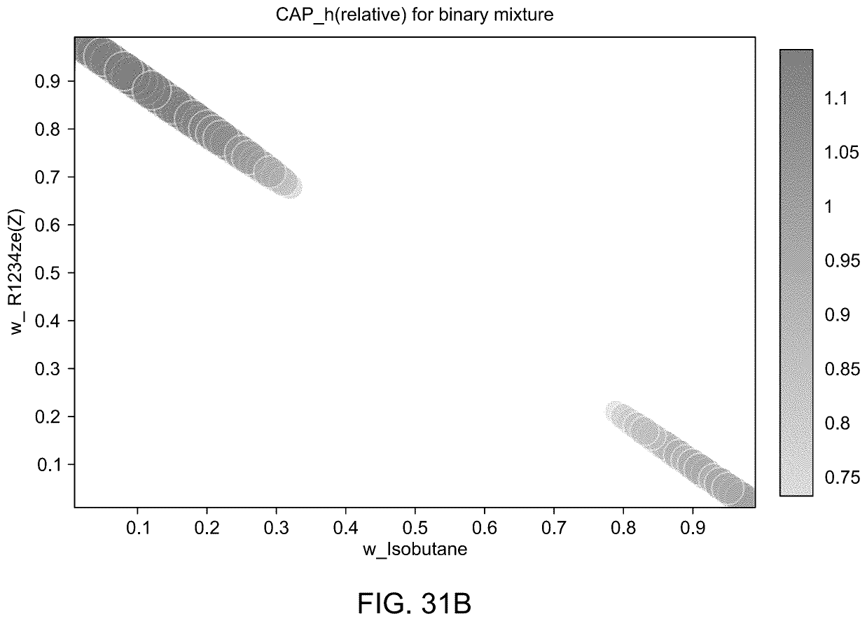

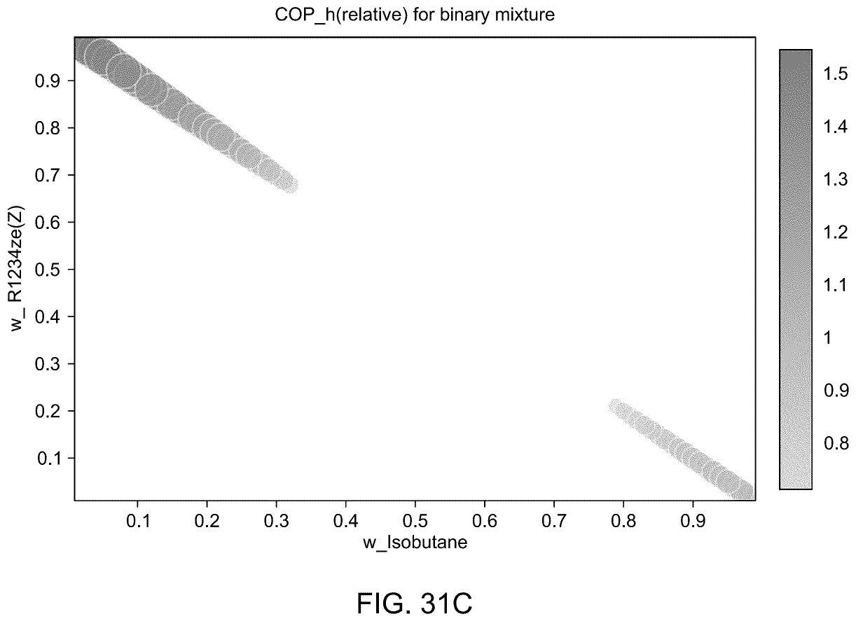

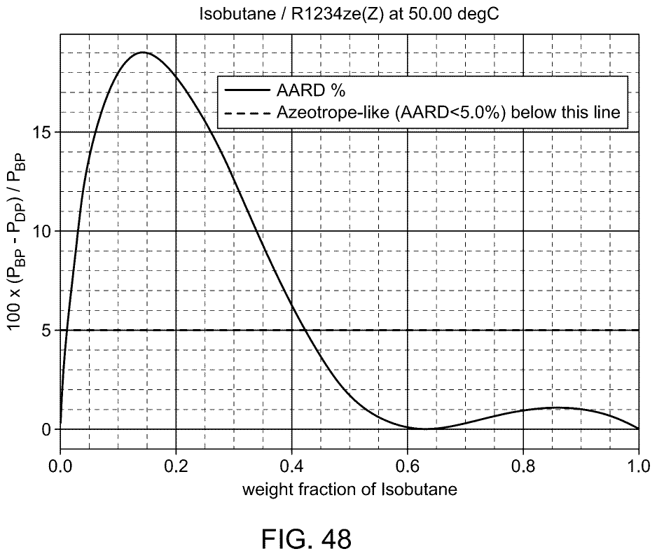

Refrigerant performance has been determined for an exemplary composition of the present invention comprising isobutane and HFO-1234ze(Z) in high temperature heat pumps as compared to isobutane. It will be understood by those skilled in the art that the weight percents in the refrigerant performance data are nominal weight fractions. The data are based on the conditions set forth in Table 23. Table 69 tabulates several compositions about the compositions of optimal heating efficiency and capacity, where the average temperature glide is <1 K and GWP˜3 or less. FIGS. 31A, 31B and 31C provide graphical representations of the average glide, the CAP for heating relative to the incumbent fluid, and the COP for heating relative to the incumbent fluid, respectively, for a composition according to Example 35. FIG. 48 shows near azeotropic behavior from 43 to 100 wt-% isobutane, with an azeotrope at 62 wt-% isobutane at 50° C. for compositions according to Example 35.

TABLE 69
High Temperature Heat Pump Heating Mode Conditions, cycle metric performance
and fluid property ranges for Isobutane/1234zeZ in Ex. 35

| | | average | | | | | |
|---|---|---|---|---|---|---|---|
| | | glide | GWP | del_h_comb | del_h_comb | LFL | LFL |
| w_Isobutane | w_R1234ze(Z) | (K) | AR5 | (kcal/g) | (relative) | (kg/m\hat{ }3) | (relative) |
| 0.99 | 0.01 | 0.0178 | 2.98 | 10.6549 | 0.99207635 | 0.043729249 | 1.016959276 |
| 0.96 | 0.04 | 0.0607 | 2.92 | 10.3996 | 0.9683054 | 0.044872272 | 1.043541206 |
| 0.93 | 0.07 | 0.0886 | 2.86 | 10.1443 | 0.944534451 | 0.046076653 | 1.071550065 |
| 0.9 | 0.1 | 0.1027 | 2.8 | 9.889 | 0.920763501 | 0.047347468 | 1.101103918 |
| 0.87 | 0.13 | 0.1041 | 2.74 | 9.6337 | 0.896992551 | 0.048690372 | 1.132334227 |
| 0.84 | 0.16 | 0.0939 | 2.68 | 9.3784 | 0.873221601 | 0.050111676 | 1.165387803 |
| 0.81 | 0.19 | 0.0715 | 2.62 | 9.1231 | 0.849450652 | 0.051618452 | 1.200429113 |
| 0.32 | 0.68 | 0.2875 | 1.64 | 4.9532 | 0.461191806 | 0.10143475 | 2.358947668 |
| 0.29 | 0.71 | 0.7356 | 1.58 | 4.6979 | 0.437420857 | 0.107804596 | 2.507083618 |
| 0.26 | 0.74 | 1.0259 | 1.52 | 4.4426 | 0.413649907 | 0.115028067 | 2.675071336 |
| 0.23 | 0.77 | 1.2884 | 1.46 | 4.1873 | 0.389878957 | 0.123289081 | 2.867187926 |
| 0.2 | 0.8 | 1.5187 | 1.4 | 3.932 | 0.366108007 | 0.132828472 | 3.089034244 |
| 0.17 | 0.83 | 1.6973 | 1.34 | 3.6767 | 0.342337058 | 0.143967868 | 3.348089963 |
| 0.14 | 0.86 | 1.7967 | 1.28 | 3.4214 | 0.318566108 | 0.157146661 | 3.654573509 |
| 0.11 | 0.89 | 1.7823 | 1.22 | 3.1661 | 0.294795158 | 0.172981341 | 4.022821893 |
| 0.08 | 0.92 | 1.6122 | 1.16 | 2.9108 | 0.271024209 | 0.192364725 | 4.473598248 |
| 0.05 | 0.95 | 1.2373 | 1.1 | 2.6555 | 0.247253259 | 0.216640302 | 5.038146569 |
| 0.02 | 0.98 | 0.601 | 1.04 | 2.4002 | 0.223482309 | 0.24792768 | 5.76575999 |

| | | ASHRAE | | |
|---|---|---|---|---|
| | | flammability | COP_h | CAP_h |
| w_Isobutane | w_R1234ze(Z) | class | (relative) | (relative) |
| 0.99 | 0.01 | 3 | 0.992910296 | 0.995422824 |
| 0.96 | 0.04 | 3 | 0.969475146 | 0.979897729 |
| 0.93 | 0.07 | 3 | 0.975642291 | 0.906181056 |
| 0.9 | 0.1 | 3 | 0.915204273 | 0.938717691 |
| 0.87 | 0.13 | 3 | 0.881284977 | 0.910640392 |
| 0.84 | 0.16 | 3 | 0.846132252 | 0.858119327 |
| 0.81 | 0.19 | 3 | 0.782610662 | 0.819031323 |
| 0.32 | 0.68 | 3 | 0.778910375 | 0.785008243 |
| 0.29 | 0.71 | 3 | 0.955907428 | 0.947746469 |
| 0.26 | 0.74 | 3 | 1.042864168 | 1.012984899 |
| 0.23 | 0.77 | 3 | 1.115019761 | 1.058128791 |
| 0.2 | 0.8 | 3 | 1.180391495 | 1.091656389 |
| 0.17 | 0.83 | 3 | 1.242679656 | 1.116265316 |
| 0.14 | 0.86 | 3 | 1.303117674 | 1.133001588 |
| 0.11 | 0.89 | 2 | 1.361088834 | 1.142195527 |
| 0.08 | 0.92 | 2 | 1.41844328 | 1.144067347 |
| 0.05 | 0.95 | 2 | 1.473947582 | 1.138451887 |
| 0.02 | 0.98 | 2 L | 1.52883517 | 1.125294094 |

Results show that the HFO-1234ze(Z) and isobutane compositions of the present invention provide similar CAP and similar energy efficiency relative to isobutane, for heating using high temperature heat pump systems. Additionally, in many cases, the HFO-1234ze(Z) and isobutane compositions of the present invention provide similar heating capacity relative to isobutane. Adding 73 wt % of HFO-1234ze(Z) to isobutane reduces the heat of combustion to below 4.54 kcal/g (8169 Btu/lbm), which is an 2L requirement, while the heating capacity remains similar to the CAP of isobutane.

### Example 36: Butane/HFO-1234ze(Z)

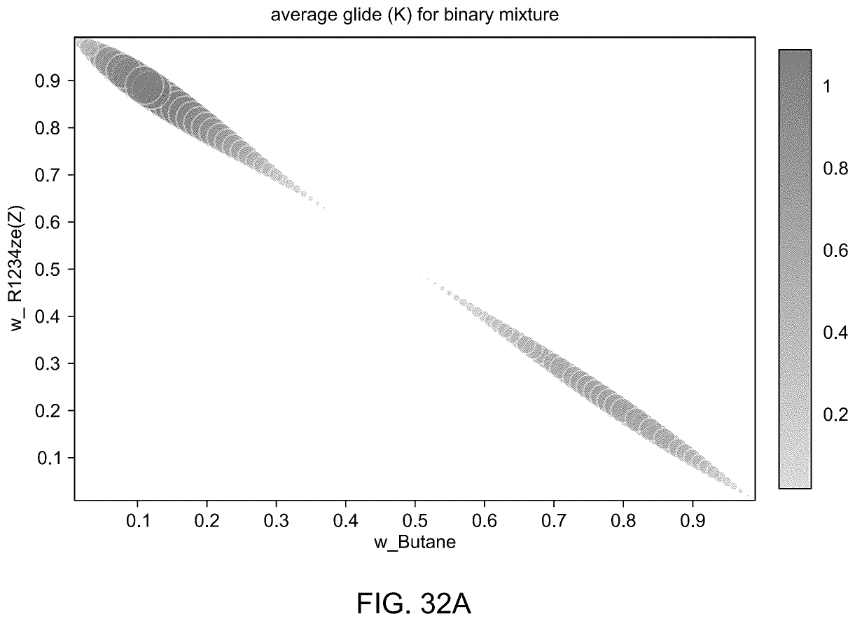

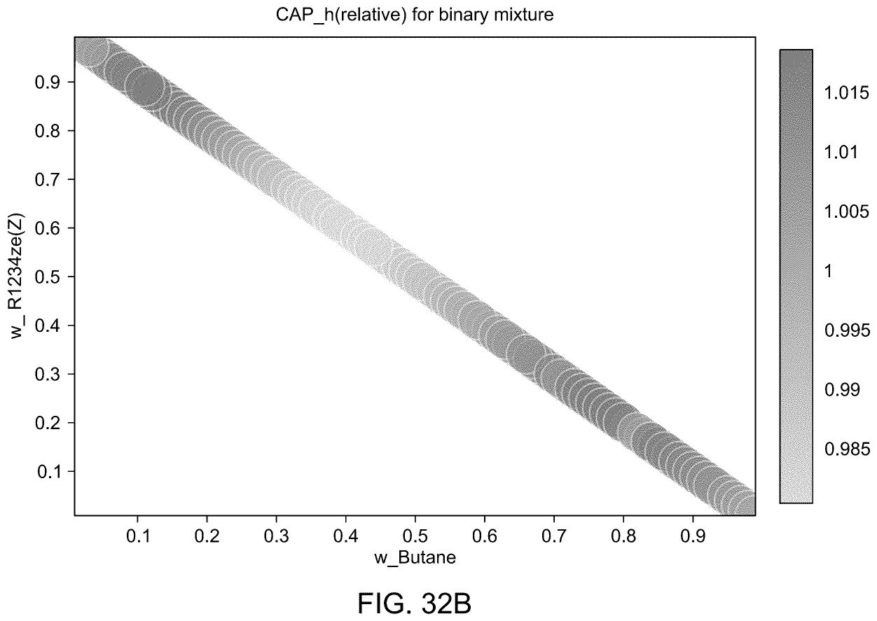

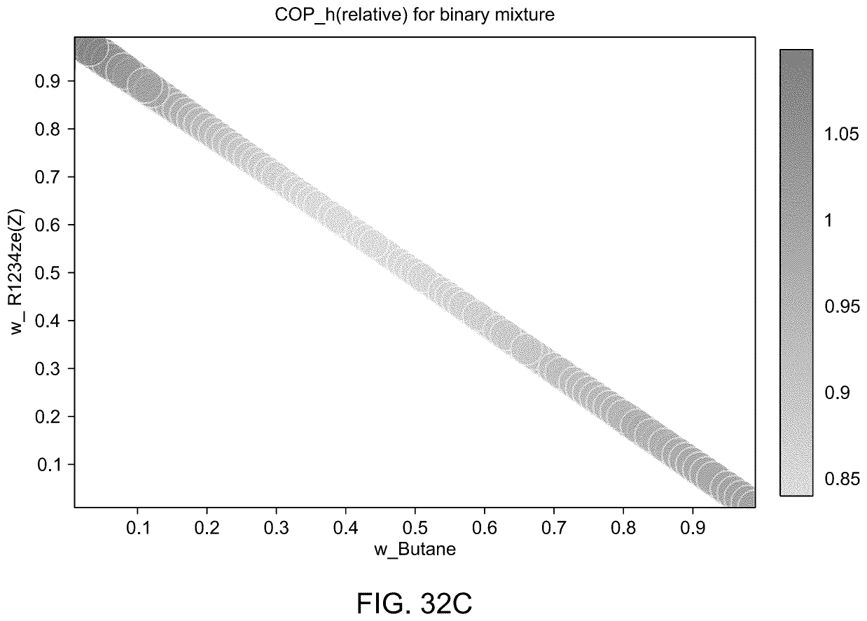

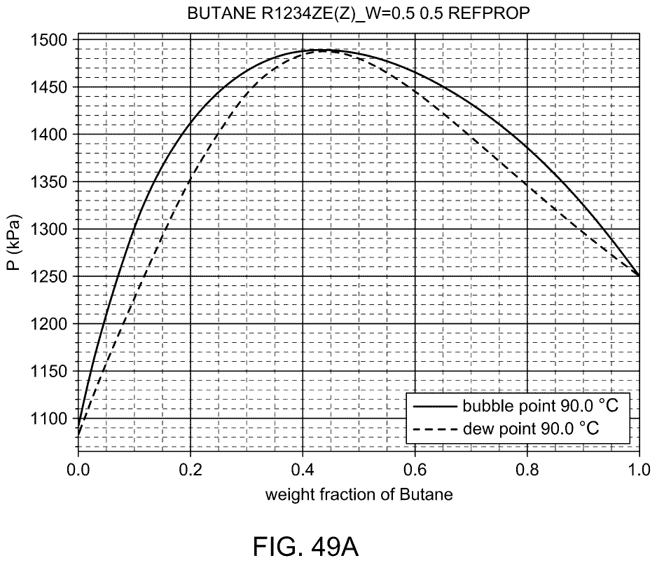

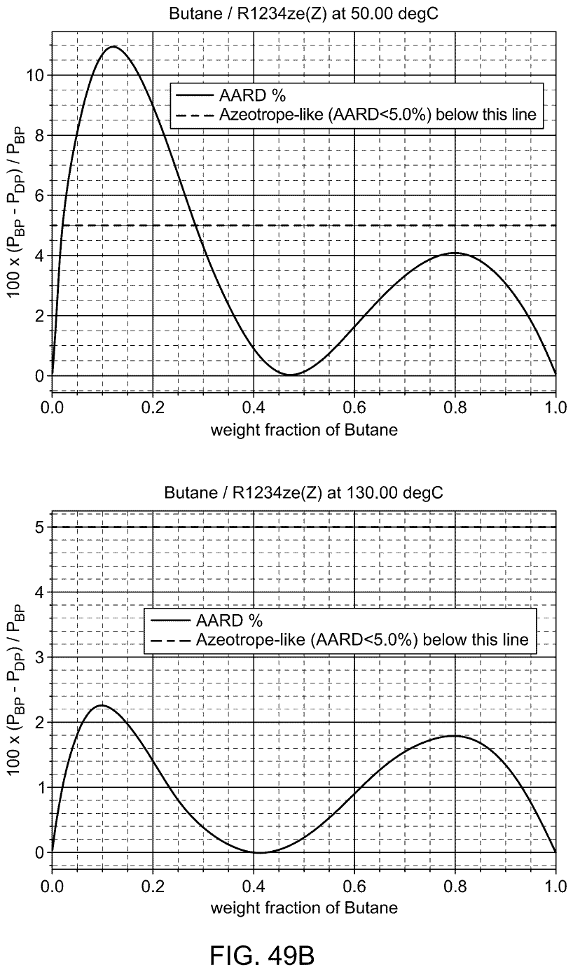

Refrigerant performance has been determined for an exemplary composition of the present invention comprising butane and HFO-1234ze(Z) in high temperature heat pumps as compared to butane. It will be understood by those skilled in the art that the weight percents in the refrigerant performance data are nominal weight fractions. The data are based on the conditions set forth in Table 23. Table 70 tabulates several compositions about the compositions of optimal heating efficiency and capacity, where the average temperature glide is <˜1 K and GWP˜3 or less. FIGS. 32A, 32B and 32C provide graphical representations of the average glide, the CAP for heating relative to the incumbent fluid, and the COP for heating relative to the incumbent fluid, respectively, for a composition according to Example 36. FIGS. 49A and 49B show an azeotrope at 44 wt-% butane and 90° ˜C as well as near azeotropic behavior over the majority of the composition range, from 28 to 100 wt-% butane at 50° C. and over the whole composition range at the condenser heating temperature of 130° C. for compositions according to Example 36.

TABLE 70
High Temperature Heat Pump Heating Mode Conditions, cycle metric performance
and fluid property ranges for Butane/1234zeZ in Ex. 36

| | | Avg. | | | | | |
|---|---|---|---|---|---|---|---|
| | | glide | GWP | del_h_comb | del_h_comb | LFL | LFL |
| w_Butane | w_R1234ze(Z) | (K) | AR5 | (kcal/g) | (relative) | (kg/m\hat{ }3) | (relative) |
| 0.99 | 0.01 | 0.0657 | 2.98 | 10.6846 | 0.992070566 | 0.04365337 | 1.015194653 |
| 0.94 | 0.06 | 0.344 | 2.88 | 10.2576 | 0.952423398 | 0.045589495 | 1.060220807 |
| 0.89 | 0.11 | 0.5398 | 2.78 | 9.8306 | 0.91277623 | 0.047705333 | 1.109426347 |
| 0.84 | 0.16 | 0.6567 | 2.68 | 9.4036 | 0.873129062 | 0.050027124 | 1.163421499 |
| 0.79 | 0.21 | 0.6998 | 2.58 | 8.9766 | 0.833481894 | 0.052586479 | 1.222941362 |
| 0.74 | 0.26 | 0.6763 | 2.48 | 8.5496 | 0.793834726 | 0.055421822 | 1.288879576 |
| 0.69 | 0.31 | 0.5959 | 2.38 | 8.1226 | 0.754187558 | 0.05858034 | 1.362333497 |
| 0.64 | 0.36 | 0.4721 | 2.28 | 7.6956 | 0.71454039 | 0.062120627 | 1.444665754 |
| 0.59 | 0.41 | 0.323 | 2.18 | 7.2686 | 0.674893222 | 0.066116351 | 1.537589564 |
| 0.54 | 0.46 | 0.1742 | 2.08 | 6.8416 | 0.635246054 | 0.070661437 | 1.643289236 |
| 0.49 | 0.51 | 0.0599 | 1.98 | 6.4146 | 0.595598886 | 0.075877544 | 1.764594047 |
| 0.44 | 0.56 | 0.019 | 1.88 | 5.9876 | 0.555951718 | 0.081925117 | 1.905235268 |
| 0.39 | 0.61 | 0.0773 | 1.78 | 5.5606 | 0.51630455 | 0.08902018 | 2.070236744 |
| 0.34 | 0.66 | 0.23 | 1.68 | 5.1336 | 0.476657382 | 0.09746069 | 2.26652768 |
| 0.29 | 0.71 | 0.4486 | 1.58 | 4.7066 | 0.437010214 | 0.107669443 | 2.503940544 |
| 0.24 | 0.76 | 0.6967 | 1.48 | 4.2796 | 0.397363045 | 0.120267109 | 2.796909521 |
| 0.19 | 0.81 | 0.9291 | 1.38 | 3.8526 | 0.357715877 | 0.136203331 | 3.167519319 |
| 0.14 | 0.86 | 1.0783 | 1.28 | 3.4256 | 0.318068709 | 0.157007969 | 3.651348122 |
| 0.09 | 0.91 | 1.0409 | 1.18 | 2.9986 | 0.278421541 | 0.185314131 | 4.309630954 |
| 0.04 | 0.96 | 0.6691 | 1.08 | 2.5716 | 0.238774373 | 0.226071381 | 5.257473982 |

| | | ASHRAE | | |
|---|---|---|---|---|
| | | flammability | COP_h | CAP_h |
| w_Butane | w_R1234ze(Z) | class | (relative) | (relative) |
| 0.99 | 0.01 | 3 | 0.997749373 | 1.001572304 |
| 0.94 | 0.06 | 3 | 0.98593392 | 1.008441462 |
| 0.89 | 0.11 | 3 | 0.972805639 | 1.013446134 |
| 0.84 | 0.16 | 3 | 0.958364529 | 1.016439125 |
| 0.79 | 0.21 | 3 | 0.943048201 | 1.017420433 |
| 0.74 | 0.26 | 3 | 0.926419045 | 1.016242863 |
| 0.69 | 0.31 | 3 | 0.90891467 | 1.01295548 |
| 0.64 | 0.36 | 3 | 0.891410295 | 1.007754546 |
| 0.59 | 0.41 | 3 | 0.874343529 | 1.001032584 |
| 0.54 | 0.46 | 3 | 0.859027201 | 0.993525576 |
| 0.49 | 0.51 | 3 | 0.847211748 | 0.986509222 |
| 0.44 | 0.56 | 3 | 0.840209998 | 0.981651746 |
| 0.39 | 0.61 | 3 | 0.841085217 | 0.980621372 |
| 0.34 | 0.66 | 3 | 0.850712623 | 0.984301278 |
| 0.29 | 0.71 | 3 | 0.869529826 | 0.992151744 |
| 0.24 | 0.76 | 3 | 0.897536826 | 1.00225922 |
| 0.19 | 0.81 | 3 | 0.932983186 | 1.011876041 |
| 0.14 | 0.86 | 3 | 0.974118467 | 1.017911087 |
| 0.09 | 0.91 | 2 | 1.020067451 | 1.017420433 |
| 0.04 | 0.96 | 2 L | 1.069079701 | 1.007509219 |

Results show that the HFO-1234ze(Z) and butane compositions of the present invention provide similar CAP and similar energy efficiency relative to butane, for heating using high temperature heat pump systems. Additionally, in many cases, the HFO-1234ze(Z) and butane compositions of the present invention provide similar heating capacity relative to butane. Adding 73 wt % of HFO-1234ze(Z) to butane reduces the heat of combustion to below 4.54 kcal/g (8169 Btu/lbm), which is an 2L requirement, while the heating capacity remains similar to the CAP of butane.

### Example 37: Pentane/HFO-1336mzz(E)

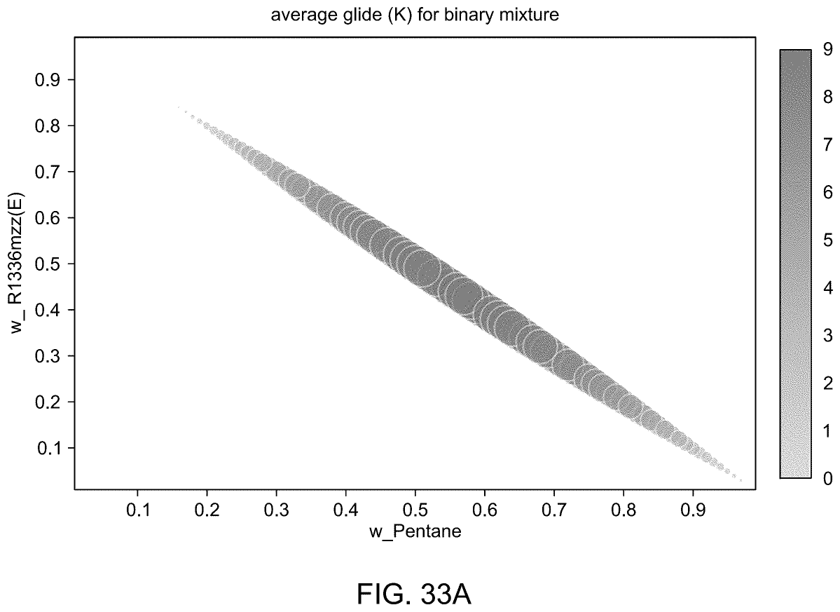

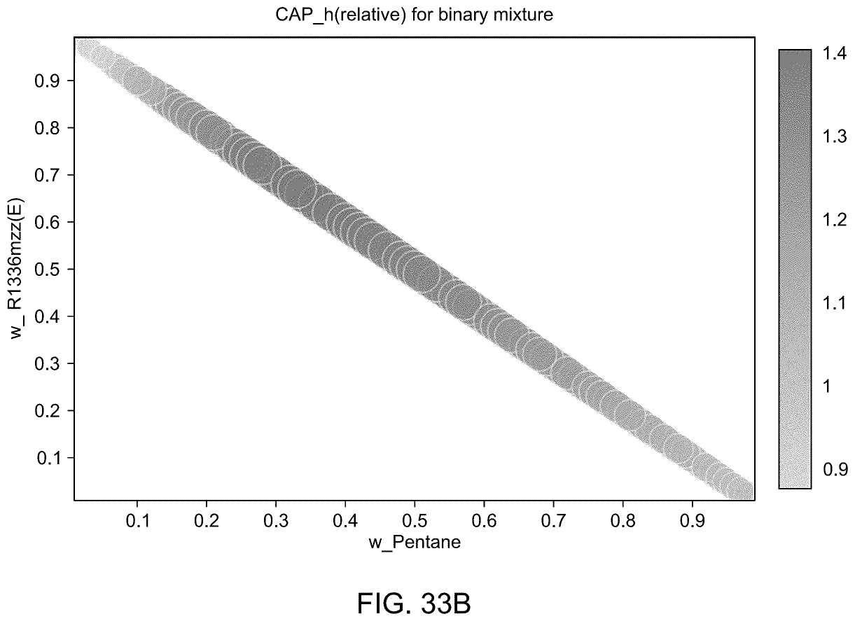

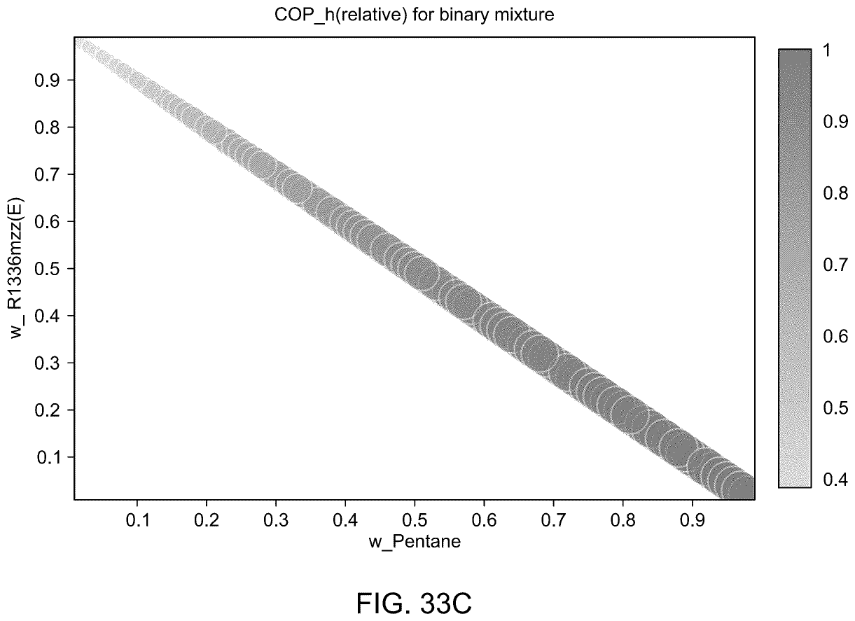

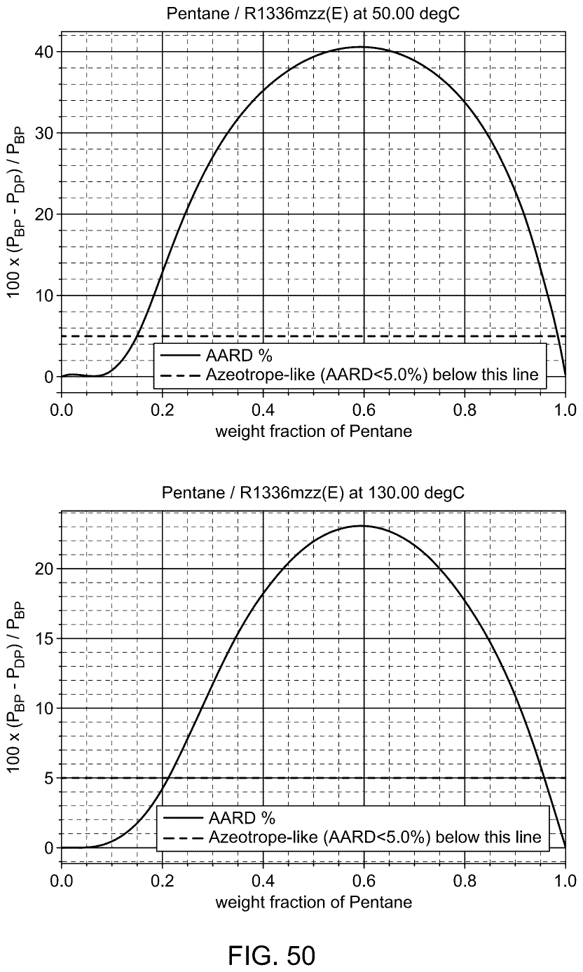

Refrigerant performance has been determined for an exemplary composition of the present invention comprising pentane and HFO-1336mzz(E) in high temperature heat pumps as compared to pentane. It will be understood by those skilled in the art that the weight percents in the refrigerant performance data are nominal weight fractions. The data are based on the conditions set forth in Table 23. Table 71 tabulates several compositions about the compositions of optimal heating efficiency and capacity, where the average temperature glide is <˜1 K and GWP˜3 or less. FIGS. 33A, 33B and 33C provide graphical representations of the average glide, the CAP for heating relative to the incumbent fluid, and the COP for heating relative to the incumbent fluid, respectively, for a composition according to Example 37. FIG. 50 shows near azeotropic behavior from 0 to 14 wt-% pentane with an azeotrope at 7 wt-% pentane at the evaporator temperature of 50° C. and near azeotropic behavior from 0 to 22 wt-% pentane at the condenser temperature of 130° C. for compositions according to Example 37.

TABLE 71
High Temperature Heat Pump Heating Mode Conditions, cycle metric performance
and fluid property ranges for Pentane/1336mzzE in Ex. 37

| | | Avg. | | | | | |
|---|---|---|---|---|---|---|---|
| | | glide | GWP | del_h_comb | del_h_comb | LFL | LFL |
| w_Pentane | w_R1336mzz(E) | (K) | AR5 | (kcal/g) | (relative) | (kg/m\hat{ }3) | (relative) |
| 0.99 | 0.01 | 0.3848 | 11.05 | 10.61186 | 0.991762617 | 0.049502237 | 1.010249728 |
| 0.94 | 0.06 | 2.1931 | 11.3 | 10.17116 | 0.950575701 | 0.051753166 | 1.05618707 |
| 0.89 | 0.11 | 3.8036 | 11.55 | 9.73046 | 0.909388785 | 0.054218553 | 1.106501083 |
| 0.84 | 0.16 | 5.2099 | 11.8 | 9.28976 | 0.868201869 | 0.056930578 | 1.161848535 |
| 0.79 | 0.21 | 6.4063 | 12.05 | 8.84906 | 0.827014953 | 0.059928201 | 1.223024517 |
| 0.74 | 0.26 | 7.3871 | 12.3 | 8.40836 | 0.785828037 | 0.063259043 | 1.291000888 |
| 0.69 | 0.31 | 8.1458 | 12.55 | 7.96766 | 0.744641121 | 0.066981936 | 1.366978288 |
| 0.64 | 0.36 | 8.6745 | 12.8 | 7.52696 | 0.703454206 | 0.071170426 | 1.452457669 |
| 0.59 | 0.41 | 8.9633 | 13.05 | 7.08626 | 0.66226729 | 0.075917682 | 1.549340455 |
| 0.54 | 0.46 | 9 | 13.3 | 6.64556 | 0.621080374 | 0.081343511 | 1.660071644 |
| 0.49 | 0.51 | 8.7698 | 13.55 | 6.20486 | 0.579893458 | 0.087604602 | 1.787849013 |
| 0.44 | 0.56 | 8.2561 | 13.8 | 5.76416 | 0.538706542 | 0.094909912 | 1.936936983 |
| 0.39 | 0.61 | 7.4441 | 14.05 | 5.32346 | 0.497519626 | 0.103544439 | 2.113151815 |
| 0.34 | 0.66 | 6.3307 | 14.3 | 4.88276 | 0.45633271 | 0.11390727 | 2.324638161 |
| 0.29 | 0.71 | 4.9441 | 14.55 | 4.44206 | 0.415145794 | 0.126575025 | 2.583163774 |
| 0.24 | 0.76 | 3.3662 | 14.8 | 4.00136 | 0.373958879 | 0.142412926 | 2.906386241 |
| 0.19 | 0.81 | 1.7554 | 15.05 | 3.56066 | 0.332771963 | 0.162781179 | 3.322064883 |
| 0.14 | 0.86 | 0.5318 | 15.3 | 3.11996 | 0.291585047 | 0.189948021 | 3.876490227 |
| 0.09 | 0.91 | 0.0737 | 15.55 | 2.67926 | 0.250398131 | 0.227999218 | 4.653045266 |
| 0.04 | 0.96 | 0.0016 | 15.8 | 2.23856 | 0.209211215 | 0.285114587 | 5.818665038 |

| | | ASHRAE | | |
|---|---|---|---|---|
| | | flammability | COP_h | CAP_h |
| w_Penanet | w_R1336mzz(E) | class | (relative) | (relative) |
| 0.99 | 0.01 | 3 | 1.000272031 | 1.008096857 |
| 0.94 | 0.06 | 3 | 1.000642365 | 1.047898467 |
| 0.89 | 0.11 | 3 | 0.99916103 | 1.086857715 |
| 0.84 | 0.16 | 3 | 0.99545769 | 1.125079896 |
| 0.79 | 0.21 | 3 | 0.989532347 | 1.162459714 |
| 0.74 | 0.26 | 3 | 0.981384999 | 1.198891876 |
| 0.69 | 0.31 | 3 | 0.970645315 | 1.234271084 |
| 0.64 | 0.36 | 3 | 0.956942958 | 1.26838675 |
| 0.59 | 0.41 | 3 | 0.94027793 | 1.300817691 |
| 0.54 | 0.46 | 3 | 0.920279896 | 1.330932137 |
| 0.49 | 0.51 | 3 | 0.895837854 | 1.357993019 |
| 0.44 | 0.56 | 3 | 0.866581471 | 1.380526206 |
| 0.39 | 0.61 | 3 | 0.832140413 | 1.396320496 |
| 0.34 | 0.66 | 3 | 0.791403677 | 1.402322326 |
| 0.29 | 0.71 | 3 | 0.743260262 | 1.393688114 |
| 0.24 | 0.76 | 3 | 0.6869695 | 1.363678964 |
| 0.19 | 0.81 | 3 | 0.631419405 | 1.274915056 |
| 0.14 | 0.86 | 2 | 0.550316268 | 1.200471305 |
| 0.09 | 0.91 | 2 L | 0.476249475 | 1.06695691 |
| 0.04 | 0.96 | 1 | 0.404775021 | 0.885006694 |

Results show that the HFO-1336mzz(E) and pentane compositions of the present invention provide similar CAP and similar energy efficiency, in some cases, relative to pentane, for heating using high temperature heat pump systems. Adding 71 wt % of HFO-1336mzz(E) to pentane reduces the heat of combustion to below 4.54 kcal/g (8169 Btu/lbm), which is an 2L requirement, while the heating capacity remains similar to the CAP of pentane.

### Example 38: Pentane/HCFO-1233zd(E)

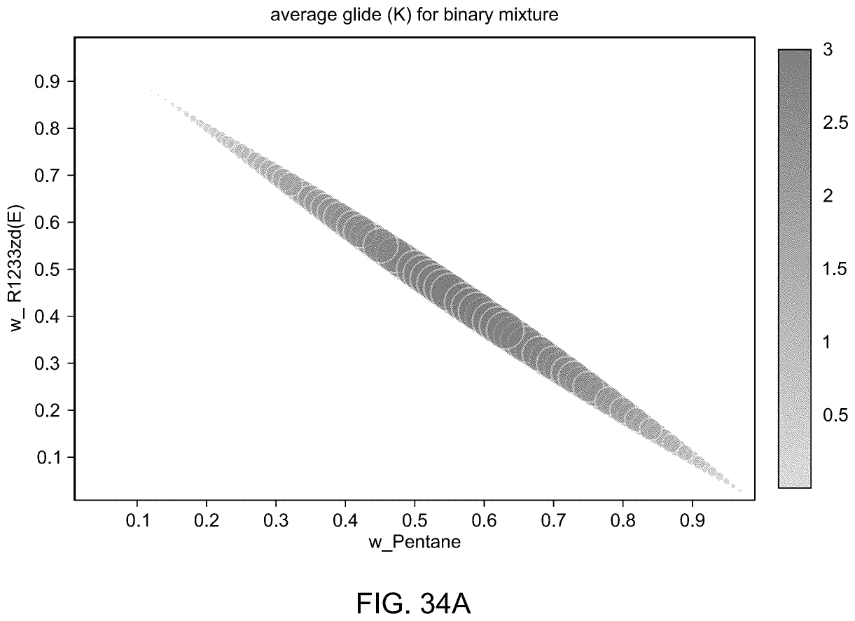

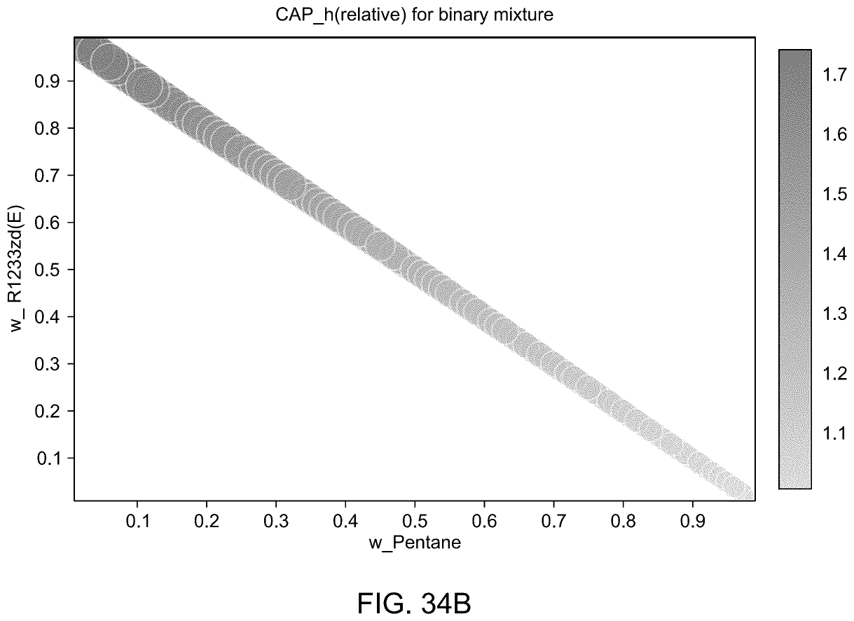

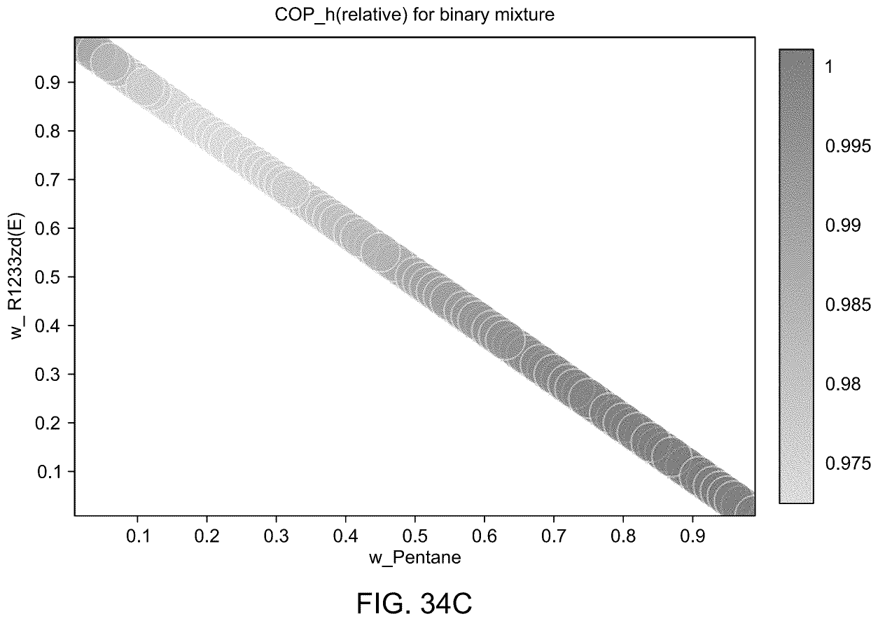

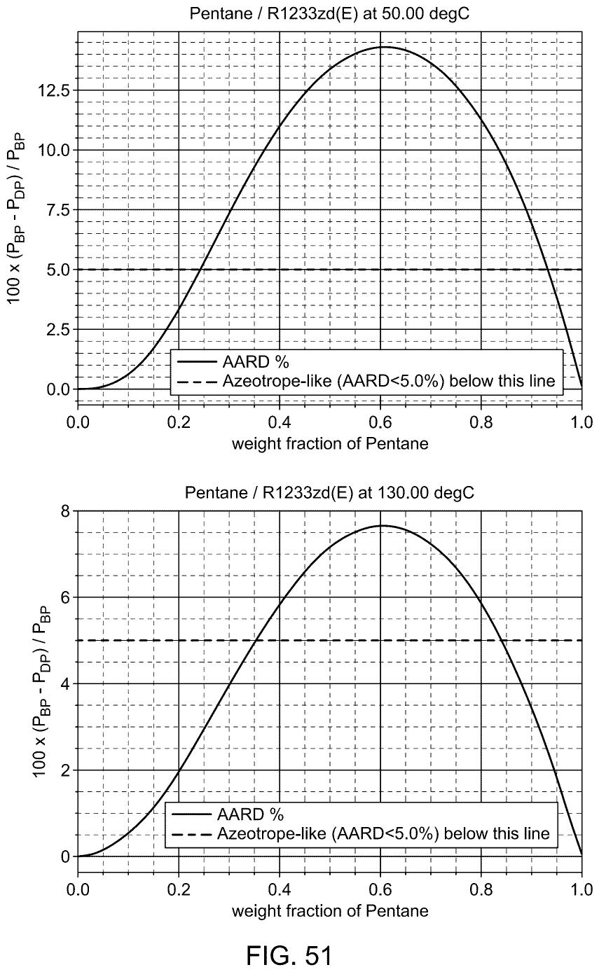

Refrigerant performance has been determined for an exemplary composition of the present invention comprising pentane and HCFO-1233zd(E) in high temperature heat pumps as compared to pentane. It will be understood by those skilled in the art that the weight percents in the refrigerant performance data are nominal weight fractions. The data are based on the conditions set forth in Table 23. Table 72 tabulates several compositions about the compositions of optimal heating efficiency and capacity, where the average temperature glide is <3 K and GWP˜10 or less. FIGS. 34A, 34B and 34C provide graphical representations of the average glide, the CAP for heating relative to the incumbent fluid, and the COP for heating relative to the incumbent fluid, respectively, for a composition according to Example 38. FIG. 51 shows near azeotropic behavior from 0 to 24 and 0 to 35 wt-% pentane at 50° C. and 130′° C., respectively, for compositions according to Example 38.

TABLE 72
High Temperature Heat Pump Heating Mode Conditions, cycle metric performance
and fluid property ranges for Pentane/1233zdE in Ex. 38

| | | Avg. | | | | | |
|---|---|---|---|---|---|---|---|
| | | glide | GWP | del_h_comb | del_h_comb | LFL | LFL |
| w_Pentane | w_R1233zd(E) | (K) | AR5 | (kcal/g) | (relative) | (kg/m\hat{ }3) | (relative) |
| 0.99 | 0.01 | 0.1286 | 10.9 | 10.6141 | 0.991971963 | 0.04949392 | 1.010079998 |
| 0.94 | 0.06 | 0.7343 | 10.4 | 10.1846 | 0.951831776 | 0.051698673 | 1.055074951 |
| 0.89 | 0.11 | 1.2756 | 9.9 | 9.7551 | 0.911691589 | 0.054109009 | 1.104265484 |
| 0.84 | 0.16 | 1.7498 | 9.4 | 9.3256 | 0.871551402 | 0.056755089 | 1.158267125 |
| 0.79 | 0.21 | 2.1538 | 8.9 | 8.8961 | 0.831411215 | 0.059673278 | 1.217821992 |
| 0.74 | 0.26 | 2.4842 | 8.4 | 8.4666 | 0.791271028 | 0.062907823 | 1.283833113 |
| 0.69 | 0.31 | 2.737 | 7.9 | 8.0371 | 0.751130841 | 0.066513116 | 1.357410526 |
| 0.64 | 0.36 | 2.9082 | 7.4 | 7.6076 | 0.710990654 | 0.070556776 | 1.439934205 |
| 0.59 | 0.41 | 2.9932 | 6.9 | 7.1781 | 0.670850467 | 0.07512393 | 1.533141433 |
| 0.54 | 0.46 | 2.9878 | 6.4 | 6.7486 | 0.63071028 | 0.080323272 | 1.63925044 |
| 0.49 | 0.51 | 2.8885 | 5.9 | 6.3191 | 0.590570093 | 0.086295822 | 1.761139218 |
| 0.44 | 0.56 | 2.6941 | 5.4 | 5.8896 | 0.550429907 | 0.093227915 | 1.902610503 |
| 0.39 | 0.61 | 2.4078 | 4.9 | 5.4601 | 0.51028972 | 0.101370987 | 2.068795651 |
| 0.34 | 0.66 | 2.04 | 4.4 | 5.0306 | 0.470149533 | 0.11107273 | 2.266790405 |
| 0.29 | 0.71 | 1.6127 | 3.9 | 4.6011 | 0.430009346 | 0.122828026 | 2.506694399 |
| 0.24 | 0.76 | 1.1617 | 3.4 | 4.1716 | 0.389869159 | 0.137366055 | 2.803388874 |
| 0.19 | 0.81 | 0.7354 | 2.9 | 3.7421 | 0.349728972 | 0.155807571 | 3.179746349 |
| 0.14 | 0.86 | 0.3849 | 2.4 | 3.3126 | 0.309588785 | 0.179968504 | 3.672826622 |
| 0.09 | 0.91 | 0.1469 | 1.9 | 2.8831 | 0.269448598 | 0.212997886 | 4.346895637 |
| 0.04 | 0.96 | 0.0281 | 1.4 | 2.4536 | 0.229308411 | 0.260876139 | 5.324002839 |

| | | ASHRAE | | |
|---|---|---|---|---|
| | | flammability | COP_h | CAP_h |
| w_Pentane | w_R1233zd(E) | class | (relative) | (relative) |
| 0.99 | 0.01 | 3 | 1.000272031 | 1.00535918 |
| 0.94 | 0.06 | 3 | 1.001012699 | 1.032630654 |
| 0.89 | 0.11 | 3 | 1.001012699 | 1.060639194 |
| 0.84 | 0.16 | 3 | 1.000642365 | 1.089700687 |
| 0.79 | 0.21 | 3 | 1.000272031 | 1.119815132 |
| 0.74 | 0.26 | 3 | 0.998790696 | 1.151087826 |
| 0.69 | 0.31 | 3 | 0.99730936 | 1.183518767 |
| 0.64 | 0.36 | 3 | 0.99545769 | 1.217423842 |
| 0.59 | 0.41 | 3 | 0.993235686 | 1.252697756 |
| 0.54 | 0.46 | 3 | 0.990273014 | 1.289445803 |
| 0.49 | 0.51 | 3 | 0.987310343 | 1.327773279 |
| 0.44 | 0.56 | 3 | 0.983977337 | 1.367469593 |
| 0.39 | 0.61 | 3 | 0.980644331 | 1.408640041 |
| 0.34 | 0.66 | 3 | 0.977311326 | 1.451074033 |
| 0.29 | 0.71 | 3 | 0.974718988 | 1.494666272 |
| 0.24 | 0.76 | 3 | 0.972867318 | 1.539206169 |
| 0.19 | 0.81 | 3 | 0.972496984 | 1.584061951 |
| 0.14 | 0.86 | 2 | 0.974348654 | 1.628917734 |
| 0.09 | 0.91 | 1 | 0.978792662 | 1.673141745 |
| 0.04 | 0.96 | 1 | 0.986569675 | 1.715786326 |

Results show that the HCFO-1233zd(E) and pentane compositions of the present invention provide similar CAP and similar energy efficiency, in some cases, relative to pentane, for heating using high temperature heat pump systems. Adding 76 wt % of HCFO-1233zd(E) to pentane reduces the heat of combustion to below 4.54 kcal/g (8169 Btu/lbm), which is an 2L requirement, while the heating capacity remains similar to the CAP of pentane.

### Performance Examples for Medium Temperature

### Refrigeration Systems Comprising Hydrocarbon Compositions

### Example 39: Isobutane/HFO-1234ze(E)

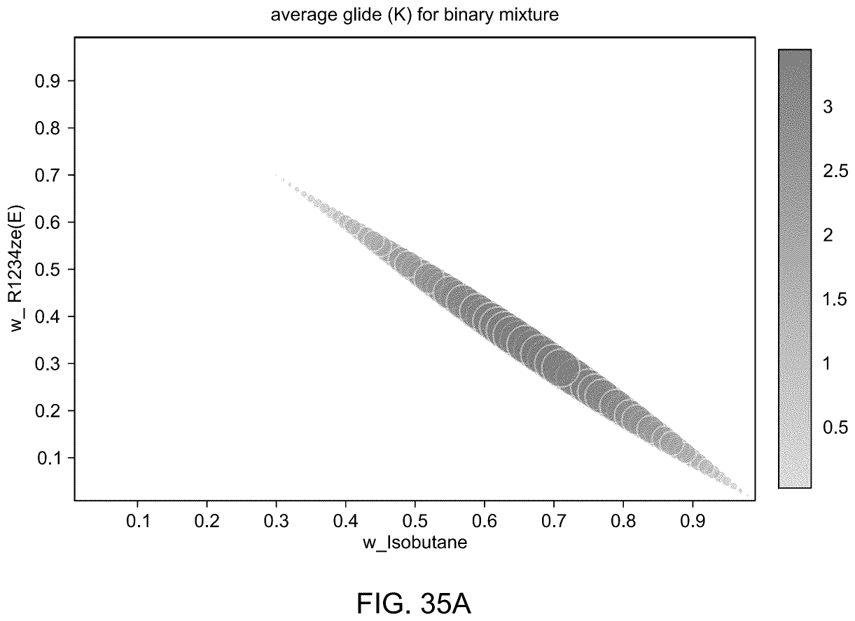

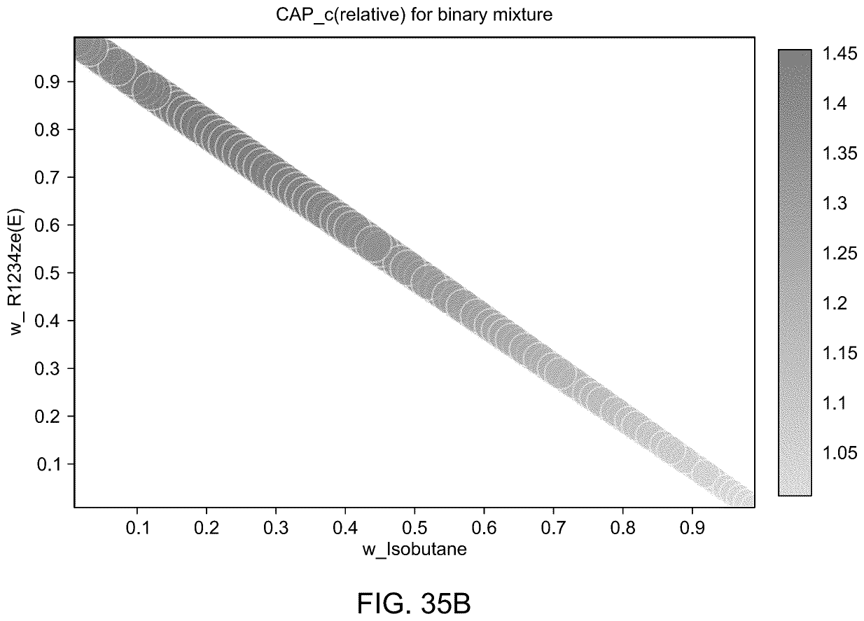

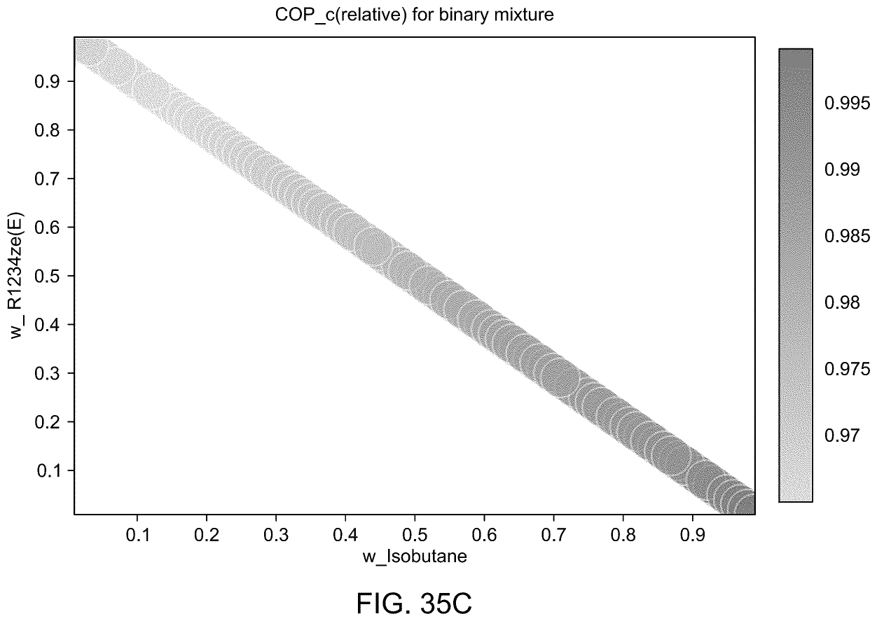

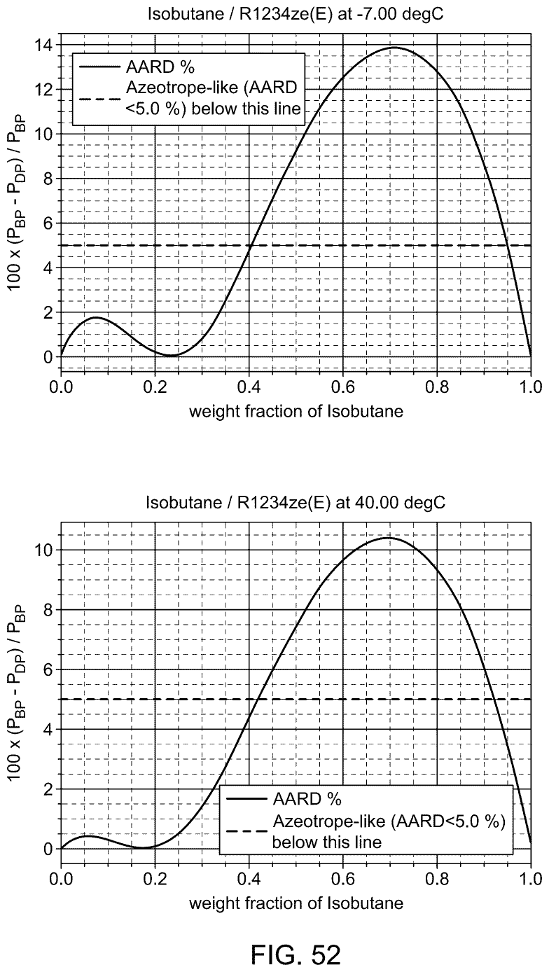

Refrigerant performance has been determined for an exemplary composition of the present invention comprising HFO-1234ze(E) and isobutane in medium temperature refrigeration systems as compared to isobutane. The data are based on the conditions set forth in Table 47. Table 73 tabulates several compositions about the compositions of optimal cooling efficiency and capacity, where the average temperature glide is <3 K and GWP˜10 or less. FIGS. 35A, 35B and 35C provide graphical representations of the average glide, the CAP for cooling relative to the incumbent fluid, and the COP for cooling relative to the incumbent fluid, respectively, for a composition according to Example 39. FIG. 52 shows near azeotropic behavior from 0 to 41 wt-% isobutane with an azeotrope at 23 wt-% isobutane at −7° C., and near azeotropic behavior from 0 to 42 wt-% isobutane with an azeotrope at 18 wt-% isobutane at 40° C., which are the evaporator and condenser temperatures, respectively, for compositions according to Example 39.

TABLE 73
Medium Temp Refrigeration System, cycle metric performance
and fluid property ranges for 1234zeE/isobutane in Ex. 39

| | | Avg. | | | | | |
|---|---|---|---|---|---|---|---|
| wt-% | wt-% | Glide | GWP | del_h_comb | del_h_comb | LFL | LFL |
| Isobutane | R1234ze(E) | (K) | AR5 | (kcal/g) | (relative) | (kg/m\hat{ }3) | (relative) |
| 0.99 | 0.01 | 0.2042 | 2.98 | 10.6548 | 0.992067039 | 0.043729326 | 1.016961059 |
| 0.94 | 0.06 | 1.1314 | 2.88 | 10.2288 | 0.952402235 | 0.045668574 | 1.062059872 |
| 0.89 | 0.11 | 1.9042 | 2.78 | 9.8028 | 0.91273743 | 0.047787803 | 1.111344263 |
| 0.84 | 0.16 | 2.5229 | 2.68 | 9.3768 | 0.873072626 | 0.050113287 | 1.165425277 |
| 0.79 | 0.21 | 2.9862 | 2.58 | 8.9508 | 0.833407821 | 0.052676676 | 1.225038983 |
| 0.74 | 0.26 | 3.2916 | 2.48 | 8.5248 | 0.793743017 | 0.055516448 | 1.291080175 |
| 0.69 | 0.31 | 3.436 | 2.38 | 8.0988 | 0.754078212 | 0.058679846 | 1.364647592 |
| 0.64 | 0.36 | 3.418 | 2.28 | 7.6728 | 0.714413408 | 0.062225538 | 1.447105536 |
| 0.59 | 0.41 | 3.2395 | 2.18 | 7.2468 | 0.674748603 | 0.066227278 | 1.540169263 |
| 0.54 | 0.46 | 2.909 | 2.08 | 6.8208 | 0.635083799 | 0.0707791 | 1.646025588 |
| 0.49 | 0.51 | 2.4452 | 1.98 | 6.3948 | 0.595418994 | 0.076002797 | 1.767506903 |
| 0.44 | 0.56 | 1.8825 | 1.88 | 5.9688 | 0.55575419 | 0.08205898 | 1.908348377 |
| 0.39 | 0.61 | 1.2781 | 1.78 | 5.5428 | 0.516089385 | 0.089163888 | 2.073578788 |
| 0.34 | 0.66 | 0.7161 | 1.68 | 5.1168 | 0.476424581 | 0.097615746 | 2.270133629 |
| 0.29 | 0.71 | 0.2932 | 1.58 | 4.6908 | 0.436759777 | 0.107837697 | 2.507853428 |
| 0.24 | 0.76 | 0.0694 | 1.48 | 4.2648 | 0.397094972 | 0.120450855 | 2.801182673 |
| 0.19 | 0.81 | 0.0321 | 1.38 | 3.8388 | 0.357430168 | 0.136405415 | 3.172218944 |
| 0.14 | 0.86 | 0.1093 | 1.28 | 3.4128 | 0.317765363 | 0.157231879 | 3.656555316 |
| 0.09 | 0.91 | 0.1975 | 1.18 | 2.9868 | 0.278100559 | 0.185563889 | 4.315439284 |
| 0.04 | 0.96 | 0.1777 | 1.08 | 2.5608 | 0.238435754 | 0.226350572 | 5.263966801 |

| | | ASHRAE | | |
|---|---|---|---|---|
| wt-% | wt-% | flammability | COP_c | CAP_c |
| Isobutane | R1234ze(E) | class | (relative) | (relative) |
| 0.99 | 0.01 | 3 | 0.999095833 | 1.006290011 |
| 0.94 | 0.06 | 3 | 0.995140825 | 1.038311968 |
| 0.89 | 0.11 | 3 | 0.992402743 | 1.070905746 |
| 0.84 | 0.16 | 3 | 0.990577354 | 1.104185709 |
| 0.79 | 0.21 | 3 | 0.989056198 | 1.137923128 |
| 0.74 | 0.26 | 3 | 0.987839272 | 1.171774912 |
| 0.69 | 0.31 | 3 | 0.986622347 | 1.205512331 |
| 0.64 | 0.36 | 3 | 0.985405421 | 1.238906658 |
| 0.59 | 0.41 | 3 | 0.983275801 | 1.271843529 |
| 0.54 | 0.46 | 3 | 0.981146182 | 1.304208579 |
| 0.49 | 0.51 | 3 | 0.978712331 | 1.335773079 |
| 0.44 | 0.56 | 3 | 0.97627848 | 1.366651395 |
| 0.39 | 0.61 | 3 | 0.973844629 | 1.39581425 |
| 0.34 | 0.66 | 3 | 0.972019241 | 1.421431815 |
| 0.29 | 0.71 | 3 | 0.969889621 | 1.440873718 |
| 0.24 | 0.76 | 3 | 0.96745577 | 1.451623947 |
| 0.19 | 0.81 | 3 | 0.965630382 | 1.452996316 |
| 0.14 | 0.86 | 3 | 0.965021919 | 1.444990827 |
| 0.09 | 0.91 | 2 | 0.96532615 | 1.427035658 |
| 0.04 | 0.96 | 2 L | 0.96745577 | 1.398215896 |

Results show that the HFO-1234ze(E) and isobutane compositions of the present invention provide similar COP or energy efficiency relative to isobutane in medium temperature refrigeration systems. Additionally, in many cases, the HFO-1234ze(E) and isobutane compositions of the present invention provide improved cooling capacity relative to isobutane. Adding 76 wt % of HFO-1234ze(E) to isobutane reduces the heat of combustion to below 4.54 kcal/g (8169 Btu/lbm), which is an 2L requirement, while the heating capacity is greater than the CAP of isobutane.

### Example 40: Butane/HFO-1234ze(E)

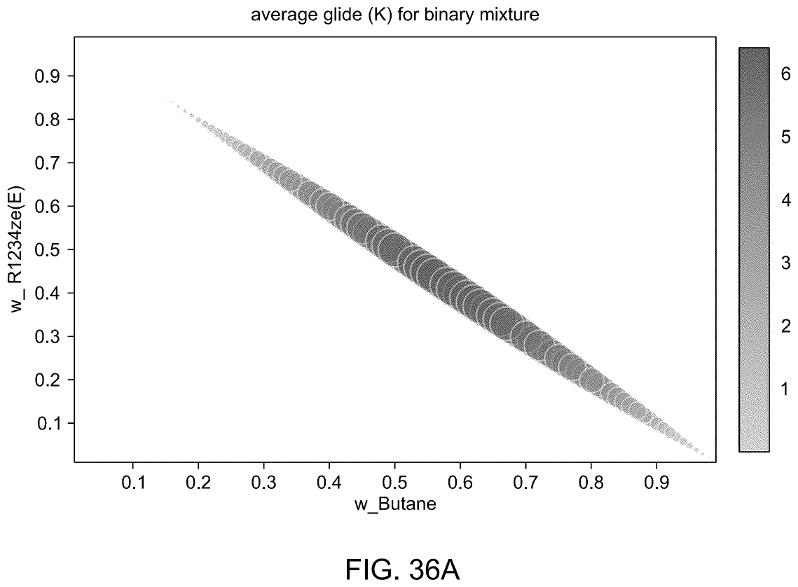

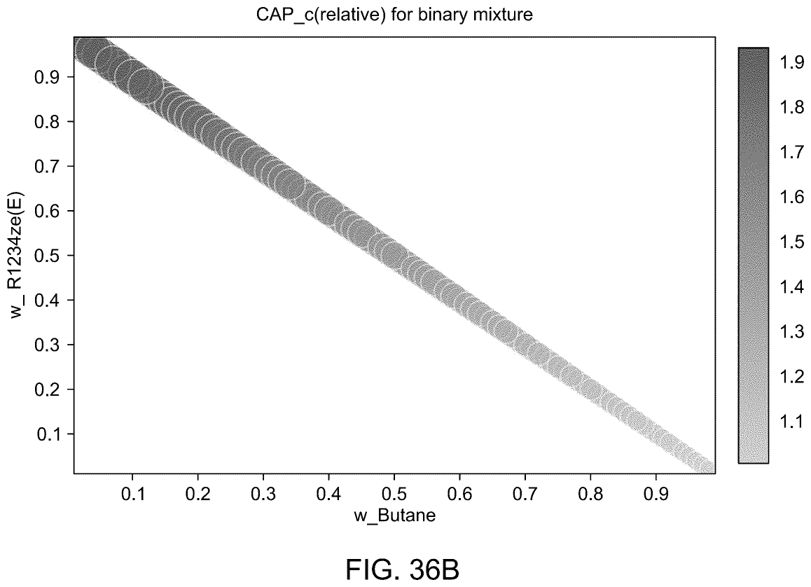

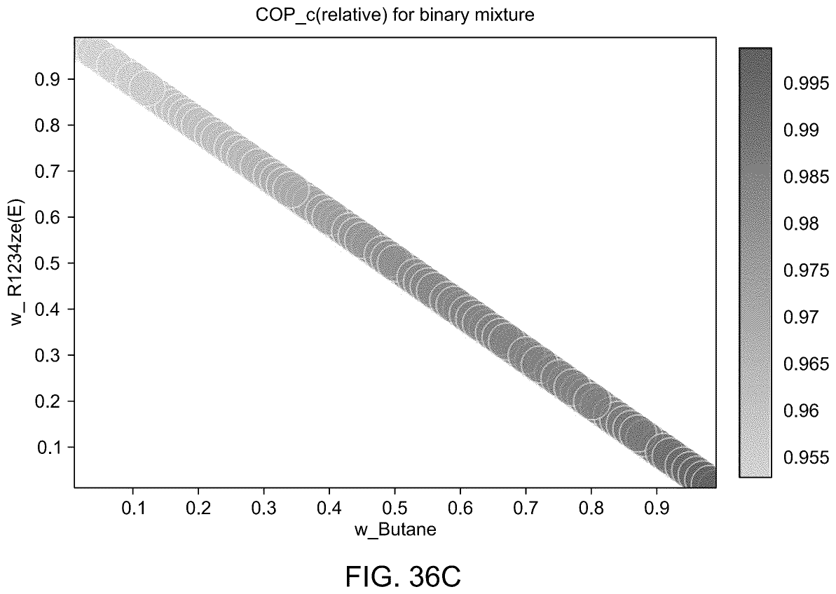

Refrigerant performance has been determined for an exemplary composition of the present invention comprising HFO-1234ze(E) and butane in medium temperature refrigeration systems as compared to butane. The data are based on the conditions set forth in Table 47. Table 74 tabulates several compositions about the compositions of optimal cooling efficiency and capacity, where the average temperature glide is <7 K and GWP˜3 or less. FIGS. 36A, 36B and 36C provide graphical representations of the average glide, the CAP for cooling relative to the incumbent fluid, and the COP for cooling relative to the incumbent fluid, respectively, for a composition according to Example 40.

TABLE 74
Medium Temp Refrigeration System, cycle metric performance
and fluid property ranges for 1234zeE/butane in Ex. 40

| | | Avg. | | | | | |
|---|---|---|---|---|---|---|---|
| wt-% | wt-% | Glide | GWP | del_h_comb | del_h_comb | LFL | LFL |
| Butane | R1234ze(E) | (K) | AR5 | (kcal/g) | (relative) | (kg/m\hat{ }3) | (relative) |
| 0.99 | 0.01 | 0.2856 | 2.98 | 10.6845 | 0.992061281 | 0.043653447 | 1.01519643 |
| 0.94 | 0.06 | 1.6182 | 2.88 | 10.257 | 0.952367688 | 0.045589995 | 1.060232437 |
| 0.89 | 0.11 | 2.7942 | 2.78 | 9.8295 | 0.912674095 | 0.047706337 | 1.109449695 |
| 0.84 | 0.16 | 3.8147 | 2.68 | 9.402 | 0.872980501 | 0.05002873 | 1.163458846 |
| 0.79 | 0.21 | 4.6777 | 2.58 | 8.9745 | 0.833286908 | 0.052588808 | 1.222995525 |
| 0.74 | 0.26 | 5.3781 | 2.48 | 8.547 | 0.793593315 | 0.055425025 | 1.288954063 |
| 0.69 | 0.31 | 5.908 | 2.38 | 8.1195 | 0.753899721 | 0.058584607 | 1.362432721 |
| 0.64 | 0.36 | 6.2571 | 2.28 | 7.692 | 0.714206128 | 0.062126199 | 1.444795332 |
| 0.59 | 0.41 | 6.4138 | 2.18 | 7.2645 | 0.674512535 | 0.06612354 | 1.537756737 |
| 0.54 | 0.46 | 6.3667 | 2.08 | 6.837 | 0.634818942 | 0.070670649 | 1.643503474 |
| 0.49 | 0.51 | 6.107 | 1.98 | 6.4095 | 0.595125348 | 0.075889321 | 1.76486794 |
| 0.44 | 0.56 | 5.6314 | 1.88 | 5.982 | 0.555431755 | 0.081940193 | 1.905585874 |
| 0.39 | 0.61 | 4.9456 | 1.78 | 5.5545 | 0.515738162 | 0.08903957 | 2.070687684 |
| 0.34 | 0.66 | 4.0723 | 1.68 | 5.127 | 0.476044568 | 0.097485838 | 2.267112514 |
| 0.29 | 0.71 | 3.0628 | 1.58 | 4.6995 | 0.436350975 | 0.107702462 | 2.504708424 |
| 0.24 | 0.76 | 2.0172 | 1.48 | 4.272 | 0.396657382 | 0.120311211 | 2.797935135 |
| 0.19 | 0.81 | 1.0912 | 1.38 | 3.8445 | 0.356963788 | 0.13626362 | 3.168921389 |
| 0.14 | 0.86 | 0.4372 | 1.28 | 3.417 | 0.317270195 | 0.157093037 | 3.653326431 |
| 0.09 | 0.91 | 0.1015 | 1.18 | 2.9895 | 0.277576602 | 0.185439543 | 4.312547504 |
| 0.04 | 0.96 | 0.007 | 1.08 | 2.562 | 0.237883008 | 0.226268318 | 5.262053901 |

| | | ASHRAE | | |
|---|---|---|---|---|
| wt-% | wt-% | flammability | COP_c | CAP_c |
| Butane | R1234ze(E) | class | (relative) | (relative) |
| 0.99 | 0.01 | 3 | 0.998720296 | 1.007642547 |
| 0.94 | 0.06 | 3 | 0.992743514 | 1.047398773 |
| 0.89 | 0.11 | 3 | 0.989157444 | 1.089255937 |
| 0.84 | 0.16 | 3 | 0.986766731 | 1.13321404 |
| 0.79 | 0.21 | 3 | 0.985571375 | 1.179111472 |
| 0.74 | 0.26 | 3 | 0.984973697 | 1.226948231 |
| 0.69 | 0.31 | 3 | 0.984674858 | 1.276401097 |
| 0.64 | 0.36 | 3 | 0.984376019 | 1.327308459 |
| 0.59 | 0.41 | 3 | 0.98377834 | 1.379347096 |
| 0.54 | 0.46 | 3 | 0.982284145 | 1.432355397 |
| 0.49 | 0.51 | 3 | 0.979893432 | 1.486333361 |
| 0.44 | 0.56 | 3 | 0.976905041 | 1.541604212 |
| 0.39 | 0.61 | 3 | 0.973020132 | 1.598652779 |
| 0.34 | 0.66 | 3 | 0.969135224 | 1.658125507 |
| 0.29 | 0.71 | 3 | 0.965549155 | 1.720022395 |
| 0.24 | 0.76 | 3 | 0.962859603 | 1.782565725 |
| 0.19 | 0.81 | 3 | 0.96046889 | 1.840907178 |
| 0.14 | 0.86 | 3 | 0.957779338 | 1.887774274 |
| 0.09 | 0.91 | 2 | 0.955089786 | 1.919288355 |
| 0.04 | 0.96 | 2 L | 0.953296751 | 1.933671705 |

Results show that the HFO-1234ze(E) and butane compositions of the present invention provide similar COP or energy efficiency relative to butane in medium temperature refrigeration systems. Additionally, in many cases, the HFO-1234ze(E) and butane compositions of the present invention provide improved cooling capacity relative to isobutane. Adding 76 wt % of HFO-1234ze(E) to butane reduces the heat of combustion to below 4.54 kcal/g (8169 Btu/lbm), which is an 2L requirement, while the heating capacity is greater than the CAP of butane.

### Example 41: Propane/HFO-1234ze(E)

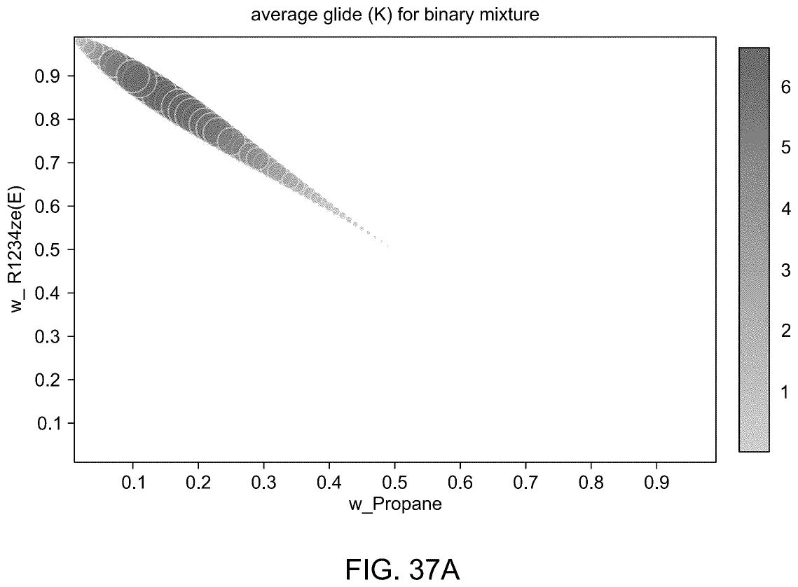

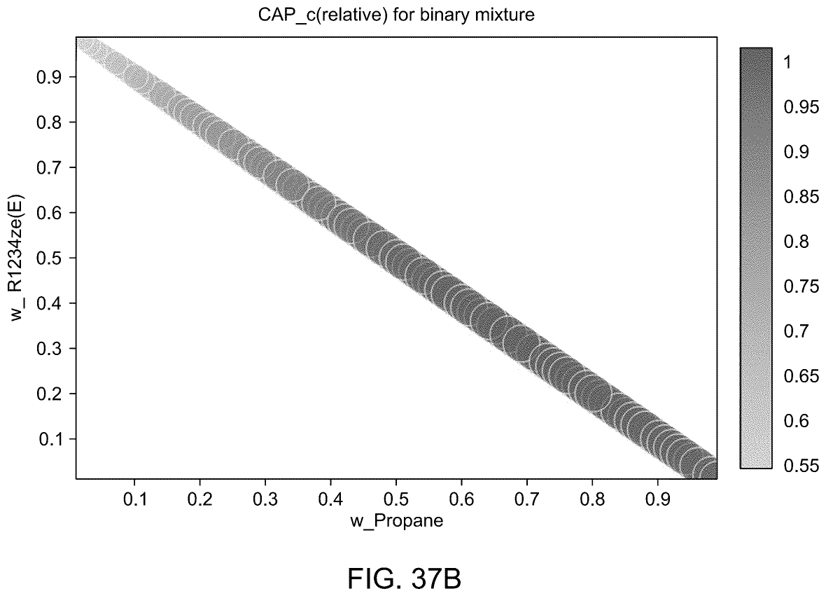

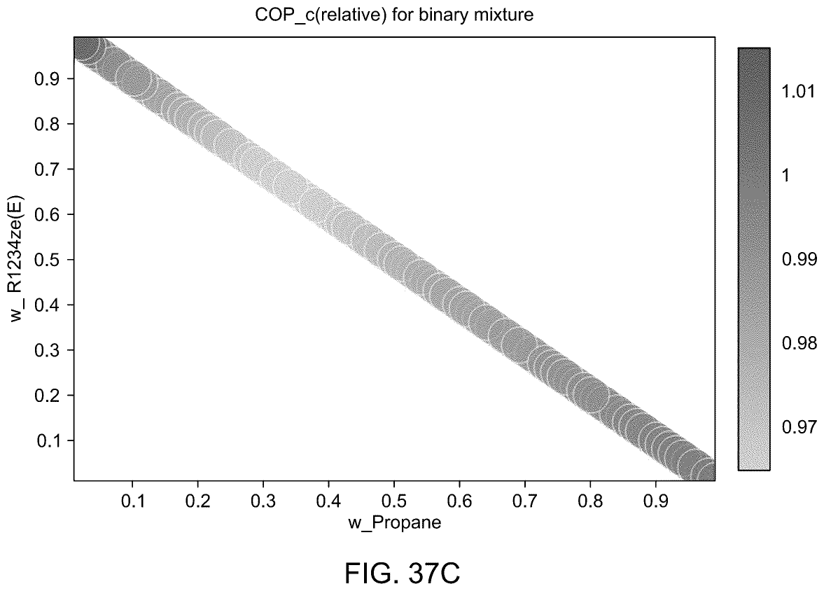

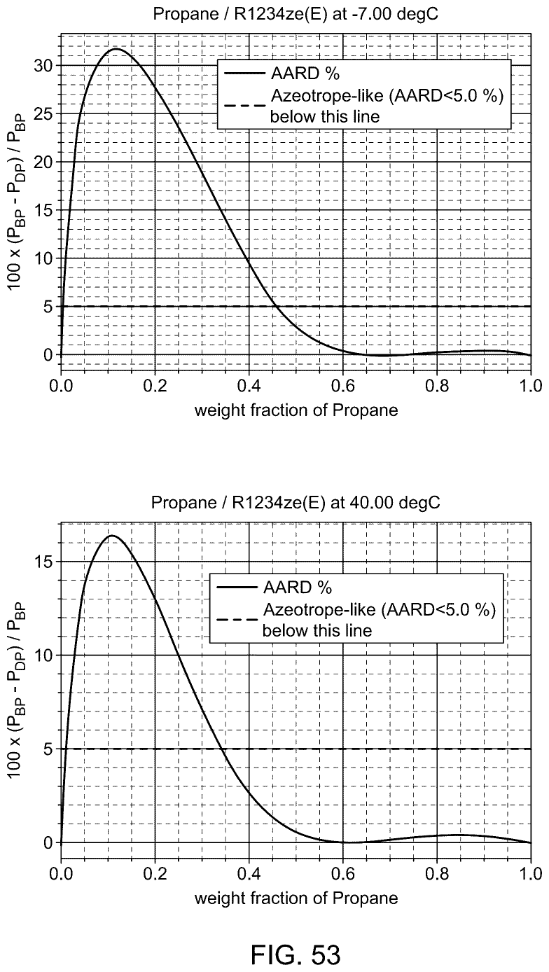

Refrigerant performance has been determined for an exemplary composition of the present invention comprising HFO-1234ze(E) and propane in medium temperature refrigeration systems as compared to propane. The data are based on the conditions set forth in Table 47. Table 75 tabulates several compositions about the compositions of optimal cooling efficiency and capacity, where the average temperature glide is <7 K and GWP˜4 or less. FIGS. 37A, 37B and 37C provide graphical representations of the average glide, the CAP for cooling relative to the incumbent fluid, and the COP for cooling relative to the incumbent fluid, respectively, for a composition according to Example 41. FIG. 53 shows near azeotropic behavior from 46 to 100 wt-% propane with an azeotrope at 67 wt-% propane at −7° C. and near azeotropic behavior for 34 to 100 wt-% propane with an azeotrope at 61 wt-% Propane at 40° C. for compositions according to Example 41.

TABLE 75
Medium Temp Refrigeration System, cycle metric performance
and fluid property ranges for 1234zeE/propane in Ex. 41

| | | Avg. | | | | | |
|---|---|---|---|---|---|---|---|
| wt-% | wt-% | Glide | GWP | del_h_comb | del_h_comb | LFL | LFL |
| Propane | R1234ze(E) | (K) | AR5 | (kcal/g) | (relative) | (kg/m\hat{ }3) | (relative) |
| 0.99 | 0.01 | 0.0159 | 3.97 | 10.8132 | 0.992036697 | 0.034575324 | 1.01692129 |
| 0.94 | 0.06 | 0.0771 | 3.82 | 10.3792 | 0.952220183 | 0.036172215 | 1.063888664 |
| 0.89 | 0.11 | 0.1086 | 3.67 | 9.9452 | 0.91240367 | 0.037923755 | 1.115404572 |
| 0.84 | 0.16 | 0.1123 | 3.52 | 9.5112 | 0.872587156 | 0.039853555 | 1.172163389 |
| 0.79 | 0.21 | 0.0928 | 3.37 | 9.0772 | 0.832770642 | 0.041990286 | 1.235008403 |
| 0.74 | 0.26 | 0.0585 | 3.22 | 8.6432 | 0.792954128 | 0.044369116 | 1.304973997 |
| 0.69 | 0.31 | 0.0239 | 3.07 | 8.2092 | 0.753137615 | 0.047033663 | 1.383343033 |
| 0.64 | 0.36 | 0.0122 | 2.92 | 7.7752 | 0.713321101 | 0.050038692 | 1.471726224 |
| 0.59 | 0.41 | 0.0603 | 2.77 | 7.3412 | 0.673504587 | 0.053453917 | 1.572174018 |
| 0.54 | 0.46 | 0.2227 | 2.62 | 6.9072 | 0.633688073 | 0.05736948 | 1.687337655 |
| 0.49 | 0.51 | 0.5698 | 2.47 | 6.4732 | 0.59387156 | 0.061904025 | 1.820706603 |
| 0.44 | 0.56 | 1.1646 | 2.32 | 6.0392 | 0.554055046 | 0.067216921 | 1.97696826 |
| 0.39 | 0.61 | 2.0221 | 2.17 | 5.6052 | 0.514238532 | 0.073527389 | 2.162570274 |
| 0.34 | 0.66 | 3.0958 | 2.02 | 5.1712 | 0.474422018 | 0.081145503 | 2.386632439 |
| 0.29 | 0.71 | 4.2884 | 1.87 | 4.7372 | 0.434605505 | 0.090524694 | 2.662490987 |
| 0.24 | 0.76 | 5.4448 | 1.72 | 4.3032 | 0.394788991 | 0.10235543 | 3.010453835 |
| 0.19 | 0.81 | 6.3366 | 1.57 | 3.8692 | 0.354972477 | 0.117743399 | 3.463041158 |
| 0.14 | 0.86 | 6.6568 | 1.42 | 3.4352 | 0.315155963 | 0.138576844 | 4.075789524 |
| 0.09 | 0.91 | 6.0051 | 1.27 | 3.0012 | 0.27533945 | 0.168367725 | 4.951991918 |
| 0.04 | 0.96 | 3.7562 | 1.12 | 2.5672 | 0.235522936 | 0.214474988 | 6.308087877 |

| | | ASHRAE | | |
|---|---|---|---|---|
| wt-% | wt-% | flammability | COP_c | CAP_c |
| Butane | R1234ze(E) | class | (relative) | (relative) |
| 0.99 | 0.01 | 3 | 0.999561113 | 1.001034693 |
| 0.94 | 0.06 | 3 | 0.997635795 | 1.006003708 |
| 0.89 | 0.11 | 3 | 0.99538959 | 1.010351596 |
| 0.84 | 0.16 | 3 | 0.993464272 | 1.013989625 |
| 0.79 | 0.21 | 3 | 0.991538953 | 1.01674033 |
| 0.74 | 0.26 | 3 | 0.989292749 | 1.018337513 |
| 0.69 | 0.31 | 3 | 0.987046544 | 1.018470612 |
| 0.64 | 0.36 | 3 | 0.984800339 | 1.016607231 |
| 0.59 | 0.41 | 3 | 0.982233248 | 1.012081878 |
| 0.54 | 0.46 | 3 | 0.97934527 | 1.003785398 |
| 0.49 | 0.51 | 3 | 0.975494634 | 0.990386804 |
| 0.44 | 0.56 | 3 | 0.970681338 | 0.971043138 |
| 0.39 | 0.61 | 3 | 0.966830701 | 0.946109331 |
| 0.34 | 0.66 | 3 | 0.964905383 | 0.9170051 |
| 0.29 | 0.71 | 3 | 0.966509815 | 0.884174108 |
| 0.24 | 0.76 | 3 | 0.971323111 | 0.846640298 |
| 0.19 | 0.81 | 3 | 0.977740838 | 0.801741698 |
| 0.14 | 0.86 | 3 | 0.983195907 | 0.74641704 |
| 0.09 | 0.91 | 2 | 0.988971862 | 0.679246605 |
| 0.04 | 0.96 | 2 L | 1.000202886 | 0.600629689 |

Results show that the HFO-1234ze(E) and propane compositions of the present invention provide similar COP or energy efficiency relative to propane in medium temperature refrigeration systems. Adding 76 wt % of HFO-1234ze(E) to propane reduces the heat of combustion to below 4.54 kcal/g (8169 Btu/lbm), which is an 2L requirement, while the heating capacity is within about 15% the CAP of propane.

### Example 43: Propylene/HFO-1234ze(E)

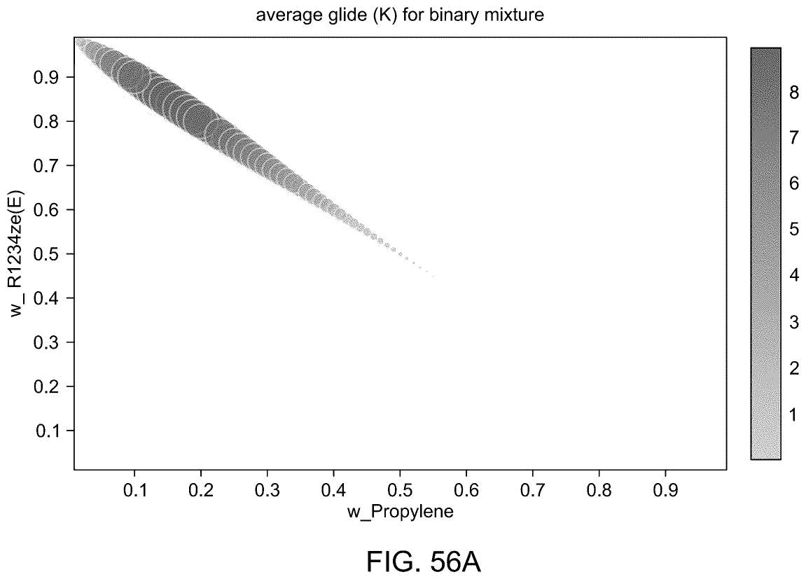

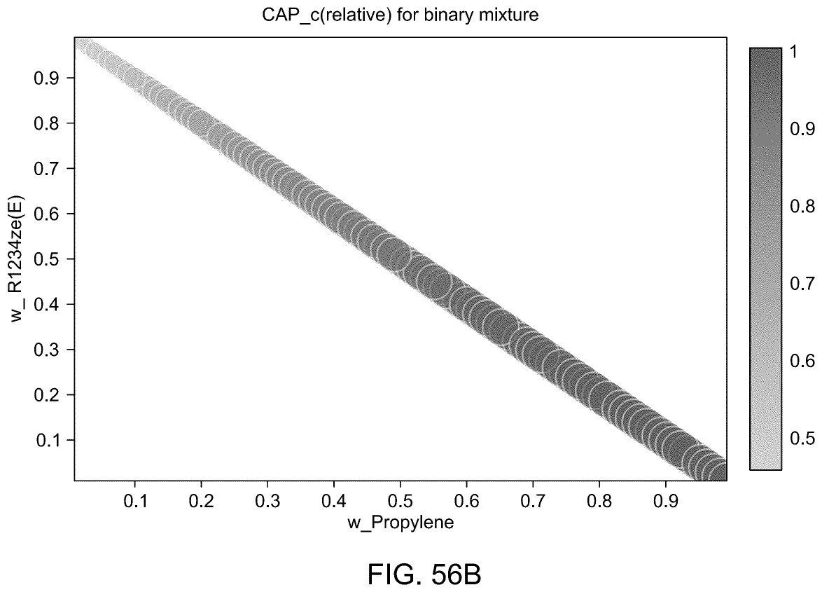

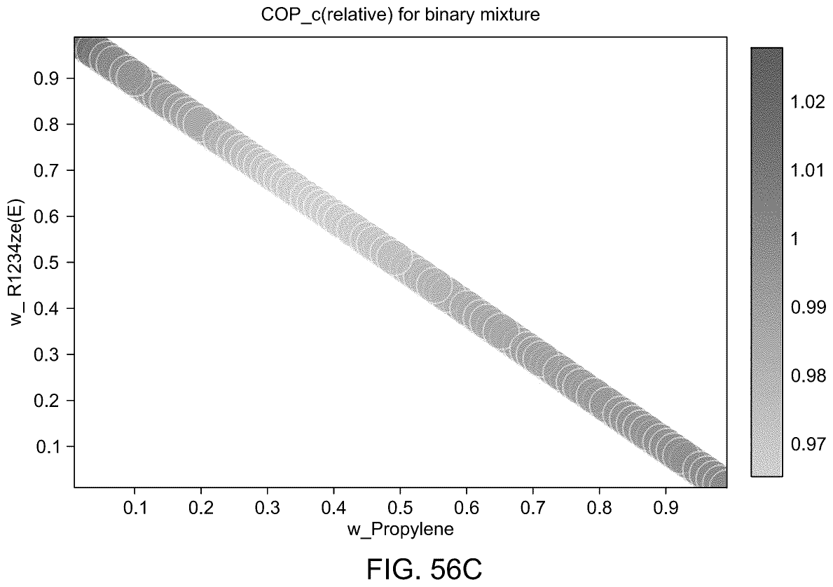

Refrigerant performance has been determined for an exemplary composition of the present invention comprising HFO-1234ze(E) and propylene in medium temperature refrigeration systems as compared to propylene. The data are based on the conditions set forth in Table 47. Table 77 tabulates several compositions about the compositions of optimal cooling efficiency and capacity, where the average temperature glide is <10 K and GWP˜2 or less. FIGS. 56A, 56B and 56C provide graphical representations of the average glide, the CAP for cooling relative to the incumbent fluid, and the COP for cooling relative to the incumbent fluid, respectively, for a composition according to Example 41.

TABLE 77
Medium Temp Refrigeration System, cycle metric performance
and fluid property ranges for 1234zeE/propane in Ex. 43

| | | Avg. | | | | | |
|---|---|---|---|---|---|---|---|
| wt-% | wt-% | Glide | GWP | del_h_comb | del_h_comb | LFL | LFL |
| Propylene | R1234ze(E) | (K) | AR5 | (kcal/g) | (relative) | (kg/m\hat{ }3) | (relative) |
| 0.99 | 0.01 | 0.004 | 1.495 | 10.8429 | 1.491088864 | 0.032492853 | 0.634855309 |
| 0.94 | 0.06 | 0.0153 | 1.47 | 10.4074 | 1.431199978 | 0.034007188 | 0.664442843 |
| 0.89 | 0.11 | 0.0149 | 1.445 | 9.9719 | 1.371311092 | 0.035669574 | 0.696923054 |
| 0.84 | 0.16 | 0.0083 | 1.42 | 9.5364 | 1.311422206 | 0.03750284 | 0.732741956 |
| 0.79 | 0.21 | 0.0043 | 1.395 | 9.1009 | 1.25153332 | 0.039534759 | 0.772442225 |
| 0.74 | 0.26 | 0.0167 | 1.37 | 8.6654 | 1.191644435 | 0.041799472 | 0.816690882 |
| 0.69 | 0.31 | 0.0669 | 1.345 | 8.2299 | 1.131755549 | 0.044339416 | 0.866317076 |
| 0.64 | 0.36 | 0.1877 | 1.32 | 7.7944 | 1.071866663 | 0.047208009 | 0.922364524 |
| 0.59 | 0.41 | 0.4266 | 1.295 | 7.3589 | 1.011977777 | 0.050473451 | 0.986165729 |
| 0.54 | 0.46 | 0.8469 | 1.27 | 6.9234 | 0.952088891 | 0.054224213 | 1.059449271 |
| 0.49 | 0.51 | 1.5128 | 1.245 | 6.4879 | 0.892200006 | 0.058577176 | 1.144498796 |
| 0.44 | 0.56 | 2.4545 | 1.22 | 6.0524 | 0.83231112 | 0.063690028 | 1.244395248 |
| 0.39 | 0.61 | 3.6466 | 1.195 | 5.6169 | 0.772422234 | 0.069780774 | 1.363398112 |
| 0.34 | 0.66 | 5.0191 | 1.17 | 5.1814 | 0.712533348 | 0.077159633 | 1.507568522 |
| 0.29 | 0.71 | 6.4575 | 1.145 | 4.7459 | 0.652644462 | 0.086283553 | 1.68583446 |
| 0.24 | 0.76 | 7.7804 | 1.12 | 4.3104 | 0.592755576 | 0.097854597 | 1.911913057 |
| 0.19 | 0.81 | 8.7178 | 1.095 | 3.8749 | 0.532866691 | 0.113009755 | 2.20801916 |
| 0.14 | 0.86 | 8.9125 | 1.07 | 3.4394 | 0.472977805 | 0.133719455 | 2.612651624 |
| 0.09 | 0.91 | 7.9063 | 1.045 | 3.0039 | 0.413088919 | 0.163722578 | 3.198861818 |
| 0.04 | 0.96 | 4.9236 | 1.02 | 2.5684 | 0.353200033 | 0.211084343 | 4.124230486 |

| | | ASHRAE | | |
|---|---|---|---|---|
| wt-% | wt-% | flammability | COP_c | CAP_c |
| Butane | R1234ze(E) | class | (relative) | (relative) |
| 0.99 | 0.01 | 3 | 0.999775084 | 1.000229763 |
| 0.94 | 0.06 | 3 | 0.997821762 | 1.000892289 |
| 0.89 | 0.11 | 3 | 0.995868441 | 1.000818675 |
| 0.84 | 0.16 | 3 | 0.994240673 | 0.999788079 |
| 0.79 | 0.21 | 3 | 0.992287351 | 0.997653274 |
| 0.74 | 0.26 | 3 | 0.99033403 | 0.994009383 |
| 0.69 | 0.31 | 3 | 0.988055155 | 0.988525142 |
| 0.64 | 0.36 | 3 | 0.98577628 | 0.98050122 |
| 0.59 | 0.41 | 3 | 0.982520744 | 0.969091055 |
| 0.54 | 0.46 | 3 | 0.9786141 | 0.953190439 |
| 0.49 | 0.51 | 3 | 0.973730797 | 0.931805582 |
| 0.44 | 0.56 | 3 | 0.968847493 | 0.905267747 |
| 0.39 | 0.61 | 3 | 0.965591957 | 0.874865179 |
| 0.34 | 0.66 | 3 | 0.966243064 | 0.841922929 |
| 0.29 | 0.71 | 3 | 0.970800814 | 0.806367383 |
| 0.24 | 0.76 | 3 | 0.978288547 | 0.766321386 |
| 0.19 | 0.81 | 3 | 0.986101833 | 0.718545922 |
| 0.14 | 0.86 | 3 | 0.991636244 | 0.659949205 |
| 0.09 | 0.91 | 2 | 0.996519548 | 0.589905516 |
| 0.04 | 0.96 | 1 | 1.008565031 | 0.509960749 |

Results show that the HFO-1234ze(E) and propylene compositions of the present invention provide similar COP or energy efficiency relative to propylene in medium temperature refrigeration systems. Adding 76 wt % of HFO-1234ze(E) to propane reduces the heat of combustion to below 4.54 kcal/g (8169 Btu/lbm), which is an 2L requirement, while the heating capacity is similar to the CAP of propylene.

### Example 44: Glide Reduction

The temperature glide for compositions containing either propane or isobutane with 2 wt. %, 0.5 wt. % or 0.1 wt. % of other hydrocarbon impurities at temperatures, and more particularly saturated liquid temperatures, of 30° C. (e.g., heat exchanger, evaporating; typical temperature for elective vehicle heat pump), 10° C. (common heat exchanger, evaporating, typical temperature for comfort coaling), and 50° C. (common heat exchanger, condensing, typical temperature for high ambient temperatures), were determined. The results are displayed in Tables 88-93.

TABLE 88
Propane Compositions at Saturated Liquid Temperature of −30° C.

| | Temp | Temp |
|---|---|---|
| Composition (wt. %) | Glide [K] | Glide [°R] |
| Propane/Cyclopropane (98/2) | 0.00 | 0.00 |
| Propane/Isobutane (98/2) | 0.72 | 1.29 |
| Propane/Butane (98/2) | 1.41 | 2.53 |
| Propane/Cyclobutane (98/2) | 2.30 | 4.14 |
| Propane/Methane (98/2) | 42.76 | 76.98 |
| Propane/Ethane (98/2) | 2.66 | 4.79 |
| Propane/Propylene (98/2) | 0.04 | 0.08 |
| Propane/Butene (98/2) | 1.05 | 1.90 |
| Propane/Propyne (98/2) | 0.13 | 0.23 |
| Propane/Isobutene (98/2) | 0.66 | 1.19 |
| Propane/Ethylene (98/2) | 6.02 | 10.84 |
| Propane/Pentane (98/2) | 5.38 | 9.68 |
| Propane/Isopentane (98/2) | 3.66 | 6.59 |
| Propane/Cyclopentane (98/2) | 8.53 | 15.36 |
| Propane/Cyclobutene (98/2) | 1.74 | 3.13 |
| Propane/cis-Butene (98/2) | 1.74 | 3.14 |
| Propane/1-Butyne (98/2) | 2.18 | 3.93 |
| Propane/1-Pentene (98/2) | 4.40 | 7.93 |
| Propane/Cyclopropane (99.5/0.5) | 0.00 | 0.00 |
| Propane/Isobutane (99.5/0.5) | 0.18 | 0.33 |
| Propane/Butane (99.5/0.5) | 0.36 | 0.65 |
| Propane/Cyclobutane (99.5/0.5) | 0.59 | 1.07 |
| Propane/Methane (99.5/0.5) | 16.54 | 29.77 |
| Propane/Ethane (99.5/0.5) | 0.71 | 1.27 |
| Propane/Propylene (99.5/0.5) | 0.01 | 0.02 |
| Propane/Butene (99.5/0.5) | 0.27 | 0.49 |
| Propane/Propyne (99.5/0.5) | 0.03 | 0.06 |
| Propane/Isobutene (99.5/0.5) | 0.17 | 0.30 |
| Propane/Ethylene (99.5/0.5) | 1.65 | 2.96 |
| Propane/Pentane (99.5/0.5) | 1.44 | 2.59 |
| Propane/Isopentane (99.5/0.5) | 0.96 | 1.73 |
| Propane/Cyclopentane (99.5/0.5) | 2.33 | 4.19 |
| Propane/Cyclobutene (99.5/0.5) | 0.45 | 0.81 |
| Propane/cis-Butene (99.5/0.5) | 0.45 | 0.81 |
| Propane/1-Butyne (99.5/0.5) | 0.57 | 1.02 |
| Propane/1-Pentene (99.5/0.5) | 1.17 | 2.10 |
| Propane/Cyclopropane (99.9/0.1) | 0.00 | 0.00 |
| Propane/Isobutane (99.9/0.1) | 0.04 | 0.07 |
| Propane/Butane (99.9/0.1) | 0.07 | 0.13 |
| Propane/Cyclobutane (99.9/0.1) | 0.12 | 0.21 |
| Propane/Methane (99.9/0.1) | 4.07 | 7.32 |
| Propane/Ethane (99.9/0.1) | 0.14 | 0.26 |
| Propane/Propylene (99.9/0.1) | 0.00 | 0.00 |
| Propane/Butene (99.9/0.1) | 0.05 | 0.10 |
| Propane/Propyne (99.9/0.1) | 0.01 | 0.01 |
| Propane/Isobutene (99.9/0.1) | 0.03 | 0.06 |
| Propane/Ethylene (99.9/0.1) | 0.34 | 0.61 |
| Propane/Pentane (99.9/0.1) | 0.29 | 0.53 |
| Propane/Isopentane (99.9/0.1) | 0.19 | 0.35 |
| Propane/Cyclopentane (99.9/0.1) | 0.47 | 0.85 |
| Propane/Cyclobutene (99.9/0.1) | 0.09 | 0.16 |
| Propane/cis-Butene (99.9/0.1) | 0.09 | 0.16 |
| Propane/1-Butyne (99.9/0.1) | 0.11 | 0.21 |
| Propane/1-Pentene (99.9/0.1) | 0.24 | 0.43 |

TABLE 89
Propane Compositions at Saturated Liquid Temperature of 10° C.

| | Temp | Temp |
|---|---|---|
| Composition (wt. %) | Glide [K] | Glide [°R] |
| Propane/Cyclopropane (98/2) | 0.00 | 0.00 |
| Propane/Isobutane (98/2) | 0.60 | 1.08 |
| Propane/Butane (98/2) | 1.09 | 1.97 |
| Propane/Cyclobutane (98/2) | 1.72 | 3.10 |
| Propane/Methane (98/2) | 29.12 | 52.42 |
| Propane/Ethane (98/2) | 2.10 | 3.78 |
| Propane/Propylene (98/2) | 0.04 | 0.07 |
| Propane/Butene (98/2) | 0.83 | 1.49 |
| Propane/Propyne (98/2) | 0.09 | 0.16 |
| Propane/Isobutene (98/2) | 0.53 | 0.95 |
| Propane/Ethylene (98/2) | 4.44 | 7.99 |
| Propane/Pentane (98/2) | 3.54 | 6.36 |
| Propane/Isopentane (98/2) | 2.54 | 4.58 |
| Propane/Cyclopentane (98/2) | 5.26 | 9.46 |
| Propane/Cyclobutene (98/2) | 1.30 | 2.34 |
| Propane/cis-Butene (98/2) | 1.30 | 2.34 |
| Propane/1-Butyne (98/2) | 1.46 | 2.64 |
| Propane/1-Pentene (98/2) | 2.98 | 5.36 |
| Propane/Cyclopropane (99.5/0.5) | 0.00 | 0.00 |
| Propane/Isobutane (99.5/0.5) | 0.15 | 0.28 |
| Propane/Butane (99.5/0.5) | 0.28 | 0.50 |
| Propane/Cyclobutane (99.5/0.5) | 0.44 | 0.79 |
| Propane/Methane (99.5/0.5) | 9.76 | 17.57 |
| Propane/Ethane (99.5/0.5) | 0.55 | 0.99 |
| Propane/Propylene (99.5/0.5) | 0.01 | 0.02 |
| Propane/Butene (99.5/0.5) | 0.21 | 0.38 |
| Propane/Propyne (99.5/0.5) | 0.02 | 0.04 |
| Propane/Isobutene (99.5/0.5) | 0.13 | 0.24 |
| Propane/Ethylene (99.5/0.5) | 1.18 | 2.12 |
| Propane/Pentane (99.5/0.5) | 0.90 | 1.63 |
| Propane/Isopentane (99.5/0.5) | 0.65 | 1.16 |
| Propane/Cyclopentane (99.5/0.5) | 1.34 | 2.42 |
| Propane/Cyclobutene (99.5/0.5) | 0.33 | 0.60 |
| Propane/cis-Butene (99.5/0.5) | 0.33 | 0.60 |
| Propane/1-Butyne (99.5/0.5) | 0.37 | 0.67 |
| Propane/1-Pentene (99.5/0.5) | 0.76 | 1.37 |
| Propane/Cyclopropane (99.9/0.1) | 0.00 | 0.00 |
| Propane/Isobutane (99.9/0.1) | 0.03 | 0.06 |
| Propane/Butane (99.9/0.1) | 0.06 | 0.10 |
| Propane/Cyclobutane (99.9/0.1) | 0.09 | 0.16 |
| Propane/Methane (99.9/0.1) | 2.19 | 3.94 |
| Propane/Ethane (99.9/0.1) | 0.11 | 0.20 |
| Propane/Propylene (99.9/0.1) | 0.00 | 0.00 |
| Propane/Butene (99.9/0.1) | 0.04 | 0.08 |
| Propane/Propyne (99.9/0.1) | 0.00 | 0.01 |
| Propane/Isobutene (99.9/0.1) | 0.03 | 0.05 |
| Propane/Ethylene (99.9/0.1) | 0.24 | 0.43 |
| Propane/Pentane (99.9/0.1) | 0.18 | 0.33 |
| Propane/Isopentane (99.9/0.1) | 0.13 | 0.23 |
| Propane/Cyclopentane (99.9/0.1) | 0.27 | 0.49 |
| Propane/Cyclobutene (99.9/0.1) | 0.07 | 0.12 |
| Propane/cis-Butene (99.9/0.1) | 0.07 | 0.12 |
| Propane/1-Butyne (99.9/0.1) | 0.07 | 0.13 |
| Propane/1-Pentene (99.9/0.1) | 0.15 | 0.27 |

TABLE 90
Propane Compositions at Saturated Liquid Temperature of 50° C.

| | Temp | Temp |
|---|---|---|
| Composition (wt. %) | Glide [K] | Glide [°R] |
| Propane/Cyclopropane (98/2) | 0.00 | 0.00 |
| Propane/Isobutane (98/2) | 0.47 | 0.84 |
| Propane/Butane (98/2) | 0.79 | 1.43 |
| Propane/Cyclobutane (98/2) | 1.21 | 2.17 |
| Propane/Methane (98/2) | 18.14 | 32.65 |
| Propane/Ethane (98/2) | 1.55 | 2.79 |
| Propane/Propylene (98/2) | 0.03 | 0.06 |
| Propane/Butene (98/2) | 0.60 | 1.09 |
| Propane/Propyne (98/2) | 0.05 | 0.08 |
| Propane/Isobutene (98/2) | 0.39 | 0.70 |
| Propane/Ethylene (98/2) | 3.06 | 5.51 |
| Propane/Pentane (98/2) | 2.27 | 4.09 |
| Propane/Isopentane (98/2) | 1.71 | 3.07 |
| Propane/Cyclopentane (98/2) | 3.21 | 5.78 |
| Propane/Cyclobutene (98/2) | 0.92 | 1.66 |
| Propane/cis-Butene (98/2) | 0.91 | 1.65 |
| Propane/1-Butyne (98/2) | 0.95 | 1.71 |
| Propane/1-Pentene (98/2) | 1.96 | 3.53 |
| Propane/Cyclopropane (99.5/0.5) | 0.00 | 0.00 |
| Propane/Isobutane (99.5/0.5) | 0.12 | 0.21 |
| Propane/Butane (99.5/0.5) | 0.20 | 0.36 |
| Propane/Cyclobutane (99.5/0.5) | 0.30 | 0.55 |
| Propane/Methane (99.5/0.5) | 5.85 | 10.53 |
| Propane/Ethane (99.5/0.5) | 0.41 | 0.73 |
| Propane/Propylene (99.5/0.5) | 0.01 | 0.01 |
| Propane/Butene (99.5/0.5) | 0.15 | 0.27 |
| Propane/Propyne (99.5/0.5) | 0.01 | 0.02 |
| Propane/Isobutene (99.5/0.5) | 0.10 | 0.18 |
| Propane/Ethylene (99.5/0.5) | 0.80 | 1.45 |
| Propane/Pentane (99.5/0.5) | 0.57 | 1.02 |
| Propane/Isopentane (99.5/0.5) | 0.43 | 0.77 |
| Propane/Cyclopentane (99.5/0.5) | 0.80 | 1.43 |
| Propane/Cyclobutene (99.5/0.5) | 0.23 | 0.42 |
| Propane/cis-Butene (99.5/0.5) | 0.23 | 0.42 |
| Propane/1-Butyne (99.5/0.5) | 0.24 | 0.43 |
| Propane/1-Pentene (99.5/0.5) | 0.49 | 0.88 |
| Propane/Cyclopropane (99.9/0.1) | 0.00 | 0.00 |
| Propane/Isobutane (99.9/0.1) | 0.02 | 0.04 |
| Propane/Butane (99.9/0.1) | 0.04 | 0.07 |
| Propane/Cyclobutane (99.9/0.1) | 0.06 | 0.11 |
| Propane/Methane (99.9/0.1) | 1.27 | 2.29 |
| Propane/Ethane (99.9/0.1) | 0.08 | 0.15 |
| Propane/Propylene (99.9/0.1) | 0.00 | 0.00 |
| Propane/Butene (99.9/0.1) | 0.03 | 0.06 |
| Propane/Propyne (99.9/0.1) | 0.00 | 0.00 |
| Propane/Isobutene (99.9/0.1) | 0.02 | 0.04 |
| Propane/Ethylene (99.9/0.1) | 0.16 | 0.29 |
| Propane/Pentane (99.9/0.1) | 0.11 | 0.20 |
| Propane/Isopentane (99.9/0.1) | 0.09 | 0.15 |
| Propane/Cyclopentane (99.9/0.1) | 0.16 | 0.29 |
| Propane/Cyclobutene (99.9/0.1) | 0.05 | 0.08 |
| Propane/cis-Butene (99.9/0.1) | 0.05 | 0.08 |
| Propane/1-Butyne (99.9/0.1) | 0.05 | 0.09 |
| Propane/1-Pentene (99.9/0.1) | 0.10 | 0.18 |

TABLE 91
Isobutane Compositions at Saturated Liquid
Temperature of −30° C.

| | Temp | Temp |
|---|---|---|
| Composition (wt. %) | Glide [K] | Glide [°R] |
| Isobutane/Cyclopropane (98/2) | 0.32 | 0.57 |
| Isobutane/Propane (98/2) | 1.02 | 1.83 |
| Isobutane/Butane (98/2) | 0.10 | 0.19 |
| Isobutane/Cyclobutane (98/2) | 0.48 | 0.86 |
| Isobutane/Methane (98/2) | 88.04 | 158.47 |
| Isobutane/Ethane (98/2) | 10.10 | 18.18 |
| Isobutane/Propylene (98/2) | 2.22 | 4.00 |
| Isobutane (100) | 0.00 | 0.00 |
| Isobutane/Butene (98/2) | 0.01 | 0.02 |
| Isobutane/Propyne (98/2) | 0.16 | 0.29 |
| Isobutane/Isobutene (98/2) | 0.01 | 0.01 |
| Isobutane/Ethylene (98/2) | 18.04 | 32.48 |
| Isobutane/Pentane (98/2) | 1.87 | 3.37 |
| Isobutane/Isopentane (98/2) | 1.18 | 2.12 |
| Isobutane/Cyclopentane (98/2) | 3.52 | 6.34 |
| Isobutane/Cyclobutene (98/2) | 0.20 | 0.36 |
| Isobutane/cis-Butene (98/2) | 0.21 | 0.38 |
| Isobutane/1-Butyne (98/2) | 0.40 | 0.72 |
| Isobutane/1-Pentene (98/2) | 1.40 | 2.51 |
| Isobutane/Cyclopropane (99.5/0.5) | 0.08 | 0.15 |
| Isobutane/Propane (99.5/0.5) | 0.27 | 0.48 |
| Isobutane/Butane (99.5/0.5) | 0.03 | 0.05 |
| Isobutane/Cyclobutane (99.5/0.5) | 0.12 | 0.22 |
| Isobutane/Methane (99.5/0.5) | 46.44 | 83.60 |
| Isobutane/Ethane (99.5/0.5) | 2.95 | 5.30 |
| Isobutane/Propylene (99.5/0.5) | 0.63 | 1.14 |
| Isobutane (100) | 0.00 | 0.00 |
| Isobutane/Butene (99.5/0.5) | 0.00 | 0.01 |
| Isobutane/Propyne (99.5/0.5) | 0.04 | 0.07 |
| Isobutane/Isobutene (99.5/0.5) | 0.00 | 0.00 |
| Isobutane/Ethylene (99.5/0.5) | 5.85 | 10.54 |
| Isobutane/Pentane (99.5/0.5) | 0.49 | 0.88 |
| Isobutane/Isopentane (99.5/0.5) | 0.30 | 0.54 |
| Isobutane/Cyclopentane (99.5/0.5) | 0.93 | 1.68 |
| Isobutane/Cyclobutene (99.5/0.5) | 0.05 | 0.09 |
| Isobutane/cis-Butene (99.5/0.5) | 0.05 | 0.10 |
| Isobutane/1-Butyne (99.5/0.5) | 0.10 | 0.18 |
| Isobutane/1-Pentene (99.5/0.5) | 0.36 | 0.65 |
| Isobutane/Cyclopropane (99.9/0.1) | 0.02 | 0.03 |
| Isobutane/Propane (99.9/0.1) | 0.05 | 0.10 |
| Isobutane/Butane (99.9/0.1) | 0.01 | 0.01 |
| Isobutane/Cyclobutane (99.9/0.1) | 0.02 | 0.04 |
| Isobutane/Methane (99.9/0.1) | 16.11 | 29.00 |
| Isobutane/Ethane (99.9/0.1) | 0.62 | 1.11 |
| Isobutane/Propylene (99.9/0.1) | 0.13 | 0.24 |
| Isobutane (100) | 0.00 | 0.00 |
| Isobutane/Butene (99.9/0.1) | 0.00 | 0.00 |
| Isobutane/Propyne (99.9/0.1) | 0.01 | 0.02 |
| Isobutane/Isobutene (99.9/0.1) | 0.00 | 0.00 |
| Isobutane/Ethylene (99.9/0.1) | 1.29 | 2.32 |
| Isobutane/Pentane (99.9/0.1) | 0.10 | 0.18 |
| Isobutane/Isopentane (99.9/0.1) | 0.06 | 0.11 |
| Isobutane/Cyclopentane (99.9/0.1) | 0.19 | 0.34 |
| Isobutane/Cyclobutene (99.9/0.1) | 0.01 | 0.02 |
| Isobutane/cis-Butene (99.9/0.1) | 0.01 | 0.02 |
| Isobutane/1-Butyne (99.9/0.1) | 0.02 | 0.04 |
| Isobutane/1-Pentene (99.9/0.1) | 0.07 | 0.13 |

TABLE 92
Isobutane Compositions at Saturated Liquid Temperature of 10° C.

| | Temp | Temp |
|---|---|---|
| Composition (wt. %) | Glide [K] | Glide [°R] |
| Isobutane/Cyclopropane (98/2) | 0.35 | 0.62 |
| Isobutane/Propane (98/2) | 0.86 | 1.55 |
| Isobutane/Butane (98/2) | 0.09 | 0.16 |
| Isobutane/Cyclobutane (98/2) | 0.40 | 0.72 |
| Isobutane/Methane (98/2) | 65.54 | 117.97 |
| Isobutane/Ethane (98/2) | 7.73 | 13.91 |
| Isobutane/Propylene (98/2) | 1.85 | 3.33 |
| Isobutane (100) | 0.00 | 0.00 |
| Isobutane/Butene (98/2) | 0.01 | 0.01 |
| Isobutane/Propyne (98/2) | 0.14 | 0.26 |
| Isobutane/Isobutene (98/2) | 0.00 | 0.00 |
| Isobutane/Ethylene (98/2) | 13.26 | 23.88 |
| Isobutane/Pentane (98/2) | 1.44 | 2.58 |
| Isobutane/Isopentane (98/2) | 0.95 | 1.71 |
| Isobutane/Cyclopentane (98/2) | 2.57 | 4.62 |
| Isobutane/Cyclobutene (98/2) | 0.16 | 0.30 |
| Isobutane/cis-Butene (98/2) | 0.16 | 0.29 |
| Isobutane/1-Butyne (98/2) | 0.26 | 0.47 |
| Isobutane/1-Pentene (98/2) | 1.10 | 1.97 |
| Isobutane/Cyclopropane (99.5/0.5) | 0.09 | 0.16 |
| Isobutane/Propane (99.5/0.5) | 0.22 | 0.40 |
| Isobutane/Butane (99.5/0.5) | 0.02 | 0.04 |
| Isobutane/Cyclobutane (99.5/0.5) | 0.10 | 0.18 |
| Isobutane/Methane (99.5/0.5) | 28.15 | 50.66 |
| Isobutane/Ethane (99.5/0.5) | 2.13 | 3.83 |
| Isobutane/Propylene (99.5/0.5) | 0.51 | 0.93 |
| Isobutane (100) | 0.00 | 0.00 |
| Isobutane/Butene (99.5/0.5) | 0.00 | 0.00 |
| Isobutane/Propyne (99.5/0.5) | 0.04 | 0.07 |
| Isobutane/Isobutene (99.5/0.5) | 0.00 | 0.00 |
| Isobutane/Ethylene (99.5/0.5) | 3.87 | 6.97 |
| Isobutane/Pentane (99.5/0.5) | 0.37 | 0.66 |
| Isobutane/Isopentane (99.5/0.5) | 0.24 | 0.44 |
| Isobutane/Cyclopentane (99.5/0.5) | 0.66 | 1.19 |
| Isobutane/Cyclobutene (99.5/0.5) | 0.04 | 0.08 |
| Isobutane/cis-Butene (99.5/0.5) | 0.04 | 0.07 |
| Isobutane/1-Butyne (99.5/0.5) | 0.07 | 0.12 |
| Isobutane/1-Pentene (99.5/0.5) | 0.28 | 0.50 |
| Isobutane/Cyclopropane (99.9/0.1) | 0.02 | 0.03 |
| Isobutane/Propane (99.9/0.1) | 0.05 | 0.08 |
| Isobutane/Butane (99.9/0.1) | 0.00 | 0.01 |
| Isobutane/Cyclobutane (99.9/0.1) | 0.02 | 0.04 |
| Isobutane/Methane (99.9/0.1) | 7.44 | 13.39 |
| Isobutane/Ethane (99.9/0.1) | 0.44 | 0.79 |
| Isobutane/Propylene (99.9/0.1) | 0.11 | 0.19 |
| Isobutane (100) | 0.00 | 0.00 |
| Isobutane/Butene (99.9/0.1) | 0.00 | 0.00 |
| Isobutane/Propyne (99.9/0.1) | 0.01 | 0.01 |
| Isobutane/Isobutene (99.9/0.1) | 0.00 | 0.00 |
| Isobutane/Ethylene (99.9/0.1) | 0.81 | 1.46 |
| Isobutane/Pentane (99.9/0.1) | 0.07 | 0.13 |
| Isobutane/Isopentane (99.9/0.1) | 0.05 | 0.09 |
| Isobutane/Cyclopentane (99.9/0.1) | 0.13 | 0.24 |
| Isobutane/Cyclobutene (99.9/0.1) | 0.01 | 0.02 |
| Isobutane/cis-Butene (99.9/0.1) | 0.01 | 0.01 |
| Isobutane/1-Butyne (99.9/0.1) | 0.01 | 0.02 |
| Isobutane/1-Pentene (99.9/0.1) | 0.06 | 0.10 |

TABLE 93
Isobutane Compositions at Saturated Liquid Temperature of 50° C.

| | Temp | Temp |
|---|---|---|
| Composition (wt. %) | Glide [K] | Glide [°R] |
| Isobutane/Cyclopropane (98/2) | 0.31 | 0.56 |
| Isobutane/Propane (98/2) | 0.71 | 1.28 |
| Isobutane/Butane (98/2) | 0.07 | 0.13 |
| Isobutane/Cyclobutane (98/2) | 0.32 | 0.57 |
| Isobutane/Methane (98/2) | 44.88 | 80.79 |
| Isobutane/Ethane (98/2) | 5.93 | 10.68 |
| Isobutane/Propylene (98/2) | 1.52 | 2.73 |
| Isobutane (100) | 0.00 | 0.00 |
| Isobutane/Butene (98/2) | 0.00 | 0.01 |
| Isobutane/Propyne (98/2) | 0.16 | 0.28 |
| Isobutane/Isobutene (98/2) | 0.00 | 0.00 |
| Isobutane/Ethylene (98/2) | 9.62 | 17.32 |
| Isobutane/Pentane (98/2) | 1.10 | 1.98 |
| Isobutane/Isopentane (98/2) | 0.76 | 1.37 |
| Isobutane/Cyclopentane (98/2) | 1.91 | 3.43 |
| Isobutane/Cyclobutene (98/2) | 0.13 | 0.23 |
| Isobutane/cis-Butene (98/2) | 0.12 | 0.22 |
| Isobutane/1-Butyne (98/2) | 0.16 | 0.30 |
| Isobutane/1-Pentene (98/2) | 0.86 | 1.54 |
| Isobutane/Cyclopropane (99.5/0.5) | 0.08 | 0.14 |
| Isobutane/Propane (99.5/0.5) | 0.18 | 0.33 |
| Isobutane/Butane (99.5/0.5) | 0.02 | 0.03 |
| Isobutane/Cyclobutane (99.5/0.5) | 0.08 | 0.14 |
| Isobutane/Methane (99.5/0.5) | 16.46 | 29.63 |
| Isobutane/Ethane (99.5/0.5) | 1.60 | 2.87 |
| Isobutane/Propylene (99.5/0.5) | 0.42 | 0.75 |
| Isobutane (100) | 0.00 | 0.00 |
| Isobutane/Butene (99.5/0.5) | 0.00 | 0.00 |
| Isobutane/Propyne (99.5/0.5) | 0.04 | 0.07 |
| Isobutane/Isobutene (99.5/0.5) | 0.00 | 0.00 |
| Isobutane/Ethylene (99.5/0.5) | 2.67 | 4.81 |
| Isobutane/Pentane (99.5/0.5) | 0.28 | 0.50 |
| Isobutane/Isopentane (99.5/0.5) | 0.19 | 0.35 |
| Isobutane/Cyclopentane (99.5/0.5) | 0.48 | 0.87 |
| Isobutane/Cyclobutene (99.5/0.5) | 0.03 | 0.06 |
| Isobutane/cis-Butene (99.5/0.5) | 0.03 | 0.06 |
| Isobutane/1-Butyne (99.5/0.5) | 0.04 | 0.08 |
| Isobutane/1-Pentene (99.5/0.5) | 0.22 | 0.39 |
| Isobutane/Cyclopropane (99.9/0.1) | 0.02 | 0.03 |
| Isobutane/Propane (99.9/0.1) | 0.04 | 0.07 |
| Isobutane/Butane (99.9/0.1) | 0.00 | 0.01 |
| Isobutane/Cyclobutane (99.9/0.1) | 0.02 | 0.03 |
| Isobutane/Methane (99.9/0.1) | 3.81 | 6.86 |
| Isobutane/Ethane (99.9/0.1) | 0.33 | 0.59 |
| Isobutane/Propylene (99.9/0.1) | 0.09 | 0.15 |
| Isobutane (100) | 0.00 | 0.00 |
| Isobutane/Butene (99.9/0.1) | 0.00 | 0.00 |
| Isobutane/Propyne (99.9/0.1) | 0.01 | 0.01 |
| Isobutane/Isobutene (99.9/0.1) | 0.00 | 0.00 |
| Isobutane/Ethylene (99.9/0.1) | 0.55 | 0.99 |
| Isobutane/Pentane (99.9/0.1) | 0.06 | 0.10 |
| Isobutane/Isopentane (99.9/0.1) | 0.04 | 0.07 |
| Isobutane/Cyclopentane (99.9/0.1) | 0.10 | 0.18 |
| Isobutane/Cyclobutene (99.9/0.1) | 0.01 | 0.01 |
| Isobutane/cis-Butene (99.9/0.1) | 0.01 | 0.01 |
| Isobutane/1-Butyne (99.9/0.1) | 0.01 | 0.02 |
| Isobutane/1-Pentene (99.9/0.1) | 0.04 | 0.08 |

The results demonstrate that additional compounds, such as cyclopropane, propane, butane, cyclobutene, methane, ethane, propylene, butene, propyne, ethylene, pentane, isopentane, cyclopentane, cyclobutene, cis-butene, 1-butyne and 1-pentene, generate glide against propane and isobutane at all temperatures. Thus, according to the present invention, the concentration of such additional compounds is limited to below 2 wt. %, preferably below 1 wt. %, more preferably below 0.5 wt. %, most preferably below 0.1 wt. %, in order to keep glide as low as possible.

### Example 45: Cooling Performance

The glide, pressures, discharge temperatures, relative COP (energy efficiency) and relative cooling capacity were determined for the following conditions, with relative COP and relative cooling capacity being compared to pure propane or isobutane:

Condenser Bubble Pt. Temp: 46.1° C.
Amount of Subcooling: 8.3° C.
Evaporator Dew Pt. Temp: 10° C.
Amount of Superheat: 11.1° C.
Compressor Isentropic Efficiency: 70%

The results are displayed in Tables 94-95.

TABLE 94

| | Condenser | Evaporator | Relative | Relative |
|---|---|---|---|---|
| Composition (wt. %) | Glide [° C.] | Glide [° C.] | Capacity | COP |
| R-410A | 0.1 | 0.1 | 1.706 | 0.932 |
| R-22 | 0.0 | 0.0 | 1.166 | 0.994 |
| R-134a | 0.0 | 0.0 | 0.778 | 1.018 |
| R-1234yf | 0.0 | 0.0 | 0.743 | 1.001 |
| Propane | 0.0 | 0.0 | 1.000 | 1.000 |
| Propane/Cyclopropane (98/2) | 0.0 | 0.0 | 1.001 | 1.000 |
| Propane/Isobutane (98/2) | 0.5 | 0.5 | 0.975 | 0.983 |
| Propane/Butane (98/2) | 0.8 | 1.0 | 0.960 | 0.969 |
| Propane/Cyclobutane (98/2) | 1.3 | 1.6 | 0.942 | 0.951 |
| Propane/Methane (98/2) | 19.1 | 5.1 | 1.007 | 0.643 |
| Propane/Ethane (98/2) | 1.6 | 1.1 | 1.014 | 0.950 |
| Propane/Propylene (98/2) | 0.0 | 0.0 | 1.004 | 0.999 |
| Propane/Butene (98/2) | 0.6 | 0.8 | 0.968 | 0.977 |
| Propane/Propyne (98/2) | 0.0 | 0.1 | 0.995 | 0.999 |
| Propane/Isobutene (98/2) | 0.4 | 0.5 | 0.977 | 0.986 |
| Propane/Ethylene (98/2) | 3.2 | 1.8 | 1.014 | 0.910 |
| Propane/Pentane (98/2) | 2.4 | 3.6 | 0.890 | 0.894 |
| Propane/Isopentane (98/2) | 1.8 | 2.5 | 0.919 | 0.924 |
| Propane/Cyclopentane (98/2) | 3.4 | 5.5 | 0.839 | 0.843 |
| Propane/Cyclobutene (98/2) | 1.0 | 1.2 | 0.955 | 0.964 |
| Propane/cis-Butene (98/2) | 1.0 | 1.2 | 0.955 | 0.963 |
| Propane/1-Butyne (98/2) | 1.0 | 1.4 | 0.950 | 0.959 |
| Propane/1-Pentene (98/2) | 2.1 | 3.0 | 0.906 | 0.911 |
| Propane/Cyclopropane (99.5/0.5) | 0.0 | 0.0 | 1.000 | 1.000 |
| Propane/Isobutane (99.5/0.5) | 0.1 | 0.1 | 0.994 | 0.996 |
| Propane/Butane (99.5/0.5) | 0.2 | 0.3 | 0.990 | 0.992 |
| Propane/Cyclobutane (99.5/0.5) | 0.3 | 0.4 | 0.985 | 0.987 |
| Propane/Methane (99.5/0.5) | 6.2 | 1.6 | 1.002 | 0.855 |
| Propane/Ethane (99.5/0.5) | 0.4 | 0.3 | 1.003 | 0.987 |
| Propane/Propylene (99.5/0.5) | 0.0 | 0.0 | 1.001 | 1.000 |
| Propane/Butene (99.5/0.5) | 0.2 | 0.2 | 0.992 | 0.994 |
| Propane/Propyne (99.5/0.5) | 0.0 | 0.0 | 0.999 | 1.000 |
| Propane/Isobutene (99.5/0.5) | 0.1 | 0.1 | 0.994 | 0.996 |
| Propane/Ethylene (99.5/0.5) | 0.8 | 0.5 | 1.003 | 0.975 |
| Propane/Pentane (99.5/0.5) | 0.6 | 0.9 | 0.972 | 0.972 |
| Propane/Isopentane (99.5/0.5) | 0.4 | 0.6 | 0.979 | 0.980 |
| Propane/Cyclopentane (99.5/0.5) | 0.8 | 1.3 | 0.959 | 0.957 |
| Propane/Cyclobutene (99.5/0.5) | 0.2 | 0.3 | 0.988 | 0.990 |
| Propane/cis-Butene (99.5/0.5) | 0.2 | 0.3 | 0.988 | 0.990 |
| Propane/1-Butyne (99.5/0.5) | 0.3 | 0.4 | 0.987 | 0.989 |
| Propane/1-Pentene (99.5/0.5) | 0.5 | 0.7 | 0.976 | 0.976 |
| Propane/Cyclopropane (99.9/0.1) | 0.0 | 0.0 | 1.000 | 1.000 |
| Propane/Isobutane (99.9/0.1) | 0.0 | 0.0 | 0.999 | 0.999 |
| Propane/Butane (99.9/0.1) | 0.0 | 0.1 | 0.998 | 0.998 |
| Propane/Cyclobutane (99.9/0.1) | 0.1 | — | 0.997 | 0.997 |
| Propane/Methane (99.9/0.1) | 1.3 | 0.3 | 1.000 | 0.965 |
| Propane/Ethane (99.9/0.1) | 0.1 | 0.1 | 1.001 | 0.997 |
| Propane/Propylene (99.9/0.1) | 0.0 | 0.0 | 1.000 | 1.000 |
| Propane/Butene (99.9/0.1) | 0.0 | 0.0 | 0.998 | 0.999 |
| Propane/Propyne (99.9/0.1) | 0.0 | 0.0 | 1.000 | 1.000 |
| Propane/Isobutene (99.9/0.1) | 0.0 | 0.0 | 0.999 | 0.999 |
| Propane/Ethylene (99.9/0.1) | 0.2 | 0.1 | 1.001 | 0.995 |
| Propane/Pentane (99.9/0.1) | 0.1 | 0.2 | 0.994 | 0.994 |
| Propane/Isopentane (99.9/0.1) | 0.1 | 0.1 | 0.996 | 0.996 |
| Propane/Cyclopentane (99.9/0.1) | 0.2 | 0.3 | 0.992 | 0.991 |
| Propane/Cyclobutene (99.9/0.1) | 0.0 | 0.1 | 0.998 | 0.998 |
| Propane/cis-Butene (99.9/0.1) | 0.0 | 0.1 | 0.998 | 0.998 |
| Propane/1-Butyne (99.9/0.1) | 0.1 | — | 0.997 | 0.998 |
| Propane/1-Pentene (99.9/0.1) | 0.1 | 0.1 | 0.995 | 0.995 |

| | | | Compressor |
|---|---|---|---|
| | Condenser | Evaporator | Discharge |
| Composition (wt. %) | Pressure [Mpa] | Pressure [Mpa] | Temp [° C.] |
| R-410A | 2.806 | 1.085 | 81.6 |
| R-22 | 1.775 | 0.681 | 84.6 |
| R-134a | 1.194 | 0.415 | 69.2 |
| R-1234yf | 1.186 | 0.438 | 60.8 |
| Propane | 1.573 | 0.637 | 68.5 |
| Propane/Cyclopropane (98/2) | 1.573 | 0.637 | 68.7 |
| Propane/Isobutane (98/2) | 1.555 | 0.619 | 69.1 |
| Propane/Butane (98/2) | 1.552 | 0.609 | 69.8 |
| Propane/Cyclobutane (98/2) | 1.549 | 0.597 | 70.9 |
| Propane/Methane (98/2) | 2.560 | 0.678 | 94.0 |
| Propane/Ethane (98/2) | 1.672 | 0.653 | 70.9 |
| Propane/Propylene (98/2) | 1.581 | 0.640 | 68.7 |
| Propane/Butene (98/2) | 1.554 | 0.614 | 69.5 |
| Propane/Propyne (98/2) | 1.564 | 0.631 | 68.8 |
| Propane/Isobutene (98/2) | 1.556 | 0.620 | 69.1 |
| Propane/Ethylene (98/2) | 1.743 | 0.656 | 73.1 |
| Propane/Pentane (98/2) | 1.551 | 0.566 | 73.2 |
| Propane/Isopentane (98/2) | 1.552 | 0.584 | 71.7 |
| Propane/Cyclopentane (98/2) | 1.549 | 0.534 | 76.2 |
| Propane/Cyclobutene (98/2) | 1.550 | 0.605 | 70.4 |
| Propane/cis-Butene (98/2) | 1.551 | 0.605 | 70.2 |
| Propane/1-Butyne (98/2) | 1.550 | 0.601 | 70.4 |
| Propane/1-Pentene (98/2) | 1.551 | 0.575 | 72.4 |
| Propane/Cyclopropane (99.5/0.5) | 1.573 | 0.637 | 68.6 |
| Propane/Isobutane (99.5/0.5) | 1.568 | 0.632 | 68.7 |
| Propane/Butane (99.5/0.5) | 1.568 | 0.630 | 68.9 |
| Propane/Cyclobutane (99.5/0.5) | 1.567 | 0.626 | 69.1 |
| Propane/Methane (99.5/0.5) | 1.834 | 0.647 | 76.4 |
| Propane/Ethane (99.5/0.5) | 1.598 | 0.641 | 69.1 |
| Propane/Propylene (99.5/0.5) | 1.575 | 0.637 | 68.6 |
| Propane/Butene (99.5/0.5) | 1.568 | 0.631 | 68.8 |
| Propane/Propyne (99.5/0.5) | 1.571 | 0.635 | 68.6 |
| Propane/Isobutene (99.5/0.5) | 1.569 | 0.633 | 68.7 |
| Propane/Ethylene (99.5/0.5) | 1.615 | 0.641 | 69.7 |
| Propane/Pentane (99.5/0.5) | 1.567 | 0.618 | 69.7 |
| Propane/Isopentane (99.5/0.5) | 1.568 | 0.623 | 69.3 |
| Propane/Cyclopentane (99.5/0.5) | 1.567 | 0.610 | 70.4 |
| Propane/Cyclobutene (99.5/0.5) | 1.567 | 0.628 | 69.0 |
| Propane/cis-Butene (99.5/0.5) | 1.567 | 0.628 | 69.0 |
| Propane/1-Butyne (99.5/0.5) | 1.567 | 0.628 | 69.0 |
| Propane/1-Pentene (99.5/0.5) | 1.567 | 0.621 | 69.5 |
| Propane/Cyclopropane (99.9/0.1) | 1.573 | 0.637 | 68.5 |
| Propane/Isobutane (99.9/0.1) | 1.572 | 0.636 | 68.6 |
| Propane/Butane (99.9/0.1) | 1.572 | 0.635 | 68.6 |
| Propane/Cyclobutane (99.9/0.1) | 1.572 | 0.635 | 68.7 |
| Propane/Methane (99.9/0.1) | 1.626 | 0.639 | 70.2 |
| Propane/Ethane (99.9/0.1) | 1.578 | 0.637 | 68.7 |
| Propane/Propylene (99.9/0.1) | 1.573 | 0.637 | 68.5 |
| Propane/Butene (99.9/0.1) | 1.572 | 0.635 | 68.6 |
| Propane/Propyne (99.9/0.1) | 1.572 | 0.636 | 68.5 |
| Propane/Isobutene (99.9/0.1) | 1.572 | 0.636 | 68.6 |
| Propane/Ethylene (99.9/0.1) | 1.581 | 0.638 | 68.8 |
| Propane/Pentane (99.9/0.1) | 1.572 | 0.633 | 68.8 |
| Propane/Isopentane (99.9/0.1) | 1.572 | 0.634 | 68.7 |
| Propane/Cyclopentane (99.9/0.1) | 1.572 | 0.631 | 68.9 |
| Propane/Cyclobutene (99.9/0.1) | 1.572 | 0.635 | 68.6 |
| Propane/cis-Butene (99.9/0.1) | 1.572 | 0.635 | 68.6 |
| Propane/1-Butyne (99.9/0.1) | 1.572 | 0.635 | 68.6 |
| Propane/1-Pentene (99.9/0.1) | 1.572 | 0.633 | 68.7 |

TABLE 95

| | Condenser | Evaporator | Relative | Relative |
|---|---|---|---|---|
| Composition (wt. %) | Glide [° C.] | Glide [° C.] | Capacity | COP |
| Isobutane/Cyclopropane (98/2) | 0.3 | 0.2 | 1.012 | 0.991 |
| Isobutane/Propane (98/2) | 0.7 | 0.5 | 1.013 | 0.979 |
| Isobutane/Butane (98/2) | 0.1 | 0.1 | 0.992 | 0.998 |
| Isobutane/Cyclobutane (98/2) | 0.3 | 0.4 | 0.979 | 0.989 |
| Isobutane/Methane (98/2) | 46.8 | 6.1 | 1.005 | 0.465 |
| Isobutane/Ethane (98/2) | 6.1 | 2.6 | 1.020 | 0.856 |
| Isobutane/Propylene (98/2) | 1.5 | 1.0 | 1.015 | 0.957 |
| Isobutane (100) | 0.0 | 0.0 | 1.000 | 1.000 |
| Isobutane/Butene (98/2) | 0.0 | 0.0 | 0.999 | 1.000 |
| Isobutane/Propyne (98/2) | 0.2 | 0.1 | 1.011 | 0.996 |
| Isobutane/Isobutene (98/2) | 0.0 | 0.0 | 0.999 | 1.000 |
| Isobutane/Ethylene (98/2) | 9.9 | 3.3 | 1.019 | 0.788 |
| Isobutane/Pentane (98/2) | 1.1 | 1.4 | 0.944 | 0.958 |
| Isobutane/Isopentane (98/2) | 0.8 | 0.9 | 0.960 | 0.972 |
| Isobutane/Cyclopentane (98/2) | 2.0 | 2.5 | 0.907 | 0.924 |
| Isobutane/Cyclobutene (98/2) | 0.1 | 0.1 | 0.989 | 0.996 |
| Isobutane/cis-Butene (98/2) | 0.1 | 0.1 | 0.989 | 0.996 |
| Isobutane/1-Butyne (98/2) | 0.2 | 0.2 | 0.985 | 0.994 |
| Isobutane/1-Pentene (98/2) | 0.9 | 1.0 | 0.955 | 0.968 |
| Isobutane/Cyclopropane (99.5/0.5) | 0.1 | 0.1 | 1.003 | 0.998 |
| Isobutane/Propane (99.5/0.5) | 0.2 | 0.1 | 1.003 | 0.994 |
| Isobutane/Butane (99.5/0.5) | 0.0 | 0.0 | 0.998 | 0.999 |
| Isobutane/Cyclobutane (99.5/0.5) | 0.1 | 0.1 | 0.995 | 0.997 |
| Isobutane/Methane (99.5/0.5) | 17.4 | 2.0 | 1.001 | 0.700 |
| Isobutane/Ethane (99.5/0.5) | 1.6 | 0.7 | 1.005 | 0.957 |
| Isobutane/Propylene (99.5/0.5) | 0.4 | 0.3 | 1.004 | 0.988 |
| Isobutane (100) | 0.0 | 0.0 | 1.000 | 1.000 |
| Isobutane/Butene (99.5/0.5) | 0.0 | 0.0 | 1.000 | 1.000 |
| Isobutane/Propyne (99.5/0.5) | 0.0 | 0.0 | 1.003 | 0.999 |
| Isobutane/Isobutene (99.5/0.5) | 0.0 | 0.0 | 1.000 | 1.000 |
| Isobutane/Ethylene (99.5/0.5) | 2.8 | 0.9 | 1.005 | 0.931 |
| Isobutane/Pentane (99.5/0.5) | 0.3 | 0.3 | 0.986 | 0.989 |
| Isobutane/Isopentane (99.5/0.5) | 0.2 | 0.2 | 0.990 | 0.993 |
| Isobutane/Cyclopentane (99.5/0.5) | 0.5 | 0.6 | 0.976 | 0.980 |
| Isobutane/Cyclobutene (99.5/0.5) | 0.0 | 0.0 | 0.997 | 0.999 |
| Isobutane/cis-Butene (99.5/0.5) | 0.0 | 0.0 | 0.997 | 0.999 |
| Isobutane/1-Butyne (99.5/0.5) | 0.0 | 0.1 | 0.996 | 0.998 |
| Isobutane/1-Pentene (99.5/0.5) | 0.2 | 0.3 | 0.988 | 0.992 |
| Isobutane/Cyclopropane (99.9/0.1) | 0.0 | 0.0 | 1.001 | 1.000 |
| Isobutane/Propane (99.9/0.1) | 0.0 | 0.0 | 1.001 | 0.999 |
| Isobutane/Butane (99.9/0.1) | 0.0 | 0.0 | 1.000 | 1.000 |
| Isobutane/Cyclobutane (99.9/0.1) | 0.0 | 0.0 | 0.999 | 0.999 |
| Isobutane/Methane (99.9/0.1) | 4.1 | 0.4 | 1.000 | 0.907 |
| Isobutane/Ethane (99.9/0.1) | 0.3 | 0.1 | 1.001 | 0.991 |
| Isobutane/Propylene (99.9/0.1) | 0.1 | 0.1 | 1.001 | 0.997 |
| Isobutane (100) | 0.0 | 0.0 | 1.000 | 1.000 |
| Isobutane/Butene (99.9/0.1) | 0.0 | 0.0 | 1.000 | 1.000 |
| Isobutane/Propyne (99.9/0.1) | 0.0 | 0.0 | 1.001 | 1.000 |
| Isobutane/Isobutene (99.9/0.1) | 0.0 | 0.0 | 1.000 | 1.000 |
| Isobutane/Ethylene (99.9/0.1) | 0.6 | 0.2 | 1.001 | 0.985 |
| Isobutane/Pentane (99.9/0.1) | 0.1 | 0.1 | 0.997 | 0.998 |
| Isobutane/Isopentane (99.9/0.1) | 0.0 | 0.0 | 0.998 | 0.999 |
| Isobutane/Cyclopentane (99.9/0.1) | 0.1 | 0.1 | 0.995 | 0.996 |
| Isobutane/Cyclobutene (99.9/0.1) | 0.0 | 0.0 | 0.999 | 1.000 |
| Isobutane/cis-Butene (99.9/0.1) | 0.0 | 0.0 | 0.999 | 1.000 |
| Isobutane/1-Butyne (99.9/0.1) | 0.0 | 0.0 | 0.999 | 1.000 |
| Isobutane/1-Pentene (99.9/0.1) | 0.0 | 0.1 | 0.998 | 0.998 |

| | | | Compressor |
|---|---|---|---|
| | Condenser | Evaporator | Discharge |
| Composition (wt. %) | Pressure [Mpa] | Pressure [Mpa] | Temp [° C.] |
| Isobutane/Cyclopropane (98/2) | 0.635 | 0.224 | 62.0 |
| Isobutane/Propane (98/2) | 0.644 | 0.225 | 62.3 |
| Isobutane/Butane (98/2) | 0.618 | 0.219 | 61.4 |
| Isobutane/Cyclobutane (98/2) | 0.615 | 0.215 | 62.0 |
| Isobutane/Methane (98/2) | 1.923 | 0.238 | 109.1 |
| Isobutane/Ethane (98/2) | 0.751 | 0.229 | 68.2 |
| Isobutane/Propylene (98/2) | 0.661 | 0.226 | 63.2 |
| Isobutane (100) | 0.621 | 0.221 | 61.3 |
| Isobutane/Butene (98/2) | 0.621 | 0.220 | 61.4 |
| Isobutane/Propyne (98/2) | 0.630 | 0.223 | 61.9 |
| Isobutane/Isobutene (98/2) | 0.621 | 0.220 | 61.4 |
| Isobutane/Ethylene (98/2) | 0.828 | 0.230 | 72.2 |
| Isobutane/Pentane (98/2) | 0.613 | 0.207 | 62.9 |
| Isobutane/Isopentane (98/2) | 0.614 | 0.211 | 62.3 |
| Isobutane/Cyclopentane (98/2) | 0.612 | 0.199 | 64.5 |
| Isobutane/Cyclobutene (98/2) | 0.617 | 0.217 | 61.8 |
| Isobutane/cis-Butene (98/2) | 0.617 | 0.218 | 61.7 |
| Isobutane/1-Butyne (98/2) | 0.616 | 0.216 | 61.8 |
| Isobutane/1-Pentene (98/2) | 0.614 | 0.210 | 62.6 |
| Isobutane/Cyclopropane (99.5/0.5) | 0.625 | 0.221 | 61.5 |
| Isobutane/Propane (99.5/0.5) | 0.627 | 0.222 | 61.6 |
| Isobutane/Butane (99.5/0.5) | 0.621 | 0.220 | 61.3 |
| Isobutane/Cyclobutane (99.5/0.5) | 0.620 | 0.219 | 61.5 |
| Isobutane/Methane (99.5/0.5) | 0.962 | 0.225 | 78.9 |
| Isobutane/Ethane (99.5/0.5) | 0.654 | 0.223 | 63.1 |
| Isobutane/Propylene (99.5/0.5) | 0.632 | 0.222 | 61.8 |
| Isobutane (100) | 0.622 | 0.221 | 61.3 |
| Isobutane/Butene (99.5/0.5) | 0.621 | 0.220 | 61.3 |
| Isobutane/Propyne (99.5/0.5) | 0.624 | 0.221 | 61.5 |
| Isobutane/Isobutene (99.5/0.5) | 0.622 | 0.221 | 61.3 |
| Isobutane/Ethylene (99.5/0.5) | 0.674 | 0.223 | 64.3 |
| Isobutane/Pentane (99.5/0.5) | 0.620 | 0.217 | 61.7 |
| Isobutane/Isopentane (99.5/0.5) | 0.620 | 0.218 | 61.6 |
| Isobutane/Cyclopentane (99.5/0.5) | 0.619 | 0.215 | 62.1 |
| Isobutane/Cyclobutene (99.5/0.5) | 0.620 | 0.220 | 61.4 |
| Isobutane/cis-Butene (99.5/0.5) | 0.620 | 0.220 | 61.4 |
| Isobutane/1-Butyne (99.5/0.5) | 0.620 | 0.220 | 61.4 |
| Isobutane/1-Pentene (99.5/0.5) | 0.620 | 0.218 | 61.6 |
| Isobutane/Cyclopropane (99.9/0.1) | 0.622 | 0.221 | 61.4 |
| Isobutane/Propane (99.9/0.1) | 0.623 | 0.221 | 61.4 |
| Isobutane/Butane (99.9/0.1) | 0.621 | 0.221 | 61.3 |
| Isobutane/Cyclobutane (99.9/0.1) | 0.621 | 0.220 | 61.4 |
| Isobutane/Methane (99.9/0.1) | 0.691 | 0.221 | 65.5 |
| Isobutane/Ethane (99.9/0.1) | 0.628 | 0.221 | 61.7 |
| Isobutane/Propylene (99.9/0.1) | 0.624 | 0.221 | 61.4 |
| Isobutane (100) | 0.622 | 0.221 | 61.3 |
| Isobutane/Butene (99.9/0.1) | 0.622 | 0.221 | 61.3 |
| Isobutane/Propyne (99.9/0.1) | 0.622 | 0.221 | 61.3 |
| Isobutane/Isobutene (99.9/0.1) | 0.622 | 0.221 | 61.3 |
| Isobutane/Ethylene (99.9/0.1) | 0.632 | 0.221 | 61.9 |
| Isobutane/Pentane (99.9/0.1) | 0.621 | 0.220 | 61.4 |
| Isobutane/Isopentane (99.9/0.1) | 0.621 | 0.220 | 61.4 |
| Isobutane/Cyclopentane (99.9/0.1) | 0.621 | 0.219 | 61.5 |
| Isobutane/Cyclobutene (99.9/0.1) | 0.621 | 0.220 | 61.3 |
| Isobutane/cis-Butene (99.9/0.1) | 0.621 | 0.220 | 61.3 |
| Isobutane/1-Butyne (99.9/0.1) | 0.621 | 0.220 | 61.3 |
| Isobutane/1-Pentene (99.9/0.1) | 0.621 | 0.220 | 61.4 |

The results demonstrate that the presence of additional compounds such as cyclopropane, propane, butane, cyclobutene, methane, ethane, propylene, butene, propyne, ethylene, pentane, isopentane, cyclopentane, cyclobutene, cis-butene, 1-butyne and 1-pentene, results in a composition having reduced COP and/or CAP against (pure) propane and isobutane. Thus, according to the present invention, the concentration of such additional compounds is limited to below 2 wt. %, preferably below 1 wt. %, more preferably below 0.5 wt. %, most preferably below 0.1 wt. %, in order to minimize any negative impact on COP and CAP.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A composition comprising:
(i) HFO-1234ze(E);
(ii) a hydrocarbon component selected from the group consisting of propane and isobutane;
(iii) one or more additional compounds selected from the group consisting of:
(a) one or more, two or more, three or more or four or more additional compounds selected from the group consisting of HFC-134a, HFC-134, HFO-1225zc, HFO-1234yf, HFC-245cb, HFC-236fa, HFO-1234zc, HFC-245fa, HCFC-124, CFC-114, trifluoropropyne, HFC-152a, HFO-1225ye(Z), HFO-1225ye(E), HCFO-1233xf, HFC-263fb, HFO-1243zf, HCFO-1233zd(E), HFO-1234ze(Z) and combinations thereof;
(b) one or more, two or more, three or more of four or more additional compounds selected from the group consisting of HFO-1234yf, HFC-143a, HFC-152a, HFO-1243zf, HCFO-1233xf, HCFO-1233zd(E), HCFO-1233zd(Z), HCFO-1224yd, HCFO-1224zc, HCFO-1326mxz, CFC-113, HFC-32, HFC-23, trifluoropropyne and combinations thereof; and
(c) one or more, two or more, three or more or four or more additional compounds selected from the group consisting of HFO-1234yf, HFC-143a, HFC-152a, HFO-1243zf, HCFO-1233xf, HCFO-1233zd(E), HCFO-1233zd(Z), HCFO-1224yd, HCFO-1224zc, HCFO-1326mxz, CFC-113, HFC-32, HFC-23, trifluoropropyne, HFC-125, HFC-143, HFC-134, HFC-263fb, CFC-114, CFC-114a, HCC-40, HCO-1140, HCFO-1113, CFC-13, CFC-12, HFC-227ca, HCFO-1131(E), HCFC-124, HCFC-124a, HFC-134a, HFC-227ea, CFC-217ca, CFC-217ba and combinations thereof; and
(iv) one or more additional compounds selected from the group consisting of:
(a) when the hydrocarbon component is propane, one or more additional compounds selected from the group consisting of butane, isobutane, propylene, pentane and isopentane, or one or more additional compounds selected from the group consisting of methane, ethane, butadiene, allene, butane, cyclobutane, acetylene, propyne and propylene; or
(b) when the hydrocarbon component is isobutane, one or more additional compounds selected from the group consisting of butane, propane, propylene, pentane and isopentane, or one or more additional compounds selected from the group consisting of methane, ethane, butadiene, allene, methyl cyclopropane, 2-methylpropene, propane, propyne and propylene.

2. The composition of claim 1, wherein the composition comprises from about 2 to about 98 weight percent HFO-1234ze(E) and from about 2 to about 98 weight percent hydrocarbon component.

3. The composition of claim 2, wherein the hydrocarbon component is propane.

4. The composition of claim 2, wherein the hydrocarbon component is isobutane.

5. The composition of claim 1, wherein the composition further comprises HFC-134.

6. The composition of claim 5, wherein the composition comprises from about 2 to about 98 weight percent HFO-1234ze(E), from about 2 to about 98 weight percent HFC-134, and from about 2 to about 98 weight percent hydrocarbon component.

7. The composition of claim 6, wherein the hydrocarbon component is propane.

8. The composition of claim 6, wherein the hydrocarbon component is isobutane.

9. The composition of claim 1, wherein when the hydrocarbon component is propane, the propane component comprises 99.9 wt. % propane and 0.1 wt. % one or more additional compounds selected from the group consisting of isobutane, butane, methane, ethane and combinations thereof.

10. The composition of claim 9, wherein a total amount of methane and ethane is less than 100 ppm, based on the total weight of the propane component.

11. The composition of claim 1, wherein when the hydrocarbon component is propane, the propane component comprises 99.9 wt. % propane and 0.1 wt. % one or more additional compounds selected from the group consisting of isobutane, butane, propylene, methane, ethane and combinations thereof.

12. The composition of claim 11, wherein a total amount of methane and ethane is less than 100 ppm, based on the total weight of the propane component.

13. The composition of claim 11, wherein a total amount of propylene, methane and ethane is less than 100 ppm, based on the total weight of the propane component.

14. The composition of claim 1, wherein when the hydrocarbon component is propane, the propane component comprises 99.9 wt. % propane and 0.1 wt. % one or more additional compounds selected from the group consisting of isobutane, butane, propylene, butadiene, allene, propyne, methane, ethane and combinations thereof.

15. The composition of claim 14, wherein a total amount of propylene, methane and ethane is less than 100 ppm, based on the total weight of the propane component.

16. The composition of claim 14, wherein a total amount of butadiene, allene and propyne is less than 100 ppm, based on the total weight of the propane component.

17. The composition of claim 1, wherein when the hydrocarbon component is isobutane, the isobutane component comprises 99.9 wt. % isobutane and 0.1 wt. % one or more additional compounds selected from the group consisting of butane, 2-methylpropene, methyl cyclopropane, methane, ethane and combinations thereof.

18. The composition of claim 17, wherein a total amount of methane and ethane is less than 100 ppm, based on the total weight of the isobutane component.

19. The composition of claim 17, wherein a total amount of butane, 2-methylpropene, methyl cyclopropane, methane and ethane is less than 100 ppm, based on the total weight of the isobutane component.

20. The composition of claim 19, wherein when the hydrocarbon component is isobutane, the isobutane component comprises 99.9 wt. % isobutane and 0.1 wt. % one or more additional compounds selected from the group consisting of propane, butane, butadiene, propyne, allene, propylene, methane, ethane and combinations thereof.

21. The composition of claim 20, wherein a total amount of methane and ethane is less than 100 ppm, based on the total weight of the isobutane component.

22. The composition of claim 20, wherein a total amount of butadiene, allene and propyne is less than 100 ppm, based on the total weight of the isobutane component.

23. The composition of claim 20, wherein a total amount of propane, butane, butadiene, propyne, allene, propylene, methane and ethane is less than 100 ppm, based on the total weight of the isobutane component.

24. A system for cooling or heating comprising an evaporator, compressor, condenser, and expansion device, said system containing the composition of claim 1.

25. A method for producing heating in a high temperature heat pump, the method comprising condensing the composition of claim 1 in a condenser, wherein the high temperature heat pump uses condenser operating temperatures greater than about 55° C., or from about 55° C. to about 160° C., or from about 55° C. to about 150° C.

26. A high temperature heat pump comprising a condenser and the composition of claim 1, wherein an operating temperature of the condenser is greater than about 55° C., or from about 55° C. to about 160° C., or from about 55° C. to about 150° C., or from about 55° C. to about 130° C.

27. The composition of claim 1, wherein the composition is at least one of a refrigerant composition, dielectric gas, an etching gas and a propellant.

28. A heating or cooling system comprising, in a serial arrangement:
a condenser;
an evaporator; and
a compressor, the system further comprising each of the condenser, evaporator and compressor operably connected, the composition of claim 1 being circulated through each of the condenser, evaporator and compressor.

29. The heating or cooling system of claim 28, wherein the system is an air conditioner for an automotive system, or wherein the system is an air conditioner for a stationary cooling system, or wherein the system is a heat pump for an automotive system, or wherein the system is heat pump for a residential heating or cooling system.

30. A heat pump system comprising the composition of claim 1.

31. The heat pump system of claim 30, wherein the heat pump system is selected from the group consisting of an HEV heat pump system, a MHEV heat pump system, a PHEV heat pump system, and an EV heat pump system.

32. A composition comprising:
(i) HFO-1234ze(Z);
(ii) isobutane;
(iii) one or more additional compounds selected from the group consisting of:
(a) one or more, two or more, or three or more additional compounds selected from the group consisting of HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFC-1131(E), CFC-114a, HCFC-124a, HFC-227ca, HFO-1234yf, HFC-152a, HFO-1234zf, HFC-134, HFC-245cb and combinations thereof;
(b) one or more, two or more, or three or more additional compounds selected from the group consisting of HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131(E), CFC-114a, HCFC-124a, HFC-227ca, HFO-1234yf, HFC-152a, HFO-1243zf, HCC-30, HFC-134a, HFC-236fa, HFO-1327 isomer, HFO-1336mzz(E), CFO-1112a, HFC-227ea, HFC-245cb and combinations thereof;
(c) one or more, two or more, or three or more additional compounds selected from the group consisting of HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131(E), CFC-114a, HCFC-124a, HFC-227ca, HFO-1234yf, HFC-152a, HFO-1243zf, HCC-30, HFC-134a, HFC-236fa, HFO-1327me, HFO-1336mzz(E), CFO-1112a, HFC-227ea, HFC-245cb, CFO-1112 and combinations thereof; and
(d) one or more, two or more, or three or more additional compounds selected from the group consisting of HFO-1234ze(E), HFC-236fa, HFC-227ea, HFC-245fa, HFO-1234zc, CFC-114, HCFO-1233xf, HCFO-1233zd(E), HCFO-1233zd(Z), HFO-1327me, HFO-1336mzz(E), CFO-1112 and combinations thereof; and
(iv) one or more additional compounds selected from the group consisting of butane, propane, propylene, pentane and isopentane, or one or more additional compounds selected from the group consisting of methane, ethane, butadiene, allene, methyl cyclopropane, 2-methylpropene, propane, propyne and propylene.

33. The composition of claim 32, wherein the composition comprises from about 2 to about 98 weight percent HFO-1234ze(E) and from about 2 to about 98 weight percent isobutane.

34. The composition of claim 32, wherein the isobutane component comprises 99.9 wt. % isobutane and 0.1 wt. % one or more additional compounds selected from the group consisting of butane, 2-methylpropene, methyl cyclopropane, methane, ethane and combinations thereof.

35. The composition of claim 34, wherein a total amount of methane and ethane is less than 100 ppm, based on the total weight of the isobutane component.

36. The composition of claim 34, wherein a total amount of butane, 2-methylpropene, methyl cyclopropane, methane and ethane is less than 100 ppm, based on the total weight of the isobutane component.

37. The composition of claim 32, wherein the isobutane component comprises 99.9 wt. % isobutane and 0.1 wt. % one or more additional compounds selected from the group consisting of propane, butane, butadiene, propyne, allene, propylene, methane, ethane and combinations thereof.

38. The composition of claim 37, wherein a total amount of methane and ethane is less than 100 ppm, based on the total weight of the isobutane component.

39. The composition of claim 37, wherein a total amount of butadiene, allene and propyne is less than 100 ppm, based on the total weight of the isobutane component.

40. The composition of claim 37, wherein a total amount of propane, butane, butadiene, propyne, allene, propylene, methane and ethane is less than 100 ppm, based on the total weight of the isobutane component.

41. A system for cooling or heating comprising an evaporator, compressor, condenser, and expansion device, said system containing the composition of claim 32.

42. A method for producing heating in a high temperature heat pump, the method comprising condensing the composition of claim 32 in a condenser, wherein the high temperature heat pump uses condenser operating temperatures greater than about 55° C., or from about 55° C. to about 160° C., or from about 55° C. to about 150° C.

43. A high temperature heat pump comprising a condenser and the composition of claim 32, wherein an operating temperature of the condenser is greater than about 55° C., or from about 55° C. to about 160° C., or from about 55° C. to about 150° C., or from about 55° C. to about 130° C.

44. The composition of claim 32, wherein the composition is at least one of a refrigerant composition, dielectric gas, an etching gas and a propellant.

45. A heating or cooling system comprising, in a serial arrangement:
a condenser;
an evaporator; and
a compressor, the system further comprising each of the condenser, evaporator and compressor operably connected, the composition of claim 32 being circulated through each of the condenser, evaporator and compressor.

46. The heating or cooling system of claim 45, wherein the system is an air conditioner for an automotive system, or wherein the system is an air conditioner for a stationary cooling system, or wherein the system is a heat pump for an automotive system, or wherein the system is heat pump for a residential heating or cooling system.

47. A heat pump system comprising the composition of claim 32.

48. The heat pump system of claim 47, wherein the heat pump system is selected from the group consisting of an HEV heat pump system, a MHEV heat pump system, a PHEV heat pump system, and an EV heat pump system.
